(19) United States
(12) Patent Application Publication
(10) Pub. No.: US 2016/0005260 A1
(43) Pub. Date: Jan. 7, 2016

(54) GAMING MACHINE

(71) Applicants: Universal Entertainment Corporation, Tokyo (JP); Aruze Gaming America, Inc., Las Vegas, NV (US)

(72) Inventors: Yuji MIYAGAWA, Tokyo (JP); Yukihiro KAWAKAMI, Tokyo (JP); Takeshi NARITA, Tokyo (JP); Hiroki NAKAMURA, Tokyo (JP); Hiromoto YAMAUCHI, Tokyo (JP); Yoichi KATO, Tokyo (JP)

(21) Appl. No.: 14/788,907

(22) Filed: Jul. 1, 2015

(30) Foreign Application Priority Data
Jul. 3, 2014 (JP) 2014-137919

(51) Int. Cl. G07F 17/32

(52) U.S. Cl. CPC G07F 17/3211

(57) ABSTRACT

The gaming machine includes: a display for displaying a game outcome in a base game mode; and a controller for controlling a first transition route along which a game mode is directly shifted to a free game mode in accordance with the game outcome and a second transition route along which once via a transit game mode, the game mode is shifted to the free game mode in accordance with the game outcome. The controller is programmed to control a game so as to make a probability with which along the second transition route, the game mode is shifted from the transit game mode to the free game mode higher than a probability with which along the first transition route, the game mode is shifted from the base game mode to the free game mode.

### CROSS-REFERENCE TO RELATED APPLICATION

This application claims the benefit of Japanese Patent Application No. 2014-137919, filed on Jul. 3, 2014, which application is incorporated herein by reference in its entirety.

### FIELD OF THE INVENTION

The present invention relates generally to a gaming machine and in particular, to a gaming machine which rearranges symbols in each unit game and changes a mode as effects, in which the symbols are displayed, in the process of the unit game.

### BACKGROUND OF THE INVENTION

Conventionally, there has been known a slot machine in which a plurality of kinds of symbols are displayed in a scrolling manner and thereafter, the plurality of kinds of symbols are displayed in a stopped manner, and based on a combination (winning pattern) of the symbols displayed in the stopped manner, gaming media (for example, coins) are provided (for example, refer to U.S. Pat. No. 6,960,133, U.S. Pat. No. 6,012,983, and U.S. Pat. No. 6,093,102).

Further, as such a slot machine, there is a slot machine in which when a predetermined condition (for example, the condition that specific symbols are displayed in the stopped manner) is established, free games are executed (for example, refer to Australian Patent Application Laid-Open Publication No. 1972901, U.S. Pat. No. 6,913,532, and U.S. Pat. No. 6,491,584). Each of the free games is a game which can be initiated without betting any gaming media and without consuming any gaming media.

Since each of the free games can be played without consuming any gaming media, in general, a player is playing a game while having a sense of high expectancy for shifting to the free games. Upon shifting to the free games, it is likely that a player could increase a profit without consuming any gaming media. Therefore, since depending on the setting of a condition for shifting to the free games, an excessive profit is provided for a player or a gaming facility is excessively protected, it is difficult to take a balance between the both sides.

In view of the above-described point, the present invention was made, and an object of the present invention is to provide a gaming machine which facilitates taking a balance between a profit provided to a player and a profit of a gaming facility.

### BRIEF SUMMARY OF THE INVENTION

A gaming machine according to the present embodiment includes: a display for displaying a game outcome in a base game mode; and a controller for controlling a first transition route along which a game mode is directly shifted to a free game mode in accordance with the game outcome and a second transition route along which once via a transit game mode, the game mode is shifted to the free game mode in accordance with the game outcome, and the controller is programmed to control a game so as to make a probability with which along the second transition route, the game mode is shifted from the transit game mode to the free game mode higher than a probability with which along the first transition route, the game mode is shifted from the base game mode to the free game mode.

Since the game mode is shifted from the base game mode to the free game mode along the first transition route or the second transition route, probabilities, with each of which the game is shifted to the free game mode, can be adjusted by the two kinds of routes of the first transition route having the probability and the second transition route having the probability. By adjusting the probabilities of the two kinds of routes, it is made possible to facilitate taking a balance between a profit of a gaming facility and a profit of a player.

In the gaming machine according to the present embodiment, the controller is further programmed to execute processes described below: a process in which when the game mode is shifted to the transit game mode along the second transition route, image information indicating that the game mode is the transit game mode is displayed on the display; a process in which after the game mode has been shifted to the transit game mode along the second transition route, a drawing table used in the base game mode to draw for shifting to the free game mode is changed to a high probability drawing table, the high probability drawing table having a higher probability with which the game mode is shifted to the free game mode than a probability of the drawing table with which the game mode is shifted to the free game mode; and a process in which a predetermined number of games in the transit game mode executed by using the high probability drawing table is managed, and when the predetermined number of games have been played, the game mode is shifted to the base game mode.

Since when the game mode has been shifted to the transit game mode, the image information indicating that the game mode is the transit game mode is displayed on the display, a player can be notified that a player is playing the game along the second transition route, thereby allowing a player to expect that the game mode will be shifted to the free game mode.

Since the drawing table is changed to the high probability drawing table, the game mode can be shifted to the free game mode with sureness. Further, when in the transit game mode, the predetermined number of games have been played, the game mode is shifted (is returned) to the base game mode, it is made possible for the game mode not to be excessively shifted to the free game mode.

In the gaming machine according to the present embodiment, a probability with which the game mode is shifted from the base game mode to the free game mode along the first transition route is set to be low, as compared with a probability with which the game mode is shifted from the base game mode to the transit game mode along the second transition route, and the controller is further programmed to execute processes described below: a process which is conducted such that with the base game mode as a starting point, a probability with which the game mode is shifted to the free game mode along the second transition route is high as a whole, as compared with a probability with which the game mode is shifted to the free game mode along the first transition route.

The probability with which the game mode is shifted to the free game mode along the first transition route, the probability with which the game mode is shifted to the transit game mode along the second transition route, and the whole probability with which the game mode is shifted to the free game mode are set, thereby allowing a balance between a profit of a gaming facility and a profit of a player to be taken.

The controller is controlled such that the probability with which the game mode is shifted via the transit game mode to the free game mode is set to be high as a whole and the game mode is at least often shifted to the transit game mode, thereby allowing a sense of expectancy of a player to be enhanced.

A gaming machine according to the present embodiment includes: a display for displaying an outcome of a unit game by rearranging a plurality of symbols; and a controller for executing a unit game in a base game mode played on the condition of placing a bet and a unit game in a free game mode which does not require any bet to be placed, and the controller is programmed to execute processes described below: a process (4-1) which is a transit game mode shifting process in which in the base game mode, upon the occurrence of a trigger which is generated when a first specific symbol is selected by conducting a symbol drawing process in which symbols to be rearranged are selected by a drawing, a game mode is shifted to a transit game mode; and a process (4-2) which is a free game mode shifting process in which in the transit game mode, upon the occurrence of a trigger which is generated when a second specific symbol is selected by conducting the symbol drawing process, the game mode is shifted from the transit game mode to the free game mode.

Since the game mode is shifted from the base game mode via the transit game mode to the free game mode, the probabilities, with each of which the game mode is shifted to the transit game mode and the game mode is shifted to the free game mode, can be adjusted by two stages of the probabilities. In addition, by providing the first specific symbols to shift to the transit game mode, a player pays attention not only to the second specific symbols to shift to the free game mode, but a player pays attention also to the first specific symbols with which the game mode is switched from the base game mode to another game mode, thereby allowing amusement of the game to be enhanced. Further, the probabilities in the base game mode and the transit game mode, with each of which the game mode is shifted to the free game mode, are made different from each other, thereby enhancing amusement of the game.

In the gaming machine according to the present embodiment, further, the controller executes a process (5-1) which is a free game mode shifting process in which in the base game mode, upon the occurrence of a trigger which is generated when the second specific symbol is selected by conducting the symbol drawing process, the game mode is shifted to the free game mode.

The game mode can also be directly shifted from the base game mode to the free game mode. The route along which the game mode is shifted to the free game mode is diversified, thereby allowing easiness of shifting to the free game mode to be adjusted and thus enabling a balance between a profit of a gaming facility and a profit of a player to be taken.

In the gaming machine according to the present embodiment, further, a probability with which the game mode is shifted via the transit game mode to the free game mode by conducting the (4-1) process and the (4-2) process is higher than a probability with which the game mode is shifted to the free game mode by conducting the (5-1) free game mode shifting process.

The probability with which the game mode is shifted to the transit game mode is higher than the probability with which the game mode is shifted directly to the free game mode. Accordingly, since shifting via the transit game mode to the free game mode is easier than shifting directly to the free game mode, when the game mode is shifted to the transit game mode, a sense of expectancy that the game mode will be shifted to the free game mode can be enhanced.

In the gaming machine according to the present embodiment, further, in each of the base game mode and the transit game mode, conducted is a game in which after scrolling along scroll lines symbol arrays which a plurality of kinds of symbols constitute, by rearranging a plurality of symbols, an outcome of a unit game is displayed, and a number of the second specific symbols included in the symbol arrays used in the transit game mode is larger than a number of the second specific symbols included in the symbol arrays used in the base game mode.

In the transit game mode, a number of the second specific symbols is increased by changing the symbol arrays (for example, the video reels, the reel strips, or the like). Since the number of the second specific symbols is increased in the transit game mode, a player can visually recognize the increase in the number of the second specific symbols and perceive that it becomes easy to shift to the free game mode, thereby allowing a sense of expectancy of a player to be enhanced.

In the gaming machine according to the present embodiment, further, when upon rearranging the plurality of symbols in the transit game mode, a number of the scroll lines having the second specific symbol is greater than or equal to a predetermined number, the game mode is shifted to the free game mode.

When the second specific symbols are present in the predetermined number or more of symbol arrays among the plurality of symbol arrays (for example, the video reels, the reel strips, or the like), the game mode is shifted to the free game mode (in other words, it is determined depending on the number of the symbol arrays that the game mode is shifted to the free game mode). For example, when the symbols are rearranged and a number of the scroll lines having the second specific symbols is greater than or equal to three (greater than or equal to the predetermined number), the game mode can be shifted to the free game mode. Accordingly, it is not needed for the second specific symbols to be rearranged in succession along a specific payline. Therefore, since it is easy to visually recognize that a winning pattern in which the game mode is shifted to the free game mode is established, a player can easily determine whether or not the game mode can be shifted to the free game mode.

In the gaming machine according to the present embodiment, further, in the transit game mode, conducted is a game in which a unit game which does not require any bet to be placed can be played at up to a predetermined maximum number of times, and in a unit game played last among the unit games, the second specific symbols are rearranged on the scroll lines whose number is obtained by subtracting one or more from the predetermined number.

The transit game mode is a game mode in which each of the unit games which are a plurality of free games can be played. In the last unit game (a unit game played last among the unit games which can be played at the maximum number of times), on the scroll lines whose number is calculated by subtracting one or more from the predetermined number (for example, at least two video reels), the second specific symbols are rearranged and a part of a winning pattern is established. When the part of the winning pattern is established, the game is in a state which is a to-be-highly-likely-established state in which the winning pattern is highly likely established (the so-called ready-to-win state, or the like). When the number of the scroll lines is greater than or equal to the predetermined number, the winning pattern is established and the game mode is shifted to the free game mode. In the last unit game in the transit game mode, at least the to-be-highly-likely-established state is established, thereby allowing a player to have a sense of expectancy until the last unit game in the transit game mode is finished.

Taking a balance between a profit provided to a player and a profit of a gaming facility can be facilitated.

These and other aspects, features and advantages of the present invention will become readily apparent to those having ordinary skill in the art upon a reading of the following detailed description of the invention in view of the drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a diagram illustrating an outline of a configuration of a gaming machine;

FIG. 2 is a front view of a slot machine;

FIG. 3 is a perspective view of the slot machine;

FIG. 4 is a perspective view of a control panel;

FIG. 5 is a block diagram illustrating a circuit configuration of the slot machine;

FIG. 6 is a block diagram illustrating a circuit configuration of the slot machine;

FIG. 7 is a block diagram illustrating a circuit configuration of the slot machine;

FIG. 8 is a diagram illustrating an outline of a configuration of gaming machines;

FIG. 9 is a block diagram illustrating a game system;

FIG. 10 is a block diagram illustrating a PTS system;

FIG. 11 is a diagram illustrating state transition in the gaming machine;

FIG. 12 shows an example of a payline definition table;

FIG. 13 shows an example of a payout table;

FIG. 14 is a table showing a configuration of reel strips;

FIG. 15 is the table showing the configuration of the reel strips;

FIG. 16 is a table showing a configuration of reel strips;

FIG. 17 is the table showing the configuration of the reel strips;

FIG. 18 is a table showing a configuration of reel strips;

FIG. 19 is the table showing the configuration of the reel strips;

FIG. 20 is a table showing a configuration of reel strips;

FIG. 21 is the table showing the configuration of the reel strips;

FIG. 22 is a table showing a configuration of reel strips;

FIG. 23 is the table showing the configuration of the reel strips;

FIG. 24 is a table showing a configuration of reel strips;

FIG. 25 is the table showing the configuration of the reel strips;

FIG. 26 is a table showing a configuration of reel strips;

FIG. 27 is the table showing the configuration of the reel strips;

FIG. 28 is a table showing a configuration of reel strips;

FIG. 29 is the table showing the configuration of the reel strips;

FIG. 30 is a table showing a configuration of reel strips;

FIG. 31 is the table showing the configuration of the reel strips;

FIG. 32 is a table showing a configuration of reel strips;

FIG. 33 is the table showing the configuration of the reel strips;

FIG. 34 is a table showing a configuration of reel strips;

FIG. 35 is the table showing the configuration of the reel strips;

FIG. 36 is a table showing a configuration of reel strips;

FIG. 37 is the table showing the configuration of the reel strips;

FIG. 38 is the table showing the configuration of the reel strips;

FIG. 39 is the table showing the configuration of the reel strips;

FIG. 40 is the table showing the configuration of the reel strips;

FIG. 41 is a table showing a configuration of reel strips;

FIG. 42 is the table showing the configuration of the reel strips;

FIG. 43 is a flowchart showing a main control process in the gaming machine;

FIG. 44 is a flowchart showing a coin-insertion/start-check process;

FIG. 45 is a flowchart showing a symbol drawing process;

FIG. 46 is a flowchart showing a symbol display control process;

FIG. 47 is a flowchart showing a to-be-paid-out number determination process;

FIG. 48 is a flowchart showing a chance game mode process;

FIG. 49 is a flowchart showing a free game mode process;

FIG. 50 is a flowchart showing a number-of-games determination process;

FIG. 51 is a flowchart showing a multiplier determination process;

FIG. 52 shows a table defining weights, with each of which one kind of a group of reel strips is determined from 11 kinds of groups of reel strips;

FIG. 53 shows a table defining weights, with each of which table No. is determined;

FIG. 54 shows tables each defining weights, with each of which a maximum number of games is determined;

FIG. 55 shows a table defining a relationship between each of the numbers of the same Kind symbols and each table class;

FIG. 56 shows a table defining weights, with each of which a multiplier is determined;

FIGS. 57A to 57D illustrate examples of images displayed on an upper display device 131 and a lower display device 141;

FIGS. 58A to 58D illustrate examples of images displayed on the upper display device 131 and the lower display device 141;

FIGS. 59A to 59D illustrate examples of images displayed on the upper display device 131 and the lower display device 141;

FIGS. 60A to 60D illustrate examples of images displayed on the upper display device 131 and the lower display device 141;

FIGS. 61A to 61D illustrate examples of images displayed on the upper display device 131 and the lower display device 141;

FIGS. 62A to 62D illustrate examples of images displayed on the upper display device 131 and the lower display device 141;

FIGS. 63A to 63D illustrate examples of images displayed on the upper display device 131 and the lower display device 141;

FIGS. 64A to 64D illustrate examples of images displayed on the upper display device 131 and the lower display device 141;

FIGS. 65A to 65D illustrate examples of images displayed on the upper display device 131 and the lower display device 141;

FIGS. 66A to 66D illustrate examples of images displayed on the upper display device 131 and the lower display device 141;

FIGS. 67A to 67D illustrate examples of images displayed on the upper display device 131 and the lower display device 141;

FIGS. 68A to 68D illustrate examples of images displayed on the upper display device 131 and the lower display device 141;

FIGS. 69A to 69D illustrate examples of images displayed on the upper display device 131 and the lower display device 141;

FIGS. 70A to 70D illustrate examples of images displayed on the upper display device 131 and the lower display device 141;

FIGS. 71A to 71D illustrate examples of images displayed on the upper display device 131 and the lower display device 141;

FIGS. 72A to 72D illustrate examples of images displayed on the upper display device 131 and the lower display device 141;

FIGS. 73A to 73D illustrate examples of images displayed on the upper display device 131 and the lower display device 141;

FIGS. 74A to 74D illustrate examples of images displayed on the upper display device 131 and the lower display device 141;

FIGS. 75A to 75D illustrate examples of images displayed on the upper display device 131 and the lower display device 141;

FIGS. 76A to 76D illustrate examples of images displayed on the upper display device 131 and the lower display device 141;

FIGS. 77A to 77D illustrate examples of images displayed on the upper display device 131 and the lower display device 141;

FIGS. 78A to 78D illustrate examples of images displayed on the upper display device 131 and the lower display device 141;

FIGS. 79A to 79D illustrate examples of images displayed on the upper display device 131 and the lower display device 141;

FIGS. 80A to 80D illustrate examples of images displayed on the upper display device 131 and the lower display device 141;

FIGS. 81A to 81D illustrate examples of images displayed on the upper display device 131 and the lower display device 141;

FIG. 82 illustrates examples of images displayed on the upper display device 131 and the lower display device 141;

FIG. 83A illustrates a case A in which symbols of FEATURE appear on video reels whose number is greater than or equal to 3 and FIG. 83B illustrates a case B in which the symbols of FEATURE appear on video reels whose number is less than 3.

### DETAILED DESCRIPTION OF THE PREFERRED EMBODIMENT

### Outline of Gaming Machine of the Present Embodiment

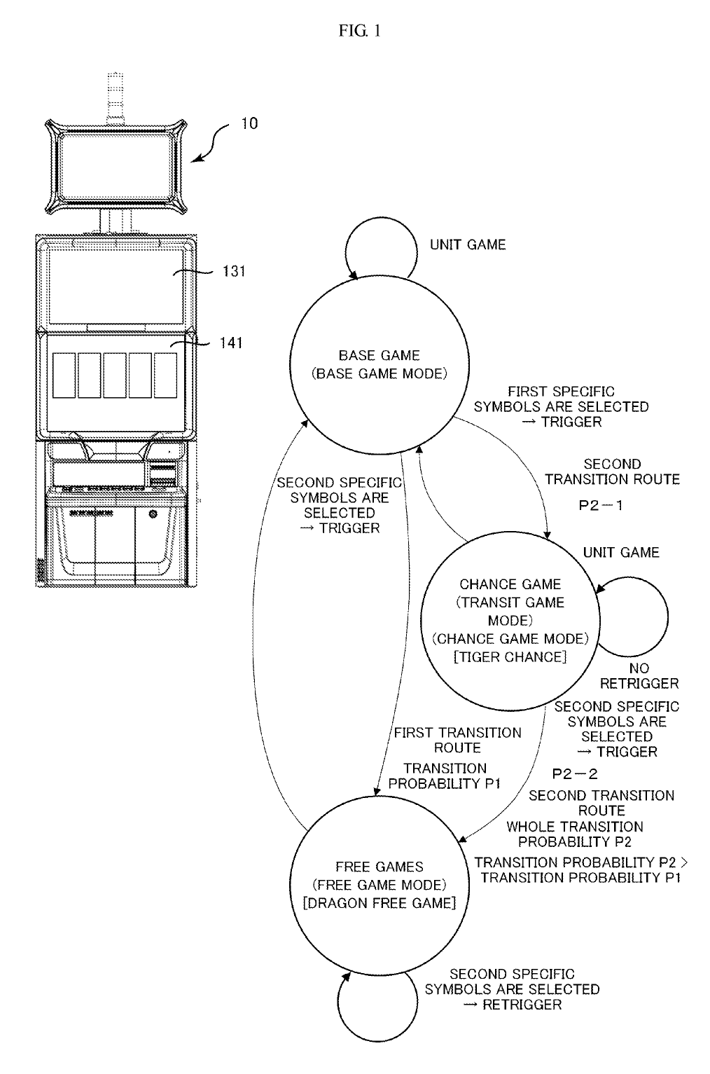

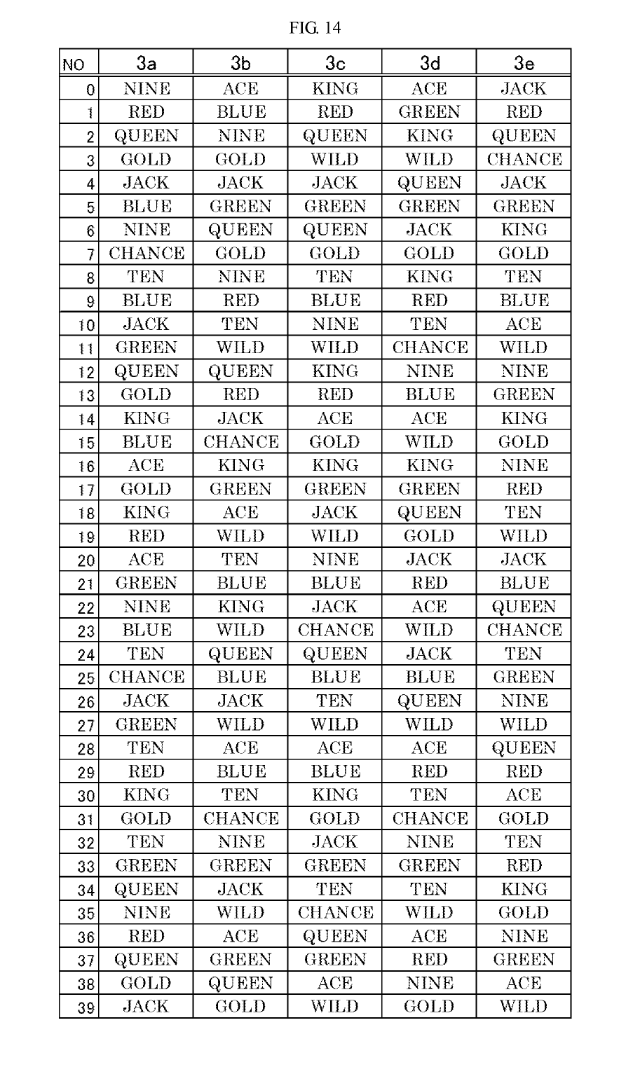

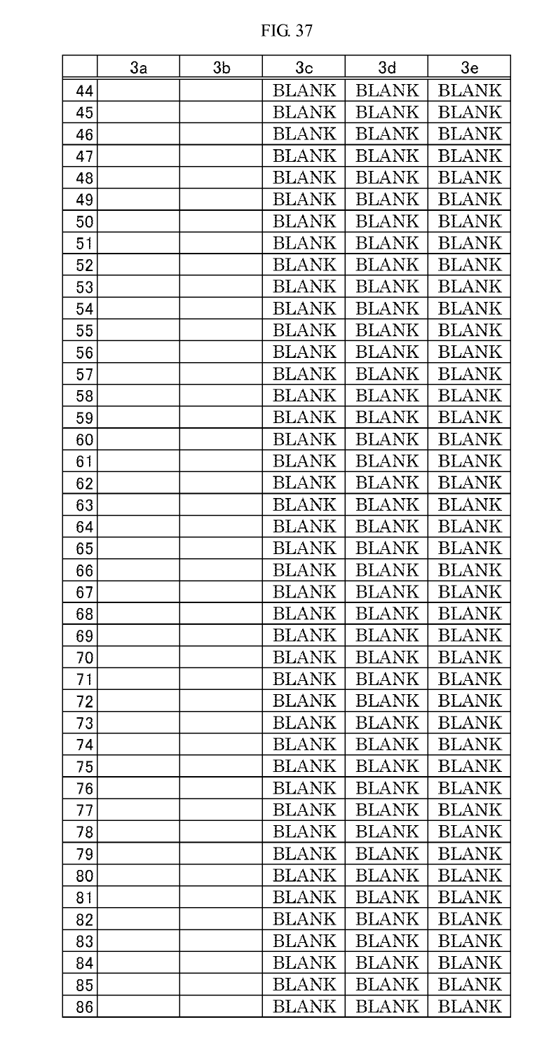

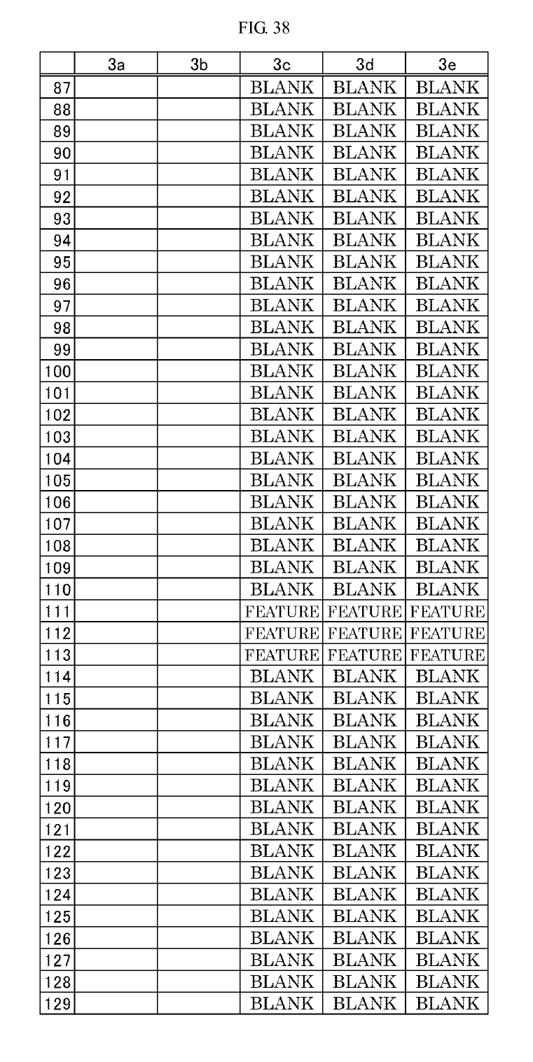

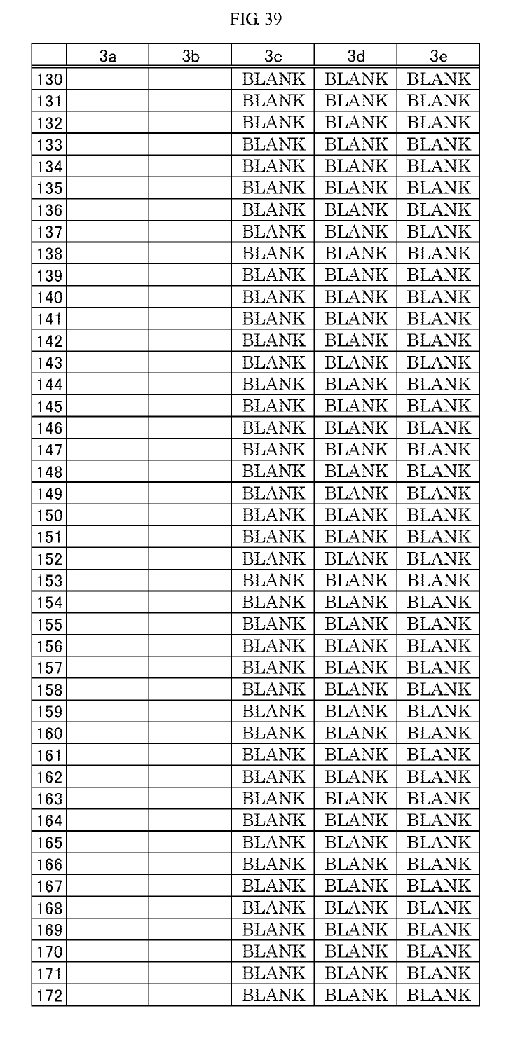

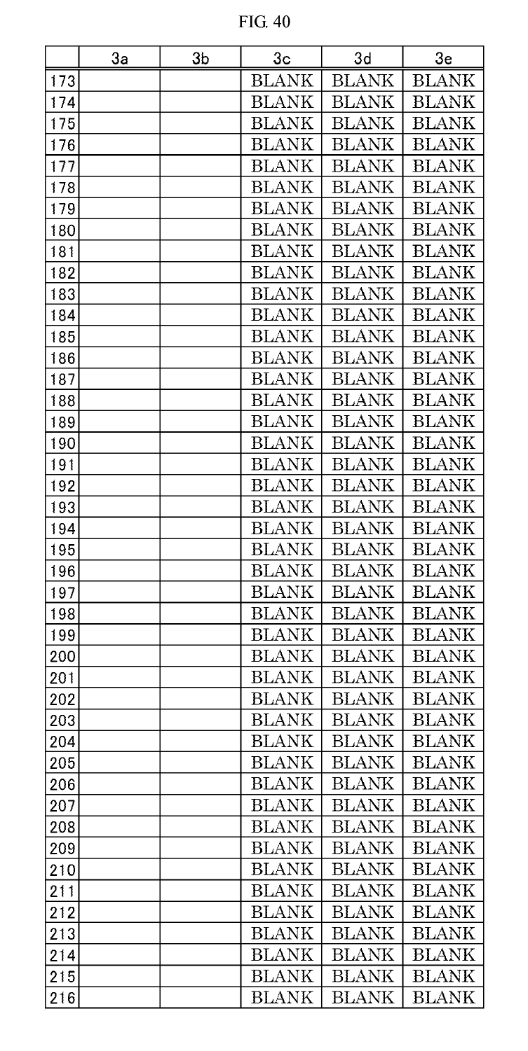

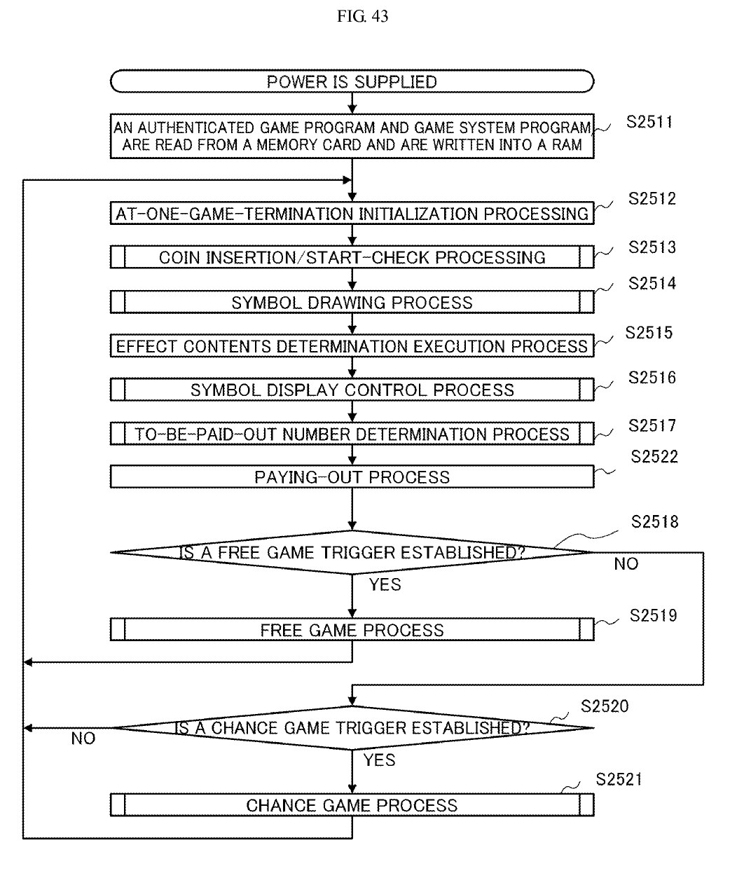

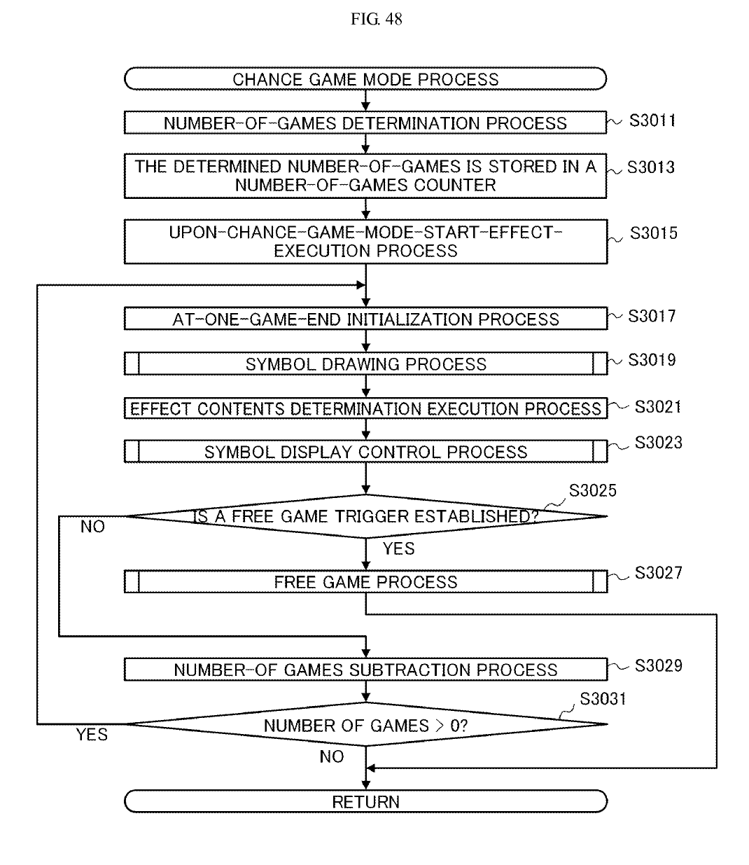

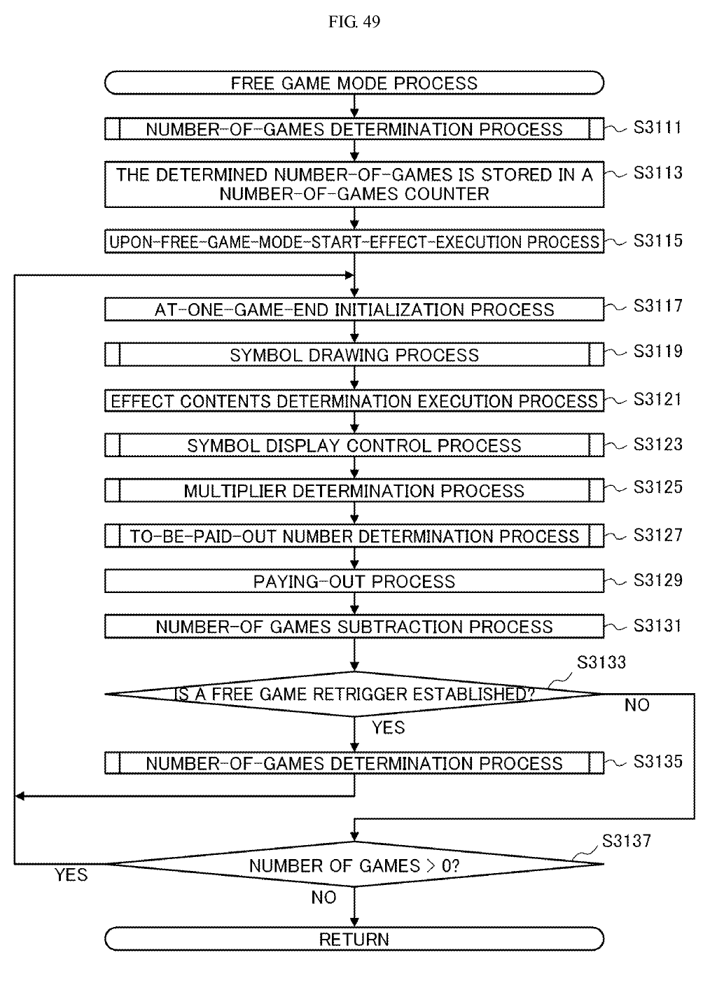

As shown in FIG. 1, a gaming machine (for example, the later-described slot machine 10 or the like) according to an embodiment of the present invention includes: a display (for example, the later-described lower display device 141 or the like) for displaying a game outcome in a base game mode; and a controller (for example, the later-described controller 100 and processor AM10, and the like) for controlling a first transition route (refer to FIG. 1) along which a game mode is directly shifted to a free game mode (for example, the later-described free game mode (dragon free games) and the like) in accordance with the game outcome; and a second transition route (refer to FIG. 1) along which once via a transit game mode (for example, the later-described chance game mode (tiger chance) and the like), the game mode is shifted to the free game mode in accordance with the game outcome, and the controller is programmed (the later-described FIG. 14 to FIG. 42, FIG. 43, FIG. 48, FIG. 49, and the like) to control the game so as to make a probability with which along the second transition route, the game mode is shifted from the transit game mode to the free game mode higher than a probability with which along the first transition route, the game is shifted from the base game mode to the free game mode.

The gaming machine according to the embodiment of the present invention is not limited to a slot machine on which the so-called slot game is played. The gaming machine according to the embodiment of the present invention has the first transition route and the second transition route for shifting to the free game mode.

The first transition route is a route along which the game is shifted (transitions) directly from the base game mode to the free game mode without playing any game in the transit game mode. The second transition route is a route along which the game is shifted (transitions) from the base game mode, via the transit game mode, to the free game mode.

Since there are the two kinds of routes, the first transition route and the second transition route, along each of which the game shifts to the free game mode, it is made possible to make a player expect that the game will be shifted to the free game mode along either of the routes.

The second transition route allows the game mode to be shifted to the free game mode with a higher probability than that of the first transition route. A transition probability P2 of the second transition route is higher than a transition probability P1 of the first transition route. In other words, the controller controls the game such that the transition probability P2 is greater than the transition probability P1, transition probability P2>transition probability P1. The transition probability P2 of the second transition route can be the whole transition probability of a transition probability P2-1 with which the game mode is shifted from the base game mode to the transit game mode and a transition probability P2-2 with which the game mode is shifted from the transit game mode to the free game mode.

Because of the relationship of transition probability P2>transition probability P1, upon shifting to the transit game mode, it is made possible to cause a player to play the game while expecting that the game mode will be shifted to the free game mode.

Since the game mode is shifted from the base game mode to the free game mode along the first transition route or the second transition route, probabilities, with each of which the game mode is shifted to the free game mode, can be adjusted by the two kinds of routes of the first transition route having the probability and the second transition route having the probability. By adjusting the probabilities of the two kinds of routes, it is made possible to facilitate taking a balance between a profit of a gaming facility and a profit of a player.

As described above, by defining the three kinds of transition probabilities of: the transition probability P1 of the first transition route; the transition probability P2-1 with which the game mode is shifted from the base game mode to the transit game mode; and the transition probability P2-2 with which the game mode is shifted from the transit game mode to the free game mode, easiness of shifting to the free game mode is adjusted, thereby allowing a balance between a profit of a gaming facility and a profit of a player to be taken.

When it is defined that a transition probability P2-1 is less than a transition probability P2-2, transition probability P2-1<transition probability P2-2, the game is shifted easily from the transit game mode to the free game mode. Therefore, when once the game mode can be shifted to the transit game mode, it is made possible for a player to expect that the game mode will be shifted to the free game mode. When it is defined that the transition probability P2-1 is greater than the transition probability P2-2, transition probability P2-1>transition probability P2-2, although the game mode is less easily shifted to the free game mode, it is made possible for a player to expect each time the game is shifted to the transit game mode that the game mode will be shifted to the free game mode.

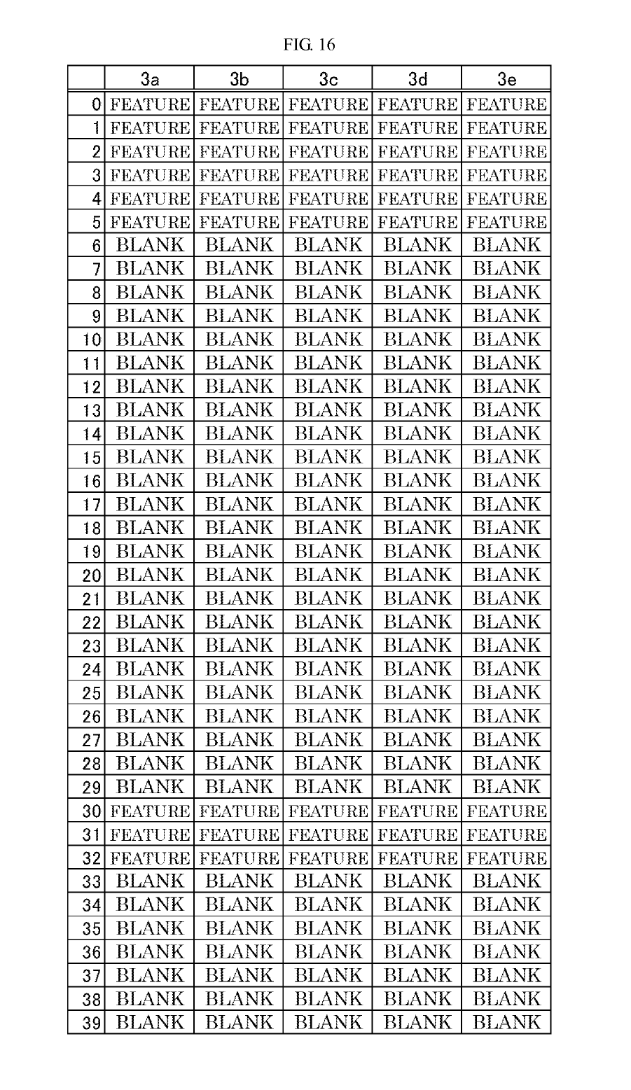

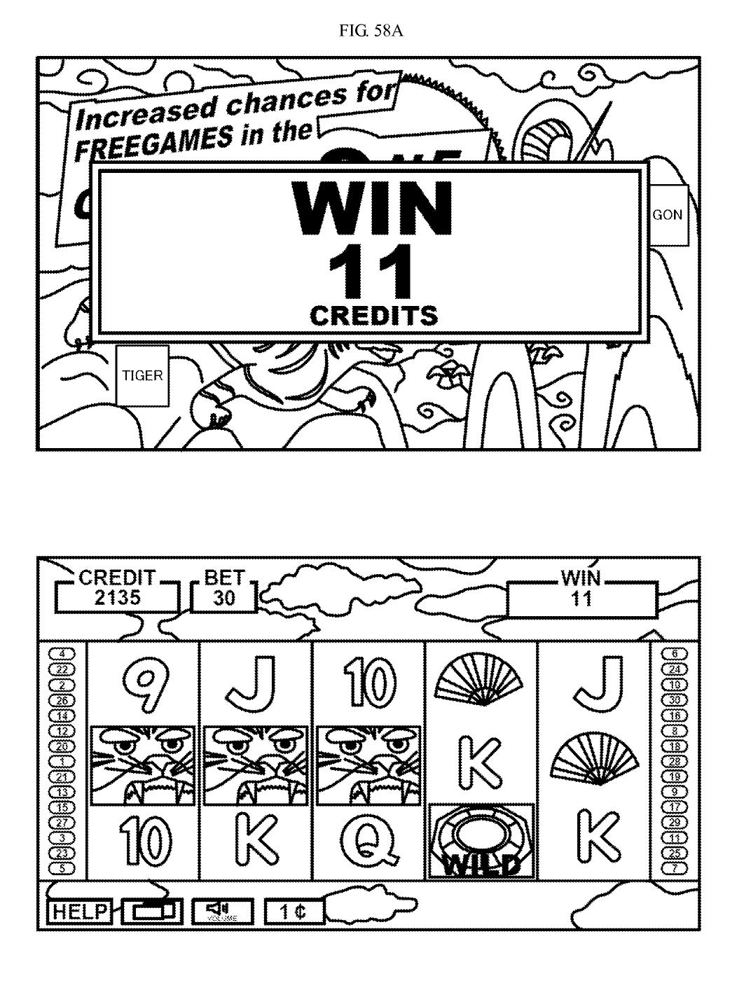

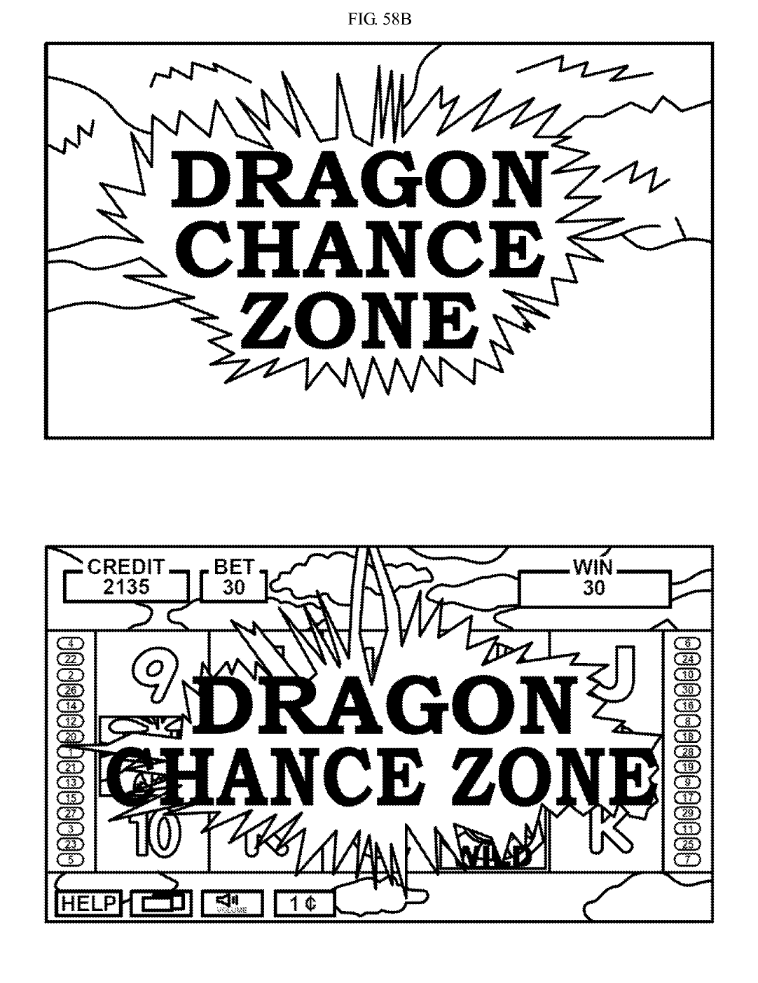

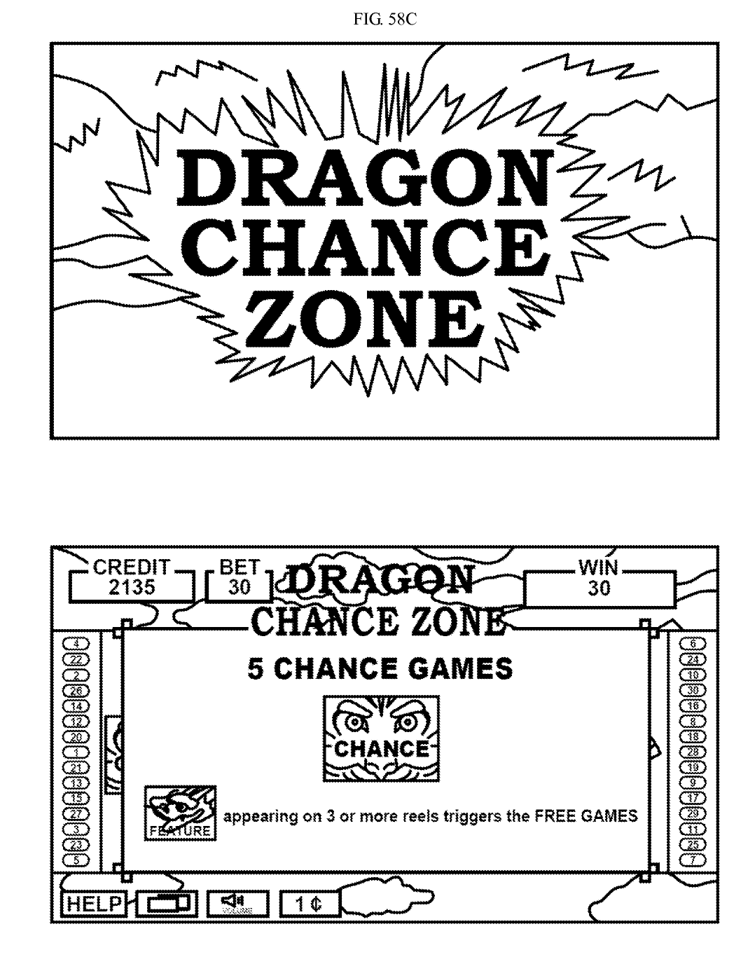

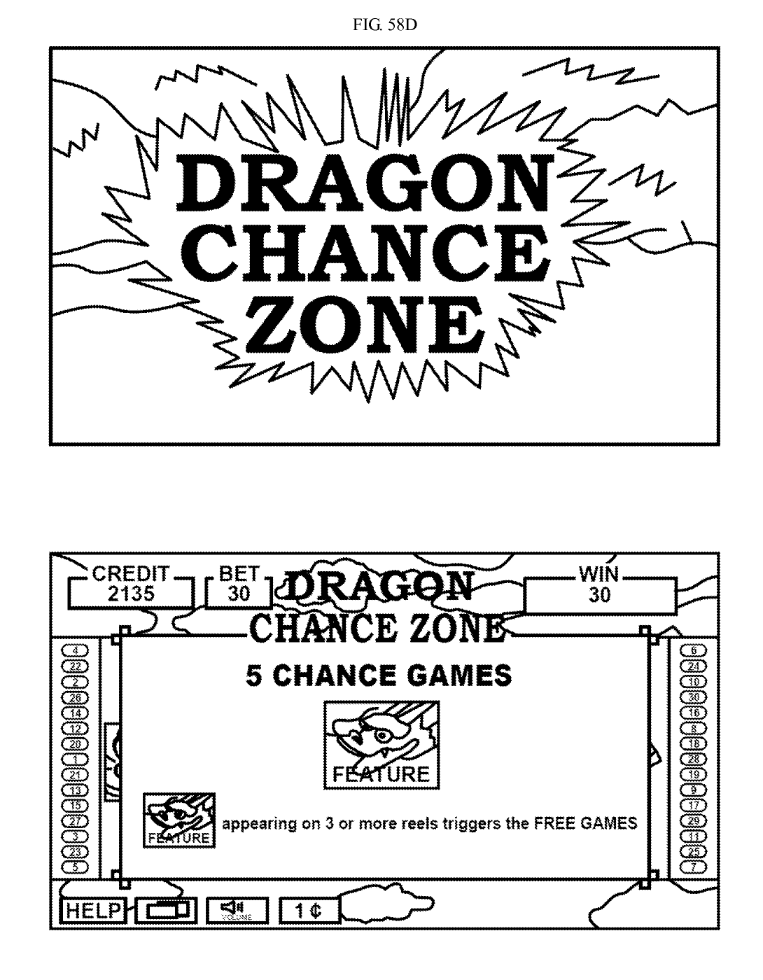

In the gaming machine according to the embodiment of the present invention, the controller is further programmed to execute the below-described processes: a process in which when the game mode is shifted to the transit game mode along the second transition route, image information indicating the transit game mode (for example, the later-described FIG. 58B to FIG. 58D, and the like) is displayed on the display (for example, the later-described lower display device 141, or the like); a process in which after the game has been shifted to the transit game mode along the second transition route, a drawing table used in the base game mode to draw for shifting to the free game mode is changed to a high probability drawing table, the high probability drawing table having a higher probability with which the game mode is shifted to the free game mode than a probability of the drawing table, with which the game mode is shifted to the free game mode (for example, the later-described FIG. 16 to FIG. 40, FIG. 48, and the like); and a process in which a predetermined number of games in the transit game mode executed by using the high probability drawing table is managed, and when the predetermined number of games have been played, the game mode is shifted to the base game mode (for example, the later-described step S3031 in FIG. 48, and the like).

When display information (identifiable information) is displayed on the display so as to allow a player to identify the base game mode, the transit game mode, and the free game mode, the display information indicative of the transit game mode is displayed on the display, thereby allowing a player to clearly recognize that the game mode is the transit game mode. In other words, it is made possible for a player to recognize that the game is proceeding along the second transition route. Thus, a player is attracted to the game so as to strongly expect that the game mode will be shifted to the free game mode, thereby allowing variations to be imparted to the game.

As the drawing tables, there are both of a base game mode drawing table used in the base game mode and a transit game mode drawing table used in the transit game mode. The probability (the above-mentioned transition probability P2-2) with which the game mode is shifted from the transit game mode to the free game mode by using the transit game mode drawing table is higher than the probability (the above-mentioned transition probability P1) with which the game mode is shifted from the base game mode to the free game mode by using the base game mode drawing table. After the game has been shifted from the base game mode to the transit game mode, in the transit game mode, the base game mode drawing table is switched to the transit game mode drawing table (high probability drawing table). Since the drawing table is changed to the high probability drawing table, the game mode can be easily shifted from the transit game mode to the free game mode.

Further, since when the predetermined number of games have been played in the transit game mode, the game mode is shifted (returned) to the base game mode, it is made possible for the game mode not to be excessively shifted to the free game mode.

The drawing table may be a drawing table only for determining whether or not the game mode is switched or may be a drawing table for determining an outcome of the game. In the case in which the drawing table is the drawing table for determining the outcome of the game, it is determined whether or not the game mode is switched as the outcome of the game.

Further, as the base game mode drawing table used in the base game mode, a plurality of kinds of base game mode drawing tables may be used. The plurality of kinds of base game mode drawing tables are drawing tables in which transition probabilities, with each of which the game mode is shifted to the transit game mode or the free game mode, are different from one another. When a profit of a player as an outcome obtained by playing the game in the base game mode over a long period of time is too small, the base game mode drawing table is switched, thereby allowing the game mode to be easily shifted to the transit game mode or the free game mode. As described above, based on the number of games played and an outcome of the game in the base game mode, the base game mode drawing table can be switched. Thus, likelihood with which a profit for a player playing the game over a long period of time is provided can be increased.

Further, in the gaming machine according to the embodiment of the present invention, the controller is further programmed to execute the below-described processes: a process in which a probability with which the game mode is shifted from the base game mode to the free games along the first transition route is set to be low, as compared with a probability with which the game mode is shifted from the base game mode to the transit game mode along the second transition route (for example, the later-described FIG. 16 to FIG. 40, FIG. 48, and the like); and a process which is conducted such that with the base game mode as a starting point, a probability with which the game mode is shifted to the free game mode along the second transition route is high as a whole, as compared with a probability with which the game mode is shifted to the free game mode along the first transition route (for example, the later-described FIG. 16 to FIG. 40, FIG. 48, and the like).

The probability (transition probability P1) with which the game mode is shifted to the free game mode along the first transition route, the probability (transition probability P2-1) with which the game mode is shifted to the transit game mode along the second transition route, and the whole probability (transition probability P2-2) with which the game mode is shifted to the free game mode are set, thereby allowing a balance between a profit of a gaming facility and a profit of a player to be taken.

The controller is controlled such that the probability (transition probability P2) with which the game mode is shifted via the transit game mode to the free game mode is set to be high as a whole and the game mode is at least often shifted to the transit game mode (transition probability P2-1), thereby allowing a sense of expectancy of a player to be enhanced.

In addition, a gaming machine according to an embodiment of the present invention includes: a display for displaying an outcome of a unit game by rearranging a plurality of symbols; and a controller for executing a unit game in a base game mode played on the condition of placing any bet and a unit game in a free game mode which does not require any bet to be placed, and the controller is programmed to execute processes described below: a process (4-1) which is a transit game mode shifting process in which in the base game mode, upon the occurrence of a trigger which is generated when first specific symbols (for example, symbols of CHANCE or the like) are selected by conducting a symbol drawing process in which symbols to be rearranged are selected by a drawing, a game mode is shifted to a transit game mode; and a process (4-2) which is a free game mode shifting process in which in the transit game mode, upon the occurrence of a trigger which is generated when second specific symbols (for example, symbols of FEATURE or the like) are selected by conducting the symbol drawing process, the game mode is shifted from the transit game mode to the free game mode.

Since the game mode is shifted from the base game mode via the transit game mode to the free game mode, the probabilities, with each of which the game mode is shifted to the transit game mode and the game mode is shifted to the free game mode, can be adjusted by two stages of the probabilities. In addition, by providing the first specific symbols to shift to the transit game mode, a player pays attention not only to the second specific symbols to shift to the free game mode, but a player pays attention also to the first specific symbols with which the game mode is switched from the base game mode to another game mode, thereby allowing amusement of the game to be enhanced. Further, the probabilities in the base game mode and the transit game mode, with each of which the game mode is shifted to the free game mode, are made different from each other, thereby enhancing amusement of the game.

In the gaming machine according to the embodiment of the present invention, further, the controller executes a process (5-1) which is a free game mode shifting process in which in the base game mode, upon the occurrence of a trigger which is generated when the second specific symbols are selected by conducting the symbol drawing process, the game mode is shifted to the free game mode.

The game mode can also be directly shifted from the base game mode to the free game mode. The route along which the game mode is shifted to the free game mode is diversified, thereby allowing easiness of shifting to the free game mode to be adjusted and thus enabling a balance between a profit of a gaming facility and a profit of a player to be taken.

In the gaming machine according to the embodiment of the present invention, further, a probability with which the game mode is shifted via the transit game mode to the free game mode by conducting the (4-1) process and the (4-2) process is higher than a probability with which the game mode is shifted to the free game mode by conducting the (5-1) free game mode shifting process.

The probability with which the game mode is shifted to the transit game mode is higher than the probability with which the game mode is shifted directly to the free game mode. Accordingly, since shifting via the transit game mode to the free game mode is easier than shifting directly to the free game mode, when the game mode is shifted to the transit game mode, a sense of expectancy that the game mode will be shifted to the free game mode can be enhanced.

In the gaming machine according to the embodiment of the present invention, further, in each of the base game mode and the transit game mode, conducted is a game in which after scrolling along scroll lines symbol arrays (for example, video reels, reel strips, or the like) which a plurality of kinds of symbols constitute, by rearranging a plurality of symbols, an outcome of a unit game is displayed, and a number of the second specific symbols included in the symbol arrays used in the transit game mode is larger than a number of the second specific symbols included in the symbol arrays used in the base game mode.

In the transit game mode, a number of the second specific symbols is increased by changing the symbol arrays (for example, the video reels, the reel strips, or the like). Since the number of the second specific symbols is increased in the transit game mode, a player can visually recognize the increase in the number of the second specific symbols and perceive that it becomes easy to shift to the free game mode, thereby allowing a sense of expectancy of a player to be enhanced.

In the gaming machine according to the embodiment of the present invention, further, when upon rearranging the plurality of symbols in the transit game mode, a number of the scroll lines having the second specific symbols is greater than or equal to a predetermined number, the game mode is shifted to the free game mode.

When the second specific symbols are present in the predetermined number or more of symbol arrays among the plurality of symbol arrays (for example, the video reels, the reel strips, or the like), the game mode is shifted to the free game mode (in other words, it is determined depending on the number of the symbol arrays that the game mode is shifted to the free game mode). For example, when the symbols are rearranged and a number of the scroll lines having the second specific symbols is greater than or equal to three (greater than or equal to the predetermined number), the game mode can be shifted to the free game mode. Accordingly, it is not needed for the second specific symbols to be rearranged in succession along a specific payline. Therefore, since it is easy to visually recognize that a winning pattern in which the game mode is shifted to the free game mode is established, a player can easily determine whether or not the game mode can be shifted to the free game mode.

In the gaming machine according to the embodiment of the present invention, further, in the transit game mode, in the transit game mode, conducted is a game in which a unit game which does not require any bet to be placed can be played at up to a predetermined maximum number of times, and in a unit game played last among the unit games, the second specific symbols are rearranged on the scroll lines whose number is calculated by subtracting one or more from the predetermined number.

The transit game mode is a game mode in which each of the unit games which are a plurality of free games can be played. In the last unit game (a unit game played last among the unit games which can be played at the maximum number of times), on the scroll lines whose number is calculated by subtracting one or more from the predetermined number (for example, at least two video reels), the second specific symbols are rearranged and a part of a winning pattern is established. When the part of the winning pattern is established, the game is in a state which is a to-be-highly-likely-established state in which the winning pattern is highly likely established (the so-called ready-to-win state, or the like). When the number of the scroll lines is greater than or equal to the predetermined number, the winning pattern is established and the game mode is shifted to the free game mode. In the last unit game in the transit game mode, at least the to-be-highly-likely-established state is established, thereby allowing a player to have a sense of expectancy until the last unit game in the transit game mode is finished.

In addition, in the gaming machine according to the embodiment of the present invention, it is preferable that on the symbol arrays (for example, video reels, reel strips, or the like) used in the transit game mode, only third specific symbols (for example, the later-described symbols of BLANK, or the like), which are different from the first specific symbols and the second specific symbols, and the second specific symbols (for example, the later-described symbols of FEATURE, or the like) are arranged.

Since on the symbol arrays used in the transit game mode, only the third specific symbols and the second specific symbols are arranged, a probability with which the winning pattern is established in the transit game mode can be easily set. A player can easily determine whether or not the winning pattern is established.

In addition, in the gaming machine according to the embodiment of the present invention, it is preferable that the third specific symbols do not establish the winning pattern and in the transit game mode, based on the number of the symbol arrays (for example, video reels, reel strips, or the like) on which the second specific symbols have appeared, it is determined that the winning pattern is established.

Since the third specific symbols do not establish the winning pattern, it is only required for a player to pay attention only to the second specific symbols, thereby allowing a player to easily determine whether or not the winning pattern is established in the transit game mode.

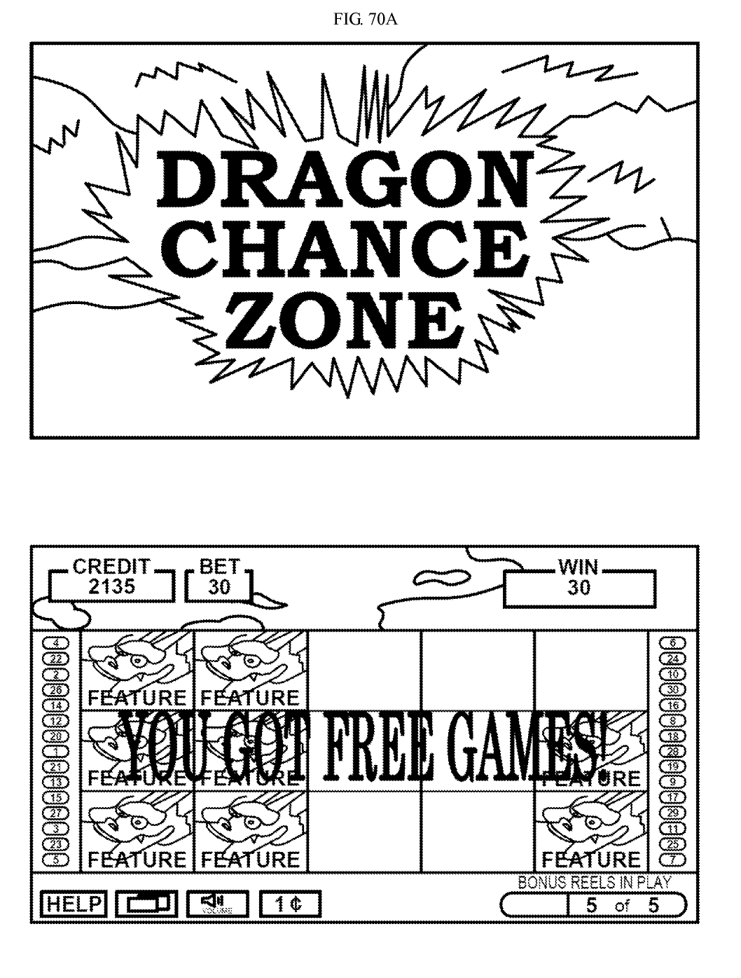

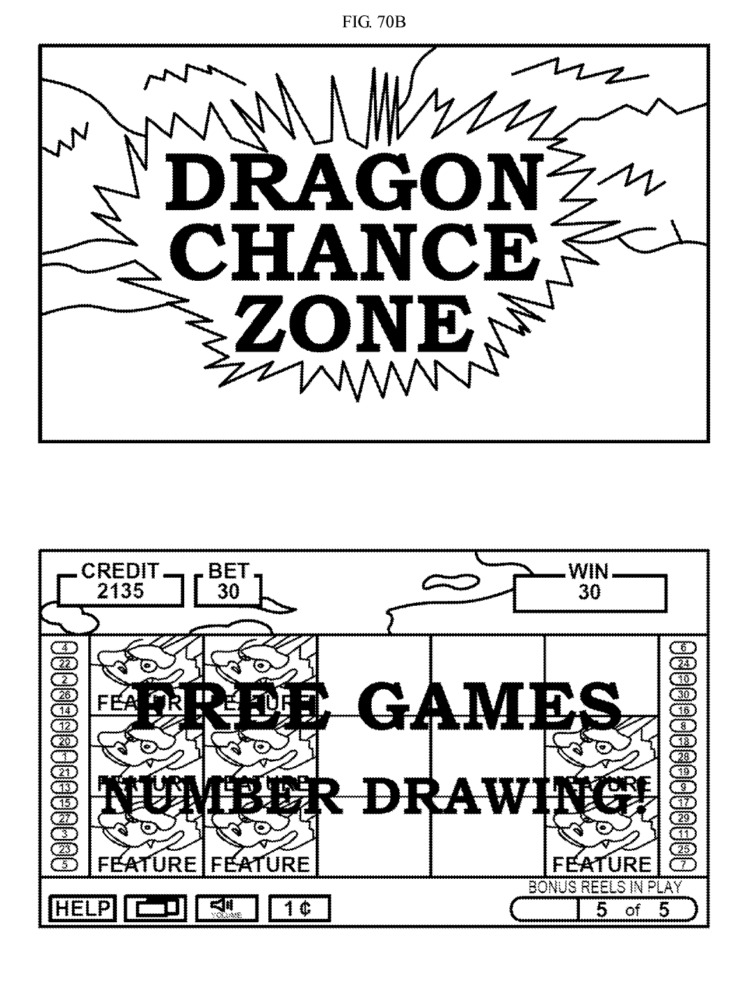

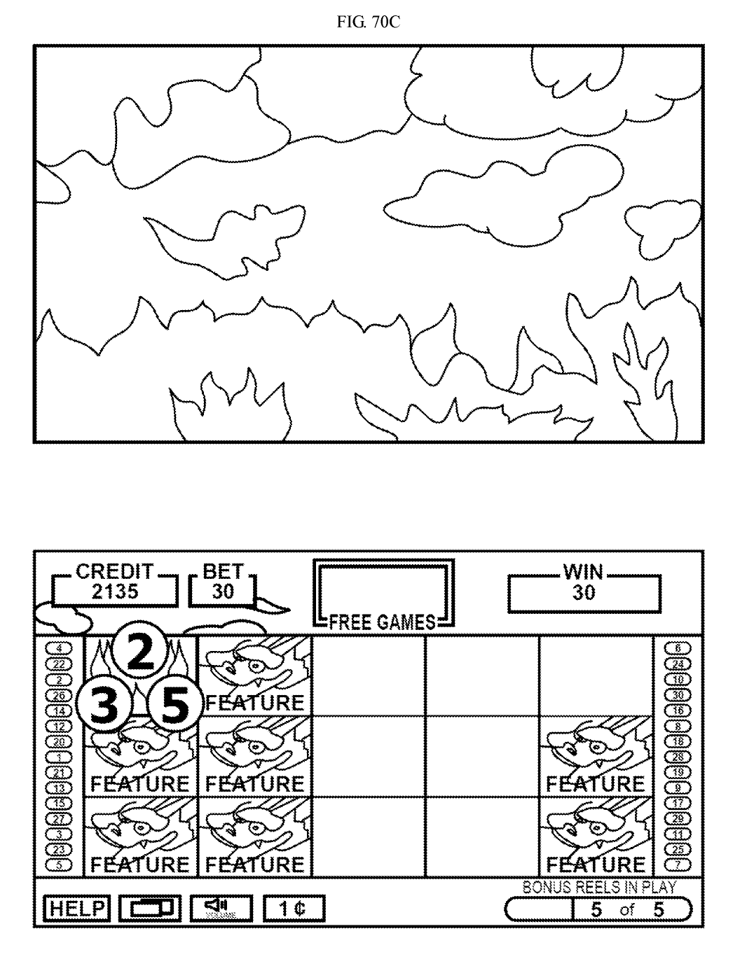

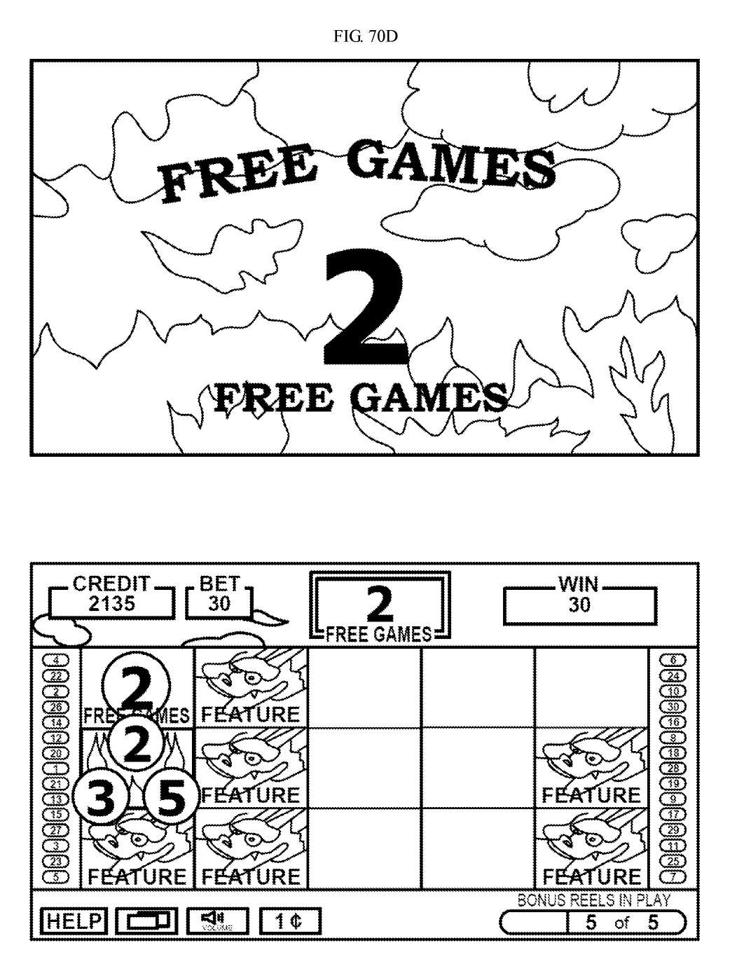

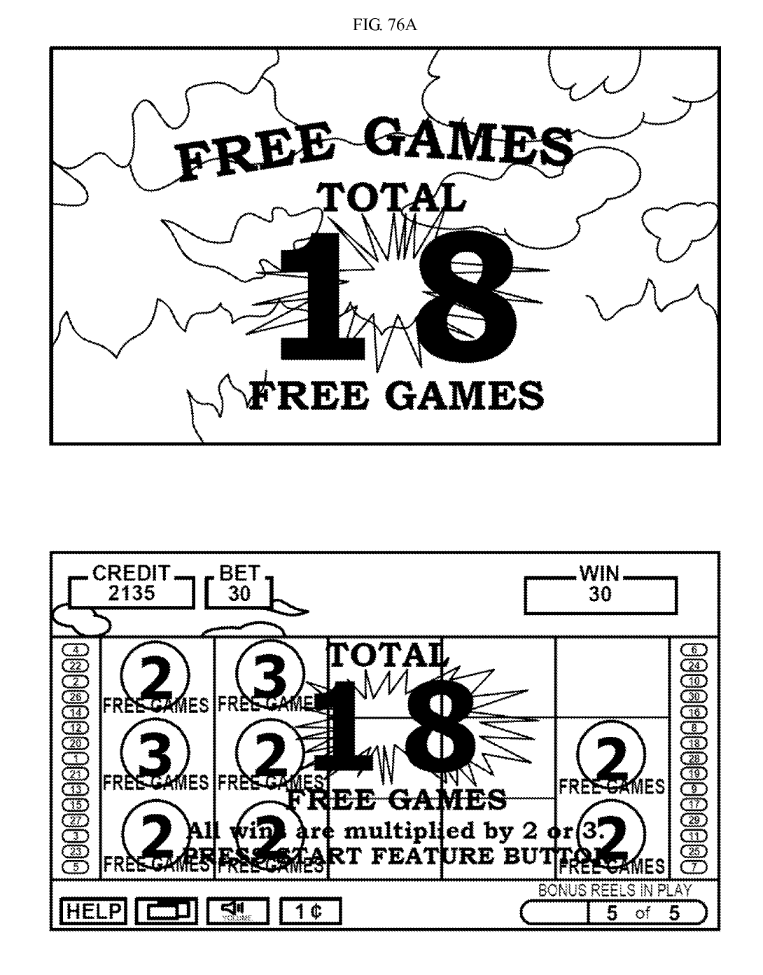

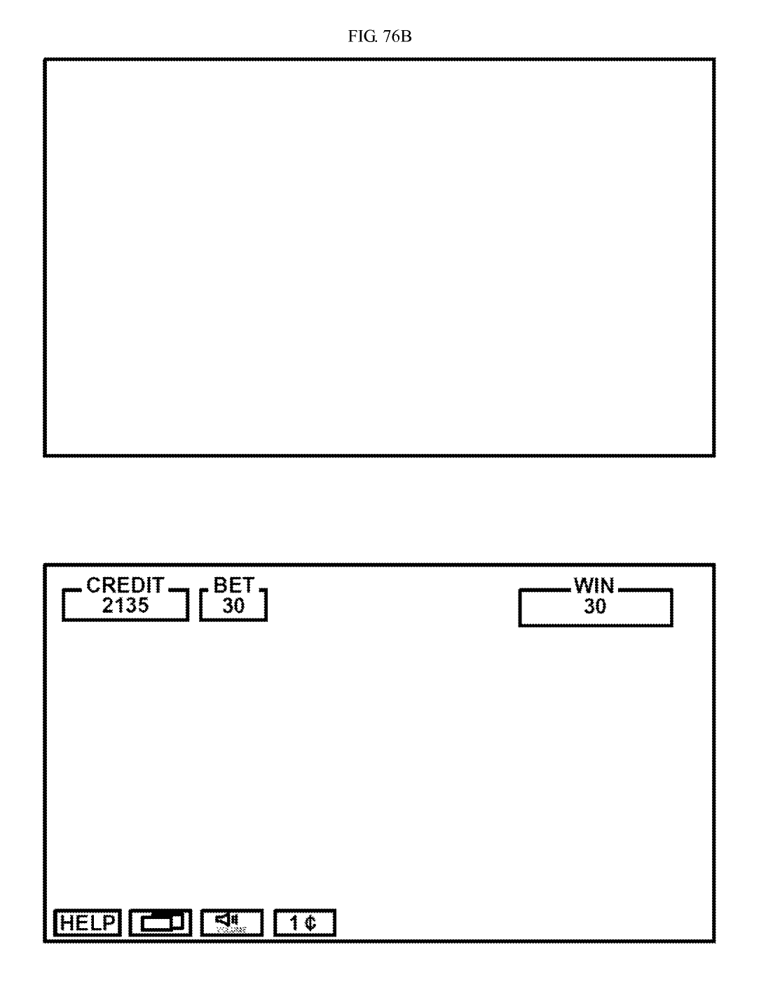

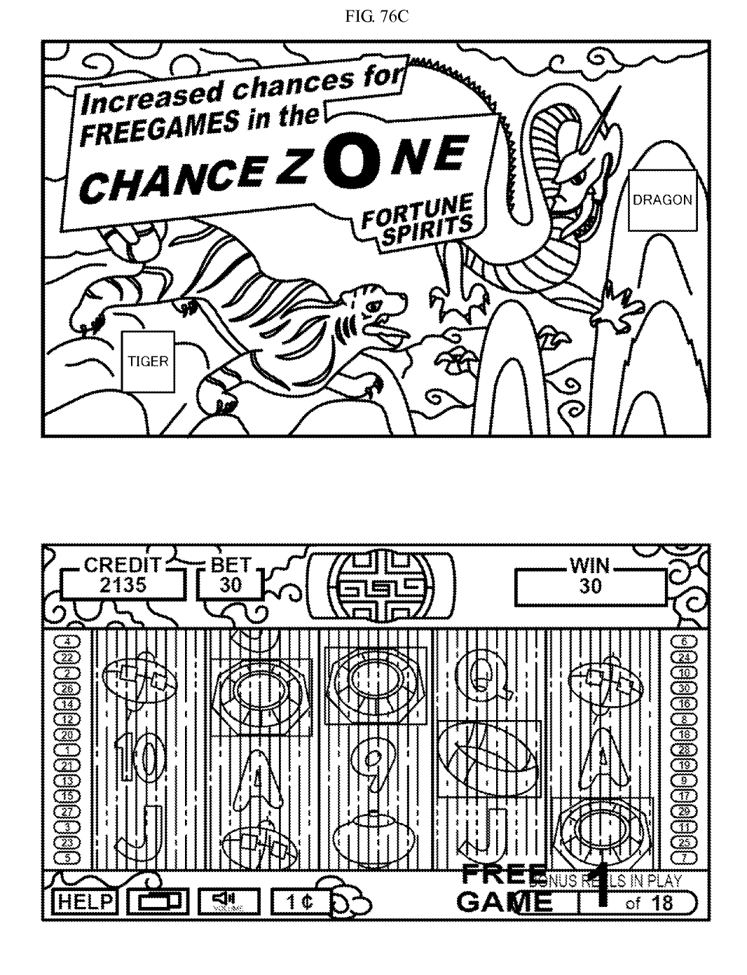

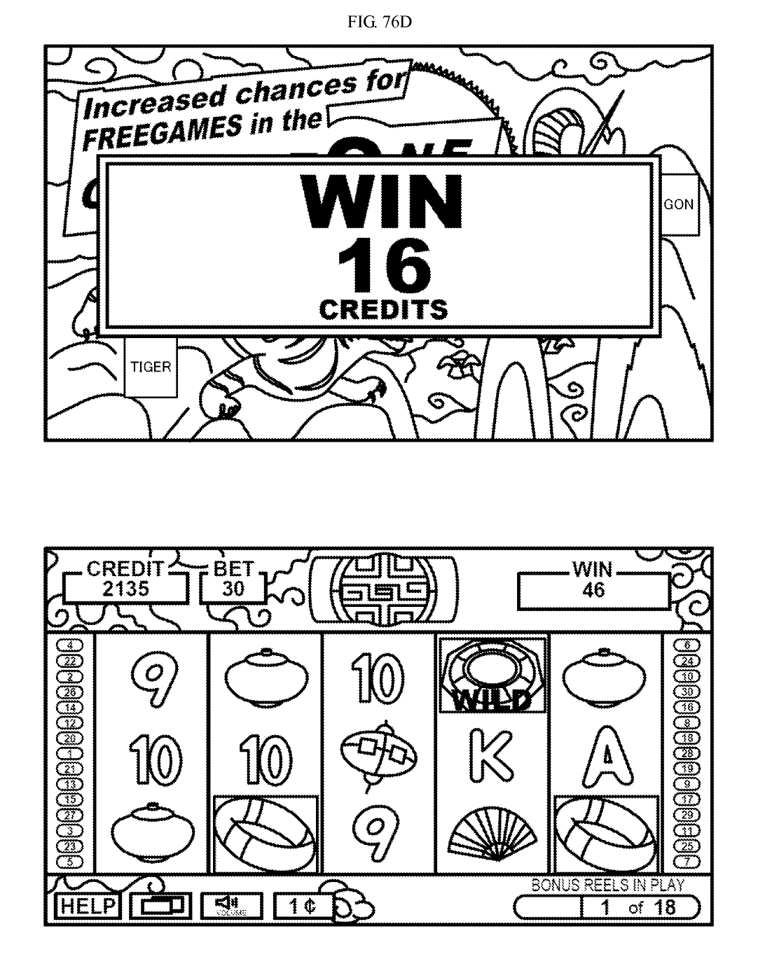

Further, in the gaming machine according to the embodiment of the present invention, it is preferable that when the game mode is shifted to the free game mode, a process in which image information (for example, the later-described FIG. 70A, FIG. 70B, FIG. 76B, and the like) indicative of the free game mode is displayed on the display is executed.

It is made possible to easily cause a player to recognize that the game mode is shifted to the free game mode, thereby allowing a sense of expectancy to be enhanced.

Further, in the gaming machine according to the embodiment of the present invention, the number of unit games in the transit game mode is a fixed number, and the number of unit games in the free game mode is randomly determined.

Since the number of the unit games in the transit game mode is the fixed number, it is made possible to easily adjust a balance between a profit provided for a player and a profit of a gaming facility in the transit game mode. On the other hand, since the number of unit games in the free game mode is randomly determined, when the game mode is shifted to the free game mode, likelihood with which a player is provided with a larger profit can be enhanced, thereby allowing a sense of expectancy to be imparted to a player.

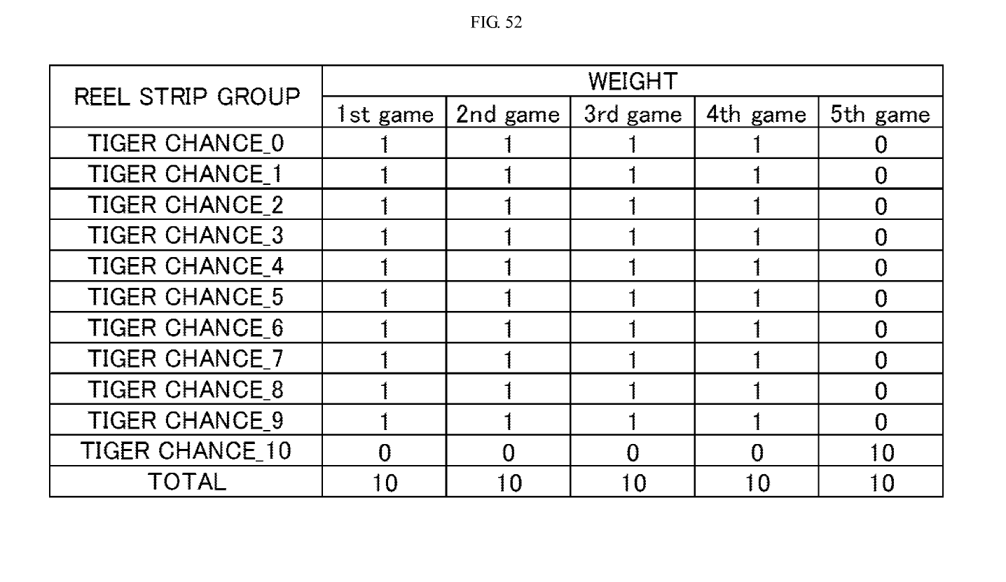

In addition, in the gaming machine according to the embodiment of the present invention, it is preferable that the symbol arrays (for example, video reels, reel strips, or the like) used in the transit game mode have a plurality of transit game symbol arrays (for example, TIGER CHANCE_0 to TIGER CHANCE_10 shown in FIG. 52, and the like); in the last unit game in the transit game mode, specific transit game symbol arrays (for example, TIGER CHANCE_10 shown in FIG. 52, and the like) among the plurality of transit game symbol arrays are selected; and in each of the unit games other than the last unit game in the transit game mode, any transit game symbols (for example, TIGER CHANCE_0 to TIGER CHANCE_9 shown in FIG. 52, and the like) other than the specific transit game symbol arrays are randomly selected.

Since in the last unit game in the transit game mode, the specific transit game symbol arrays are selected, even when the winning pattern is not completely established, the symbols can be rearranged so as to establish a part of the winning pattern. In other words, the to-be-highly-likely-established state in which the winning pattern is highly likely to be established can be realized, and it is made possible for a player to visually recognize that the game mode would have been shifted to the free game mode in a little bit. Thus, it is made possible to cause a player to feel that the shifting to the free game mode is approaching, to expect, even when the game mode is once returned to the base game mode, that the game mode is shifted via the transit game mode to the free game mode next time for sure, and to continuously play the game. A player is caused to continuously play the game, thereby allowing a profit of a gaming facility to be ensured.

In addition, in the gaming machine according to the embodiment of the present invention, it is preferable that when in each of the unit games other than the last unit game in the transit game mode, the winning pattern is established and a trigger of the free game mode is established, the game mode is shifted from the transit game mode to the free game mode.

The game mode is shifted to the free game mode before reaching the last unit game, thereby allowing an excessive increase in timing at which the game mode is shifted to the free game mode to be prevented and a profit of a gaming facility to be protected.

<<<Concept and Others>>>

A slot machine 10 is a kind of a gaming machine. In the present embodiment, the slot machine 10 is described as one example of the gaming machine. However, the present invention is not limited thereto and may be an apparatus in which a game in any base game mode is independently executed and a game mode is developed from the base game mode to other game mode such as a chance game mode and a free game mode.

A game executed in the base game mode in the present embodiment is executed on the slot machine 10. In the present embodiment, the game in the base game mode is referred to as a base game. The base game is a slot game in which a plurality of symbols are rearranged. The base game is a game whose concept is opposed to those of the chance game and the free game.

Specifically, the rearrangement of the symbols in the slot game is realized by five video reels 3a to 3e which are capable of varying and stopping. The rearranged symbols are displayed in a manner in which the symbols are stopped in a symbol display region 141d of a lower display device 141 (lower liquid crystal panel 141b).

The slot game has the base game mode, the chance game mode, and the free game mode. The base game mode is a game mode in which a unit game (base game (slot game)), in which on the condition that a gaming value is bet, a plurality of symbols are rearranged in the symbol display region 141d and a normal payout in accordance with the rearranged symbols is paid out, is executed. The game in the base game mode is not limited to the slot game and may be a game which can be independently executed on a game terminal such as the slot machine 10.

Upon initiating the unit game, the rearrangement of the plurality of symbols is once released. The rearrangement of the plurality of symbols is released, and the symbols are thereby displayed in a varying manner. After the elapse of a predetermined period of time, the symbols are displayed in a stopped manner. Through the displaying the symbols in the stopped manner, the plurality of symbols are rearranged. Through the rearrangement of the plurality of symbols, an outcome of the unit game is displayed. In the present embodiment, the displaying of the symbols in the stopped manner is synonymous with the appearing of the symbols.

The chance game mode is a game mode in which a unit game (free game), in which when the symbols are rearranged in the base game mode on a predetermined condition, on a condition which is different from that in the base game mode, the symbols are rearranged and a payout in accordance with the rearranged symbols is paid out, is executed.

The free game mode is a game mode in which a unit game (free game), in which when the symbols are rearranged in the base game mode or the chance game mode on a predetermined condition, on a condition which is different from that in the base game mode, the symbols are rearranged and a payout in accordance with the rearranged symbols is paid out, is executed.

It is only required for the symbols to be symbols which are rearrange in the symbol display region 141d so as to be viewable, and kinds and numbers thereof are not limited. The concept of the symbols is a superordinate concept of specific symbols and normal symbols. The specific symbols are added to the normal symbols as needed.

For example, the specific symbols include wild symbols (for example, the later-described symbols of WILD, or the like) and trigger symbols (for example, the later-described symbols of CHANCE and FEATURE, or the like). The wild symbols can serve as substitute symbols as other kinds of symbols. The wild symbols are replaced with other symbols so as to establish an advantageous winning pattern. The trigger symbols are symbols which serve as a trigger which initiates the execution of at least a bonus game. In addition, the trigger symbols may have a function to increase the specific symbols in the bonus game, that is, to increase the specific symbols of at least one of the trigger symbols or the wild symbols. In addition, the trigger symbols may have a function to increase the number of games in the bonus game.

Specifically, the symbols collectively mean symbols of WILD, GOLD, RED, BLUE, GREEN, ACE, KING, QUEEN, JACK, TEN, NINE, CHANCE, FEATURE, and BLANK. It is to be noted that as the symbols in the present embodiment, blank symbols (the later-described symbols of BLANK) are also included.

The symbols of BLANK do not constitute any winning pattern. Accordingly, even when a plurality of symbols of BLANK are rearranged on a payline, the plurality of symbols of BLANK do not function as the normal symbols and do not constitute any winning pattern. In addition, the symbols of BLANK do not function also as scatter symbols and do not constitute any winning pattern even when the plurality of symbols of BLANK appear, irrespective of a payline.

In the present embodiment, on each of the symbols of BLANK, any picture pattern or symbol design is not formed, thereby allowing a player to visually recognize that no winning pattern is constituted. For example, it is preferable that each of the symbols of BLANK is configured in a single color. As the symbol of BLANK, there included are a symbol which has depicted therein even a picture pattern such as a decorative design, most of which is a single-color region, and a symbol which has depicted therein even a picture pattern such as a pattern, whose color is pale and which is visually recognized as a single-color region.

The gaming value is coins, bills, or electrical valuable information corresponding to these. The gaming value in the present embodiment is not particularly limited, and for example, may be gaming media such as medals, a token, electronic money, and a ticket. The ticket is not particularly limited, and for example, may be the-later-described ticket with a barcode and the like.

The bonus game is synonymous with a feature game. For example, a game in which a unit game is repeated in the free game mode may be the bonus game. It is only required for the bonus game to be a game whose gaming state is more advantageous than that in the base game mode, and as such a bonus game, any kind of a game may be adopted. In addition, if a gaming state is an advantageous gaming state for a player, that is, if the gaming state in the game in the bonus game mode is more advantageous than that in the game in the base game mode, a plurality of kinds of bonus games may be combined and the combined plurality of kinds of bonus games may be adopted. For example, the bonus game may be realized, singly by each of the kinds of states or by combining the kinds of states such as a state in which a larger amount of a gaming value can be obtained than that in the base game mode, a state in which a gaming value can be obtained with a higher probability than that in the base game mode, and a state in which an amount of a consumed gaming value is made smaller than that in the base game mode.

It is only required for the chance game mode and the free game mode (bonus game mode) to be a game mode which is different from the base game mode, and as such a change game mode and a free game mode, any kinds of game modes may be adopted. In the present embodiment, as the bonus game, the free games are executed. Each of the free games may be a game which can be executed by placing a smaller bet of a gaming value than that in the base game and in which a gaming value of an amount in accordance with a winning pattern which is established based on rearranged symbols is paid out. In other words, each of the free games may be a game which can be initiated without consuming any gaming value. The case of “without consuming any gaming value” includes a case in which an amount of the bet is “0”.

A state of the rearrangement means a state in which after the arrangement of symbols has been released, symbols are again arranged in the symbol display region 141d. By initiating the unit game (slot game), the arrangement of symbols is released, and thereafter, symbols are again arranged (rearranged), and based on the rearranged symbols, an outcome of the unit game is determined, thereby finishing the unit game. A state of the “arrangement” means a state in which a player external thereto can visually confirm the symbols.

### Specific Outline of Gaming Machine of the Present Embodiment

An outline of a gaming machine 1 of the present embodiment is as described below. The details thereof will be described later.

The gaming machine 1 has five video reel 3a, 3b, 3c, 3d, and 3e. The five video reel 3a, 3b, 3c, 3d, and 3e are displayed by images on a lower image display panel 141. Along a longitudinal direction of each of the five video reels 3a to 3e, a plurality of symbols are arranged. Each of the plurality of symbols arranged on each of the five video reels 3a to 3e is displayed by an image. One reel strip (one symbol array) is constituted of the plurality of symbols arranged on each of the video reels. As described above, since the plurality of symbols are displayed by the images, the reel strips in the present embodiment are virtual and are arrays of symbols, in each of which the plurality of symbols are arranged in a column state. The images of the plurality of symbols are displayed in the column state, thereby allowing one reel strip to be displayed as one video reel on the lower image display panel 141. The five reel strips (five symbol arrays) are constituted of the five video reels 3a to 3e. In the present embodiment, the reel strips are synonymous with symbol arrays, and the five reel strips and the plurality of reel strips are collectively referred to as a group of reel strips. The video reels 3a to 3e are displayed in the varying manner and are displayed in the stopped manner, whereby scroll lines of the symbol arrays are configured.

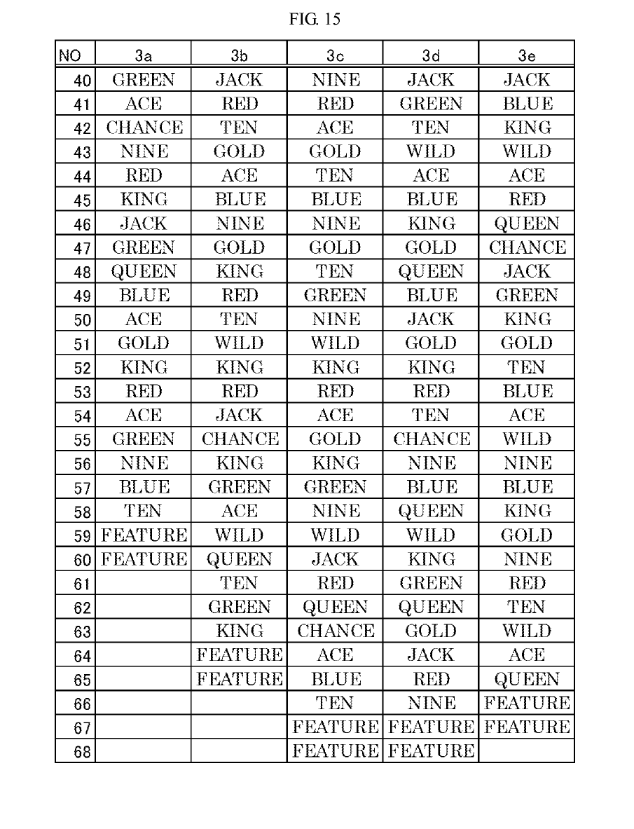

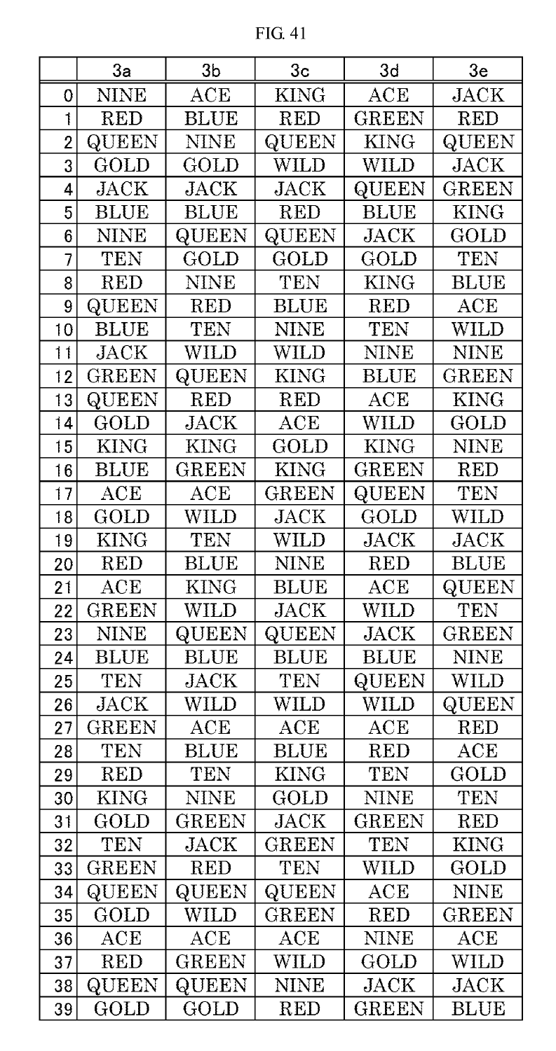

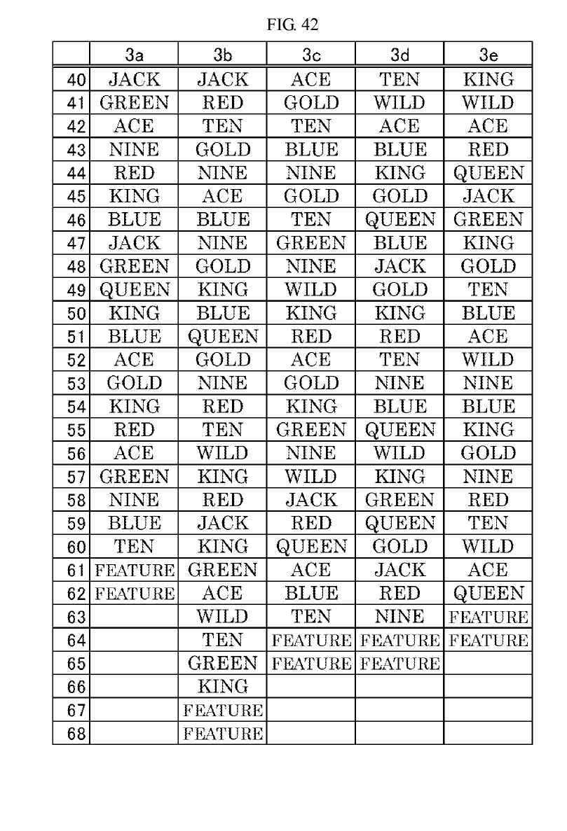

In the present embodiment, there are three kinds of game modes: a base game mode; a chance game mode; and a free game mode. Five reel strips used in each of these game modes are different from one another. As described later, in FIG. 14 and FIG. 15, five reel strips used in the base game mode are shown. In FIG. 16 to FIG. 40, five reel strips (TIGER CHANCE_0 to TIGER CHANCE_10) used in the chance game mode are shown. In FIG. 41 and FIG. 42, five reel strips used in the free game mode are shown.

In a symbol display region 141d of the gaming machine 1, 30 paylines are formed. The 30 paylines are fixed, irrespective of any BET.

As kinds of symbols in the gaming machine 1 of the present embodiment, there included are WILD (wild symbols), GOLD, RED, BLUE, GREEN, ACE, KING, QUEEN, JACK, TEN, NINE, CHANCE (trigger symbols), FEATURE (trigger symbols), and BLANK.

The symbol of WILD is a symbol which is replaced with other symbol when it is determined whether or not a winning pattern along a payline is established. The WILD is replaced with other symbol so as to establish an advantageous winning pattern, thereby determining that any winning pattern is established.

The symbol of CHANCE is a scatter symbol. Irrespective of any payline, when it is determined by a symbol drawing process that a predetermined number of, for example, three symbols of CHANCE appear in the symbol display region 141d, a winning pattern is established. For example, when it is determined that two symbols of CHANCE appear on the video reel 3a and one symbol of CHANCE appear on the video reel 3d in the symbol display region 141d, a winning pattern is established.

The winning pattern of CHANCE is established, whereby the chance game mode (tiger chance) is triggered. The winning pattern of CHANCE is established only in the base game mode and is not established in the chance game mode and the free game mode.

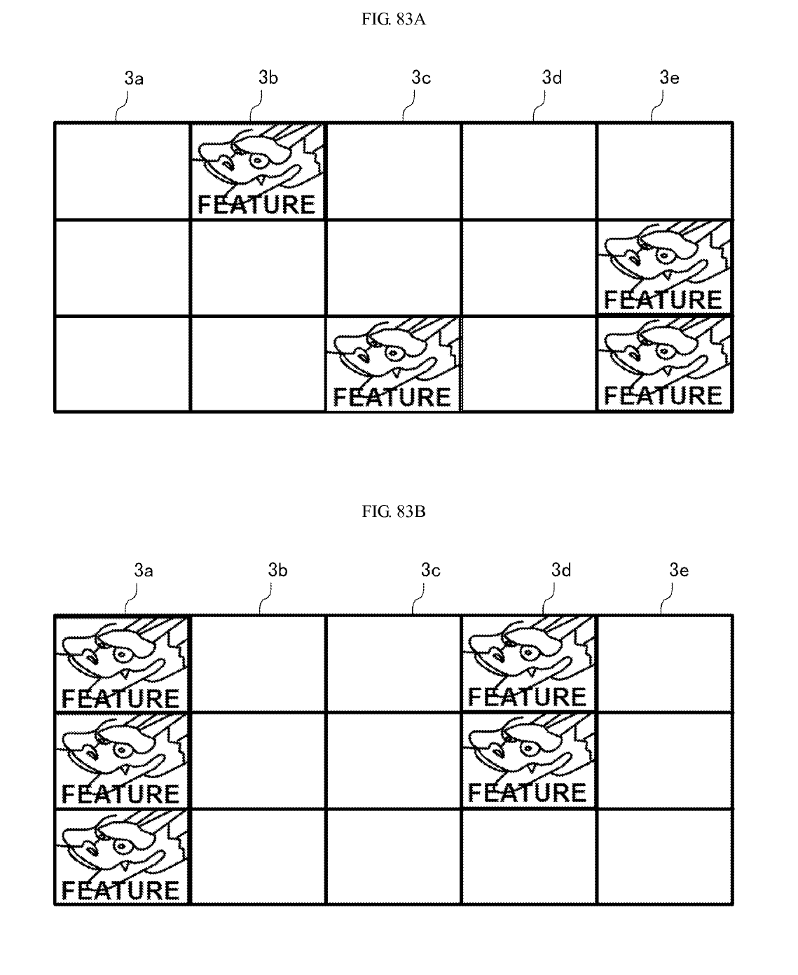

The symbol of FEATURE is a symbol, with which a winning pattern is established, irrespective of any payline. When it is determined by the symbol drawing process that the symbols of FEATURE appear on a predetermined number of reels, for example, three or more video reels in the symbol display region 141d, whereby a winning pattern is established. As shown in FIG. 83A, when it is determined that one symbol of FEATURE appear on the video reel 3b, one symbol of FEATURE appear on the video reel 3c, and two symbols of FEATURE appear on the video reel 3e in the symbol display region 141d, since the symbols of FEATURE appear on the three video reels in the symbol display region 141d, a winning pattern is established. In FIGS. 83A and 83B, the symbol display region 141d is shown, and the five video reels 3a to 3e and stop positions of an upper row, a middle row, and a lower row are shown.

On the other hand, as shown in FIG. 83B, when it is determined that three symbols of FEATURE appear on the video reel 3a and two symbols of FEATURE appear on the video reel 3d in the symbol display region 141d, any winning pattern is not established. Although the total number of symbols of FEATURE which have appeared in the symbol display region 141d is five, since the symbols of FEATURE have appeared on the two video reels 3a and 3d, any winning pattern is not established. As described above, in accordance with the number of video reels on which the symbols of FEATURE have appeared, it is determined whether or not a winning pattern is established. As described above, in the present embodiment, the symbol of FEATURE is not treated as a scatter symbol, a condition of establishing a winning pattern is not determined by the number of symbols of FEATURE.

The winning pattern of the symbols of FEATURE is established, whereby the free game mode (dragon free games) is triggered. The winning pattern of the symbols of FEATURE is established in any of the base game mode, the chance game mode, and the free game mode. The winning pattern of the symbols of FEATURE in the free game mode is established, whereby the free game mode (dragon free games) is retriggered.

<Chance Game Mode (Tiger Chance)>

On the condition that the winning pattern of the symbols of CHANCE in the unit game executed in the base game mode has been established, the chance game mode (tiger chance) is triggered. The chance game mode is triggered, whereby the game mode is shifted (transitions) from the base game mode to the chance game mode. When three symbols of CHANCE have appeared in the symbol display region 141d, the game mode is shifted from the base game mode to the chance game mode.

Upon shifting to the chance game mode, five unit games are set. A player can play up to five unit games in the chance game mode. In each of the unit games in the chance game mode, five reel strips which are different from those used in the unit game in the base game mode are used as the five video reels 3a to 3e.

As described above, the respective five reel strips (group of reel strips) used in the respective game modes are different from one another. Hereinafter, the five reel strips is referred to as a group of reel strips, and data of symbol arrays for displaying as images the five video reels 3a to 3e in the symbol display region 141d is defined. There are 11 kinds of groups of reel strips used in the chance game mode (refer to FIG. 16 to FIG. 40). As shown in FIG. 52, these 11 kinds of groups of reel strips are TIGER CHANCE_0 to TIGER CHANCE_10.

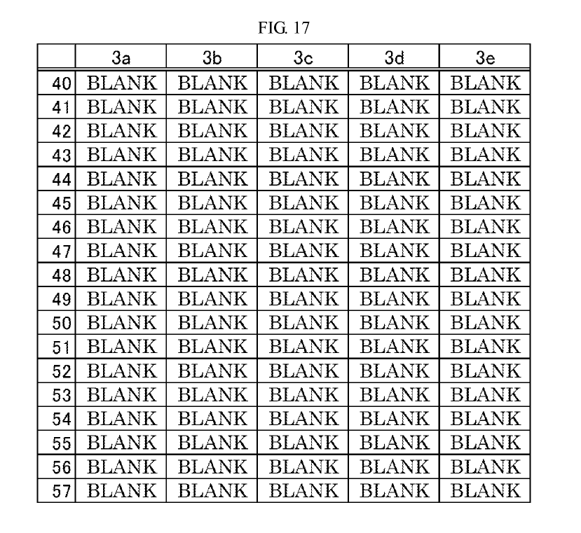

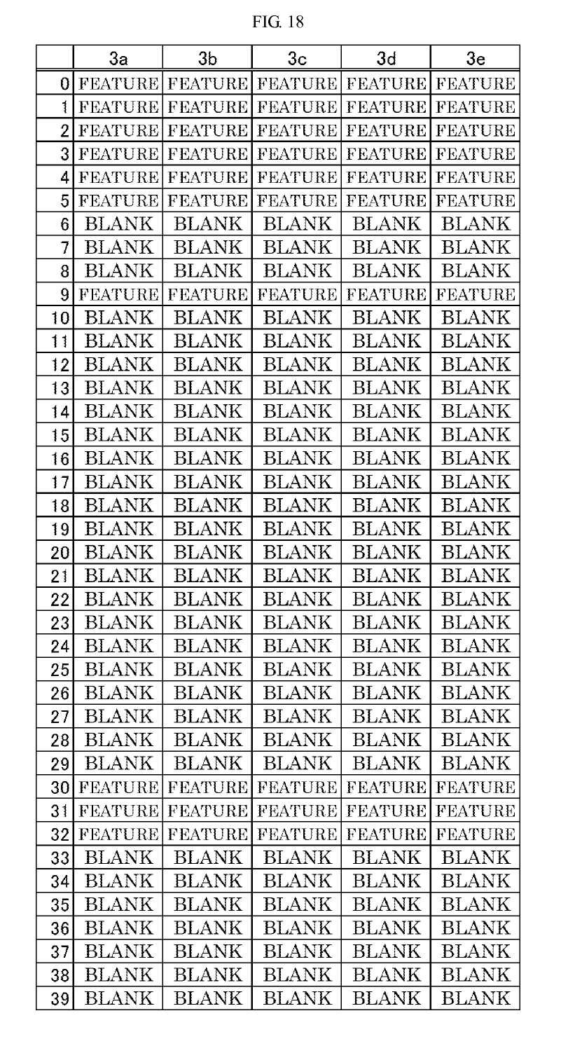

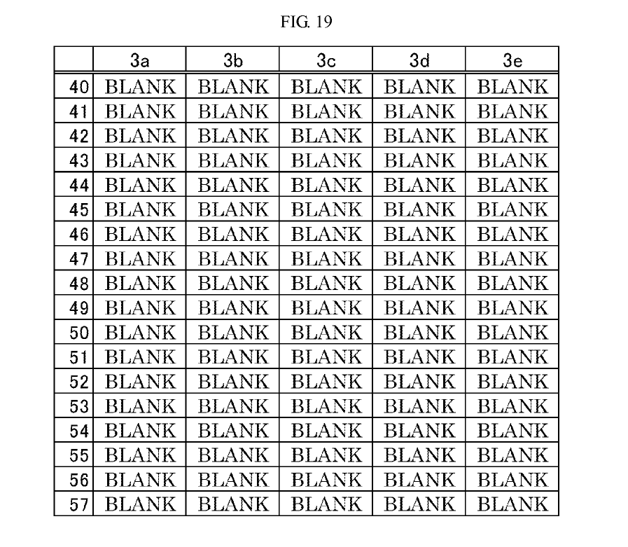

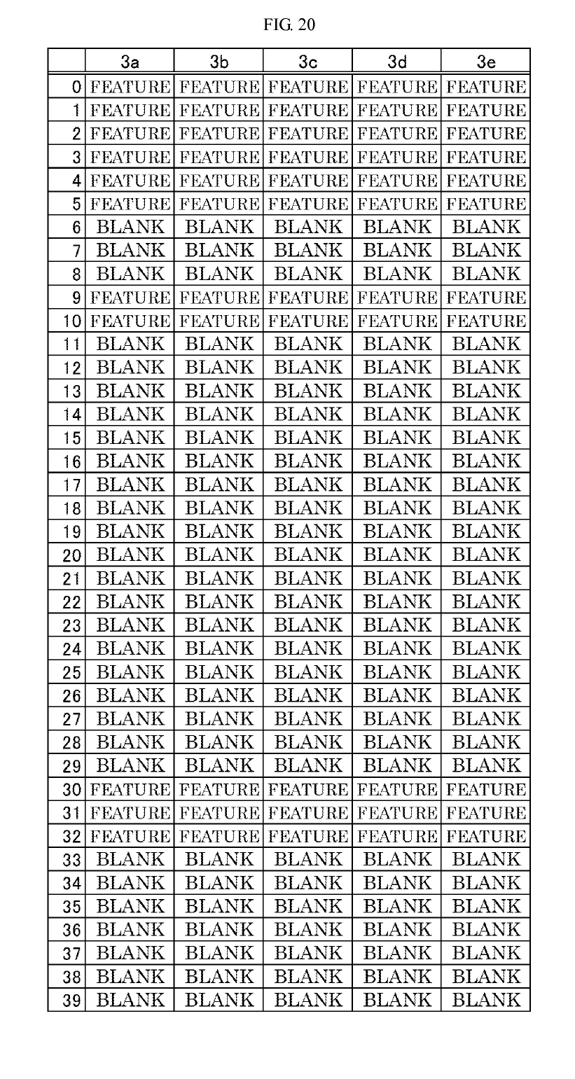

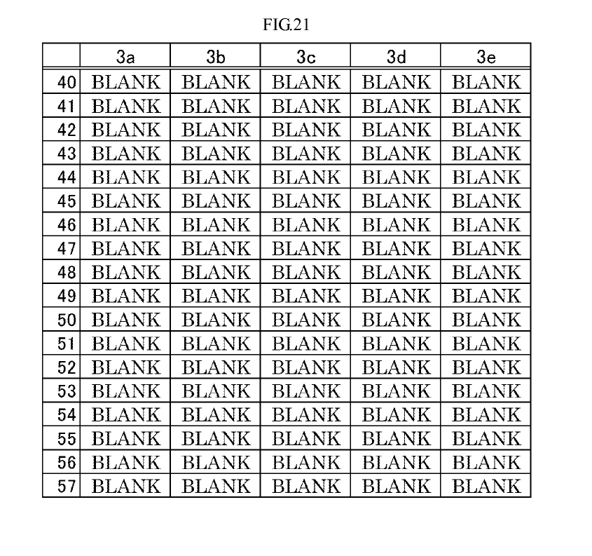

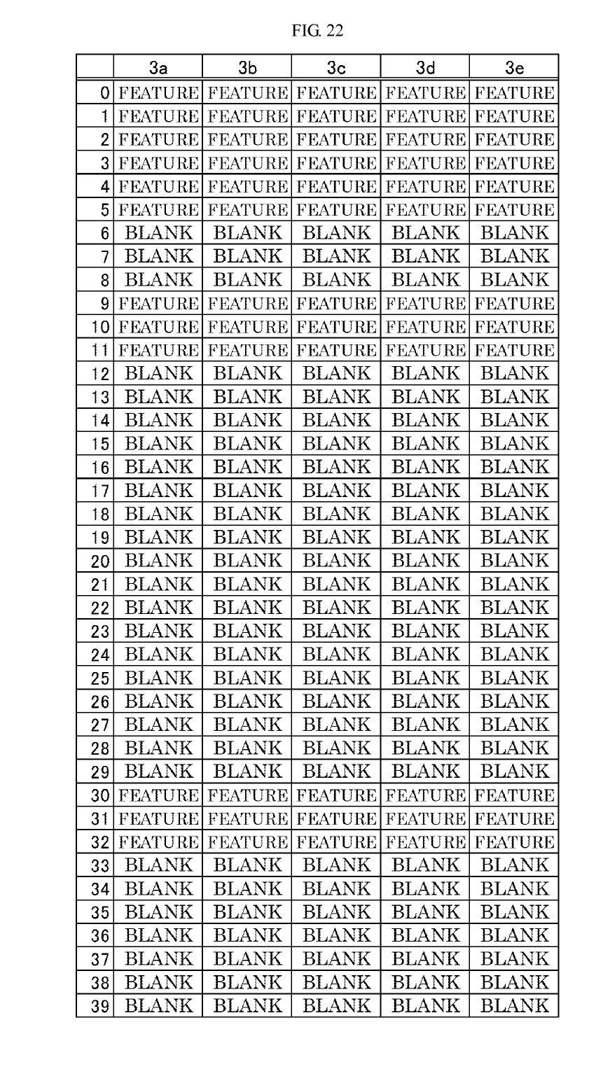

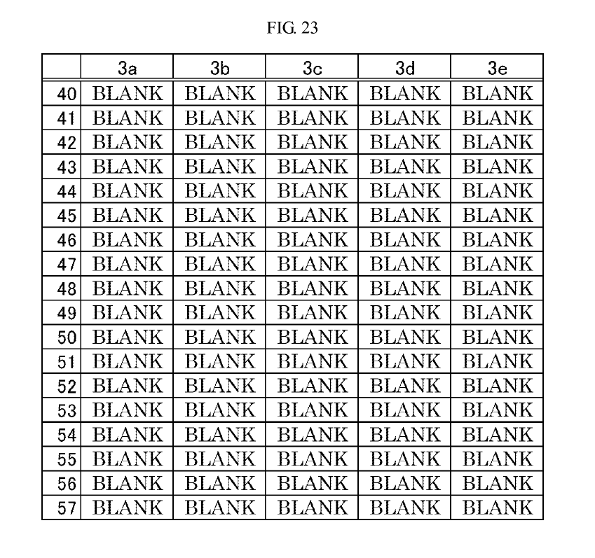

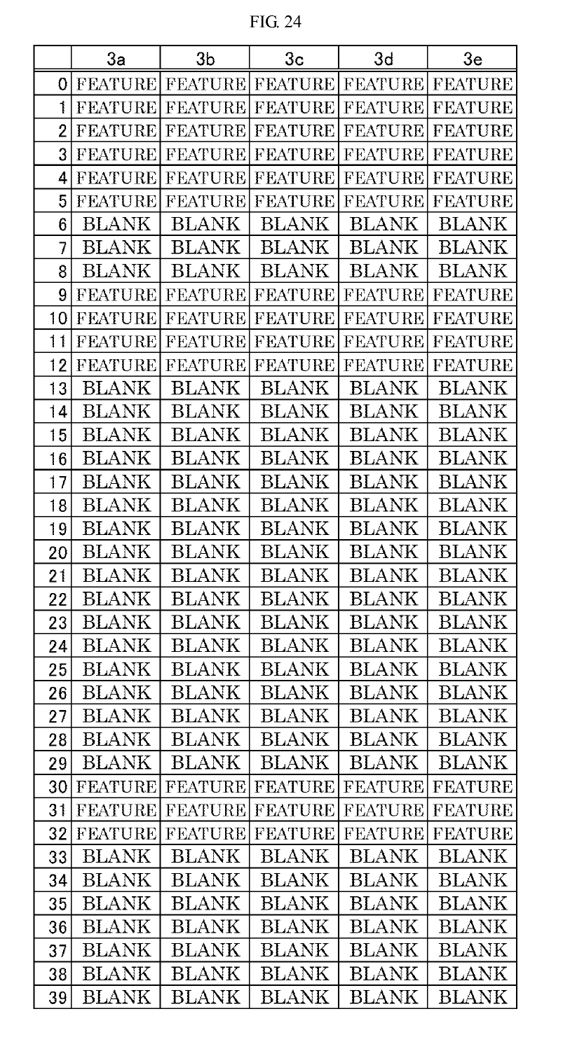

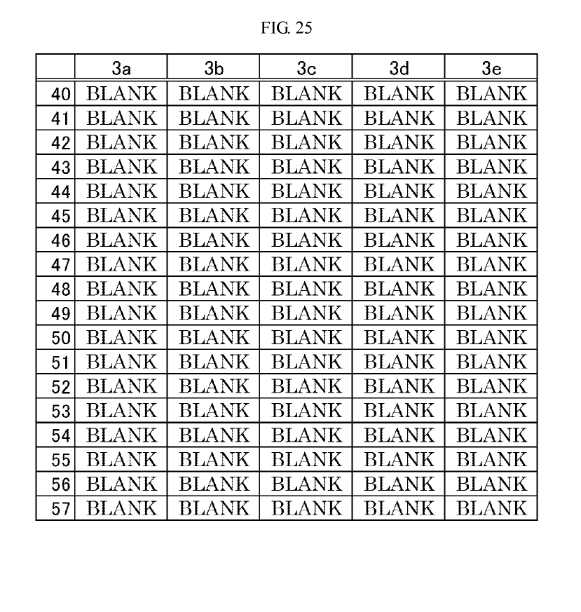

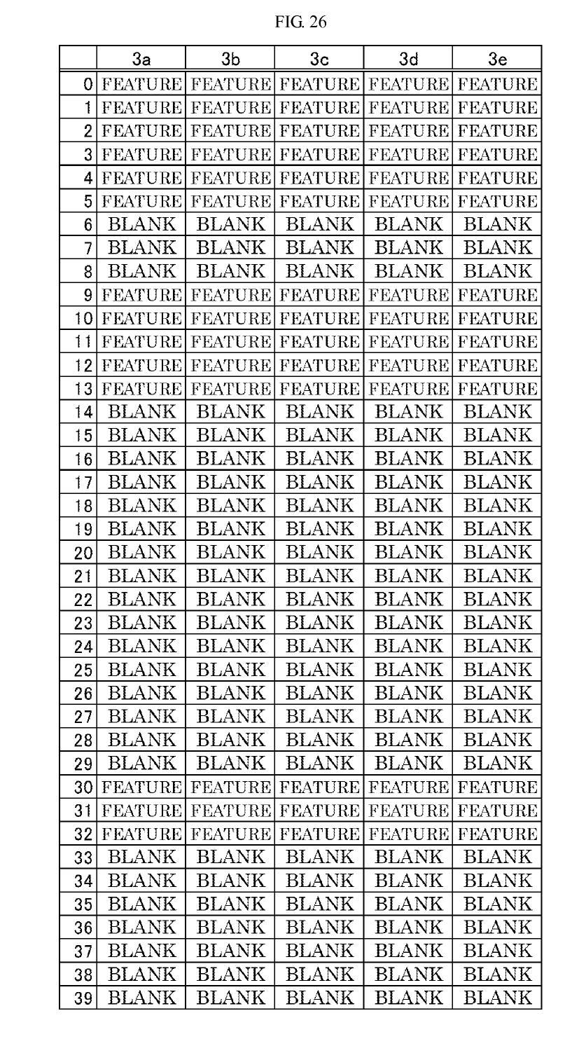

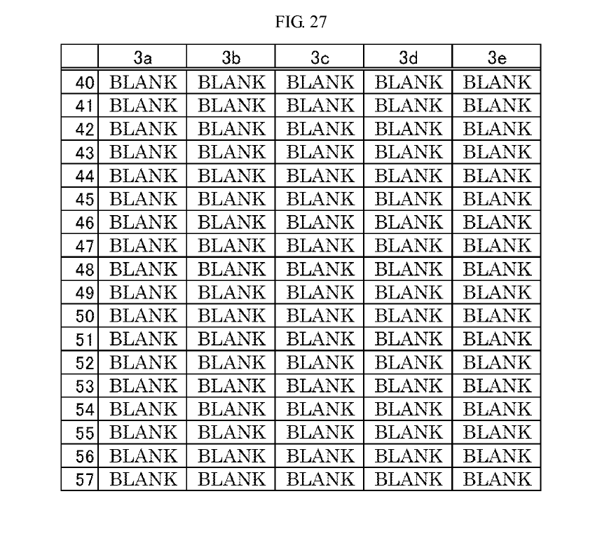

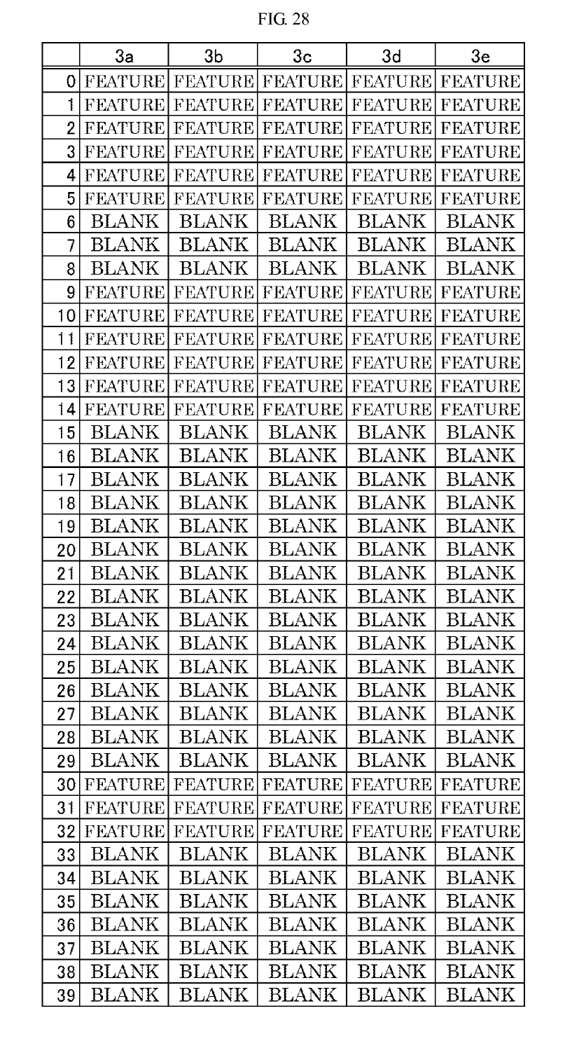

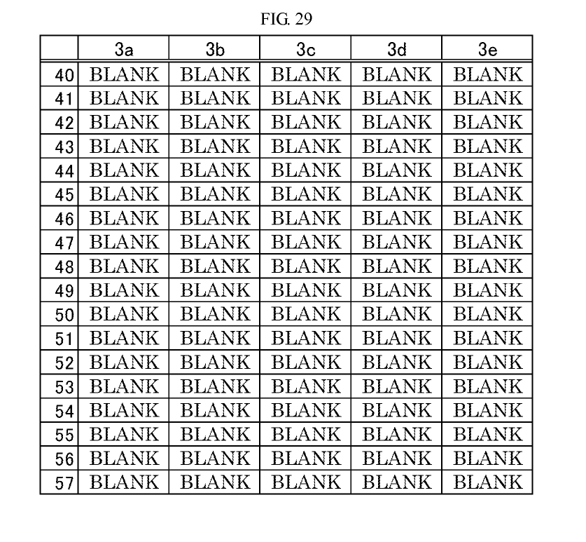

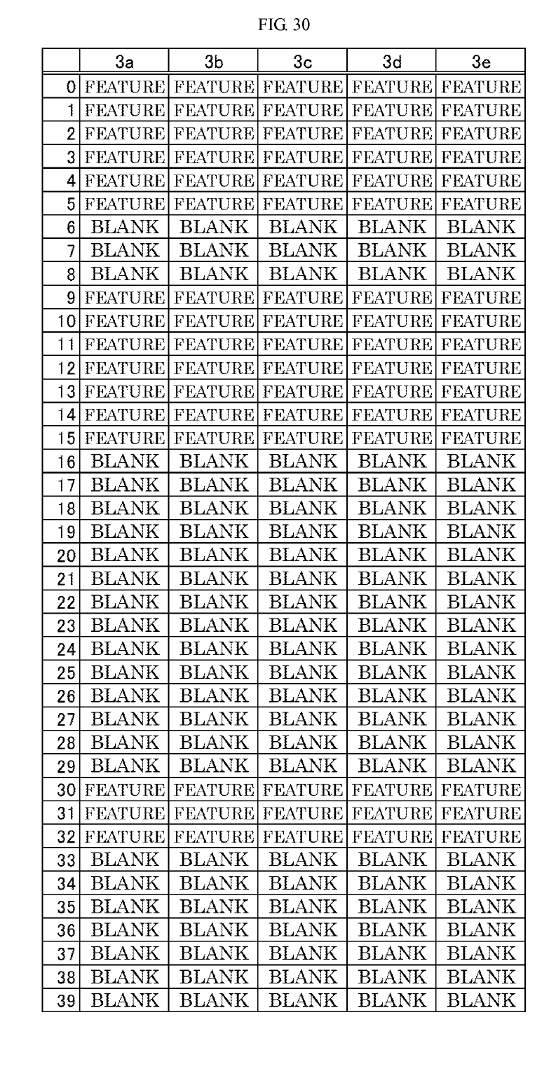

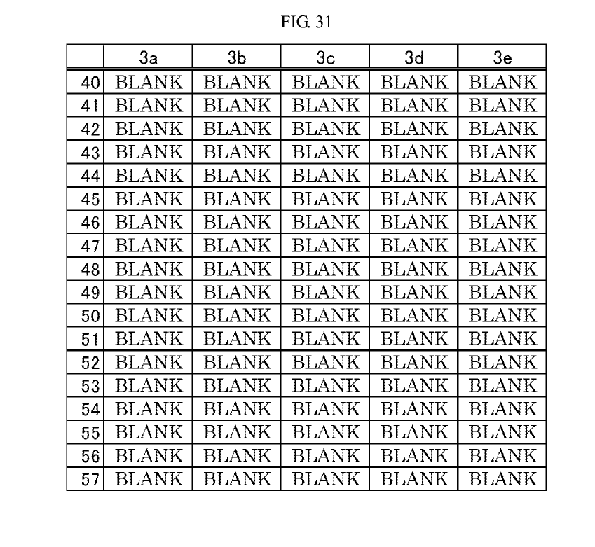

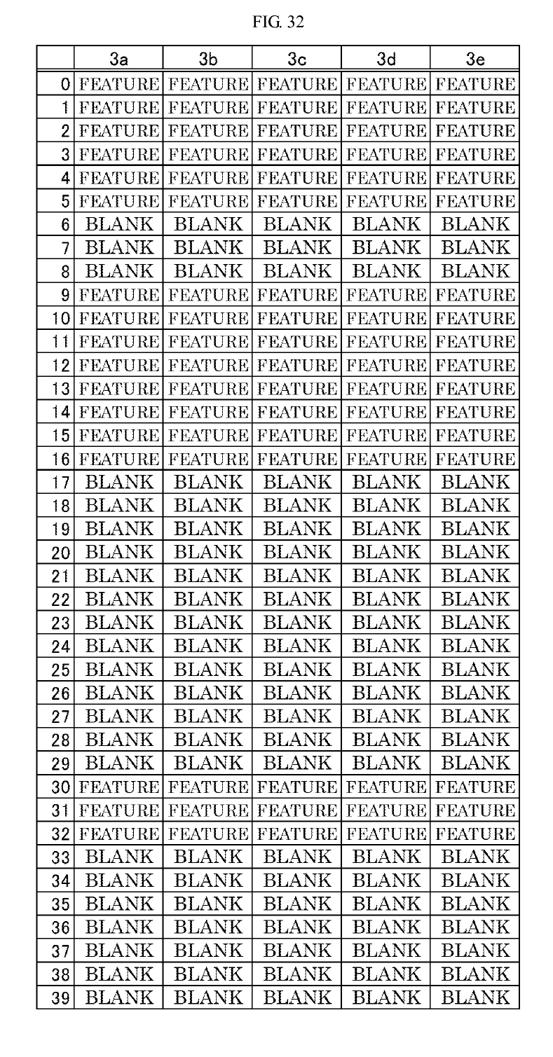

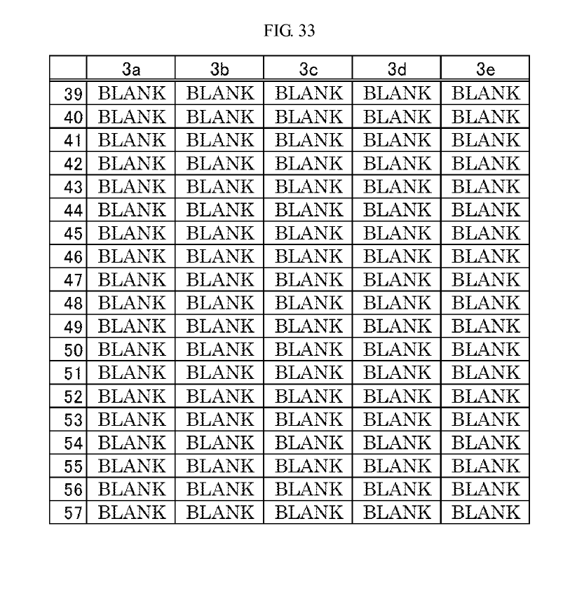

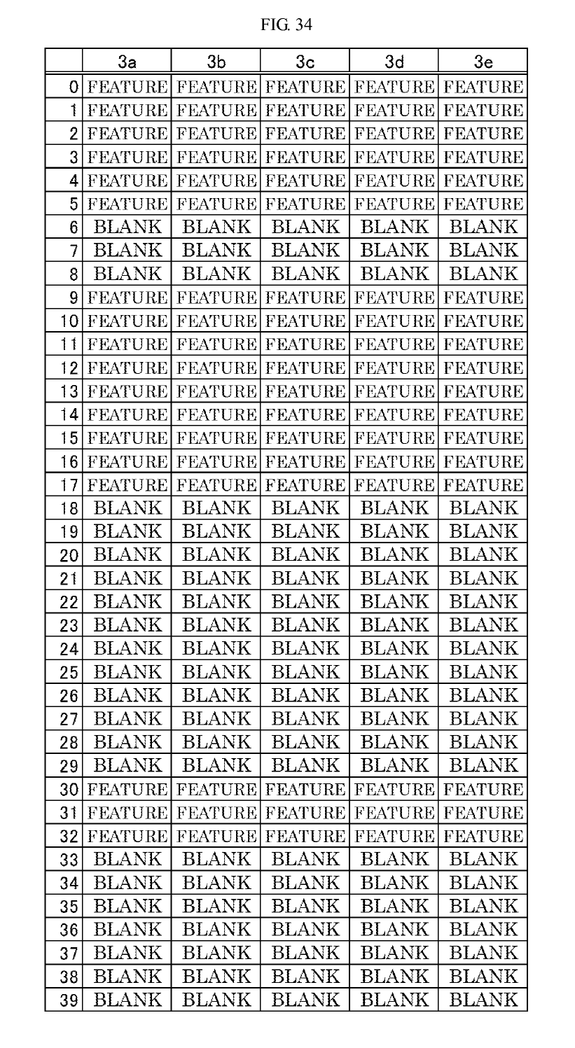

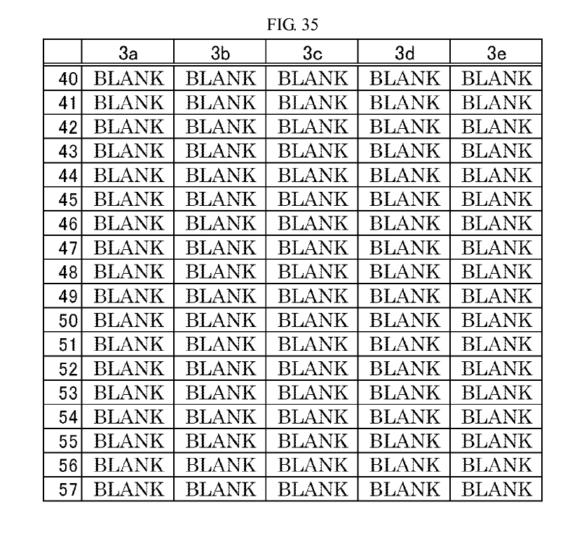

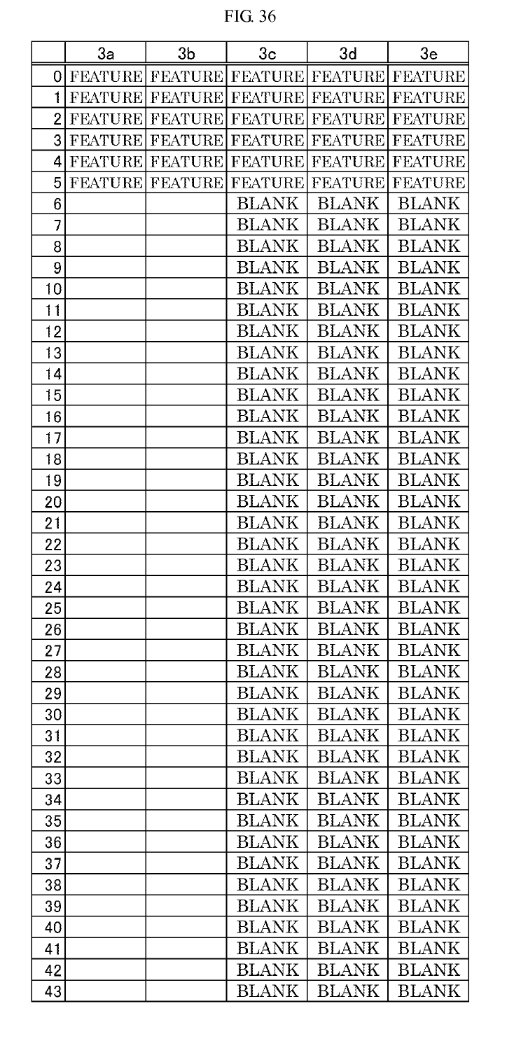

Specifically, in FIG. 16 to FIG. 17, a table indicative of a group of reel strips, TIGER CHANCE_0, is shown. In FIG. 18 to FIG. 19, a table indicative of a group of reel strips, TIGER CHANCE_1, is shown. In FIG. 20 to FIG. 21, a table indicative of a group of reel strips, TIGER CHANCE_2, is shown. In FIG. 22 to FIG. 23, a table indicative of a group of reel strips, TIGER CHANCE_3, is shown. In FIG. 24 to FIG. 25, a table indicative of a group of reel strips, TIGER CHANCE_4, is shown. In FIG. 26 to FIG. 27, a table indicative of a group of reel strips, TIGER CHANCES, is shown. In FIG. 28 to FIG. 29, a table indicative of a group of reel strips, TIGER CHANCE_6, is shown. In FIG. 30 to FIG. 31, a table indicative of a group of reel strips, TIGER CHANCE_7, is shown. In FIG. 32 to FIG. 33, a table indicative of a group of reel strips, TIGER CHANCE_8, is shown. In FIG. 34 to FIG. 35, a table indicative of a group of reel strips, TIGER CHANCE_9, is shown. In FIG. 36 to FIG. 40, a table indicative of a group of reel strips, TIGER CHANCE_10, is shown.

As described later, upon initiating a unit game in the chance game mode, any one kind of a group of reel strips among the 11 kinds of groups of reel strips, TIGER CHANCE_0 to TIGER CHANCE_10, is selected by a drawing process. This allows five reel strips for displaying the five video reels 3a to 3e as images in each of the unit games in the chance game mode to be determined.

In the chance game mode, up to five unit games can be played. In FIG. 52, a table which defines the relationship between each of the first to fifth unit games and a weight of each of the 11 kinds of groups of reel strips is shown.

As shown in FIG. 52, in each of the first to fourth unit games, a weight of each of the 10 kinds of groups of reel strips, TIGER CHANCE_0 to TIGER CHANCE_9, is one, and a weight of the group of reel strips, TIGER CHANCE_10, is zero. Accordingly, in each of the first to fourth unit games, the group of reel strips, TIGER CHANCE_10, is not selected, and any one of the 10 kinds of groups of reel strips, TIGER CHANCE_0 to TIGER CHANCE_9, is selected with an equal probability by the drawing process.

On the other hand, in the fifth unit game (the last unit game), a weight of each of the 10 kinds of groups of reel strips, TIGER CHANCE_0 to TIGER CHANCE_9, is zero, and a weight of the group of reel strips, TIGER CHANCE_10, is 10. Accordingly, in the fifth unit game, only the fixed group of reel strips, TIGER CHANCE_10, is invariably selected by the drawing process.

The chance game mode is finished when the winning pattern of symbols of FEATURE has been established (when the free game mode has been triggered) or all of the five unit games have been played. When the winning pattern of symbols of FEATURE has been established, the game mode is shifted from the chance game mode to the free game mode. When all of the five unit games have been played, the game mode is returned from the chance game mode to the base game mode. It is to be noted that even when all of the five unit games have not been played, upon establishing the winning pattern of symbols of FEATURE, the game mode is shifted from the chance game mode to the free game mode. Further, even when all of the five unit games have not been played, the game mode is not returned from the free game mode to the chance game mode and is returned to the base game mode.

In the chance game mode, a winning pattern of symbols of CHANCE is not established, and the chance game mode is not retriggered.

As shown in FIG. 14 to FIG. 40, in the chance game mode, only two kinds of symbols of FEATURE and BLANK are displayed on the five video reels 3a to 3e. The plurality of symbols of FEATURE are arranged in succession along the reel strips. Thus, the plurality of symbols of FEATURE are arranged in succession (arranged in a clustered state or a block state), thereby allowing a player to expect that the free game mode will be triggered.

As described above, since in the chance game mode, the plurality of symbols of FEATURE are arranged in succession along the reel strips, it is made easy to display the plurality of symbols of FEATURE in the stopped manner in the symbol display region 141d. Thus, if the symbol of FEATURE is treated as a scatter symbol, the winning pattern is easily established, thereby increasing likelihood with which a profit is excessively provided for a player.

Therefore, it is defined that when the symbols of FEATURE have appeared on the predetermined number of reels, for example, on the three or more video reels, the winning pattern is established. In other word, based on the number of video reels on which the symbols of FEATURE have appeared, instead of the number of symbols of FEATURE, the condition on which the winning pattern is established is defined. Thus, the winning pattern is prevented from easily being established, thereby allowing a profit of a gaming facility to be protected.

<Free Game Mode (Dragon Free Fame)>

On the condition that a winning pattern of symbols of FEATURE has been established in each of the unit games executed in a base game mode, a chance game mode, and a free game mode, the free game mode (dragon free game) is triggered. As described above, when it is determined by a symbol drawing process that the symbols of FEATURE appear on the predetermined number or more of reels, for example, on three or more video reels in a symbol display region 141d, the winning pattern is established and the free game mode is triggered.

The free game mode is triggered, whereby the game mode is shifted to the free game mode. There are a case in which the game mode is shifted from the base game mode to the free game mode; a case in which the game mode is shifted from the chance game mode to the free game mode; and a case in which the game mode is shifted from the free game mode to the free game mode (a case in which a retrigger has occurred and the free game mode is continued).

Upon shifting to the free game mode, based on the symbols of FEATURE by which the winning pattern is established, the number of unit games to be played in the free game mode is determined. A player can play unit games whose number is determined in the chance game mode.

In the free game mode, there may be a case in which the winning pattern of the symbols of FEATURE is established, and the free game mode is retriggered. When the free game mode has been retriggered, based on the symbols of FEATURE by which the winning pattern has been established, the number of unit games in the free game mode is determined. It is to be noted that by the occurrence of the retrigger, the number of unit games may be newly determined or a new number of unit games may be added to the number of remaining unit games.

Further, in the free game mode, a multiplier for a payout is determined, all of each of the payouts is multiplied by the multiplier of a double or a triple, thereby determining an amount to be paid out.

<<<Overall Configuration of Slot Machine 10>>>

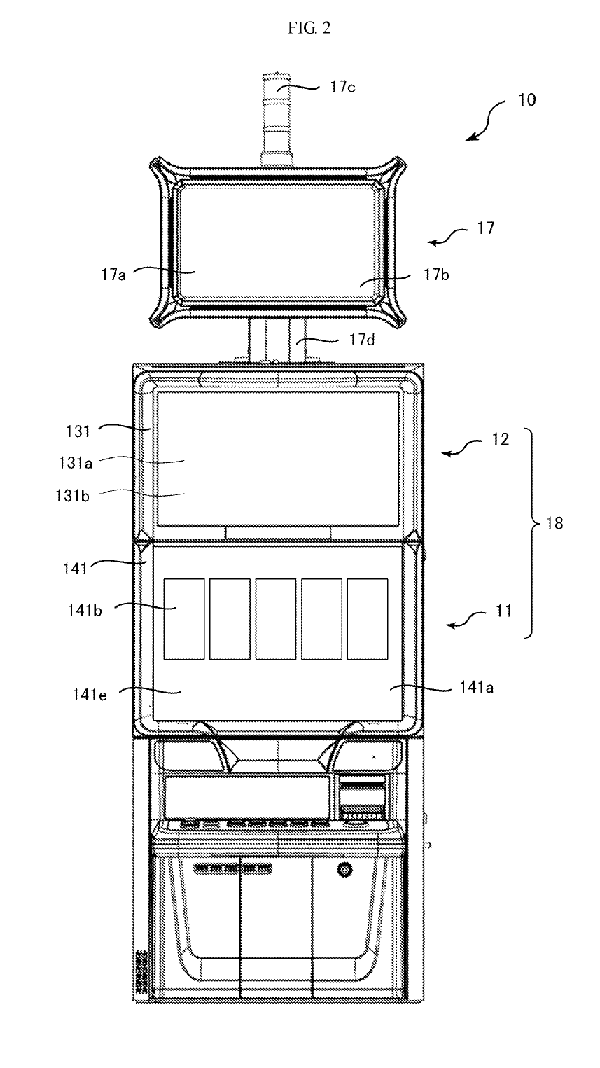

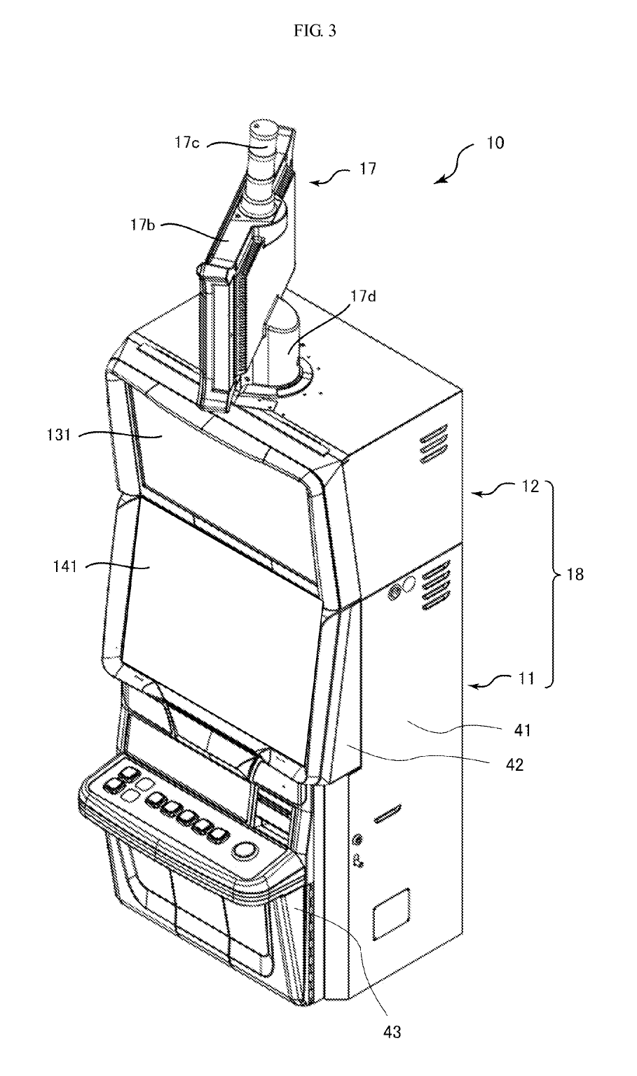

As shown in FIG. 2 and FIG. 3, a slot machine 10 as a gaming machine has a topper device 17 and a gaming machine main body 18 having an upper surface wall on which the topper device 17 is provided. The gaming machine main body 18 has a top device 12 and an apparatus main body 11. The top device 12 includes an upper display device 131. The top device 12 is provided on an upper surface wall of the apparatus main body 11. The apparatus main body 11 includes a lower display device 141.

The topper device 17 has a function to make the slot machine 10 conspicuous even from a distant place and a function to make the contents of a game on the slot machine 10 be viewable even from a distant place. The top device 12 has a function to display the specific contents and a payout table of a game and game-related information such as rules. The apparatus main body 11 has a function to execute a game.

It is to be noted that in the present embodiment, a side (a direction) which faces from the slot machine 10 toward a player is referred to as a front side (an anterior direction) of the slot machine 10, a side opposite to the front side is referred to as a rear side (a posterior direction, a depth direction), and a right side and a left side viewed from a player are referred to as a right side (a right direction) and a left side (a left direction), respectively. In addition, a direction including the front side and the rear side is referred to as an anterior-posterior direction, a thickness direction, or a depth direction, and a direction including the right side and the left side is referred to as a horizontal direction or a width direction. A direction which is perpendicular to the anterior-posterior direction (the thickness direction or the depth direction) and the horizontal direction (the width direction) is referred to as a vertical direction or a height direction.

<Outline of Topper Device 17>

The topper device 17 is provided on the upper surface wall of the top device 12 so as to be located in the highest position of the slot machine 10. The topper device 17 has an axis of rotation which coincides with the vertical direction of the slot machine 10 and is configured to be rotatable in a predetermined angle range with this axis of rotation as the center in a normal direction (clockwise) and a reverse direction (counterclockwise). Thus, the topper device 17 is configured such that a display face 17a thereof for displaying the contents of a game takes a front posture (FIG. 2) in which the display face 17a faces toward the front side and an oblique posture (FIG. 3) in which the display face 17a faces toward an obliquely front side, the front posture and the oblique posture being switchable.

The front posture is adopted in a normal state such as when a game is being executed and when a game is in a standby state and is configured so as to allow people in a location distant from the slot machine 10 (players, those concerned with a gaming facility, etc.) to visually recognize the contents of a game. On the other hand, the oblique posture is a special posture adopted when the display on the topper device 17 is changed. As shown in FIG. 3, the oblique posture is taken by rotating the topper device 17 such that an end portion of the right side of the topper device 17 is located on the front side, and the oblique posture allows the display on the topper device 17 to be changed from the front side of the slot machine 10.

<Specific Configuration of Topper Device 17>

As shown in FIG. 2 and FIG. 3, the topper device 17 has a topper main body 17b having the display face 17a and a tower member 17c provided on an upper surface wall of the topper main body 17b. The tower member 17c has a transparent cover formed of resin, which is cylindrical in shape, and light emitting devices such as LEDs therein. The tower member 17c emits light in a single color or a plurality of colors at the uppermost part of the slot machine 10, thereby enhancing visibility from a distant place with respect to a position and a state of the slot machine 10.

As shown in FIG. 2 and FIG. 3, the topper device 17 has a topper supporting mechanism 17d. The topper main body 17b is supported by the topper supporting mechanism 17d so as to be rotatable in the predetermined angle range with respect to the top device 12 in the horizontal direction.

<Top Device 12>

The topper device 17 configured as described above, as shown in FIG. 2 and FIG. 3, is provided in an upper face of the top device 12. The top device 12 has an upper display device 131 provided on a front face of the top device 12. In addition, on an upper wall of the top device 12, the topper main body 17b is supported by the topper supporting mechanism 17d so as to be rotatable in the predetermined angle range with respect to the top device 12 in the horizontal direction.

<Upper Display Device 131>

The upper display device 131 has an upper touch panel 131a located on the forefront face, an upper liquid crystal display panel 131b located on a rear side of the upper touch panel 131a, and an upper control board base 131c.

The upper liquid crystal display panel 131b displays image data constituted of a moving image such as video and a still image such as letters and graphics. The upper touch panel 131a causes an image displayed on the upper liquid crystal display panel 131b to be transmissive therethrough such that a player can view the image and enables a player to operate a screen with a tip of a finger. The upper control board base 131c has thereinside a control board, not shown, for controlling the display on the upper liquid crystal display panel 131b.

<Apparatus Main Body 11>

The top device 12 configured as described above is provided on an upper face of the apparatus main body 11. The apparatus main body 11 has the lower display device 141, an upper door device 42, and a lower door device 43 located below the front face of the lower display device 141. The upper door device 42 and the lower door device 43 are configured to be openable and closable with respect to the game mechanism device 41. The upper door device 42 is configured to be openable and closable on the condition that the lower door device 43 is opened.

<Lower Display Device 141>

As shown in FIG. 2 and FIG. 3, the lower display device 141 has a lower touch panel 141a located on the forefront face, a lower liquid crystal panel 141b located on a rear side of the lower touch panel 141a, and a lower control board base 141c.

On the lower liquid crystal panel 141b, mainly, five video reels 3a to 3e are displayed as images. In addition, on the lower liquid crystal panel 141b, image data constituted of a moving image such as video and a still image such as letters and graphics is also displayed. The lower touch panel 141a causes an image displayed on the lower liquid crystal display panel 141b to be transmissive therethrough such that a player can view the image and enables a player to operate a screen with a tip of a finger. The lower control board base 141c has thereinside a control board, not shown, for controlling the display on the lower liquid crystal display panel 141b.

The lower display device 141 has a symbol display region 141d. In the symbol display region 141d, the five video reels 3a to 3e are displayed as the images. The five video reels 3a to 3e are displayed in a varying manner and displayed in a stopped manner in the symbol display region 141d. The five video reels 3a to 3e constitute five reel strips (five symbol arrays). In other words, in the symbol display region 141d, the five reel strips are displayed in the varying manner and displayed in the stopped manner. A plurality of symbols are arranged in an aligned manner, thereby configuring each of the reel strips. Images of symbols constituting the reel strips can be displayed as the video reels 3a to 3e in the symbol display region 141d.

In the present embodiment, in the symbol display region 141d, as stop positions of symbols of the respective video reels 3a to 3e, three rows, which are an upper row, a middle row, and a lower row, are defined. Accordingly, when the five video reels 3a to 3e (five reel strips) are displayed in the stopped manner, the total of 15 symbols, which is calculated by performing the multiplication 5×3 (5 columns×3 rows), appear (are displayed in the stopped manner) in the symbol display region 141d. Upon initiating a unit game, the five video reels 3a to 3e start to vary. Thereafter, after the elapse of a predetermined period of time, the five video reels 3a to 3e are displayed in the stopped manner. This causes the 15 symbols to appear (to be displayed in the stopped manner) in the symbol display region 141d, thereby rearranging the symbols. In other words, each time a unit game is played, symbols are rearranged in the symbol display region 141d and an outcome of the unit game is displayed.

A speed at which and a direction in which the five video reels 3a to 3e are displayed in the varying manner can be determined in accordance with a game mode and a unit game.

In a left end portion and a right end portion of the symbol display region 141d, payline generation arrays are located so as to be bilaterally symmetrical. Viewed from a side of a player, the payline generation array in the left end portion located on the left side has 30 payline generation parts. In addition, the payline generation array in the right end portion located on the right side has 30 payline generation parts.

Each of the payline generation parts in the left end portion forms a pair with any of the payline generation parts in the right end portion. A payline, which is a line extending from each of the payline generation parts in the left end portion toward any of the payline generation parts in the right end portion which is in the relationship of the pair with this payline generation part, is previously defined. In the present embodiment, 30 paylines are defined.

In the present embodiment, the 30 paylines are invariably activated. A number of activated paylines may be determined based on an amount of BET. In a case of MAX BET which is a maximum amount of BET, the 30 paylines which is the maximum number are activated. The activated paylines cause a variety of winning patterns with respect to the respective symbols to be established. The details of the winning patterns will be described later.

In the present embodiment, the case in which the slot machine 10 displays the video reels 3a to 3e is described. However, in the slot machine 10, a video reel system and a mechanical reel system may be mixed.

On the lower liquid crystal panel 141b, below the symbol display region 141d, a game state display region 141e is formed. In the game state display region 141e, a variety of pieces of information related to a game, such as a credit state and bet details, are displayed.

<Control Panel CP>

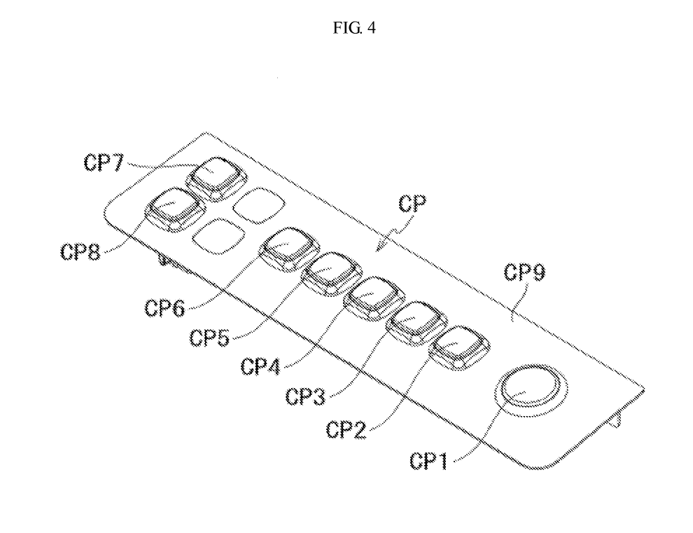

The slot machine 10 has a control panel CP. As shown in FIG. 4, the control panel CP has a flat plate base plate CP9 and a plurality of operation buttons CP1 to CP8 provided on the base plate CP9. The operation button CP1 is formed so as to be of a circular shape having a larger size than those of the other buttons CP2 to CP8 in order for the operation button CP1 to be easily identified and operated to be pressed by a player. The operation button CP1 is located in a right end portion of the base plate CP9 and has a function as a start button and a spin button for starting a game by a pressing operation.

The operation buttons CP2, CP3, CP4, CP5, and CP6 are located on a left side of the operation button CP1 in an aligned manner at equal intervals. Each of these operation buttons CP2 to CP6 is formed so as to be of a quadrangular shape. The operation button CP2 located in a right end has a function as a MAX BET button which causes a game to be played with a maximum number of bets such as a decuple by a pressing operation. The operation button CP3 has a function as a 5 BET button which causes a game to be played with a quintupled number of bets by a pressing operation. The operation button CP4 has a function as a 3 BET button which causes a game to be played with a tripled number of bets by a pressing operation. The operation button CP5 has a function as a 2 BET button which causes a game to be played with a doubled number of bets by a pressing operation. The operation button CP6 has a function as a 1 BET button which causes a game to be played with one bet by a pressing operation.

The operation buttons CP7 and CP8 are located in a left end portion of the base plate CP9 in an anterior-posterior direction. The operation button CP7 has a function as a help button which causes the game state display region 141e to display help information indicative of a game method and the like by a pressing operation. In addition, the operation button CP8 has a function as a cash-out button which returns credits and the like in the form of coins or a printed matter by a pressing operation.

<Overall Configuration of Game System>

A game system 600 which includes the slot machine 10 equipped with the above-described functions will be described.

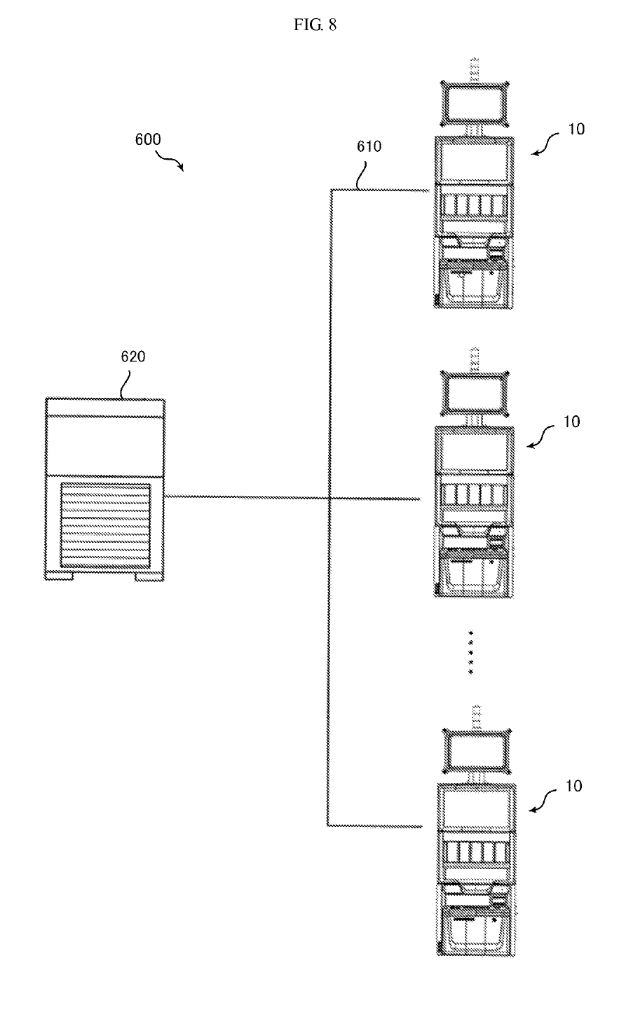

As shown in FIG. 8, the game system 600 is equipped with a plurality of slot machines 10 and an external control device 620 which is connected via a communication line 610 with each of the slot machines 10.

The external control device 620 is to control the plurality of slot machines 10. In the present embodiment, the external control device 620 is the so-called hall server which is installed in a gaming facility having the plurality of slot machines 10. Each of the slot machines 10 is provided with a unique identification number, and the external control device 620 identifies transmission sources of data transmitted from the respective slot machines 10 by using the identification numbers. In addition, in a case in which the external control device 620 transmits data to the slot machines 10, the identification numbers are used for specifying the transmission destination.

It is to be noted that the game system 600 may be constructed within a single gaming facility where various games can be played, such as a casino, or may be constructed among a plurality of gaming facilities. In addition, when the game system 600 is constructed in a single game facility, the game system 600 may be constructed in each floor or section of the gaming facility. The communication line 610 may be a wired or wireless line, and can adopt a dedicated line, an exchange line, or the like.

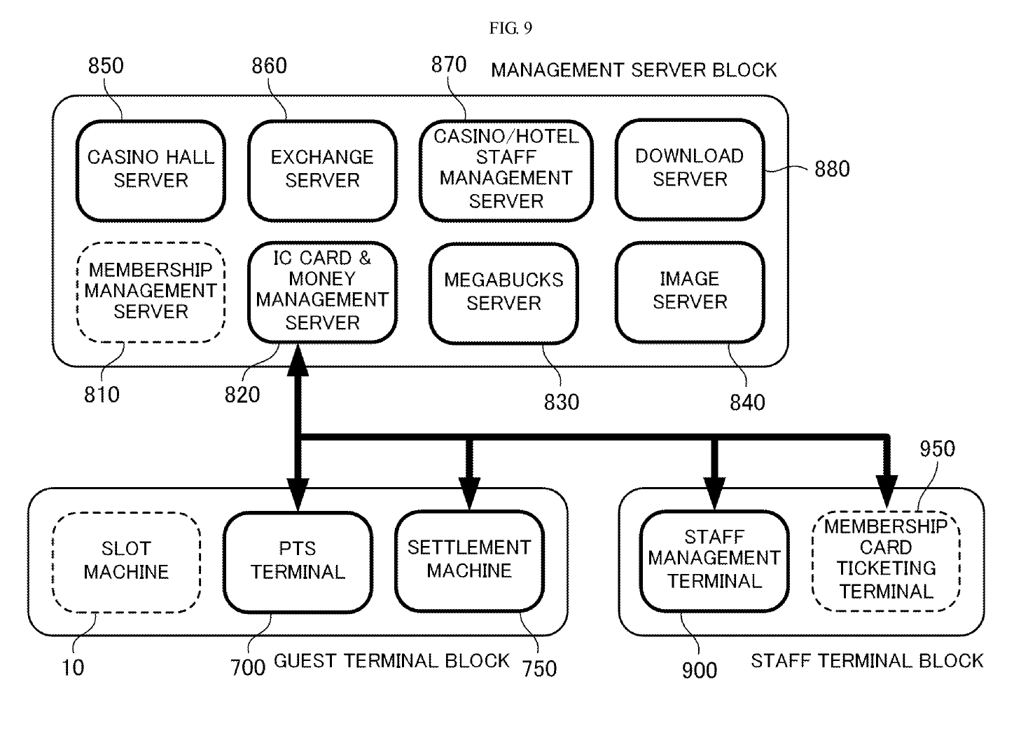

As shown in FIG. 9, the game system is divided into three blocks, which are a management server block, a guest terminal block, and a staff terminal block. The management server block has a casino hall server 850, an exchange server 860, a casino/hotel staff management server 870, and a download server 880.

The casino hall server 850 is a server which manages the whole casino hall where the slot machines 10 are installed. The exchange server 860 is a server which prepares exchange rate data based on exchange information. The casino/hotel staff management server 870 is a server which manages a staff of a casino hall or a staff of a hotel related to the casino hall. The download server 880 is a server which downloads, for example, the latest information such as information related to games and news and notifies a player of the latest information via a PTS terminal 700 of each of the slot machines 10.

In addition, the management server block has a membership management server 810, an IC card & money management server 820, a megabucks server 830, and an image server 840.

The membership management server 810 is a server which manages membership information or the like of a player playing a slot machine 10. The IC card & money management server 820 is a server which manages an IC card 500 used in a slot machine 10. Specifically, the IC card & money management server 820 is a server which stores fractional cash data so as to be associated with an identification code and outputs the fractional cash data to the PTS terminal 700. It is to be noted that the IC card & money management server 820 also prepares and manages denomination rate data or the like. The megabucks server 830 is a server which manages, for example, a game of megabucks in which the total amount of bets placed on the plurality of slot machines 10 installed in a plurality of casino halls or the like is to be paid out. The image server 840 is a server which downloads, for example, the latest image of an image related to a game and news and notifies a player of the latest image via the PTS terminal 700 of each of the slot machines 10.

The guest terminal block has a slot machine 10, the PTS terminal 700, and a settlement machine 750. The PTS terminal 700 is mountable onto the slot machine 10 and is communicable mutually with a management server 800. The settlement machine 750 is a machine which makes settlement by redeeming cash data stored in the IC card 500 which a player has and causes the IC card 500 to store a number of coins and bills as cash data.

The staff terminal block has a staff management terminal 900 and a membership card ticketing terminal 950. The staff management terminal 900 is a terminal used when a staff of a casino hall manages the slot machines 10. In particular, in the case of the present embodiment, the staff of a casino hall manages a number of IC cards 500 stocked in the PTS terminal 700 so as to avoid any excessive stock and any shortage thereof. The membership card ticketing terminal 950 is used when a player playing a game in a casino hall issues a membership card.

<PTS Terminal 700>

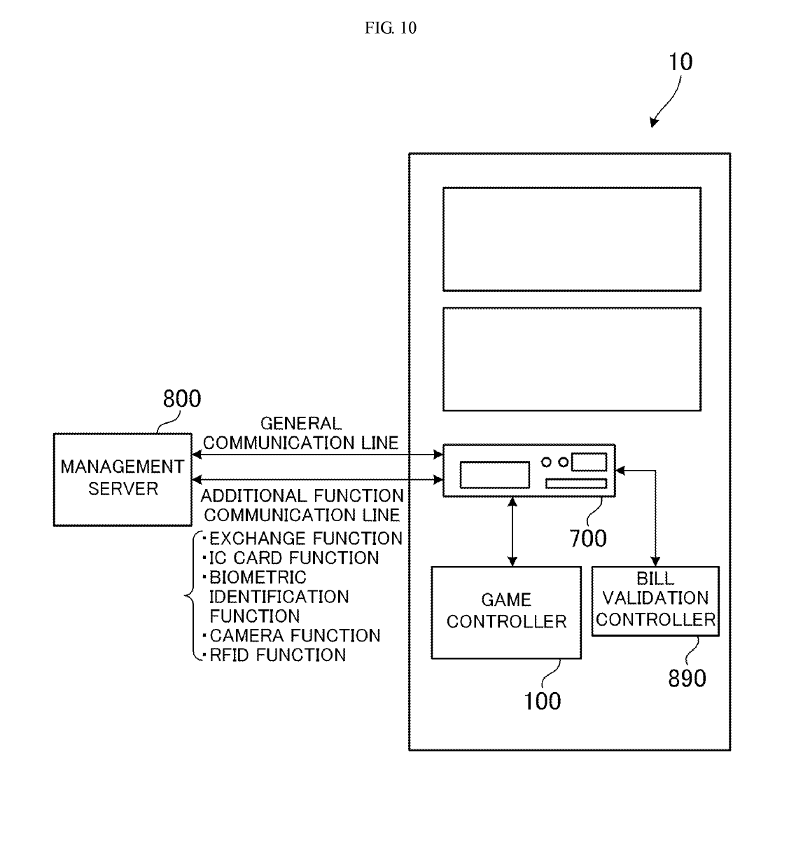

As shown in FIG. 10, the PTS terminal 700 is incorporated into a PTS system. The PTS terminal 700 attached onto a slot machine 10 is communicably connected to a game controller 100 and a bill validation controller 890 of the slot machine 10.

In the communication with the game controller 100, the PTS terminal 700 performs effects of a game by sounds, images, and the like and updates credit data. In addition, in the communication with the bill validation controller 890, the PTS terminal 700 transmits credit data needed upon the settlement.

In addition, the PTS terminal 700 is communicably connected to the management server 800. The PTS terminal 700 communicates over two lines, which are a general communication line and an additional function communication line, with the management server 800.

Over the general communication line, the PTS terminal 700 communicates, for example, data such as cash data, identification code data, and a player's membership information. On the other hand, over the additional function communication line, the PTS terminal 700 communicates with respect to newly added functions. In the case of the present embodiment, over the additional function communication line, the PTS terminal 700 communicates with respect to an exchange function, an IC card function, a biometric identification function, a camera function, and an RFID (Radio Frequency IDentification) function which is a function to perform individual identification using electric waves.

<<Electric Configuration of Slot Machine 10>>

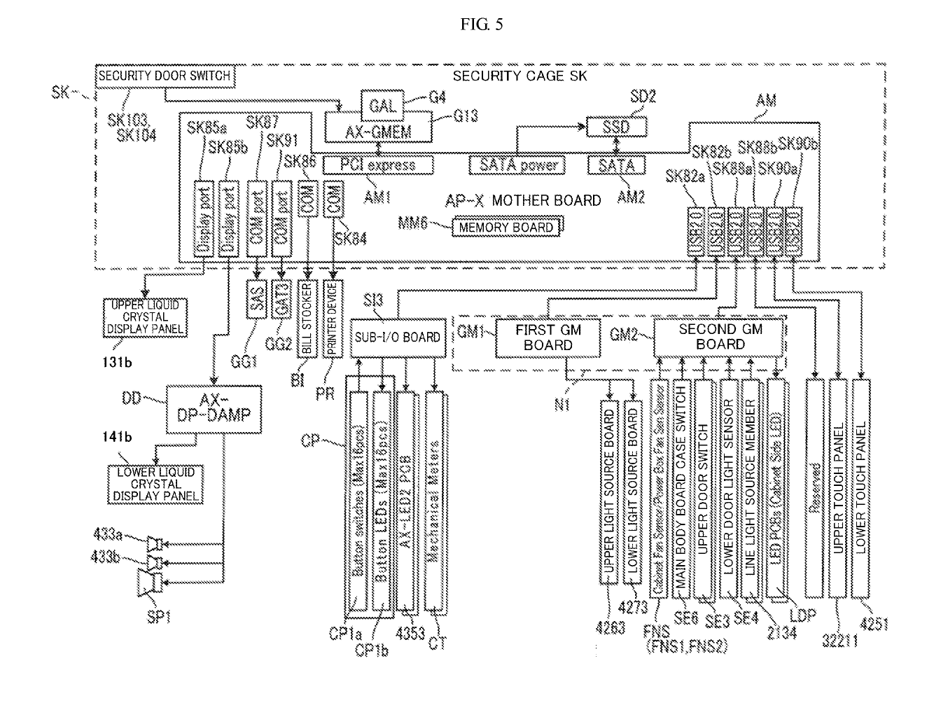

Next, an electric configuration of a slot machine 10 will be described. As shown in FIG. 5, the slot machine 10 uses a CPU with a built-in GPU (Graphics Processing Unit) function which makes a graphic board unnecessary, thereby allowing a fraudulent operation via PCI EXPRESS to be prevented and realizing a reduction in power consumption and a reduction in heat generation. In other words, the slot machine 10 is a gaming machine which uses the CPU with the built-in GPU and has a configuration which has the CPU with the built-in GPU (on a single die), a PCI EXPRESS expansion slot AM1 to which a GAL substrate G4 having stored therein a program for authentication is connected, and DisplayPort connectors SK85 connected to the GPU.

Thus, since in the slot machine 10, it is not required to connect the graphic board to the PCI EXPRESS expansion slot AM1, the expansion slot AM1 is caused to serve as a terminal dedicated to the authentication, thereby making the appearance thereof clear and enabling monitoring of the fraudulent operation to be facilitated. Further, in the slot machine 10, it is made possible to avoid problems which may arise when the PCI EXPRESS expansion slot AM1 is connected to the graphic board, for example, which are a problem in that there may be a case in which dues to a process such as interruption, which occurs between the graphic board and other board, a video signal or an audio signal cannot be smoothly outputted; and a problem in that in the relationship with other boards, the interruption collides therewith. Further, in the slot machine 10, each of the DisplayPort connectors SK85 is caused to serve as a terminal dedicated to video (audio), thereby preventing the interference with other board, allowing a video (audio) signal to be smoothly outputted, and enabling accurate synchronization with a progress of a game.

The slot machine 10 is equipped with a mother board on which the CPU with the built-in graphic engine, which realizes the GPU function, is mounted, thereby allowing likelihood, with which video is suspended during a game, to be reduced. In other words, the slot machine 10 has a configuration in which on the mother board on which the CPU with the built-in graphic engine is mounted, video data of an effect image is outputted from the graphic engine controlled by the CPU to a sub-board and the CPU outputs an audio signal to the sub-board. By employing this configuration, since the video data and the audio data which are outputted from the mother board are outputted through the control of the CPU with one built-in graphic engine, unless the CPU is broken, the situation where only one of the video and the audio is outputted to the sub-board and the notification made by the effect is made inaccurate can be prevented.

It is to be noted that the slot machine 10 may have a configuration in which an authentication board (GAL board G4), which includes a boot BIOS used upon activating the slot machine 10 and a flash RAM having stored therein a variety of pieces of activation-related data, such as a public key, whose data amounts vary is connected to the mother board via the PCI EXPRESS; the data amounts of the activation-related data are detected; each of the pieces of the activation-related data is transferred to a DRAM on the mother board at a transfer rate in accordance with each of the data amounts; and an activation process based on the activation-related data in the DRAM is executed. By employing this configuration, the PCI EXPRESS can dynamically alter the transfer rate from software, thereby allowing power consumption to be saved when a maximum rate is not needed. Thus, when a data amount is greatly changed by updating the data of the boot BIOS and the like on the authentication board, activation time and power consumption can be automatically set in an optimum state.

In addition, the slot machine 10 may have a configuration in which an authentication board, which includes a boot BIOS used upon activating the slot machine 10 and a flash RAM having stored therein a variety of pieces of activation-related data, such as a public key, whose data amounts vary is connected to the mother board via the PCI EXPRESS; each of the pieces of the activation-related data is transferred to a DRAM on the mother board; upon executing an activation process based on the activation-related data in the DRAM, an increased temperature of the authentication board in conjunction with the transfer is detected; and based on the increased temperature, a transfer rate of the activation-related data is controlled. By employing this configuration, since it is assumed that an increase in a temperature of the authentication board and power consumption are in a proportional relationship, for example, the transfer rate is controlled so as to maintain the increase in the temperature constant, thereby allowing the activation process to be executed at a transfer rate at which power consumption is stabilized.

In addition, the slot machine 10 is a gaming machine which uses an SSD (SSD board SD2) having stored therein an OS (Operating System) and has a configuration which includes an APX mother board AM having a CPU and a SATA terminal (SATA board-connector AM2) and an SSD connected to the SATA terminal. Thus, in the slot machine 10, the SSD is connected via the SATA terminal and the OS is booted from the SSD, thereby making it possible to solve problems which may arise when the OS is booted from a flash memory such as an SD card, that is, a problem in that a conversion adaptor is required; a problem in that an operation is easily destabilized; and further, a problem in that a cot is high. It is to be noted that when the OS is booted from the flash memory such as the SD card, the recognition at a BIOS level is required and there have been mother boards incapable of booting the OS. However, by employing the configuration in which the SSD is used to boot the OS, the OS is booted accurately at a high speed, thereby allowing versatility to be enhanced and enabling a program for the gaming machine to be immediately booted up.

In addition, in the slot machine 10, two DisplayPort terminals are mounted on the mother board and three screen outputs including a DVI output are enabled, thereby enabling a higher speed and a larger screen than those of an HDMI (registered trademark) and making any license cost unnecessary. Further, the slot machine 10 has a DPDAMP board DD (an audio amplifier board for DisplayPort) which extracts an audio signal for the DisplayPort and amplifies the audio signal to be outputted.

As described above, the slot machine 10 has a configuration in which video data and audio data during the execution of a game are outputted per packet from the DisplayPort and effects by video and audio are performed on respective effect devices. By employing this configuration, since the video data and the audio data are outputted from signal lines drawn out from the DisplayPort, it does not occur that either data of the video data or audio data disappears. Thus, it can be avoided that upon outputting the video and the audio of a drawing outcome, only one thereof is outputted and the drawing outcome cannot be sufficiently notified. Further, a plurality of displays can be connected in a daisy-chained manner and it is made easy to increase a number of displays, thereby facilitating design changes based on the existing slot machine 10. For example, in a case in which in addition to the upper liquid crystal display panel 131b and the lower liquid crystal panel 141b, a display device is provided on the top device 12, only by conducting work to connect a signal line from the upper liquid crystal display panel 131b or the like to the display device of the top device 12, the mechanical work for the connection of the signal line can be completed and maintenance can be facilitated. Further, the data transmission is performed per packet, it is not required to sequentially transmit the data to the plurality of display devices, thereby allowing a program to be easily changed.

Specifically, in the electric configuration of the slot machine 10, the slot machine 10 has the APX mother board AM housed in a security cage SK. The APX mother board AM has mounted thereon an Intel 4th Generation Core (registered trademark) Processor, not shown, and a power supply management function (C-State) upon idling is thereby enhanced. In addition, a VR (voltage regulator) is integrated into a package/die of the processor, thereby simplifying a power source design of the whole platform and realizing a reduction in power consumption including that of the mother board. It is to be noted that in the Intel 4th Generation Core processor, 20 EUs (Execution Units) which are image processing execution units in a GPU core are set. Thus, as compared with the 3rd Generation Core Processor, great enhancement of performance is realized. In addition, a chip set for the 4th Generation Core i series has a plurality of ports of SATA 6 Gb/s (SATA 3.0) which are high speed interfaces and conforms to a standard of PCI Express 3.0 for performing smooth data transfer with a high performance video card and a standard of DDR3-1600 which is a high speed memory standard.

The APX mother board AM has: an expansion slot AM1 of PCI (Peripheral Component Interconnect) Express; a SATA board connector AM2; first and second connectors SK85a and SK85b for DisplayPort; first and second LAN jacks SK87 and SK91; first and second D sub-connectors SK86 and SK84; and first to sixth USB connectors SK82a, SK82b, SK88a, SK88b, SK90a, and SK90b.

Here, the “PCI Express” is a serial transfer interface for personal computers, which replaces a PCI bus. Although the PCI Express has no compatibility at a physical level with the PCI bus which is a parallel transfer system, a communication protocol and the like used in the PCI Express are in common with those used in the PCI bus. A transmission path (referred to as a “lane”) which is the smallest constituent unit used in the PCI Express enables full duplex communication at 2.5 Gbps for unidirectional communication and 5.0 Gbps for bidirectional communication. Since in order to transmit 8-bit data, 10 bits having 2 bits for a clock signal or the like added therein is spent, an effective data transfer rate for the unidirectional communication is 2.0 Gbps (250 MB/s) and an effective data transfer rate for the bidirectional communication is 4.0 Gbps (500 MB/s). The expansion slot AM1 of the APX mother board AM is configured by bundling a plurality of lanes of a PCI Express port.

The “SATA (Serial AT Attachment)” is one of extension specifications of an IDE (ATA) standard for connecting a computer and a memory device such as a hard disk and an optical drive. The SATA whose transfer system is changed to a serial transfer system from a parallel transfer system adopted in the ATA specification realizes a high-speed transfer rate with a simple cable.

The “DisplayPort” is a full digital video interface and adopts a micro-packet-based system utilizing an embedded clock. The micro-packet-based system, in addition to video data as main data to be transferred, can transfer secondary digital audio data and adopts a mechanism in which pixels and audio signals are collected into a packet called a micro-packet and the micro-packet is transferred. In other words, in the micro-packet-based system, all of video and audio are divided into micro-packets which are “Transfer Unit”s to be serially transferred to a destination device.

Since the “DisplayPort” generates a clock from data without using any external clock signal, it is easy to increase a rate of data transfer and to expand functions. Further, since the “DisplayPort” is a video output interface designed for digital display devices, the “DisplayPort” is used for liquid crystal displays, thereby allowing a number of components to be decreased and having a transmission distance of approximately 15 meters.

In the “DisplayPort”, an output side is defined as a “source device” and an input side is defined as a “sink device”. The source device and the sink device communicate with each other, thereby allowing a resolution, a color depth, a refresh rate, and the like to be automatically adjusted so as to be optimum. In the video and audio data transfer by the “DisplayPort”, a transmission rate can be changed by combining 1, 2, or 4 channels, each of which is called a “lane”, and 2 data rates (1.62 Gbps and 2.7 Gbps). For example, as the smallest constituent unit, 1 lane and 1.62 Gbps are combined, thereby providing a transmission rate of 1.62 Gbps, and as the largest constituent unit, 4 lanes and 2.7 Gbps are combined, thereby providing 4 lane×2.7 Gbps=10.8 Gbps. Main data channels of the “DisplayPort” can be configured into 1, 2, or 4 high-speed SerDes lanes, with each lane providing a bandwidth of 2.7 Gbps or 1.62 Gbps.

The “DisplayPort” includes a hot plug detection (Hot Plug Detect: HPD) signal, which is used not only to confirm that display devices are connected but also to establish a link. The HPD has a process called link training, through which the source is notified that a link will be established. During this process, both of the source and the receiver also confirm whether all of the four lanes are required. In addition, the “DisplayPort” has an AUX (auxiliary) channel, which is a slow speed “side channel” communication channel for link management, status, configuration and control by information on the side of the source. The AUX channel enables bidirectional video and audio communication.

The “DisplayPort” allows multi-display monitors and multiple display devices to be used from a single digital output port in an uninhibited manner and enables full display performance with zero latency that has no display application limitations to be made available. In addition, the “DisplayPort” provides a plug-and-play, service-free operation, through which a user is not required to manually change a design. For example, if a display device is added without using the “DisplayPort”, a setup of a graphic card is required or a setup of a multi-head graphic card including a plurality of output ports is required, and these cards causes an increase in power consumption, thereby making the setup work difficult. However, the “DisplayPort” is employed, thereby causing the above-mentioned problem not to arise. As a result, the “DisplayPort” enables additional displays and the like to be set up without opening a security cage SK of the slot machine 10, whose confidentiality is high.

By adopting the micro-packet-based system, the “DisplayPort” enables the concurrent transport of multiple audio and video streams and other data types, thereby enabling multiple video and audio packets to be transmitted on the same cable. By using this micro-packet-based system, at a link speed which is similar to that of a hub implementation, the “DisplayPort” enables picture-in-picture or multiple daisy-chained display devices through a single connection to operate.

The daisy-chain-connection has a configuration in which the “DisplayPort” input port and output port are mounted on each display device, the output port from a source side is connected to input ports of subsequent (sink side) display devices in a single link, and output ports of the subsequent display devices are connected to the “DisplayPort” input port of the subsequent display device (sink side) as the source side. On the other hand, the hub connection has a configuration in which there are a plurality of output ports with respect to a single “DisplayPort” input port and these output ports are connected to input ports of a plurality of display devices.

The expansion slot AM1 is connected to an AXGMEM board GB so as to be operable to perform unidirectional data transmission. Connected to the AXGMEM board G13 is a GAL substrate G4 so as to be operable to perform bidirectional data transmission, and the AXGMEM board G13 and the GAL substrate G4 perform a Boot BIOS self authentication process and the like. The details of the Boot BIOS self authentication process will be described later. In addition, the AXGMEM board G13 is connected to a first detection sensor SK103 and a second detection sensor SK104, each of which functions as a security door switch, thereby monitoring opening and closing of a security cage door SK3 based on a detection signal from each of these detection sensors SK103 and SK104.

The SATA board connector AM2 is connected an SSD board SD2 so as to be operable to perform bidirectional data transmission. A first DisplayPort connector SK85a is connected the upper liquid crystal display panel 131b so as to be operable to perform unidirectional data transmission. A second DisplayPort connector SK85b is connected the DPDAMP board DD so as to be operable to perform unidirectional data transmission. The DPDAMP board DD is an audio amplifier board for the DisplayPort and is connected to the lower liquid crystal panel 141b and a loudspeaker (not shown) so as to be operable to perform unidirectional data transmission.

A first LAN jack SK87 is an SAS (Serial Attached SCSI) interface in which SCSI standards are adapted to be operable to perform serial transmission and is used for data communication with a PTS device GG1 having the SAS interface. A second LAN jack SK91 is used for data communication with an information process device GG2 for checking, which is referred to as “GAT3”. A first D sub-connector SK86 is connected to a bill stocker BI so as to be operable to perform unidirectional data transmission. A second D sub-connector SK84 is connected to a printer device PR so as to be operable to perform unidirectional data transmission.

Connected to a first USB connector SK82a is a sub-I/O board SI3 so as to be operable to perform unidirectional data reception. Connected to the sub-I/O board SI3 are up to 16 button switches CP1a of the control panel CP and are button LEDs CP1b. In addition, The sub-I/O board SI3 is connected to a light emitting board (not shown) and a counter mechanism CT.

Connected to a second USB connector SK82b is a first GM board GM1 so as to be operable to perform unidirectional data reception. The first GM board GM1 is connected to an upper light source board (not shown) and a lower light source board (not shown).

Connected to a third USB connector SK88a is a second GM board GM2 so as to be operable to perform unidirectional data reception. Connected to the second GM board GM2 is a housing fan sensor FNS2 (not shown) and a power source box fan sensor FNS1 (not shown). The fan sensor FNS is operable to output a fan temperature signal indicative of a temperature of each fan. In addition, connected to the second GM board GM2 are a main body board case switch SE6, an upper door switch SE3, light sensors SE4 and SE4, and a line light source member (not shown) as well as to an LED board LDP which drives the line light source member (not shown), an illumination mechanism (not shown), and the like.

In addition, a fourth USB connector SK88b is used as an auxiliary. A fifth USB connector SK90a is connected the upper touch panel 131a so as to be operable to perform bidirectional data transmission. A sixth USB connector SK90b is connected to the lower touch panel 141a so as to be operable to perform bidirectional data transmission.

In addition, on the APX mother board AM, a memory board MM6 on which a DDR3 memory is mounted is attached. The memory board MM6, in conjunction with the SSD board SD2, is operable to conduct an OS authentication process and to conduct other processes. The details of the OS authentication process will be described later.

Thus, the slot machine 10 has the SSD mounted therein, thereby enabling a life to be prolonged. In other words, the slot machine 10 has a configuration in which a variety of programs for activating and operating the slot machine 10 are stored, the SSD which is constituted of the flash memory is mounted, the programs read out from the SSD are transmitted to the DRAM of the mother board, and the variety of programs are executed in the DRAM, thereby activating and operating the gaming machine.

By employing the above-described configuration, since any driving mechanism such as a bearing and a motor for rotating a disk of an HDD is not present in the SSD, mechanical breakage such as wear of the driving mechanism can be drastically eliminated. In addition, in general, an oxide film which serves as a insulating material of storage elements in the flash memory is deteriorated by electrons along with an increase in numbers of times at which writing and erasing of the SSD are performed. However, by employing the above-described configuration, the SSD is accessed mainly for reading out the programs. Therefore, as compared with a case in which the flash memory is accessed for rewriting and erasing, the deterioration of the storage elements can be reduced. Thus, in the same manner in which the HDD is accessed, the SSD can be continuously used without causing the wear of the storage elements. As a result, a probability of the occurrence of a failure in which an effect screen or audio is interrupted during playing a game is more reduced than in a case in which the HDD is mounted. In other words, by mounting the SSD, the life of the gaming machine can be prolonged.

Further, the slot machine 10 has the SSD mounted therein, thereby making it possible to prevent any breakage during playing a game. In other words, the slot machine 10 has a configuration in which the variety of programs for activating and operating the slot machine 10 are stored, the SSD which is constituted of the flash memory is mounted, the number of times of writing and erasing into and from the SSD is grasped at predetermined timing, and when the number of times of writing and erasing reaches a fixed threshold value or more, at which the storage elements are broken, replacement of the SSD or the like is notified.

By employing the above-described configuration, in the SSD, even without intentionally storing data, some data such as boot information and a data reading state is invariably written thereinto. Therefore, even in a case in which the SSD is used only for the purpose of accessing for reading, the storage elements are deteriorated by the use. Then, when the gaming machine is used over a long period of time, a degree at which the deterioration of the storage elements progresses comes to reach a level at which any breakage easily occurs. Therefore, by employing the above-described configuration, when the number of writing and erasing thereinto and therefrom reaches the fixed threshold value or more at which the storage elements are broken, the replacement of the SSD or the like is notified, thereby allowing the occurrence of breakage during playing a game to be prevented.

It is to be noted that in the present embodiment, although the upper liquid crystal display panel 131b is connected to the DisplayPort connector SK85a on one side and the lower liquid crystal panel 141b is connected to the DisplayPort connector SK85b on the other side via the DPDAMP board DD, thereby respectively controlling the plurality of displays by the plurality of DisplayPort terminals, the present invention is not limited thereto. The plurality of displays may be controlled by a single DisplayPort terminal.

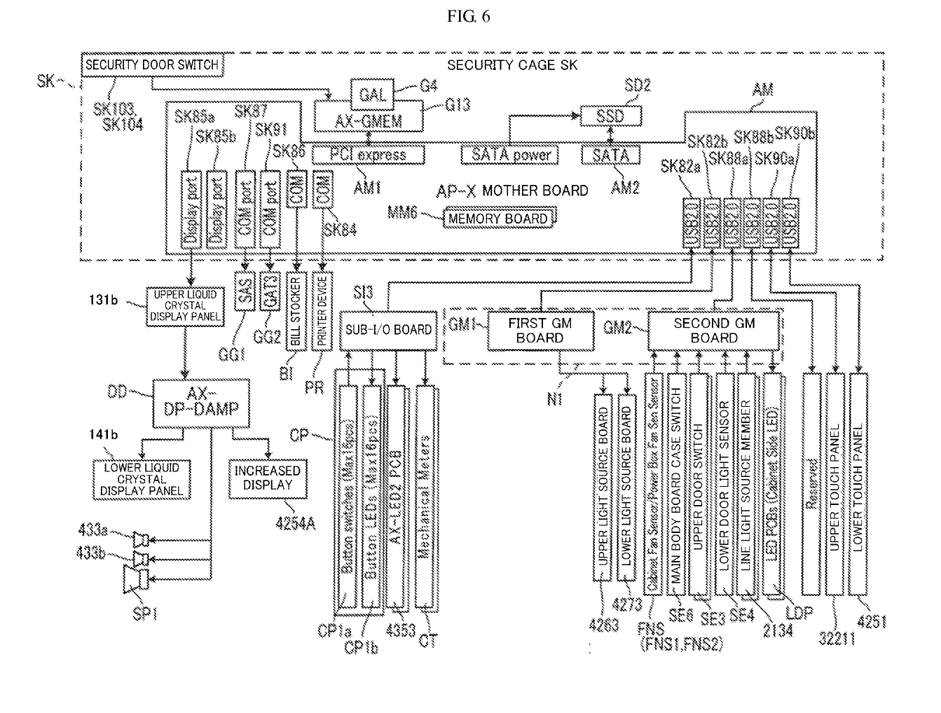

For example, as shown in FIG. 6, the DisplayPort including input and output ports is provided in the upper liquid crystal display panel 131b and the output port of the DisplayPort of the upper liquid crystal display panel 131b is connected to the DPDAMP board DD, whereby the upper liquid crystal display panel 131b and the lower liquid crystal panel 141b may be connected in the daisy-chained manner. Alternatively, a DisplayPort output port may be provided in the lower liquid crystal panel 141b and the upper liquid crystal display panel 131b may be connected to this output port. In addition, when displays are added in the setup, the added displays may be connected to the output ports of the upper liquid crystal display panel 131b and the lower liquid crystal panel 141b.

<APX Mother Board AM>

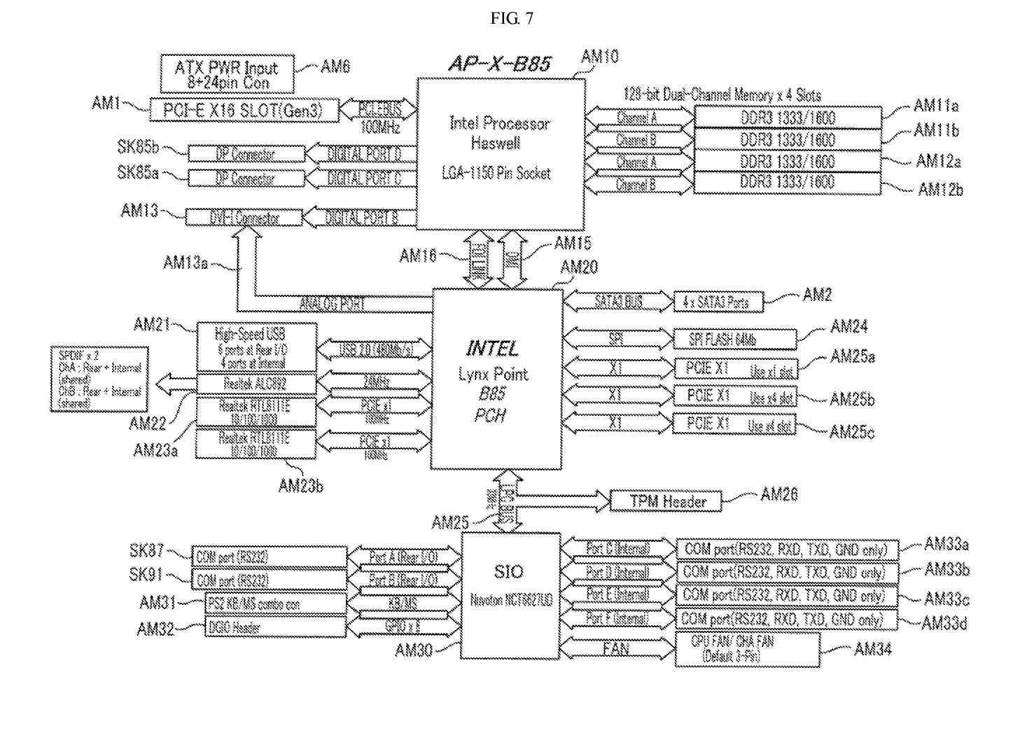

Next, an electric configuration of an APX mother board AM will be described. As shown in FIG. 7, the APX mother board AM has mounted thereon the Intel 4th generation Core (registered trademark) processor (Haswell) AM10, and 20 EUs, each of which is an image processing execution unit in the GPU core, are set. The processor AM10 is mounted on the Intel LGA 1150 CPU Socket. The processor AM10 is connected to the expansion slot AM1 (refer to FIG. 5) of the PCI-EX x16 slots (Gen 3) standards via a PCIE bus (100 MHz) so as to be operable to perform bidirectional data transmission. In addition, power is supplied to the APX mother board AM by a 8+24 pin connector AM6.

In addition, the processor AM10 is connected to a total of four 128 bit-dual-channel memory slots which are Channel A slots AM11a and AM12a and Channel B slots AM11b and AM12b so as to be operable to perform bidirectional data transmission. Attached to the respective memory slots are DDR3 SRAMs of DDR3-1333 or DDR3-1600 standards. In addition, the processor AM10 is connected to DP (DisplayPort) connectors SK85a and SK85b respectively via digital ports C and D so as to be operable to perform unidirectional data transmission. Further, the processor AM10 is connected via a digital port B to a DVI-I connector AM13, which is capable of transmitting both of analog and digital video signals, so as to be operable to perform unidirectional data transmission.

The APX mother board AM has mounted thereon a PCH (Linx Point B85) circuit AM20 which is an Intel chip set. The PCH chip set AM20 is a Platform Controller Hub into which a function of a North Bridge (MCH) connected to a memory and a graphics chip and a function of a South Bridge (ICH) providing a function of an interface such as a PCIE slot and SATA are integrated. The PCH chip set AM20 and the processor AM10 are connected by both of a bus AM15 which employs a DMI (direct media interface) connection system and a bus AM16 which employs a FDI (flexible display interface) connection system so as to be operable to perform bidirectional data transmission.

The PCH chip set AM20 is connected to a plurality of high speed USB ports AM21 by a USB 2.0 whose transfer rate is 480 Mb/s so as to be operable to perform bidirectional data transmission. Among the high speed USB ports, six ports are the USB connectors SK82a, SK82b, SK88a, SK88b, SK90a, and SK90b shown in FIG. 5.

The PCH chip set AM20 is connected to an audio codec chip (Realtek ALC892) AM22 so as to be operable to perform bidirectional data transmission at 24 MHz. The audio codec chip AM22 is connected to two SPDIF channels which are channels ChA and ChB. The SPDIF are standards for digitally transferring an audio signal on a video/audio apparatus. The PCH chip set AM20 is connected to two network controller chips (Realtek RTL8111E 10/100/1000) AM23a and AM23b via PCIE buses, respectively so as to be operable to perform bidirectional data transmission at 100 MHz. Further, the PCH chip set AM20 is connected to a DVI-I connector AM13 via an analog port AM13a so as to be operable to perform unidirectional data transmission.

The PCH chip set AM20 is connected to four SATA3 ports AM2 (SATA board connectors shown in FIG. 107A) via a SATA3 standard bus so as to be operable to perform bidirectional data transmission. In addition, the PCH chip set AM20 is connected to a SPI FLASH port AM24 via a SPI (serial peripheral interface) bus so as to be operable to perform bidirectional data transmission at 64 Mb. In addition, the PCH chip set AM20 is connected to a plurality of PCIEX1 slots AM25a to 25c via a plurality of PCIEX1 buses so as to be operable to perform bidirectional data transmission.

The APX mother board AM has an SIO (Super I/O: Nuvoton NCT6627UD) chip AM30 mounted thereon. The SIO chip AM30 is an input/output integrated circuit for a mother board, and in the SIO chip AM30, diverse low bandwidth device interfaces are combined. The PCH chip set AM20 and the SIO chip AM30 are connected by an LPC (Low Pin Count) bus AM25, which is a bus for connecting a low bandwidth device (legacy device connected by an SIO chip) to a processor, so as to be operable to perform bidirectional data transmission at 33 MHz. Connected to the LPC bus AM25 is a TPM (trusted platform module) header AM26 so as to be operable to perform unidirectional data transmission. The TPM is a security chip for realizing security, which is hardware-tamper-resistant.

Connected to the SIO chip AM30 are COM ports SK87 and SK91 (refer to FIG. 5) of RS232C via ports A and B so as to be operable to perform bidirectional data transmission. In addition, the SIO chip AM30 is connected to a PS2 KB/MS combo con AM31 via a KB/MS bus so as to be operable to perform bidirectional data transmission. In addition, the SIO chip AM30 is connected to a DGIO header AM32 via a GPIO x8 bus so as to be operable to perform bidirectional data transmission. In addition, the SIO chip AM30 is connected to COM ports AM33a to 33d any of RS232, RXD, TXD, and GND via ports C, D, E, and F located thereinside so as to be operable to perform bidirectional data transmission. Further, the SIO chip AM30 is connected to a fan AM34 located in the CPU or the housing via a FAN bus so as to be operable to perform bidirectional data transmission. The fan AM34 is connected to a default-3-pin connector.

In the present embodiment, the APX mother board AM is referred to as a controller 100 or a game controller 100. In addition, the processor AM10 is referred to as a main CPU 200. The DDR3 SRAM attached to the memory slot is referred to as a main RAM 210. Further, an SSD device SD1 is referred to as an auxiliary memory device 220.

<Game State Transition>

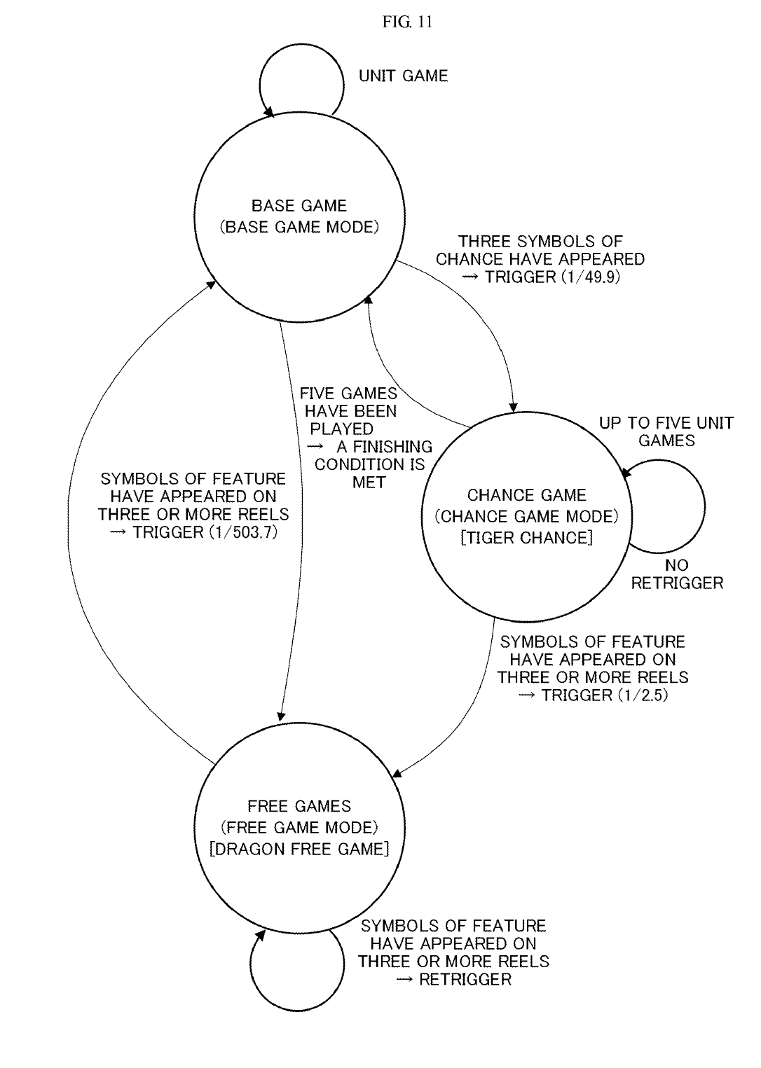

FIG. 11 is a diagram illustrating state transition in a gaming machine 1. FIG. 11 shows the state transition in a base game mode, a chance game mode, and a free game mode.

The gaming machine 1 has three kinds of game modes which include the base game mode, the chance game mode, and the free game mode. On the gaming machine 1, a unit game is executed in the base game mode as a main game mode, and when a trigger (event) of a chance game has occurred in the base game mode, the game mode is shifted to the chance game mode. In addition, when a trigger (event) of free games has occurred in the base game mode and the chance game mode, the game mode is shifted to the free game mode.

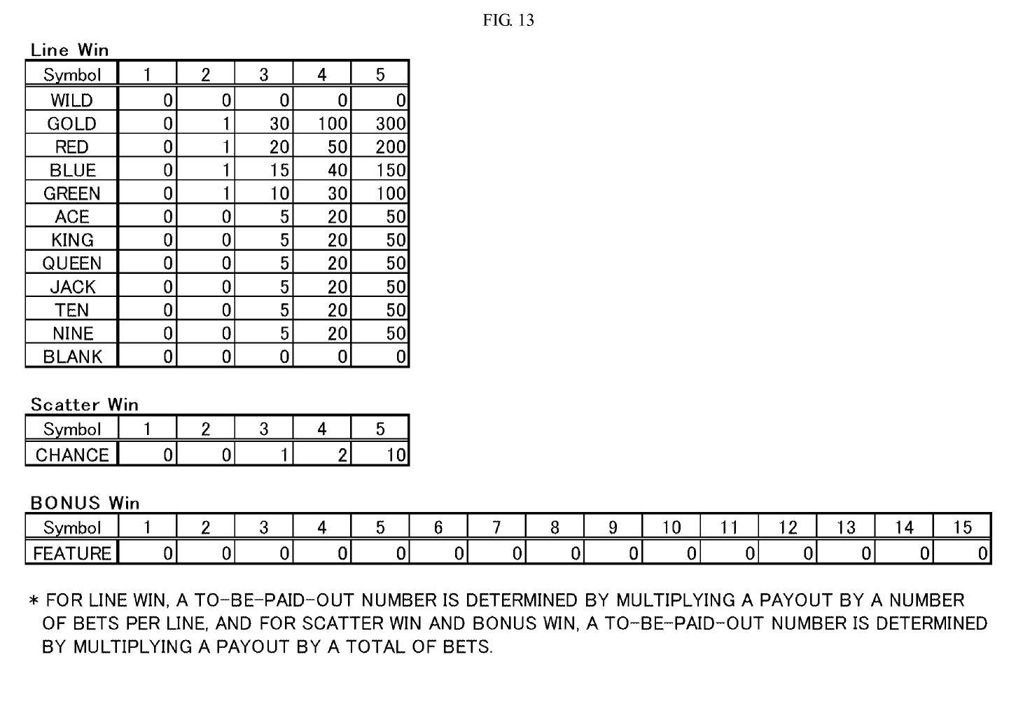

As shown in FIG. 11, in the base game mode, the unit game is repeated until each of the triggers of the chance game and the free games is established. In the base game mode, the unit game can be played by consuming (betting) gaming media such as medals or the like. In this base game mode, when any of winning patterns shown in FIG. 13 is established, an amount of a payout in accordance with a payout corresponding to that winning pattern is paid out.

In the base game mode, when a winning pattern of CHANCE is established, a chance game mode (tiger chance) is triggered. The winning pattern of CHANCE is established only in the base game mode and is not established in the chance game mode and the free game mode.

Since the symbol of CHANCE is a scatter symbol, irrespective of any payline, when it is determined by a symbol drawing process that a predetermined number of symbols of CHANCE, for example, three symbols of CHANCE appear in a symbol display region 141d, a winning pattern is established.

It is only required for the symbols of CHANCE that it is determined that three symbols of CHANCE appear in the symbol display region 141d. Accordingly, for example, even when it is determined that two symbols of CHANCE appear on a video reel 3a and one symbol of CHANCE appear on a video reel 3d, the winning pattern is established.

As described above, on the condition that the winning pattern of CHANCE has been established in the base game mode, the chance game mode is triggered. The chance game mode is triggered, whereby the game mode is shifted (transitions) from the base game mode to the chance game mode.

In the chance game mode, a unit game is played without consuming any gaming media such as medals. In the chance game mode, up to five unit games can be played.

When a winning pattern of FEATURE has been established (when the free game mode is triggered) or when all of the five unit games have been played, the chance game mode is finished. When the winning pattern of FEATURE has been established, the game mode is shifted from the chance game mode to the free game mode. When all of the five unit games have been played, the game mode is returned from the chance game mode to the base game mode. When the five unit games have even not been played, but the winning pattern of FEATURE has been established, the game mode is shifted from the chance game mode to the free game mode. Further, even when the five unit games have not been played, it does not occur that the game mode is return from the free game mode to the chance game mode, and the game mode is returned to the base game mode.

In the chance game mode, any winning pattern of CHANCE is not established and the chance game mode is not retriggered.

In the base game mode or the chance game mode, the winning pattern of FEATURE has been established, whereby the free game mode (dragon free games) is triggered. The winning pattern of FEATURE is established in both of the base game mode and the chance game mode. Further, the winning pattern of FEATURE is established also in the free game mode. In this case, the free game mode is retriggered.

The symbols of FEATURE are symbols by which the winning pattern is established, irrespective of any payline. When it is determined by the symbol drawing process that on a predetermined number of reels, for example, on three video reels, the symbols of FEATURE appear in the symbol display region 141d, the winning pattern is established. When it is determined that one symbol of FEATURE appear on the video reel 3a, one symbol of FEATURE appear on the video reel 3d, and one symbol of FEATURE appear on a video reel 3e in the symbol display region 141d, the winning pattern is established.

The symbols of FEATURE are different from normal scatter symbols. Accordingly, when it is determined that two symbols of FEATURE appear on the video reel 3a and one symbol of FEATURE appear on the video reel 3d in the symbol display region 141d, any winning pattern is not established. Since the number of symbols of FEATURE appearing in the symbol display region 141d is three, but the symbols of FEATURE appear only on the two reels, the video reels 3a and 3d, any winning pattern is not established.

The free game mode is triggered, whereby the game mode is shifted to the free game mode. There are a case in which the game mode is shifted from the base game mode to the free game mode; a case in which the game mode is shifted from the chance game mode to the free game mode; and a case in which the game mode is shifted from the free game mode to the free game mode (a case in which a retrigger is established and the free game mode is continued).

In the free game mode, a unit game is played without consuming any gaming media such as medals. Upon shifting to the free game mode, based on the symbols of FEATURE by which a winning pattern is established, a number of unit games in the free game mode is determined A player can play unit games whose number is determined in the chance game mode.

In the free game mode, there may be a case in which a winning pattern of the symbols of FEATURE is established, the free game mode is retriggered. When the free game mode is retriggered, based on the symbols of FEATURE by which the winning pattern is established, the number of unit games in the free game mode is determined A number of unit games may be newly determined by the retrigger, or a new number of unit games may be added to the number of remaining unit games.

The free game mode is finished when all of the determined number of unit games have been played, and the game mode is returned to the base game mode.

As described above, the winning pattern of FEATURE is establish in both of the base game mode and the chance game mode. Accordingly, in the present embodiment, along both routes of a first transition route along which the game mode is directly shifted to the free game mode without shifting from the base game mode via the chance game mode and a second transition route along which the game mode is shifted from the base game mode via the chance game mode to the free game mode, the game mode can be shifted to the free game mode.

In the base game mode, the winning pattern of CHANCE is established with a probability of 1/49.9. In addition, in the chance game mode, the winning pattern of FEATURE is established with a probability of 1/2.5. On the other hand, in the base game mode, the winning pattern of FEATURE is established with a probability of 1/503.7. Therefore, the probability with which the free game mode is triggered in the chance game mode is considerably larger than the probability with which the free game mode is triggered in the base game mode. Accordingly, it is made possible to more easily shift to the free game mode along the second transition route than along the first transition route.

<Payline>

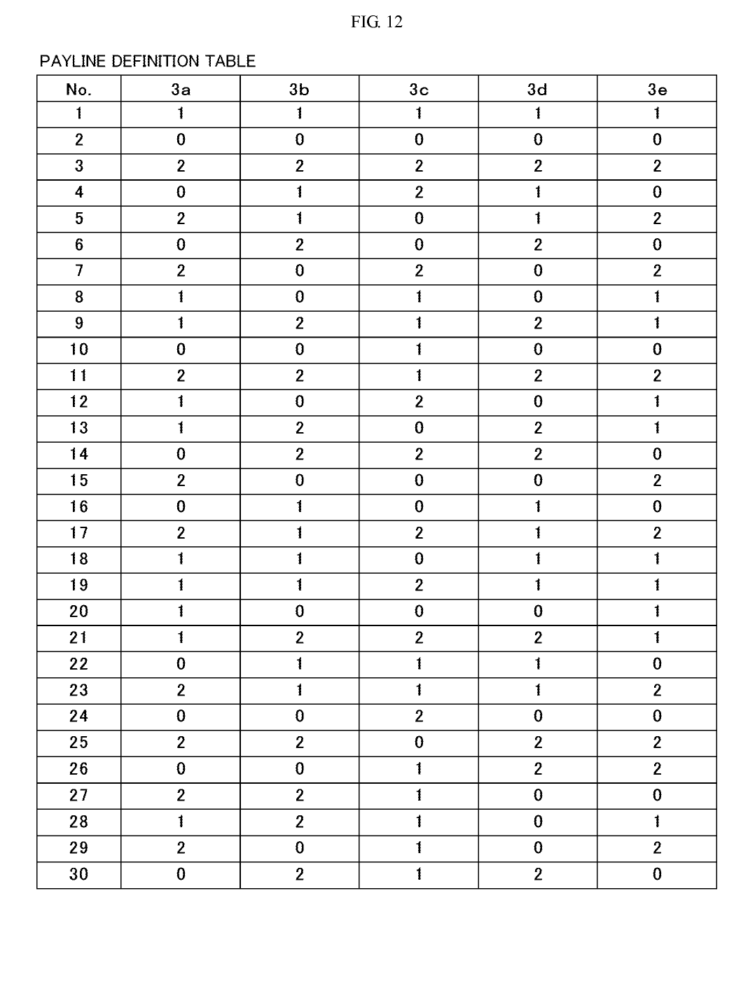

FIG. 12 shows an example of a payline definition table which defines paylines adopted in a gaming machine 1. In the gaming machine 1, 30 paylines are set in a symbol matrix. The payline definition table defines the paylines in a symbol display region 141d which are formed by connecting regions of an upper row, a middle row, or a lower row of respective first to fifth video reels 3a to 3e.

For example, a region in a middle row of the first video reel 3a (first reel strip), a region in a middle row of the second video reel 3b (second reel strip), a region in a middle row of the third video reel 3c (third reel strip), a region in a middle row of the fourth video reel 3d (fourth reel strip), and a region in a middle row of the fifth video reel 3e (fifth reel strip) constitute one payline (payline No. 1).

In the slot machine 10 according to the present embodiment, all of the 30 paylines are active, irrespective of a bet amount and any selection by a player. The paylines may be made active in accordance of the selection by a player. In addition, a total number of the paylines can be appropriately determined in accordance with a size of the symbol matrix.

<Payout Table>

FIG. 13 shows an example of a payout table. The payout table shown in FIG. 13 defines 14 kinds of winning patterns.

The payout table shows a relationship of the winning patterns, the numbers of Kinds of symbols, and payouts. The numbers of Kinds are the numbers of symbols constituting the winning patterns and represent the numbers of symbols which are respectively arranged in succession from a left side to a right side along a payline. As described above, in the gaming machine 1 according to the present embodiment, except for the symbols of CHANCE and FEATURE, winning is determined by symbols arranged in a LEFT TO RIGHT manner. Accordingly, a payout is determined by a kind and a number of symbols which are arranged in succession along a payline, starting from the video reel 3a on the leftmost side toward the video reel 3e on the rightmost side. A winning pattern may be determined by a number of symbols arranged along a payline, instead of the symbols arranged in the LEFT TO RIGHT manner.

The first winning pattern is a pattern in which symbols of WILD are arranged. In the present embodiment, any direct payout is not defined for the arrangement of the symbols of WILD. The symbols of WILD are replaced with other symbols so as to establish an advantageous winning pattern. When the symbols of WILD are replaced with other symbols and any winning pattern is established, a payout corresponding to that winning pattern is determined.

The second winning pattern is a pattern in which two to five symbols of GOLD are arranged along a payline. For example, when three symbols of GOLD are arranged along a payline, a payout is defined as 30.

The third to fifth winning patterns are patterns, in each of which two to five symbols of each of RED, BLUE, and GREEN are arranged along a payline.

In the second to fifth winning patterns, it is defined that a payout with respect to the number of the same Kind of symbols is decreased in the order of GOLD, RED, BLUE, and GREEN. For example, it is defined that when the number of the same Kind of symbols is 4, payouts are 100, 50, 40, and 30 in the order of GOLD, RED, BLUE, and GREEN, respectively.

The sixth to 11th winning patterns are patterns, in each of which three to five symbols of each of ACE, KING, QUEEN, JACK, TEN, and NINE are arranged along a payline. When three symbols are arranged therealong, a payout is 5. When four symbols are arranged therealong, a payout is 20. When five symbols are arranged therealong, a payout is 50.

In the second to 11th winning patterns, as shown in FIG. 13, it is defined that in accordance with an increase in each of the numbers of the same Kind of symbols, a payout is increased. In the second to 11th winning patterns, the payout table shown in FIG. 13 is referenced and a payout corresponding to the number of the same Kind of symbols is determined, and the payout is multiplied by a number of BETs per payline in a unit game being played at that time, thereby determining a to-be-paid-out number.

The 12th winning pattern is a pattern in which symbols of BLANK are arranged. In the present embodiment, any direct payout is not defined for the arrangement of symbols of BLANK.

The 13th winning pattern is a pattern in which symbols of CHANCE appear. As described above, the symbols of CHANCE are scatter symbols. A payout is defined as 1 when three symbols of CHANCE appear, a payout is defined as 2 when four symbols of CHANCE appear, and a payout is defined as 10 when five symbols of CHANCE appear.

The 14th winning pattern is a pattern in which symbols of FEATURE are arranged. The symbols of FEATURE are symbols by which a winning pattern is established, irrespective of any payline. A payout is defined in accordance with the number of video reels on which the symbols of FEATURE appear.

<Configuration of Reel Strips>

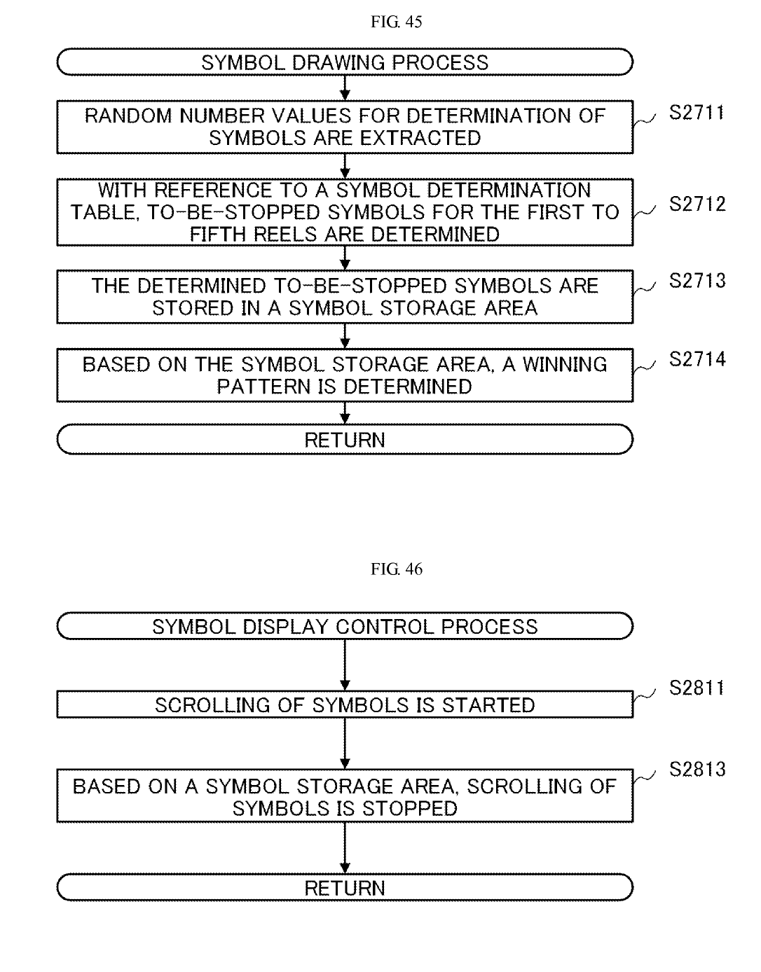

Each of FIG. 14 to FIG. 42 is a table showing a group of reel strips (symbol arrays) which constitute video reels. Each of FIG. 14 to FIG. 42 is a table showing respective reel strips of five video reels 3a to 3e. Each table shown in each of FIG. 14 to FIG. 42 is to define code Nos. and symbols and functions as a symbol determination table for determining five to-be-stopped symbols in a symbol drawing process shown in FIG. 45. In other words, five code Nos. are determined by extracting random number values, and symbols which correspond to the code Nos. are determined as the five to-be-stopped symbols.

FIG. 14 and FIG. 15 is a table showing a group of reel strips used in a base game mode. FIG. 16 to FIG. 40 are tables showing groups of reel strips (TIGER CHANCE_0 to TIGER CHANCE_10) used in a chance game mode. FIG. 41 and FIG. 42 is a table showing a group of reel strips used in a free game mode.

As shown in FIG. 14 and FIG. 15, 13 kinds of symbols of WILD, GOLD, RED, BLUE, GREEN, ACE, KING, QUEEN, JACK, TEN, NINE, CHANCE, and FEATURE, other than a symbol of BLANK, are assigned to the group of reel strips used in the base game mode. For example, the symbol of NINE is assigned to a code No. 10 of the video reel 3c.

Sixty one symbols are assigned to the reel strip of the video reel 3a; 66 symbols are assigned to the reel strip of the video reel 3b; 69 symbols are assigned to the reel strip of the video reel 3c; 69 symbols are assigned to the reel strip of the video reel 3d; and 68 symbols are assigned to the reel strip of the video reel 3e. By the symbol drawing process, one symbol is selected with an equal probability with respect to each of the five video reels 3a to 3e.

FIG. 16 to FIG. 40 are tables showing 11 kinds of groups of reel strips which are TIGER CHANCE_0 to TIGER CHANCE_10 used in the chance game mode. As shown in FIG. 16 to FIG. 40, only two kinds of symbols which are FEATURE and BLANK assigned to the groups of reel strips, TIGER CHANCE_0 to TIGER CHANCE_10 used in the chance game mode. Accordingly, in the chance game mode, only the symbols of FEATURE and BLANK are displayed on the five video reels 3a to 3e.

FIG. 16 and FIG. 17 is a table showing the group of reel strips which is TIGER CHANCE_0. This group of reel strips, TIGER CHANCE_0, is selected in the first to fourth unit games in the chance game mode.

In the group of reel strips, TIGER CHANCE_0, in code Nos. 0 to 5 and code Nos. 30 to 32 of the video reels 3a to 3e, the symbols of FEATURE are assigned, and in all of the remaining code Nos. of the video reels 3a to 3e, the symbols of BLANK are assigned. Fifty eight symbols are assigned to each of the video reels 3a to 3e.

FIG. 18 and FIG. 19 is a table showing the group of reel strips which is TIGER CHANCE_1. This group of reel strips, TIGER CHANCE_1, is also selected in the first to fourth unit games in the chance game mode.

In the group of reel strips, TIGER CHANCE_1, in code Nos. 0 to 5, code No. 9, and code Nos. 30 to 32 of the video reels 3a to 3e, the symbols of FEATURE are assigned, and in all of the remaining code Nos. of the video reels 3a to 3e, the symbols of BLANK are assigned. Fifty eight symbols are assigned to each of the video reels 3a to 3e.

FIG. 20 and FIG. 21 is a table showing the group of reel strips which is TIGER CHANCE_2. This group of reel strips, TIGER CHANCE_2, is also selected in the first to fourth unit games in the chance game mode.

In the group of reel strips, TIGER CHANCE_2, in code Nos. 0 to 5, code Nos. 9 and 10, and code Nos. 30 to 32 of the video reels 3a to 3e, the symbols of FEATURE are assigned, and in all of the remaining code Nos. of the video reels 3a to 3e, the symbols of BLANK are assigned. Fifty eight symbols are assigned to each of the video reels 3a to 3e.

FIG. 22 and FIG. 23 is a table showing the group of reel strips which is TIGER CHANCE_3. This group of reel strips, TIGER CHANCE_3, is also selected in the first to fourth unit games in the chance game mode.

In the group of reel strips, TIGER CHANCE_3, in code Nos. 0 to 5, code Nos. 9 to 11, and code Nos. 30 to 32 of the video reels 3a to 3e, the symbols of FEATURE are assigned, and in all of the remaining code Nos. of the video reels 3a to 3e, the symbols of BLANK are assigned. Fifty eight symbols are assigned to each of the video reels 3a to 3e.

FIG. 24 and FIG. 25 is a table showing the group of reel strips which is TIGER CHANCE_4. This group of reel strips, TIGER CHANCE_4, is also selected in the first to fourth unit games in the chance game mode.

In the group of reel strips, TIGER CHANCE_4, in code Nos. 0 to 5, code Nos. 9 to 12, and code Nos. 30 to 32 of the video reels 3a to 3e, the symbols of FEATURE are assigned, and in all of the remaining code Nos. of the video reels 3a to 3e, the symbols of BLANK are assigned. Fifty eight symbols are assigned to each of the video reels 3a to 3e.

FIG. 26 and FIG. 27 is a table showing the group of reel strips which is TIGER CHANCES. This group of reel strips, TIGER CHANCES, is also selected in the first to fourth unit games in the chance game mode.

In the group of reel strips, TIGER CHANCES, in code Nos. 0 to 5, code Nos. 9 to 13, and code Nos. 30 to 32 of the video reels 3a to 3e, the symbols of FEATURE are assigned, and in all of the remaining code Nos. of the video reels 3a to 3e, the symbols of BLANK are assigned. Fifty eight symbols are assigned to each of the video reels 3a to 3e.

FIG. 28 and FIG. 29 is a table showing the group of reel strips which is TIGER CHANCE_6. This group of reel strips, TIGER CHANCE_6, is also selected in the first to fourth unit games in the chance game mode.

In the group of reel strips, TIGER CHANCE_6, in code Nos. 0 to 5, code Nos. 9 to 14, and code Nos. 30 to 32 of the video reels 3a to 3e, the symbols of FEATURE are assigned, and in all of the remaining code Nos. of the video reels 3a to 3e, the symbols of BLANK are assigned. Fifty eight symbols are assigned to each of the video reels 3a to 3e.

FIG. 30 and FIG. 31 is s a table showing the group of reel strips which is TIGER CHANCE_7. This group of reel strips, TIGER CHANCE_7, is also selected in the first to fourth unit games in the chance game mode.

In the group of reel strips, TIGER CHANCE_7, in code Nos. 0 to 5, code Nos. 9 to 15, and code Nos. 30 to 32 of the video reels 3a to 3e, the symbols of FEATURE are assigned, and in all of the remaining code Nos. of the video reels 3a to 3e, the symbols of BLANK are assigned. Fifty eight symbols are assigned to each of the video reels 3a to 3e.

FIG. 32 and FIG. 33 is a table showing the group of reel strips which is TIGER CHANCE_8. This group of reel strips, TIGER CHANCE_8, is also selected in the first to fourth unit games in the chance game mode.

In the group of reel strips, TIGER CHANCE_8, in code Nos. 0 to 5, code Nos. 9 to 16, and code Nos. 30 to 32 of the video reels 3a to 3e, the symbols of FEATURE are assigned, and in all of the remaining code Nos. of the video reels 3a to 3e, the symbols of BLANK are assigned. Fifty eight symbols are assigned to each of the video reels 3a to 3e.

FIG. 34 and FIG. 35 is s a table showing the group of reel strips which is TIGER CHANCE_9. This group of reel strips, TIGER CHANCE_9, is also selected in the first to fourth unit games in the chance game mode.

In the group of reel strips, TIGER CHANCE_9, in code Nos. 0 to 5, code Nos. 9 to 17, and code Nos. 30 to 32 of the video reels 3a to 3e, the symbols of FEATURE are assigned, and in all of the remaining code Nos. of the video reels 3a to 3e, the symbols of BLANK are assigned. Fifty eight symbols are assigned to each of the video reels 3a to 3e.

FIG. 36 to FIG. 40 is a table showing the group of reel strips which is TIGER CHANCE_10. This group of reel strips, TIGER CHANCE_10, is selected in the fifth unit game in the chance game mode. When in the chance game mode, a winning pattern of FEATURE is not established and when the last fifth unit game is executed, the group of reel strips, TIGER CHANCE_10, is selected.

As shown in FIG. 36 to FIG. 40, two kinds of symbols which are FEATURE and BLANK are assigned to the group of reel strips used in the chance game mode. In code Nos. 0 to 5 of the video reel 3a and the video reel 3b, the symbols of FEATURE are assigned. Only the symbols of this FEATURE are assigned to the video reel 3a and video reel 3b. Six symbols are assigned to each of the video reel 3a and the video reel 3b. In the code Nos. 0 to 5 and code Nos. 111 to 113 of the video reels 3c to 3e, the symbols of FEATURE are assigned, and in all of the remaining code Nos. the symbols of BLANK are assigned. Assigned to each of the video reels 3c to 3e are 217 symbols.

As described above, in the first to fourth unit games, the group of reel strips, TIGER CHANCE_10, is not selected, and any one of the 10 kinds of groups of reel strips, TIGER CHANCE_0 to TIGER CHANCE_9, is selected with an equal probability by the drawing process. On the other hand, in the fifth unit game (the last unit game), only the fixed group of reel strips, TIGER CHANCE_10, is invariably selected by the drawing process.

As shown in FIG. 16 and FIG. 17, in the group of reel strips, TIGER CHANCE_0, the nine symbols of FEATURE are arranged for each of the reel strips. As shown in FIG. 18 and FIG. 19, in the group of reel strips, TIGER CHANCE_1, the 10 symbols of FEATURE are arranged for each of the reel strips. As shown in FIG. 20 and FIG. 21, in the group of reel strips, TIGER CHANCE_2, the 11 symbols of FEATURE are arranged for each of the reel strips. As shown in FIG. 22 and FIG. 23, in the group of reel strips, TIGER CHANCE_3, the 12 symbols of FEATURE are arranged for each of the reel strips. As shown in FIG. 24 and FIG. 25, in the group of reel strips, TIGER CHANCE_4, the 13 symbols of FEATURE are arranged for each of the reel strips. As shown in FIG. 26 and FIG. 27, in the group of reel strips, TIGER CHANCES, the 14 symbols are arranged for each of the reel strips. As shown in FIG. 28 and FIG. 29, in the group of reel strips, TIGER CHANCE_6, the 15 symbols are arranged for each of the reel strips. As shown in FIG. 30 and FIG. 31, in the group of reel strips, TIGER CHANCE_7, the 16 symbols are arranged for each of the reel strips. As shown in FIG. 32 and FIG. 33, in the group of reel strips, TIGER CHANCE_8, the 17 symbols are arranged for each of the reel strips. As shown in FIG. 34 and FIG. 35, in the group of reel strips, TIGER CHANCE_9, the 18 symbols are arranged for each of the reel strips.

As described above, in the group of reel strips, TIGER CHANCE_0 to TIGER CHANCE_9, the numbers of the symbols of FEATURE are different from one another. In a table shown in FIG. 52, in each of the first to fourth unit games, since a weight of each of the groups of reel strips, TIGER CHANCE_0 to TIGER CHANCE_9, is one, each of the groups of reel strips, TIGER CHANCE_0 to TIGER CHANCE_9, is selected with an equal probability. However, as shown in FIG. 16 to FIG. 35, the numbers of the symbols of FEATURE in the groups of reel strips, TIGER CHANCE_0 to TIGER CHANCE_9, are different from one another. A weight may be defined such that a weight in each of the groups of reel strips gradually decreases, starting from that in the group of reel strips, TIGER CHANCE_0, toward the group of reel strips, TIGER CHANCE_9. By defining the weights as described above, in accordance with an increase in the number of the symbols of FEATURE, it is made possible to less easily select the group of reel strips whose number of the symbols of FEATURE is large. Accordingly, the free game mode is less easily triggered, thereby allowing a profit to be less easily provided for a player.

The case in which in the groups of reel strips, TIGER CHANCE_0 to TIGER CHANCE_9, shown in FIG. 16 to FIG. 35, the numbers of the symbols of FEATURE are different from one another is described. However, the numbers of the symbols of FEATURE may be defined to be the same as one another. Even when the number of the symbols of FEATURE is large, each of the groups of reel strips is selected with an equal probability. Therefore, the free game mode is easily triggered, thereby allowing a profit to be easily provided for a player.

As described above, in the chance game mode, when it is determined that the symbols of FEATURE appear on at least three video reels in the symbol display region 141d, the winning pattern is established. The winning pattern is established, thereby triggering the free game mode and allowing the game made to be shifted from the chance game mode to the free game mode.

FIG. 41 and FIG. 42 is a table showing a group of reel strips used in the free game mode. Twelve kinds of symbols of WILD, GOLD, RED, BLUE, GREEN, ACE, KING, QUEEN, JACK, TEN, NINE, and FEATURE, other than the symbols of CHANCE and BLANK, are assigned to each of the groups of reel strips used in the free game mode.

The symbols of CHANCE are not assigned to each of the groups of reel strips used in the free game mode. Accordingly, in the free game mode, a winning pattern of symbols of CHANCE is not established, and the chance game mode (tiger chance) is not triggered.

Each of the plurality of symbols constituting each of the five video reels 3a to 3e shown in FIG. 14 to FIG. 42 is selected with an equal probability in the symbol drawing process (refer to FIG. 45). Accordingly, symbols whose number of arranged symbols is large are easily determined as to-be-stopped symbols, and symbols whose number of arranged symbols is large are less easily determined as to-be-stopped symbols. It may be defined that a weight of each of the plurality of symbols is defined, and in accordance with a value of a weight, a degree of easiness (difficulty) with which symbols are determined as to-be-stopped symbols is defined.

<<Contents of Programs>>

Next, with reference to FIG. 43 to FIG. 51, programs executed by the gaming machine 1 will be described.

<Main Control Process>

First, with reference to FIG. 43, a main control process will be described. FIG. 43 is a flowchart of the main control process in the gaming machine 1 according to the embodiment of the present invention. This game mode in the main control process shown in FIG. 43 is a base game mode.

First, when power is supplied to the gaming machine 1, a main CPU 200 reads out a game program and a game system program, which have been authenticated, via an AXGMEM board G13 from an auxiliary memory device 220 (SSD device SD1) and writes the game program and the game system program into a main RAM 210 (step S2511).

Next, the main CPU 200 conducts an at-one-game-end initialization process (step S2512). For example, data that becomes unnecessary after each game in the working areas of the main RAM 210, such as the number of BETs and the symbols determined by the drawing, is cleared.

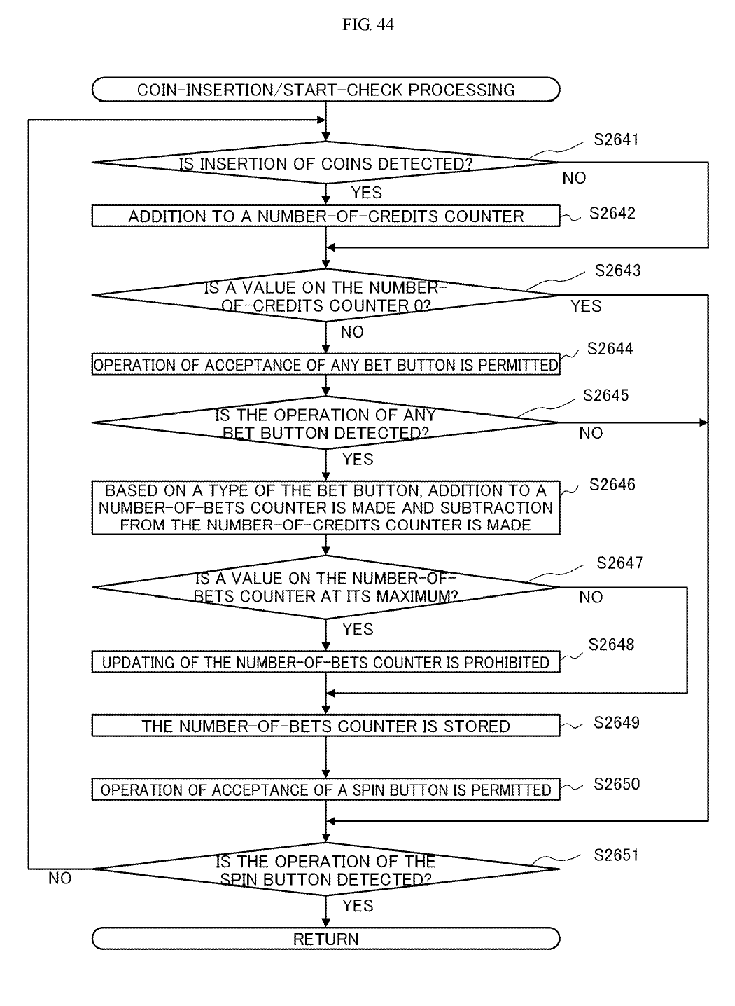

Next, the main CPU 200 conducts a coin-insertion/start-check process which is described later with reference to FIG. 44 (step S2513). In this process, input from the BET switch and the spin switch is checked.

Next, the main CPU 200 conducts a symbol drawing process which is described later with reference to FIG. 45 (step S2514). In this process, to-be-stopped symbols are determined based on random number values for symbol determination, and when a free game trigger is established, further, a value of BONUS symbols is determined.

Next, the main CPU 200 conducts an effect contents determination execution process (step S2515). The main CPU 200 extracts random number values for effects, determines any of a predetermined plurality of effect contents by a drawing, and executes said effect contents at the timing of the determined effect contents. For example, the main CPU 200 displays video for effects on an upper liquid crystal display panel 131b, outputs audio from a loudspeaker (not shown), lights a lamp (not shown), and performs the control, for example, by subjecting these to effect processes. When the free game trigger has been established and, for example, thereafter, a player selects free games, video is displayed on the upper liquid crystal display panel 131b.

Next, the main CPU 200 conducts a symbol display control process which is described later with reference to FIG. 46 (step S2516). In this process, the scrolling of the five video reels 3a to 3e (five reel strips) is started, and the to-be-stopped symbols determined at step S2514 in the symbol drawing process are stopped in predetermined positions.

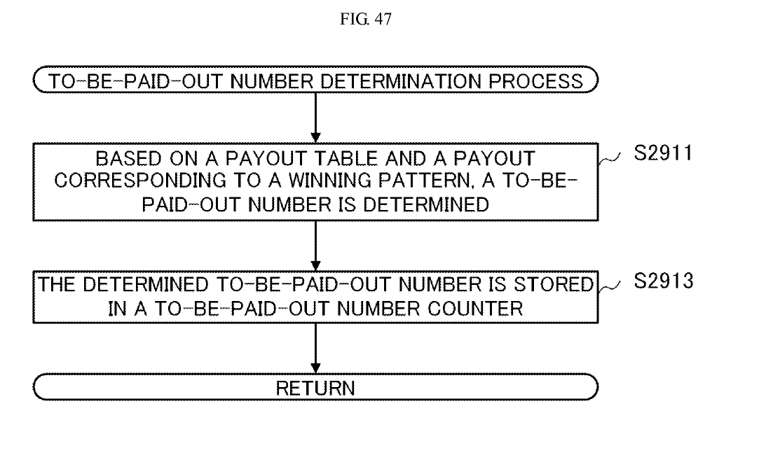

Next, the main CPU 200 conducts a to-be-paid-out number determination process which is described later with reference to FIG. 47 (step S2517). In this process, in the base game, a to-be-paid-out number is determined based on the payout table (refer to FIG. 13) in accordance with a winning pattern of symbols displayed on any payline, and the to-be-paid-out number is stored in a to-be-paid-out number storage area (to-be-paid-out number counter) provided in the main RAM 210.

Next, the main CPU 200 conducts a paying-out process (step S2522). The main CPU 200 adds a value stored in the to-be-paid-out number storage area (to-be-paid-out number counter) to a value stored in a number-of-credits storage area provided in the main RAM 210 (number-of-credits counter). The driving of a hopper (not shown) may be controlled, thereby discharging coins in accordance with the to-be-paid-out number counter from a coin payout exit. In addition, the driving of a ticket printer (not shown) may be controlled, thereby issuing a ticket with a barcode having the to-be-paid-out number counter registered thereon.

Next, the main CPU 200 determines whether or not a free game trigger has been established (step S2518). When the main CPU 200 determines that the free game trigger has been established, the main CPU 200 conducts a free game mode process which is described later with reference to FIG. 49 (step S2519) and returns the processing to step S2512.

Next, when the main CPU 200 determines at step S2518 that the free game trigger has not been established, the main CPU 200 determines whether or not a chance game trigger has been established (step S2520). When the main CPU 200 determines that the chance game trigger has been established, the main CPU 200 conducts a chance game mode process which is described later with reference to FIG. 48 (step S2521) and returns the processing to step S2512.

Next, when the main CPU 200 determines at step S2520 that the chance game trigger has not been established, the main CPU 200 returns the processing to step S2512.

<Coin-Insertion/Start-Check Process>

Next, with reference to FIG. 44, a coin-insertion/start-check process will be described. FIG. 44 is a flowchart of the coin-insertion/start-check process in the gaming machine 1 according to the embodiment of the present invention.

First, the main CPU 200 determines whether or not insertion of coins has been detected by a coin counter (step S2641). When the main CPU 200 determines that the insertion of coins has been detected, the main CPU 200 adds a value of inserted coins to a value stored in the number-of-credits storage area (number-of-credits counter) (step S2642). In addition to the determination of the insertion of coins, the main CPU 200 may determine whether or not insertion of bills has been detected based on bill validation data (for example, by a PTS terminal 700 or the like), and when the main CPU 200 determines that the insertion of bills has been detected, the main CPU 200 may add a value in accordance with the bills to a value of the number-of-credits counter.

When after step S2642 or at step S2641, the main CPU 200 determines that the insertion of coins has not been detected, the main CPU 200 determines whether or not a value of the number-of-credits counter is zero (step S2643). When the main CPU 200 determines that the value of the number-of-credits counter is not zero, the main CPU 200 permits acceptance of an operation of any of BET buttons (operation buttons CP2 to CP6) (step S2644).

Next, the main CPU 200 determines whether or not the operation of any of the BET buttons (operation buttons CP2 to CP6) has been detected (step S2645). When the main CPU 200 determines by a BET switch that any of the BET buttons (operation buttons CP2 to CP6) has been pressed by a player, based on a kind of the pressed button among the BET buttons (operation buttons CP2 to CP6), the main CPU 200 performs addition of a value stored in a number-of-BETs storage area (number-of-BETs counter) provided in the main RAM 210 and performs subtraction for the number-of-credits counter (step S2646).

Next, the main CPU 200 determines whether or not a value of the number-of-BETs counter is at its maximum (step S2647). When the main CPU 200 determines that the value of the number-of-BETs counter is at its maximum, the main CPU 200 prohibits updating of the number-of-BETs counter (step S2648).

Next, when after step S2648 or at step S2647, the main CPU 200 determines that the value of the number-of-BETs counter is not at its maximum, the main CPU 200 stores the value of the number-of-BETs counter (step S2649). In the chance game mode and the free game mode, without consuming any gaming media such as medals, the free games (unit games) can be played. Accordingly, without placing any BET, the free games can be initiated, and a value of the number-of-BETs counter cannot be determined by the BET operation. Therefore, upon shifting to the chance game mode or the free game mode, a value of the number-of-BETs counter in the base game mode immediately prior to shifting thereto is used. The value of the number-of-BETs counter stored at step S2649 is read out and used upon shifting to the chance game mode or the free game mode.

Next, the main CPU 200 permits acceptance of an operation of the spin button (operation button CP1) (step S2650).

When after step S2649 or at step S2645, the main CPU 200 determines that the operation of any of the BET buttons (operation buttons CP2 to CP6) has not been detected or determines at step S2643 that the value of the number-of-credits counter is zero, the main CPU 200 determines whether or not the operation of the spin button (operation button CP1) has been detected (step S2651). When the main CPU 200 determines that the operation of the spin button (operation button CP1) has not been detected, the main CPU 200 shifts to step S2641.

When the main CPU 200 determines that the operation of the spin button (operation button CP1) has been detected, the main CPU 200 finishes the coin-insertion/start-check process.

<Symbol Drawing Process>

Next, with reference to FIG. 45, a symbol drawing process will be described. FIG. 45 is a flowchart of the symbol drawing process in the gaming machine 1 according to the embodiment of the present invention.

First, the main CPU 200 extracts five random number values for the determination of symbols (step S2711). Next, the main CPU 200 determines to-be-stopped symbols of the five video reels 3a to 3e from the five random number values by a drawing (step S2712).

In the process at step S2712, with reference to any the symbol determination tables, the five to-be-stopped symbols are determined. In the present embodiment, the symbol determination tables are tables shown in FIG. 14 to FIG. 42.

When the game mode is the base game mode, with reference to the symbol determination table for the base game mode shown in FIG. 14 and FIG. 15, five to-be-stopped symbols are determined.

When the game mode is the chance game mode, with reference to the symbol determination table and the like for the base game mode shown in FIG. 16 to FIG. 40, five to-be-stopped symbols are determined. As described above, when the game mode is the chance game mode, one kind of the group of reel strips among the 11 kinds of groups of reel strips which are TIGER CHANCE_0 to TIGER CHANCE_10 (symbol determination tables) is selected, and five to-be-stopped symbols are thereby determined.

When the game mode is the free game mode, with reference to the symbol determination table for the free game mode shown in FIG. 41 and FIG. 42, five to-be-stopped symbols are determined.

In other words, the main CPU 200 extracts the five random number values for the determination of symbols and in accordance with each of the game modes, with reference to each of the symbol determination tables shown in FIG. 14 to FIG. 42, one symbol is determined as a to-be-stopped symbol for each of the five video reels 3a to 3e.

In the present embodiment, each of the symbols defined in the symbol determination tables shown in FIG. 14 to FIG. 42 is selected at the equal probability. Accordingly, symbols included in the reel strips, whose number is large, are selected at a high probability. In other words, depending on the number of symbols, an appearing probability can be determined.

By conducting the process at step S2712, the five to-be-stopped symbols corresponding to each of the five video reels 3a to 3e are determined. The stopping of the five video reels 3a to 3e is controlled such that the determined five to-be-stopped symbols stop in the middle row of the symbol matrix (middle row of the symbol display region 141d).

Next, the main CPU 200 stores the determined to-be-stopped symbols of the respective video reels in a symbol storage area provided in the main RAM 210 (step S2713). Next, with reference to the payout table shown in FIG. 13, based on the symbols stored in the symbol storage area, the main CPU 200 determines a winning pattern (step S2714). When the winning pattern is satisfied, the main CPU 200 determines a payout in accordance with the number of the same Kind of symbols.

As described above, in this symbol drawing process, each of the plurality of symbols (refer to FIG. 14 to FIG. 42) which constitute the five video reels 3a to 3e is selected at the equal probability. Depending on the number of the symbols constituting the five video reels 3a to 3e, easiness of the determination as the to-be-stopped symbols is determined. In contrast to this, a predetermined value (weight) may be defined with respect to each of the plurality of symbols constituting the respective five video reels 3a to 3e. The weight is defined with respect to each of the plurality of symbols, thereby allowing easiness, with which each of the to-be-stopped symbols is determined depending on a value of the weight, to be controlled.

<Symbol Display Control Process>

Next, with reference to FIG. 46, a symbol display control process will be described. FIG. 46 is a flowchart of the symbol display control process in the gaming machine according to the present embodiment.

The main CPU 200 starts the scrolling of the five video reels 3a to 3e displayed in the symbol display region 141d of the lower image display panel 141 (step S2811).

When the game mode is the base game mode, the five video reels 3a to 3e for the base game mode shown in FIG. 14 and FIG. 15 are selected and displayed as the reel strips.

When the game mode is the chance game mode, the five video reels 3a to 3e for the chance game mode shown in FIG. 16 to FIG. 40 are selected and displayed as the reel strips.

When the game mode is the free game mode, the five video reels 3a to 3e for the free game mode shown in FIG. 41 and FIG. 42 are selected and displayed as the reel strips.

Next, based on the symbol storage area, the main CPU 200 stops the scrolling of the five video reels 3a to 3e (step S2813). After this process has been conducted, the symbol display control process is finished.

When the game mode is the chance game mode, while the symbols of FEATURE are being displayed in the symbol display region 141d in a varying manner, a speed of the scrolling of the video reels on which the symbols of FEATURE are being displayed is reduced. This can cause a player to expect that the symbols of FEATURE will be displayed in a stopped manner and rearranged in the symbol display region 141d and the free game trigger will be established.

<To-be-Paid-Out Number Determination Process>

Next, with reference to FIG. 47, a to-be-paid-out number determination process will be described. FIG. 47 is a flowchart of the to-be-paid-out number determination process in the gaming machine 1 according to the embodiment of the present invention.

First, based on the symbol storage area and the payout table (FIG. 13), the main CPU 200 determines a to-be-paid-out number based on a payout which satisfies a winning pattern (step S2911).

The main CPU 200 stores the determined to-be-paid-out number in a to-be-paid-out number counter of the to-be-paid-out number storage area (step S2913), finishing this sub-routine.

<Chance Game Mode Process>

With reference to FIG. 48, a chance game mode process will be described. FIG. 48 is a flowchart of the chance game mode process in the gaming machine 1 according to the present embodiment.

First, the main CPU 200 determines a maximum number of times in the chance game mode at which a unit game is played (step S3011). In the present embodiment, the maximum number of times of the unit games is a fixed value which is five.

Next, the main CPU 200 stores the maximum number of times of the unit games in a number-of-games counter (step S3013).

Next, the main CPU 200 conducts an upon-chance-game-mode-start-effect-execution process (step S3015). The main CPU 200 extracts random number values for effects, determines any of a predetermined plurality of upon-chance-game-mode-start effect contents by a drawing, and executes the upon-chance-game-mode-start effects. For example, the main CPU 200 displays video for effects on the upper liquid crystal display panel 131b, outputs audio from a loudspeaker (not shown), lights a lamp (not shown), and performs the control, for example, by subjecting these to effect processes. The above-described effects are performed, thereby it is made possible to notify a player that the game mode is shifted to the chance game mode.

Next, the main CPU 200 conducts an at-one-game-end initialization process (step S3017). For example, data that becomes unnecessary after each game in the working areas of the main RAM 210, such as the symbols determined by the drawing, is cleared.

Next, the main CPU 200 conducts the symbol drawing process which is described with reference to FIG. 45 (step S3019). In this process, to-be-stopped symbols are determined based on the random number values for symbol determination.

Next, the main CPU 200 conducts an effect contents determination execution process (step S3021). The main CPU 200 extracts random number values for effects, determines any of a predetermined plurality of effect contents by a drawing, and executes the effect contents at the timing of the determined effect contents. For example, the main CPU 200 displays video for effects on the upper liquid crystal display panel 131b, outputs audio from a loudspeaker (not shown), lights a lamp (not shown), and performs the control, for example, by subjecting these to effect processes.

Next, the main CPU 200 conducts a symbol display control process which is described with reference to FIG. 46 (step S3023). In this process, the scrolling of the five video reels 3a to 3e is started, and the to-be-stopped symbols determined at step S3019 in the symbol drawing process are stopped in predetermined positions.

Next, the main CPU 200 determines whether or not a free game trigger has been established (step S3025). When it is determined that the free game trigger has been established, the main CPU 200 conducts a free game mode process which is described later with reference to FIG. 49 (step S3027), finishing this sub-routine.

On the other hand, when it is determined that the free game trigger has not been established, the main CPU 200 subtracts one from the number of games (step S3029) and determines whether or not the number of games is greater than zero (step S3031).

When the main CPU 200 determines that the number of games is greater than zero, the main CPU 200 returns the processing to step S3017. When the main CPU 200 determines that the number of games is less than or equal to zero, the main CPU 200 finishes this sub-routine.

As described above, when the free game trigger has been established, even if the game or games remain, the free game mode process is immediately executed, thereby shifting to the free game mode. Thus, without consuming the remaining games in the chance game mode, the game mode can be shifted to the free game mode, thereby allowing an excessive increase in timing at which the game mode is shifted to the free game mode to be prevented and a profit of a gaming facility to be protected.

<Free Game Mode Process>

With reference to FIG. 49, a free game mode process will be described. FIG. 49 is a flowchart of the free game mode process in the gaming machine 1 according to the present embodiment.

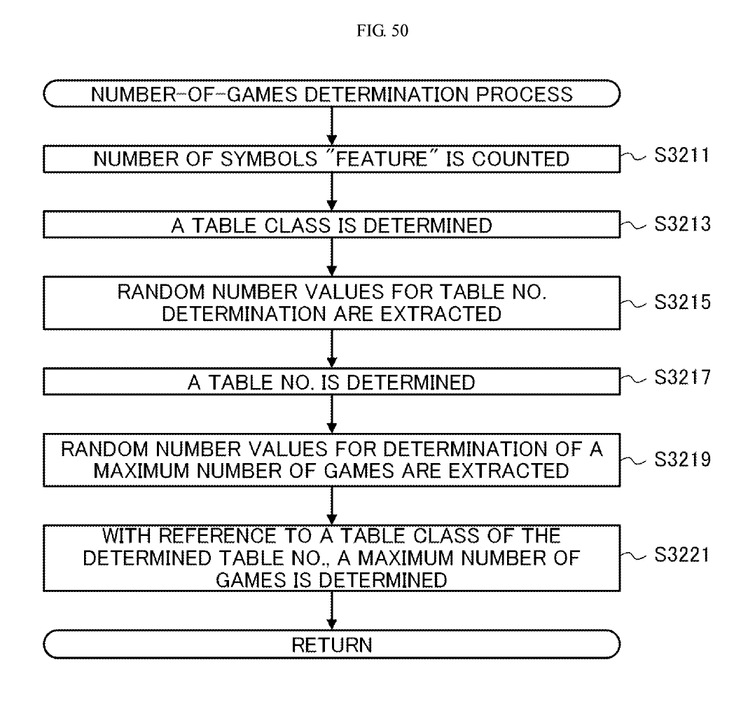

First, the main CPU 200 calls up a sub-routine of a number-of-games determination process shown in FIG. 50 and determines a maximum number of times in the free game mode at which a unit game is played (step S3111). Unlike in the chance game mode, in the free game mode, the maximum number of times of the unit games is determined by the number-of-games determination process.

Next, the main CPU 200 stores the maximum number of times at which the unit game is played in a number-of-games counter (step S3113).

Next, the main CPU 200 conducts an upon-free-game-mode-start-effect-execution process (step S3115). The main CPU 200 extracts random number values for effects, determines any of a predetermined plurality of upon-free-game-mode-start effect contents by a drawing, and executes the upon-free-game-mode-start effects. For example, the main CPU 200 displays video for effects on the upper liquid crystal display panel 131b, outputs audio from a loudspeaker (not shown), lights a lamp (not shown), and performs the control, for example, by subjecting these to effect processes. The above-described effects are performed, thereby it is made possible to notify a player that the game mode is shifted to the free game mode.

Next, the main CPU 200 conducts an at-one-game-end initialization process (step S3117). For example, data that becomes unnecessary after each game in the working areas of the main RAM 210, such as the symbols determined by the drawing, is cleared.

Next, the main CPU 200 conducts the symbol drawing process which is described with reference to FIG. 45 (step S3119). In this process, to-be-stopped symbols are determined based on the random number values for symbol determination.

Next, the main CPU 200 conducts an effect contents determination execution process (step S3121). The main CPU 200 extracts random number values for effects, determines any of a predetermined plurality of effect contents by a drawing, and executes the effect contents at the timing of the determined effect contents. For example, the main CPU 200 displays video for effects on the upper liquid crystal display panel 131b, outputs audio from a loudspeaker (not shown), lights a lamp (not shown), and performs the control, for example, by subjecting these to effect processes.

Next, the main CPU 200 conducts a symbol display control process which is described with reference to FIG. 46 (step S3123). In this process, the scrolling of the five video reels 3a to 3e is started, and the to-be-stopped symbols determined at step S3119 in the symbol drawing process are stopped in predetermined positions.

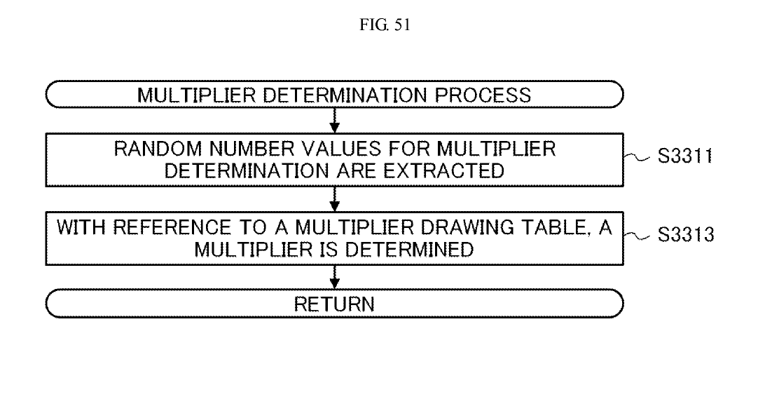

Next, the main CPU 200 calls up a sub-routine of a multiplier determination process shown in FIG. 51 and determines a multiplier (step S3125).

Next, the main CPU 200 calls up a sub-routine of a to-be-paid-out number determination process shown in FIG. 47 and determines a to-be-paid-out number (step S3127). In this process, a payout based on the payout table (refer to FIG. 13) is determined in accordance with a winning pattern, the payout is further multiplied by the multiplier determined in the process at step S3125, and the resultant is stored in a to-be-paid-out number storage area provided in the main RAM 210.

Next, the main CPU 200 conducts a paying-out process (step S3129). The main CPU 200 adds the value stored in the to-be-paid-out number storage area to a value stored in the number-of-credits storage area provided in the main RAM 210.

The driving of a hopper (not shown) may be controlled, thereby discharging coins in accordance with the to-be-paid-out number counter from a coin payout exit. In addition, the driving of a ticket printer (not shown) may be controlled, thereby issuing a ticket with a barcode having the to-be-paid-out number counter registered thereon.

Next, the main CPU 200 subtracts only one from the number of games (step S3131).

Next, the main CPU 200 determines whether or not a free game retrigger has been established (step S3133). When it is determined that the free game retrigger has been established, the main CPU 200 calls up a sub-routine of a number-of-games determination process shown in FIG. 50, determines a maximum number of times in the free game mode at which a unit game is played (step S3135), and returns the processing to step S3117.

Next, when it is determined that the free game retrigger has not been established, the main CPU 200 determines whether or not the number of games is greater than zero (step S3137).

When it is determined that the number of games is greater than zero, the main CPU 200 returns the processing to step S3117. When it is determined that the number of games is less than or equal to zero, the main CPU 200 finishes this sub-routine.

<Number-of-Games Determination Process>

FIG. 50 is a flowchart of a sub-routine showing a process in which a maximum number of times at which a unit game is played in a free game mode.

First, the main CPU 200 counts the number of the same Kind of symbols of FEATURE (step S3211). This number of the same Kind of symbols of FEATURE is a number of the symbols of FEATURE which have appeared in the symbol display region 141d upon establishing a winning pattern of the symbols of FEATURE.

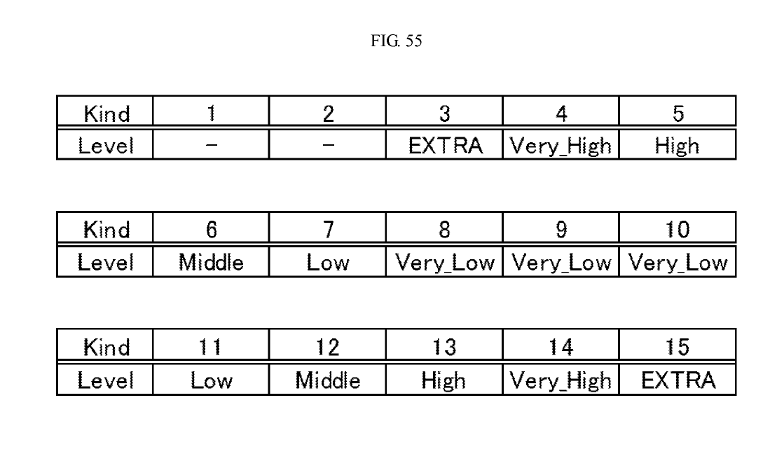

Next, the main CPU 200 determines a table class based on the number of the same Kind of symbols of FEATURE (step S3213). As shown in FIG. 55, there are six table classes, which are EXTRA, Very High, High, Middle, Low, and Very Low. When the number of the same Kind of symbols of FEATURE is 3 or 15, the table class EXTRA is determined; when the number of the same Kind of symbols of FEATURE is 4 or 14, the table class Very High is determined; when the number of the same Kind of symbols of FEATURE is 5 or 13, the table class High is determined; when the number of the same Kind of symbols of FEATURE is 6 or 12, the table class Middle is determined; when the number of the same Kind of symbols of FEATURE is 7 or 11, the table class Low is determined; and when the number of the same Kind of symbols of FEATURE is 8 to 10, the table class Very Low is determined.

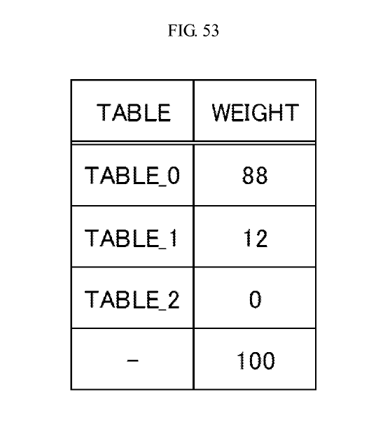

Next, the main CPU 200 extracts random number values for table No. determination (step S3215). Next, the main CPU 200 determines a table No. by using the extracted random number values for table No. determination (step S3217). As the table Nos. as shown in FIG. 53, there are three kinds of table Nos. which are Table 0, Table 1, and Table 2. Based on the extracted random number values, one kind of these three kinds of table Nos. is determined. In an example shown in FIG. 53, Table_0 is selected with a probability of 88/100; Table_1 is selected with a probability of 12/100; and Table_2 is selected with a probability of 0/100.

Next, the main CPU 200 extracts random number values for determination of a maximum number of games (step S3219). Next, by using the random number values for determination of the maximum number of games extracted at step S3219 and with reference to the table class of the table No. determined at step S3217, the main CPU 200 determines the maximum number of games (step S3221).

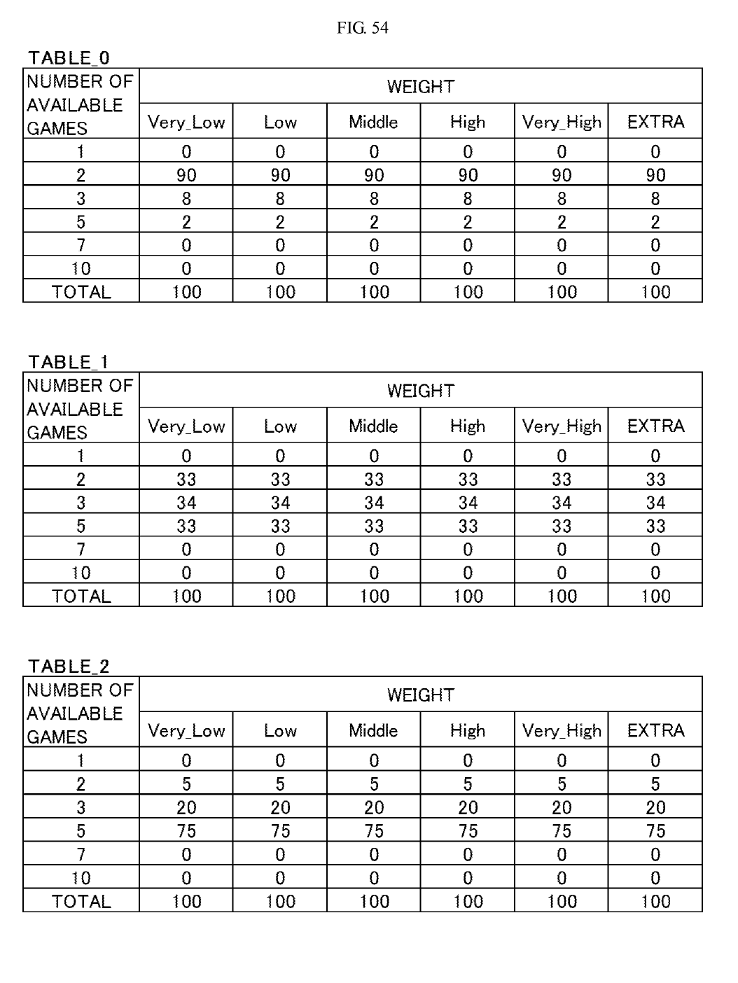

As shown in FIG. 54, weights of the maximum numbers of games are defined in accordance with the table classes. The relationship between the weights of the maximum numbers of games and the table classes is defined for each of the three kinds of table Nos.

The maximum number of games is 1, 2, 3, 5, 7, or 10, one among these is selected, and that one is determined as a maximum number of games in the free game mode.

In the case of Table 0, not depending on any table class, a probability with which a maximum number of games is 2 is the largest (90/100). Subsequently, a probability with which a maximum number of games is 3 is large (8/100), and subsequently, a probability with which a maximum number of games is 5 is large (2/100). In the case of Table_0, as the maximum number of games, 1, 7, and 10 are not selected.

In the case of Table_1, not depending on any table class, probabilities with which maximum numbers of games are 2, 3, and 5, respectively are substantially equal to one another (33/100, 34/100, and 33/100). In the case of Table_{—}1, as the maximum numbers of games, 1, 7, and 10 are not selected.

In the case of Table 2, not depending on any table class, a probability with which a maximum number of games is 5 is the largest (75/100). Subsequently, a probability with which a maximum number of games is 3 is large (20/100), and subsequently, a probability with which a maximum number of games is 2 is large (5/100). In the case of Table_2, as the maximum numbers of games, 1, 7, and 10 are not selected.

<Multiplier Determination Process>

FIG. 51 is a flowchart of a sub-routine of a process in which a multiplier for a payout in a free game mode is determined.

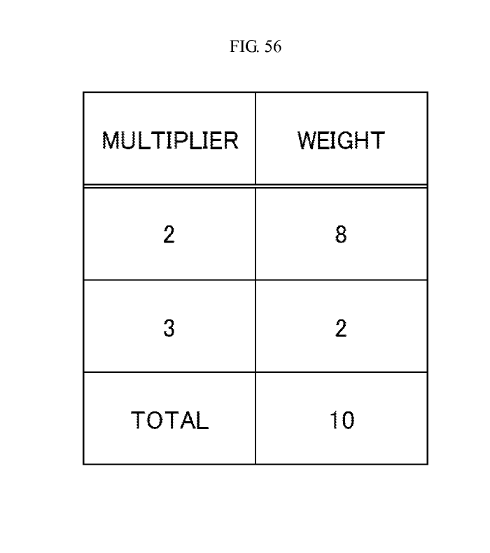

First, the main CPU 200 extracts random number values for multiplier determination (step S3311). Next, with reference to a multiplier drawing table, the main CPU 200 determines a multiplier (step S3313). FIG. 56 is a table showing an example of the multiplier drawing table. In the multiplier drawing table shown in FIG. 56, a probability with which a multiplier is determined as 2 is 8/10 and a probability with which a multiplier is determined as 3 is 2/10. As described above, in the present embodiment, the multiplier is determined as 2 or 3.

<<<Specific Example of Display Image>>>

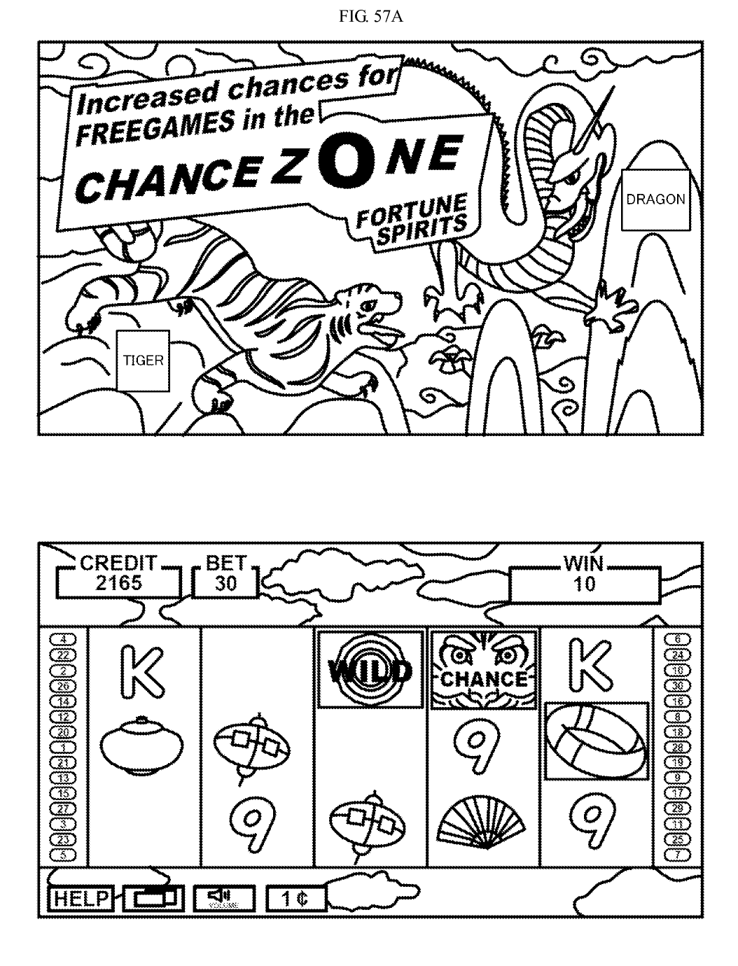

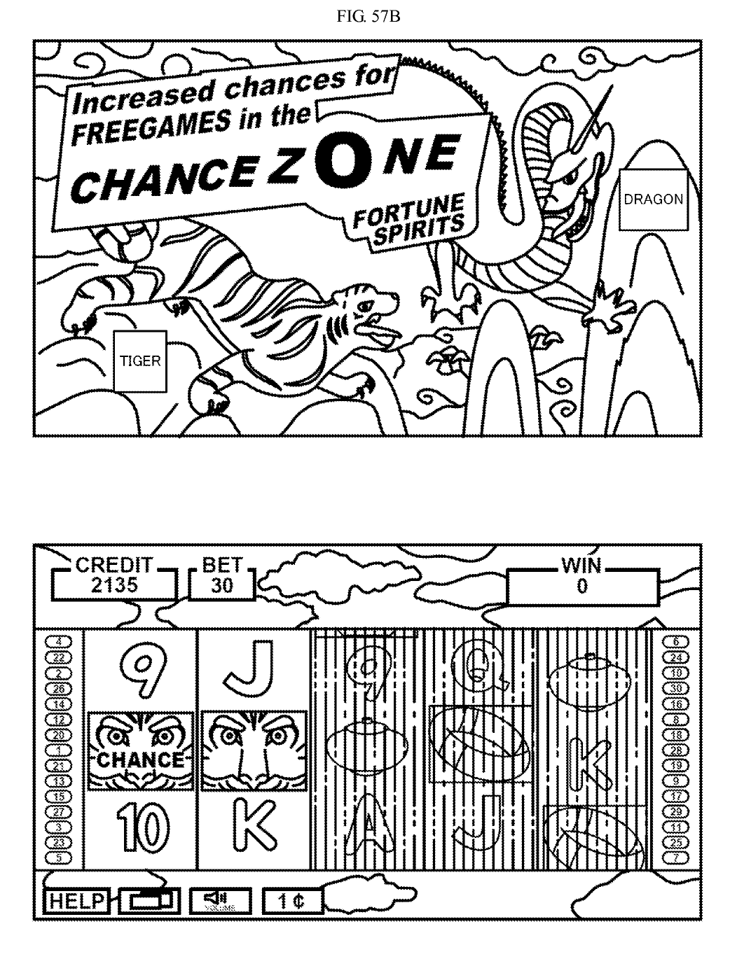

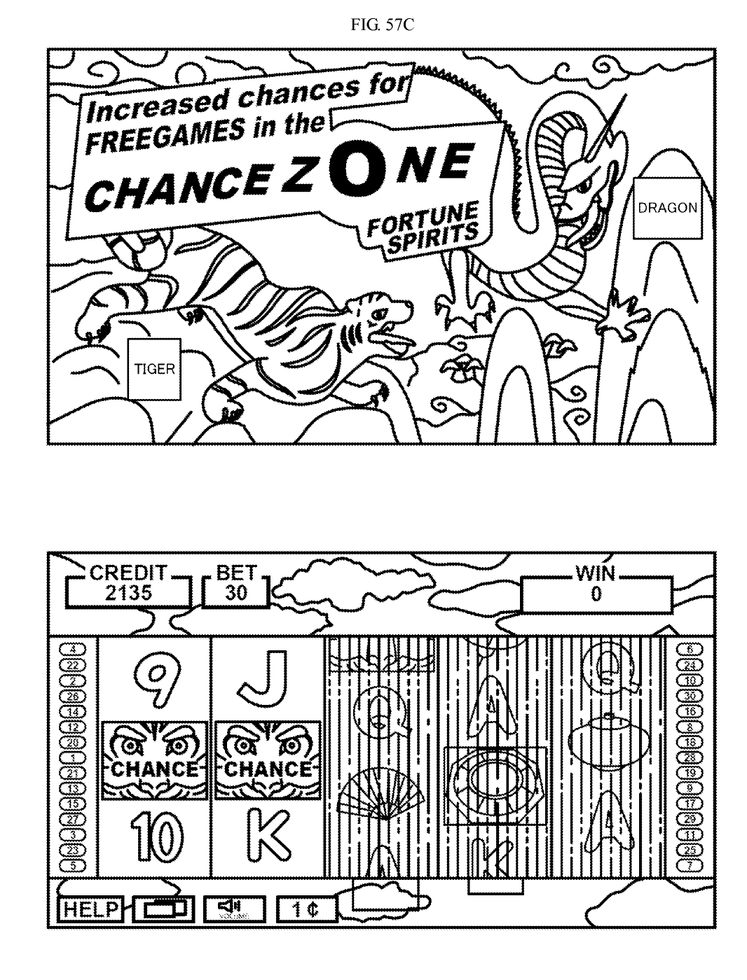

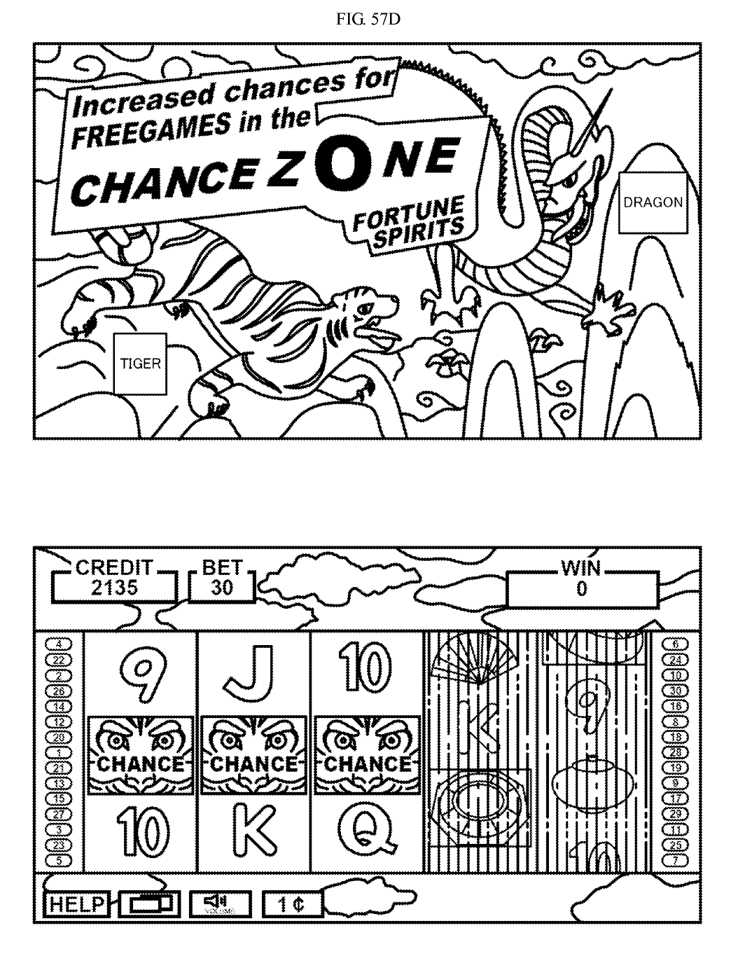

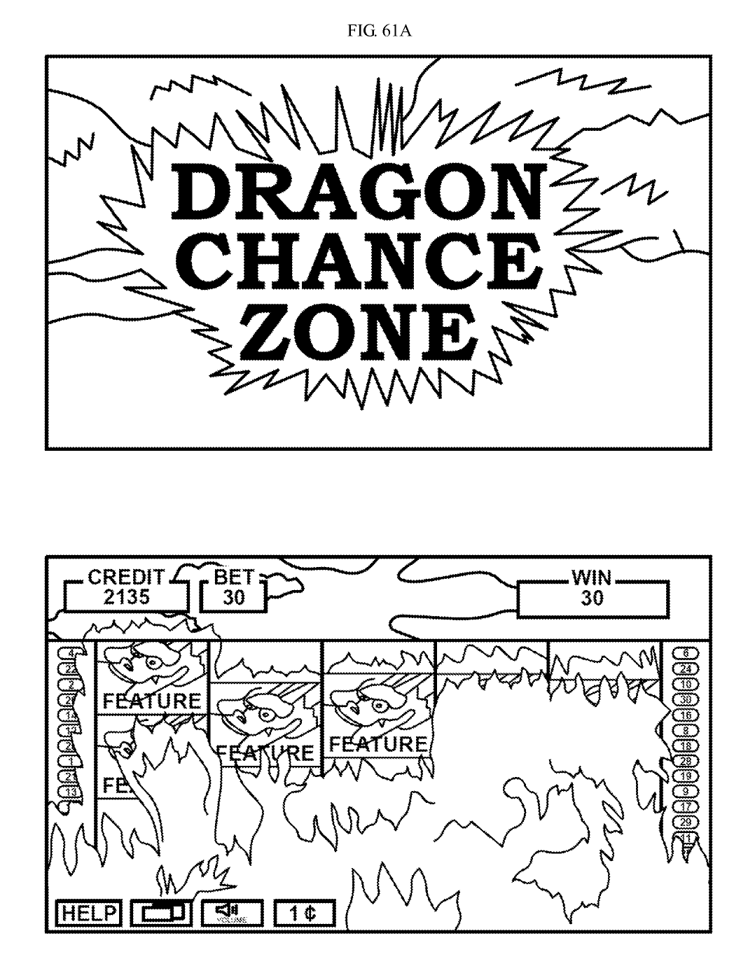

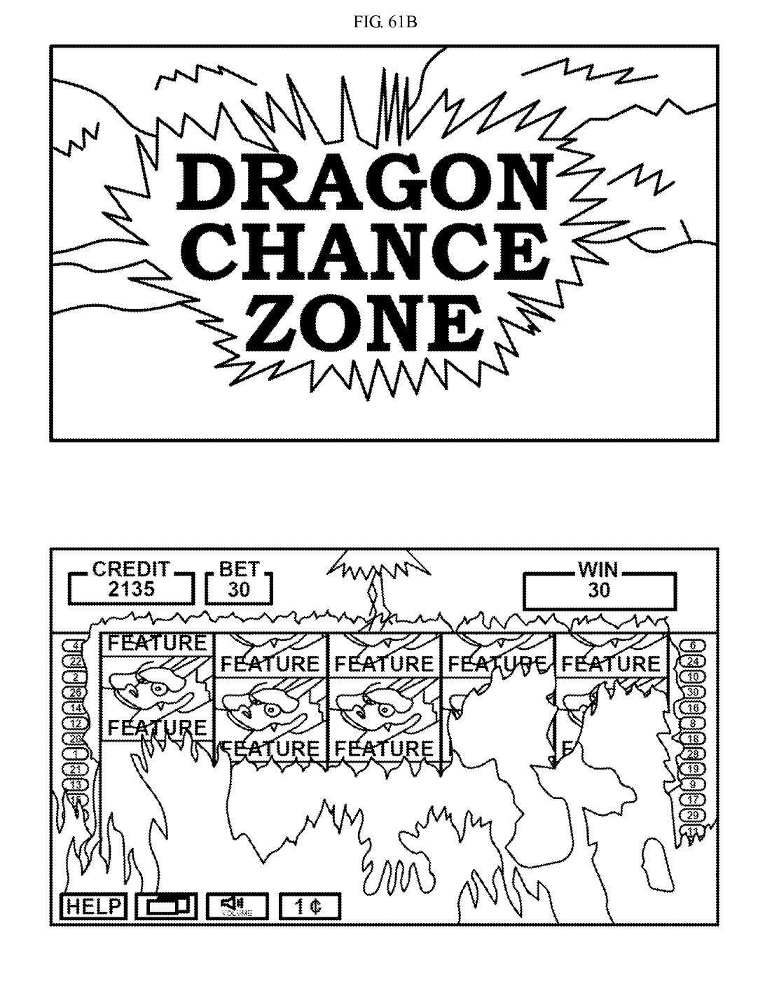

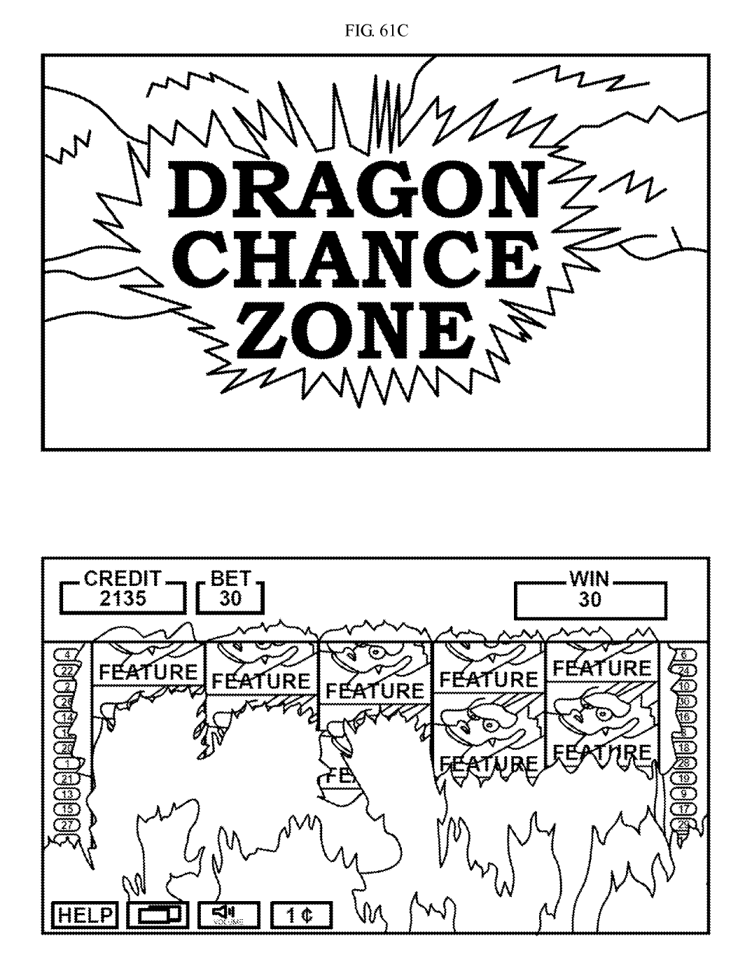

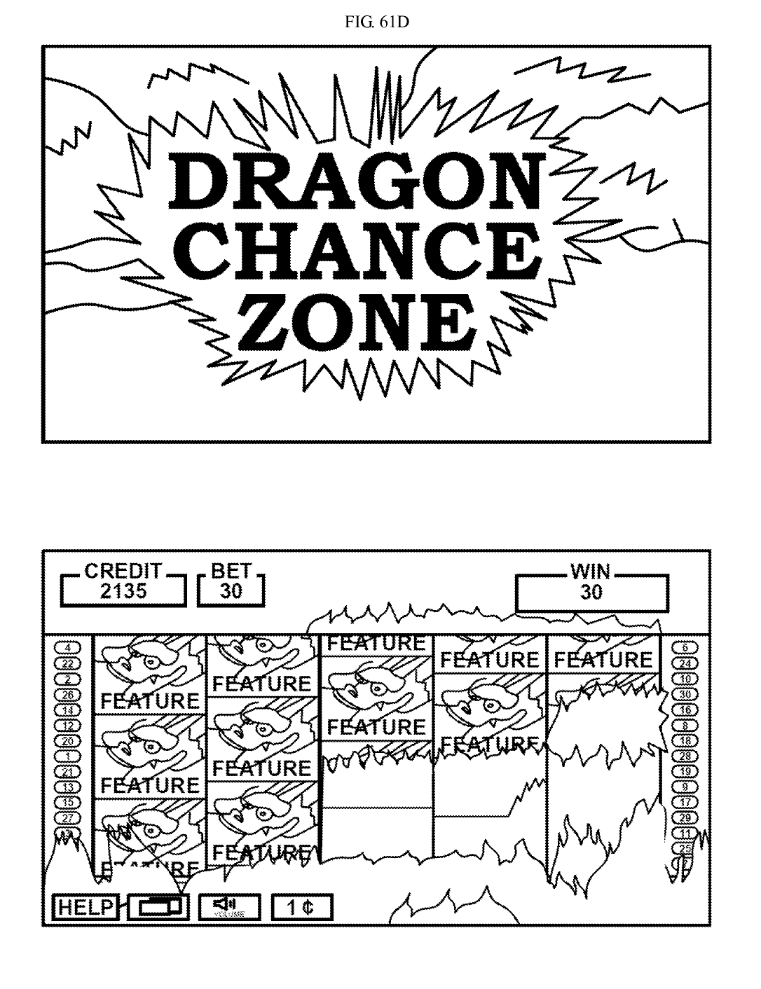

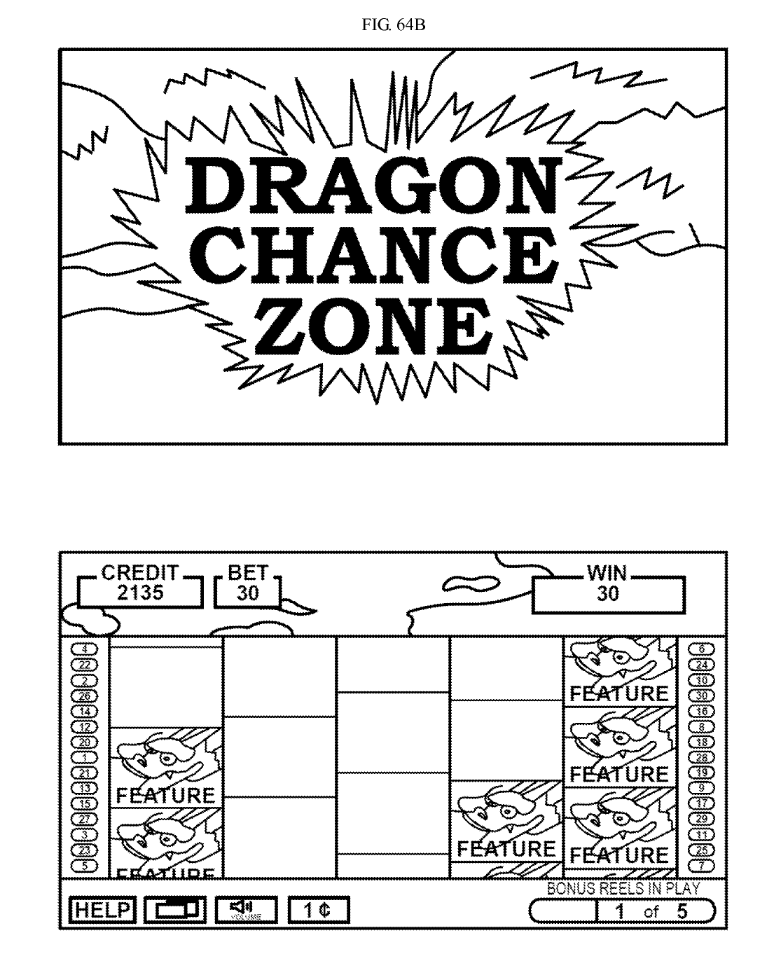

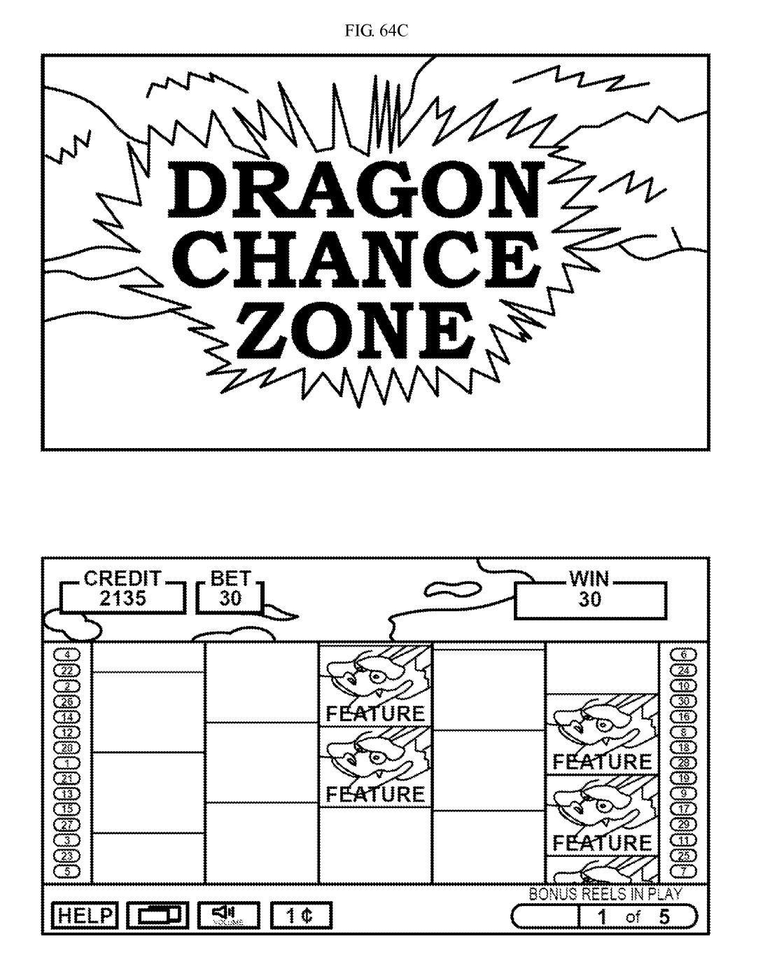

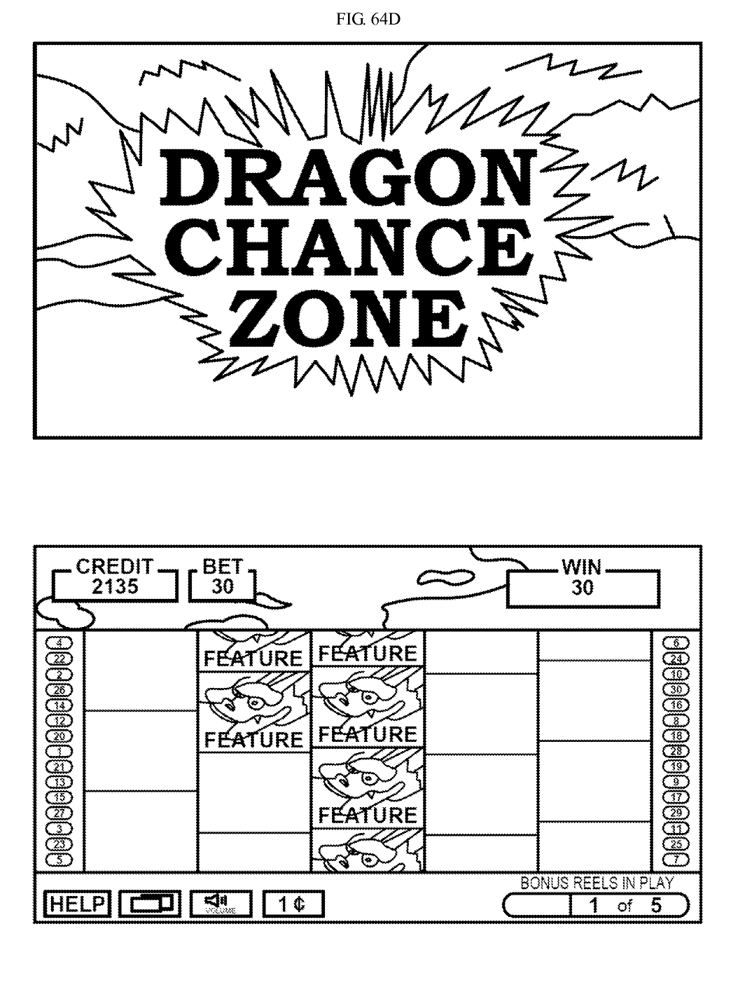

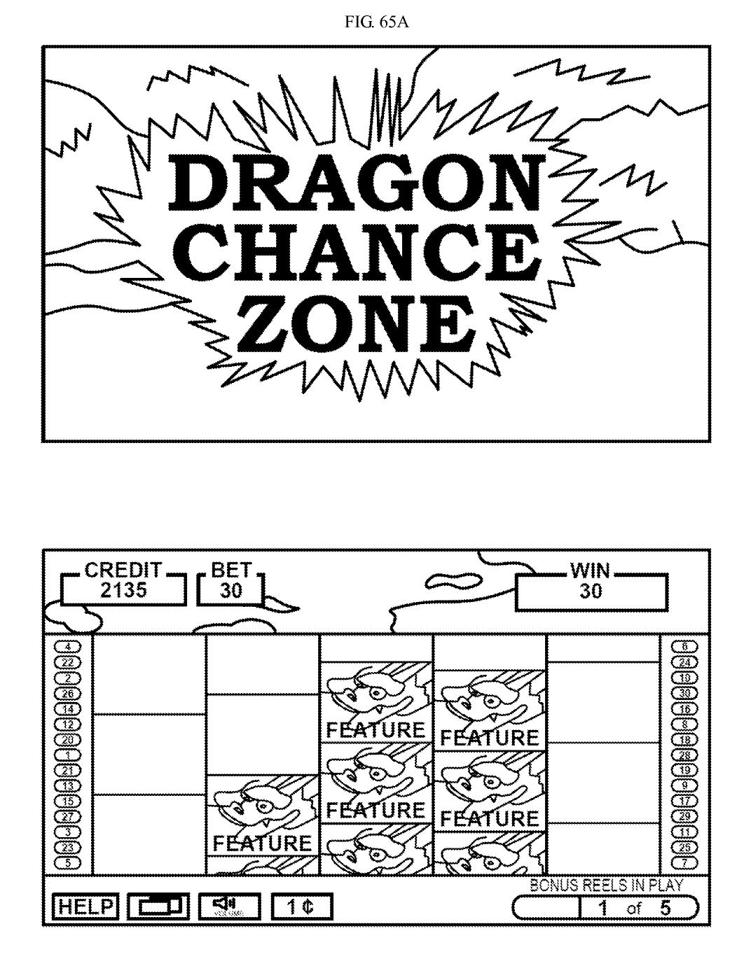

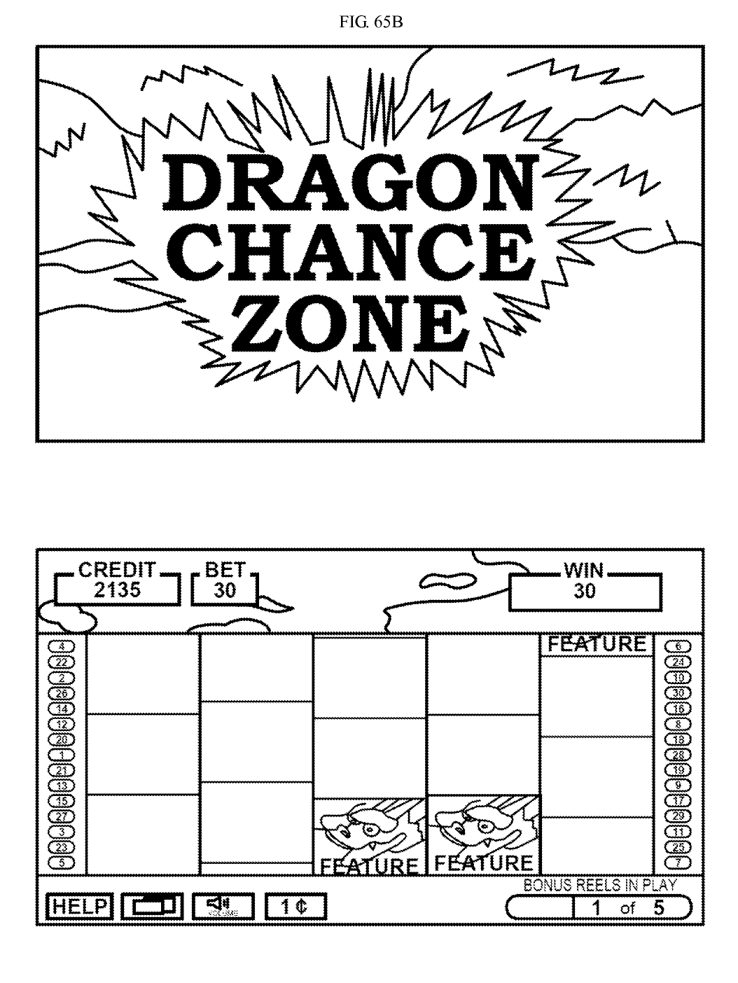

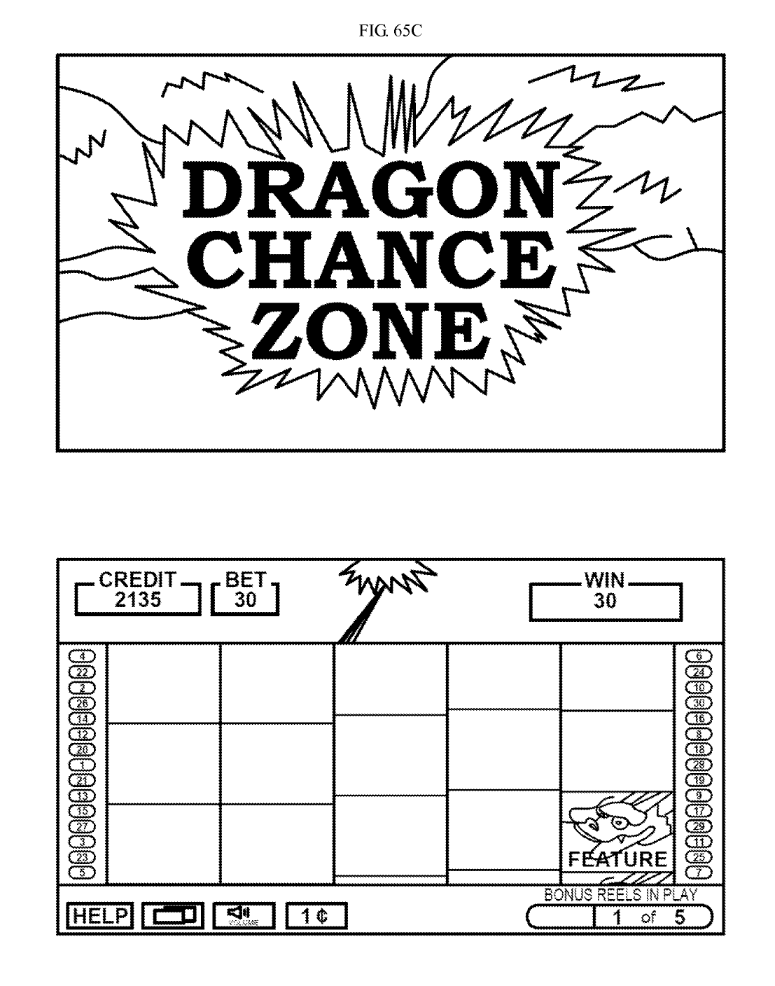

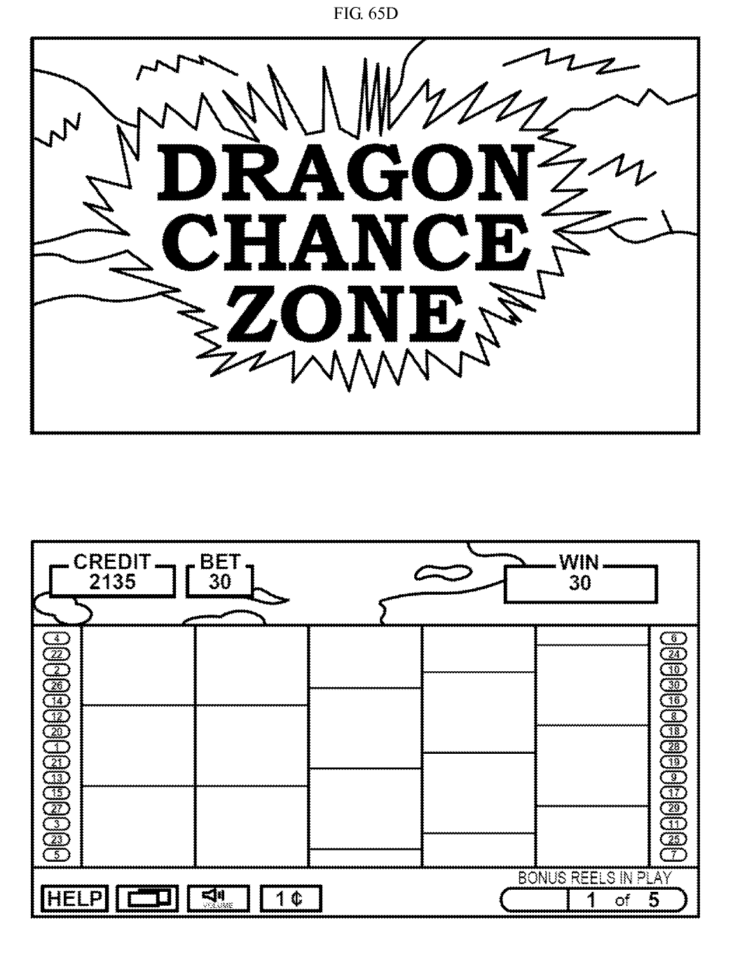

FIG. 57A to FIG. 82 illustrate specific images displayed on an upper display device 131 (specifically, an upper liquid crystal display panel 131b) and a lower display device 141 (specifically, a lower liquid crystal panel 141b). In each of FIG. 57A to FIG. 82, an upper diagram is an image displayed on the upper display device 131 and a lower diagram is an image displayed on the lower display device 141.

On the lower display device 141, mainly, images of five video reels 3a to 3e are displayed in a moving manner or a stopped manner. On the lower display device 141, the video reel 3a, 3b, 3c, 3d, and 3e are displayed as images in the order starting from a left side. Further, on the lower display device 141, in addition to the images of the five video reels 3a to 3e, images and letters in accordance with a state and a progress of a game are also displayed.

On the upper display device 131, images and letters in accordance with a state and a process of a game are also displayed.

<<Examples of Images in Base Game Mode>>

FIG. 57A to FIG. 58A are diagrams illustrating examples of images in a base game mode.

FIG. 57A is a diagram illustrating images before a unit game in the base game mode is initiated. On the lower display device 141, images of five video reels 3a to 3e are displayed in a stop state. In this diagram, symbols rearranged in the previous unit game, whose number is 3×5, are shown.

FIG. 57B is a diagram illustrating a state in which after the unit game in the base game mode has been initiated, one video reel which is a video reel 3a is displayed in a stopped manner and the remaining four video reels which are video reels 3b to 3e are displayed in a varying manner. The video reel 3a is displayed in the stopped manner, and in a middle row, a symbol of CHANCE (an image of a tiger and a symbol of letters “CHANCE”) is displayed in the stopped manner.

FIG. 57C is a diagram illustrating a state in which the video reel 3b is displayed in the stopped manner, and two video reels which are the video reel 3a and the video reel 3b are thereby displayed in the stopped manner, and the remaining three video reels 3c to 3e are displayed in the varying manner. Both of the video reel 3a and the video reel 3b are displayed in the stopped manner and in the middle row, the symbols of CHANCE are displayed in the stopped manner.

FIG. 57D is a diagram illustrating a state in which the video reel 3c is displayed in the stopped manner, and three video reels which are the video reel 3a to 3c are thereby displayed in the stopped manner, and the remaining two video reels which are the video reel 3d and the video reel 3e are displayed in the varying manner. The video reels 3a, 3b, and 3c are displayed in the stopped manner and in the middle row, the symbols of CHANCE are displayed in the stopped manner.

FIG. 58A is a diagram illustrating a state in which in the unit game in the base game mode, all of the five video reels 3a to 3e are stopped. In other words, FIG. 58A shows a state in which all of the symbols in this unit game, whose number is 3×5, have been rearrange and an outcome of the unit game is displayed. It is illustrated therein that in this unit game, in positions of the respective middle rows of the three video reels 3a, 3b, and 3c, the symbols of CHANCE have appeared and a winning pattern of CHANCE has been established. It is thereby illustrated that a chance game mode (tiger chance) has been triggered.

As shown in FIG. 58A, on the upper display device 131, information indicating “WIN 11 CREDITS” is displayed. It is thereby illustrated that in this unit game, 11 credits are awarded to a player as a payout.

As shown in FIGS. 57A to 57D, in the unit game in the base game mode, on the upper display device 131, images showing characters such as a tiger and a dragon and letters indicating “Increases chances for FREEGAMES in the CHANCE ZONE FORTUNE SPIRITS” are displayed.

<<Examples of Images in Chance Game Mode (Tiger Chance)>>

As described above, the winning pattern of CHANCE has been established, thereby shifting the game mode from the base game mode to a chance game mode.

FIG. 58B to FIG. 69B are diagrams illustrating examples of images in the chance game mode.

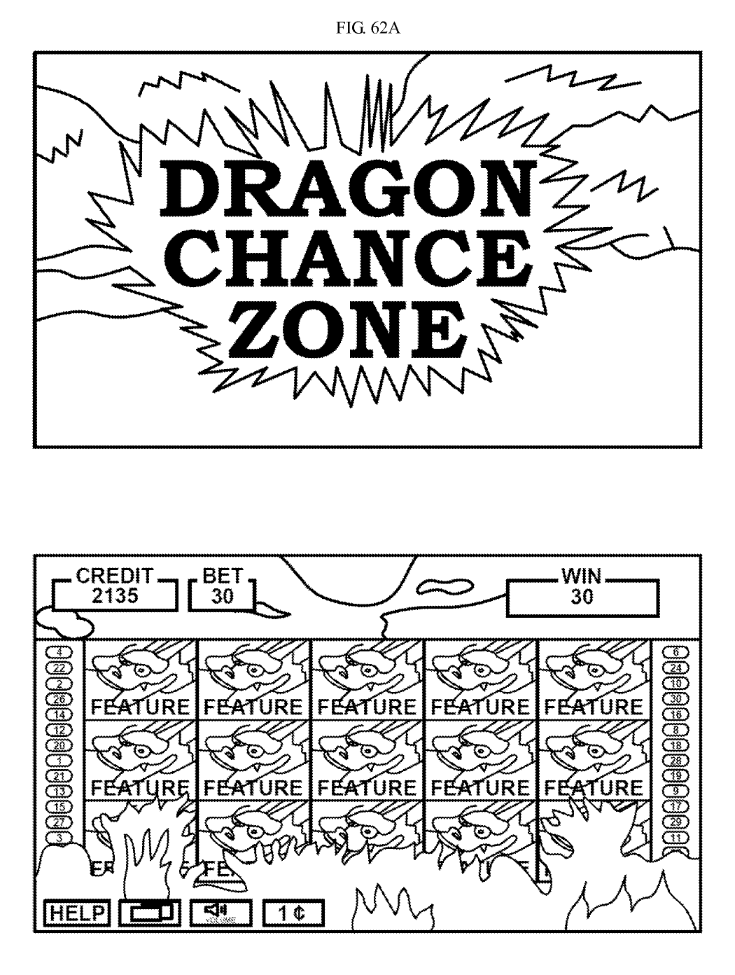

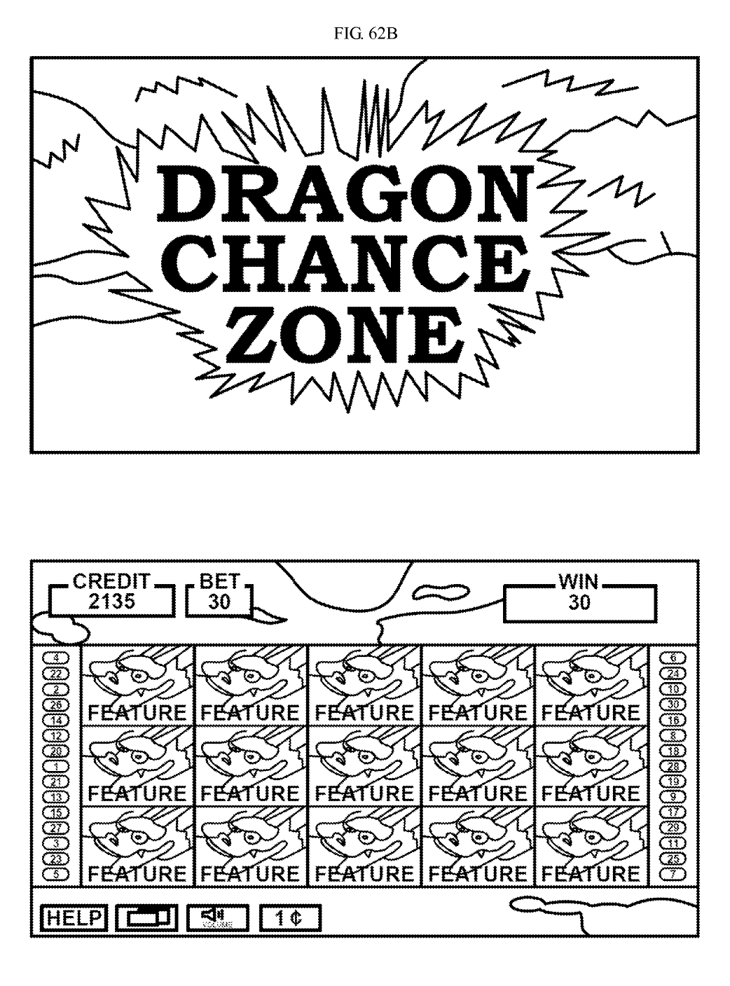

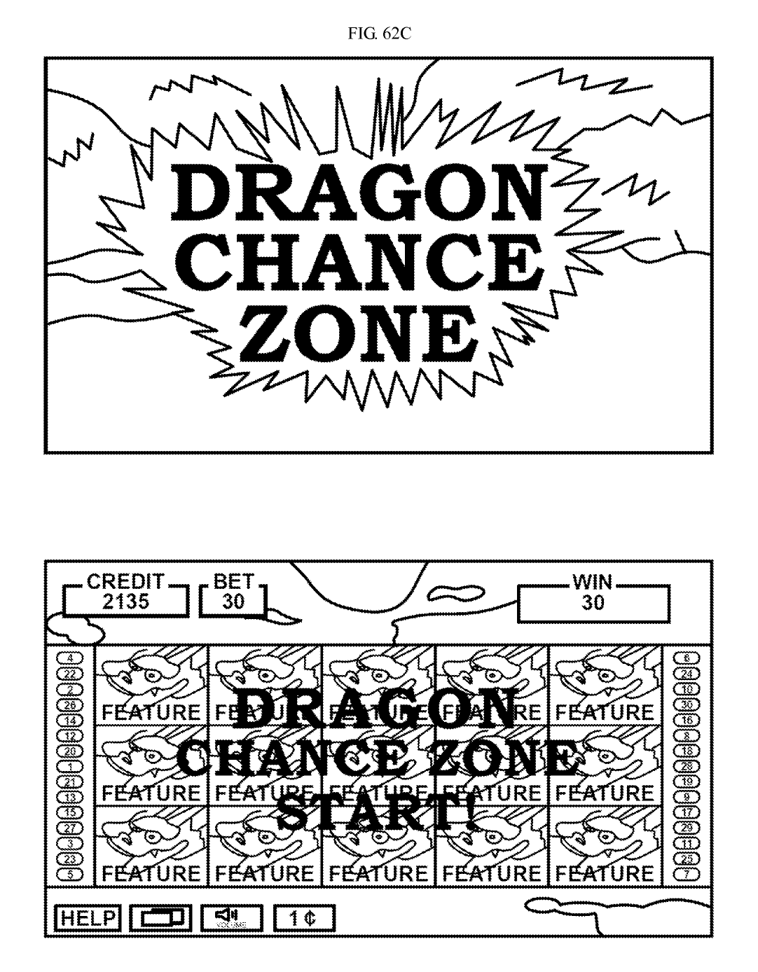

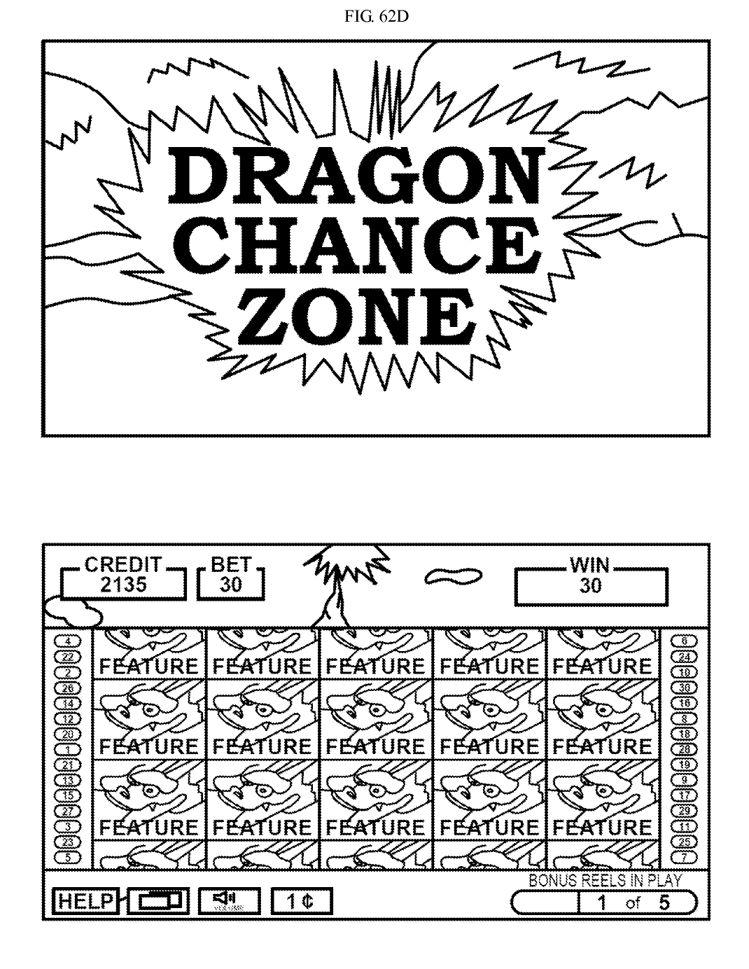

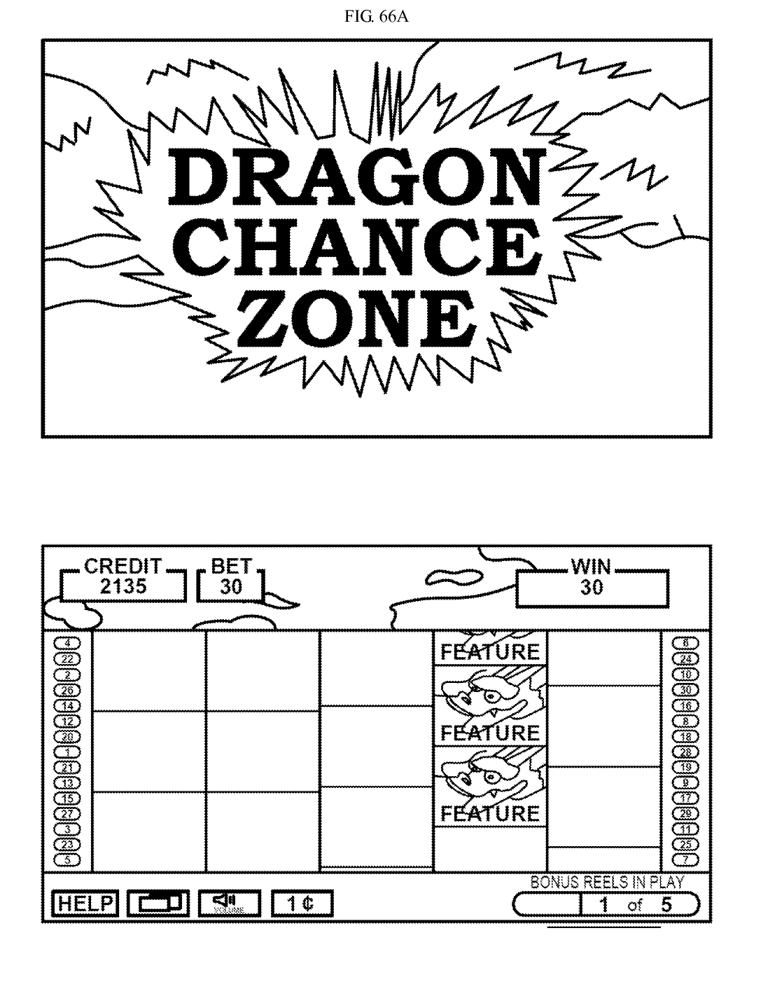

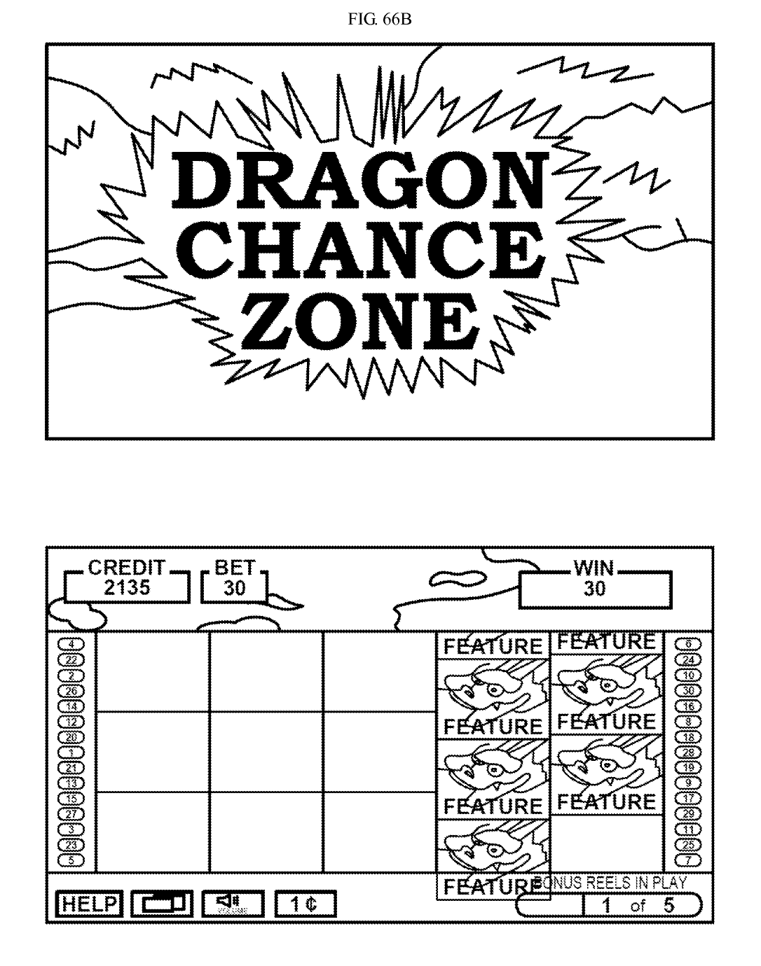

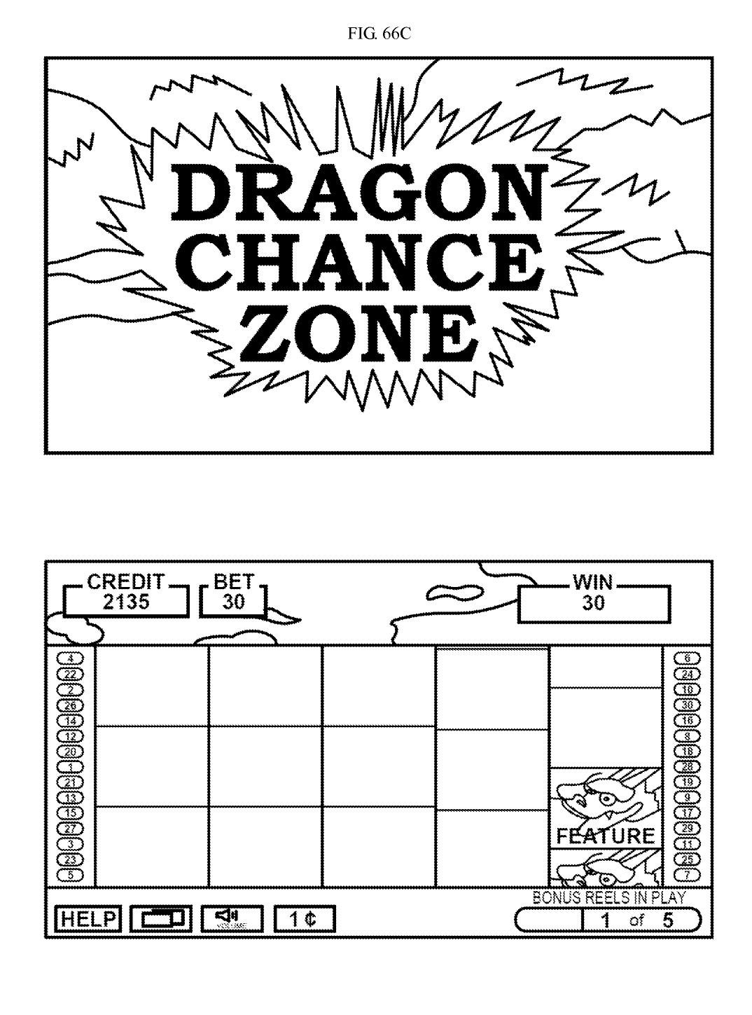

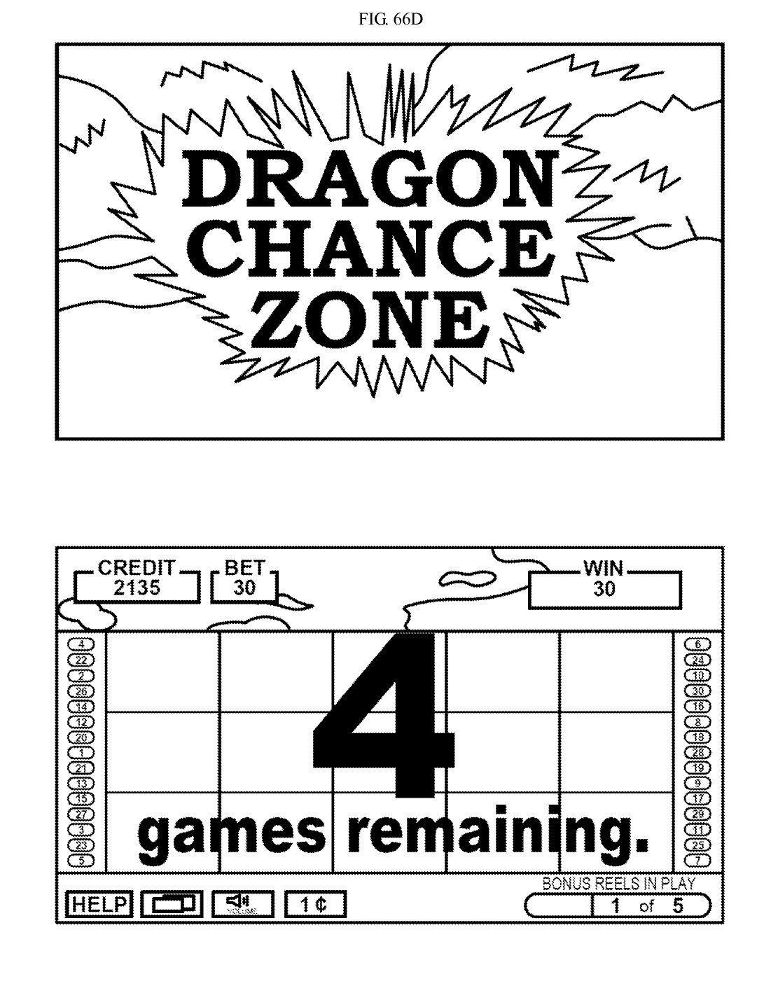

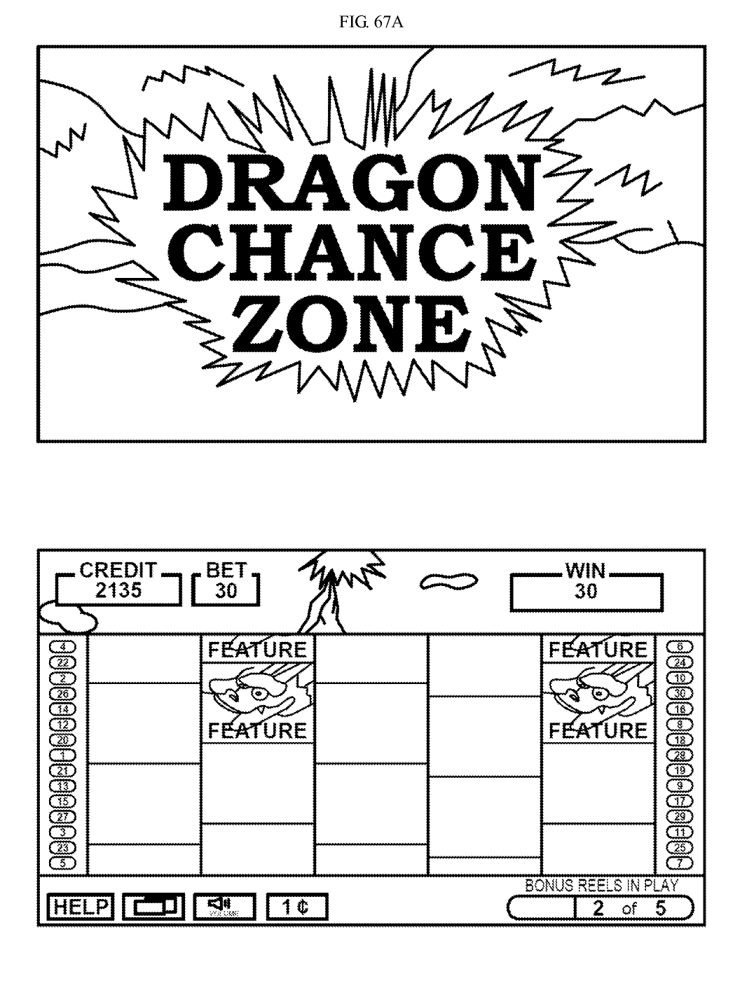

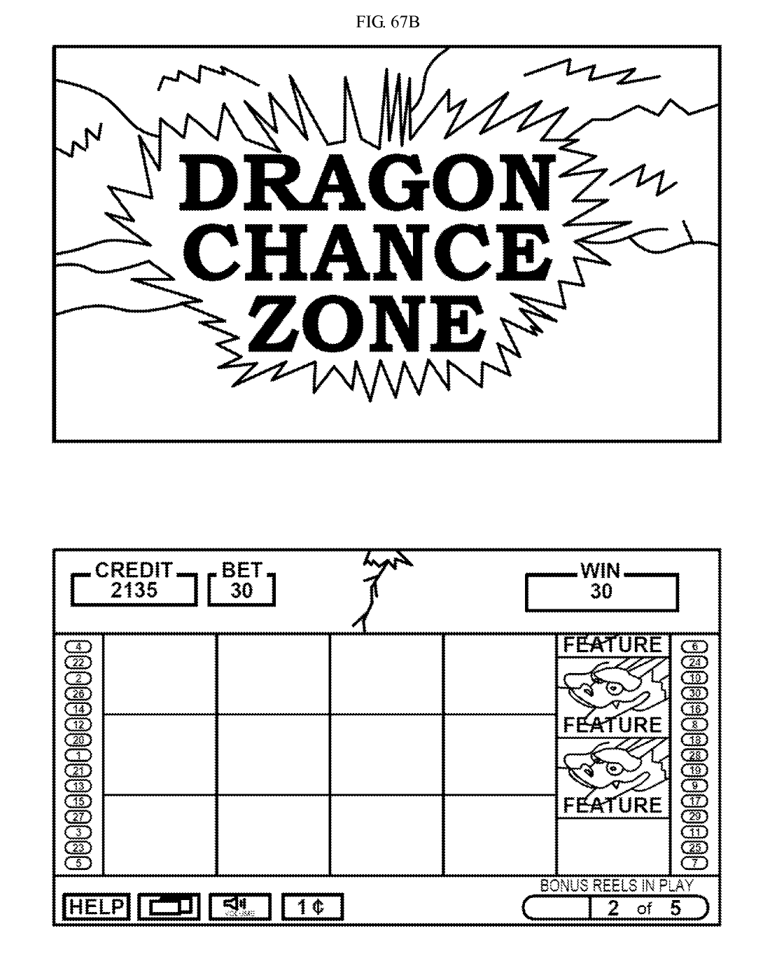

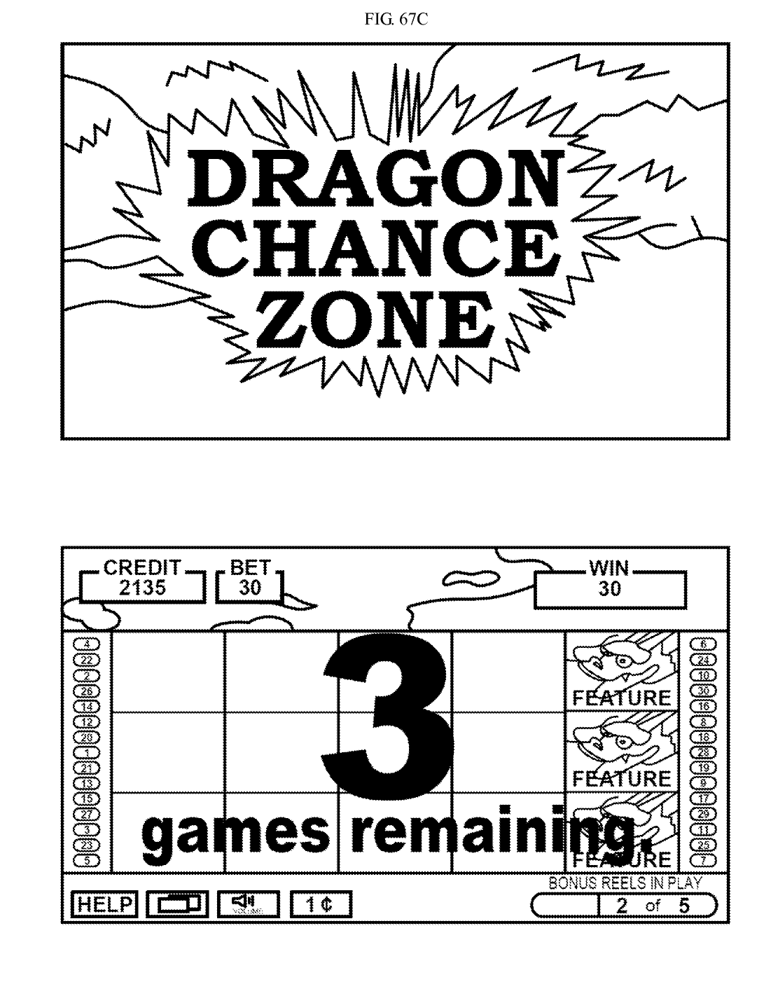

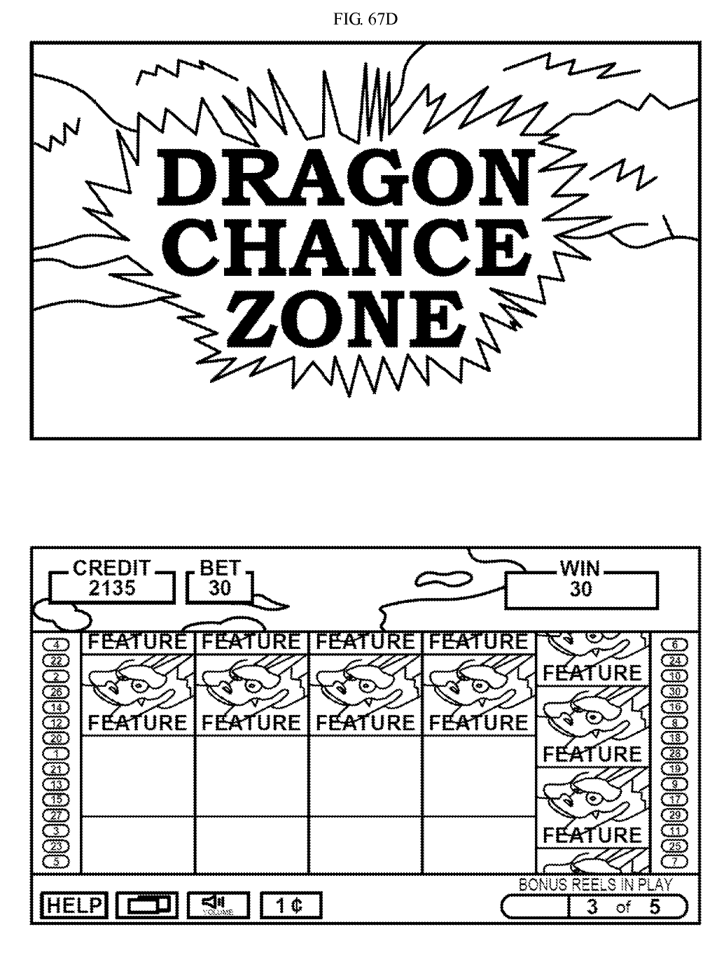

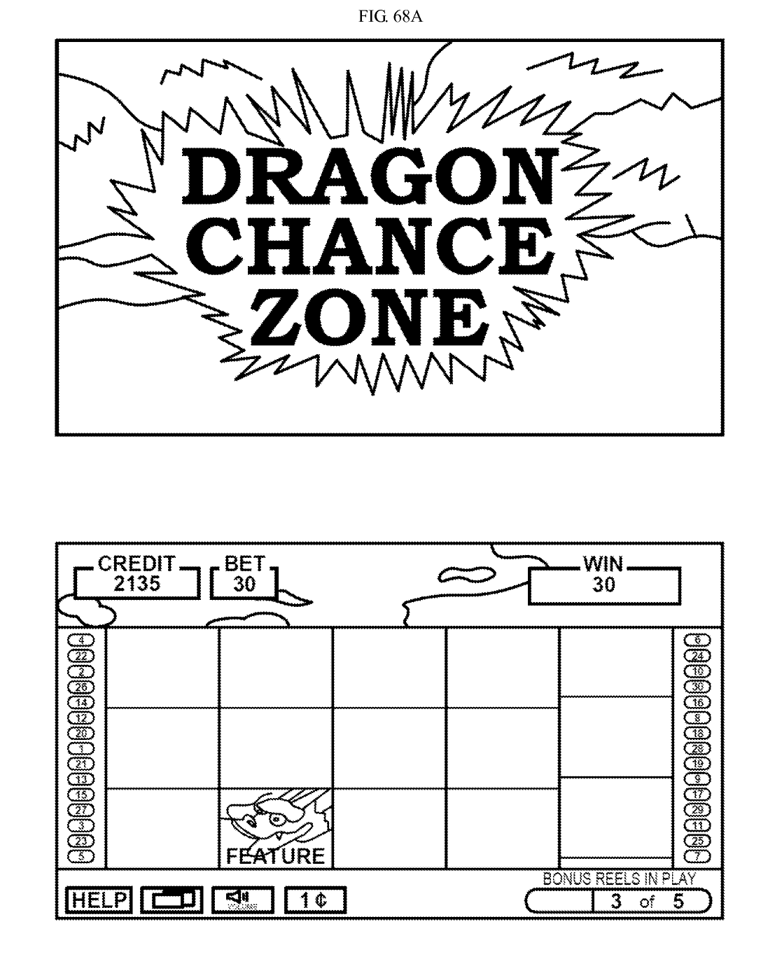

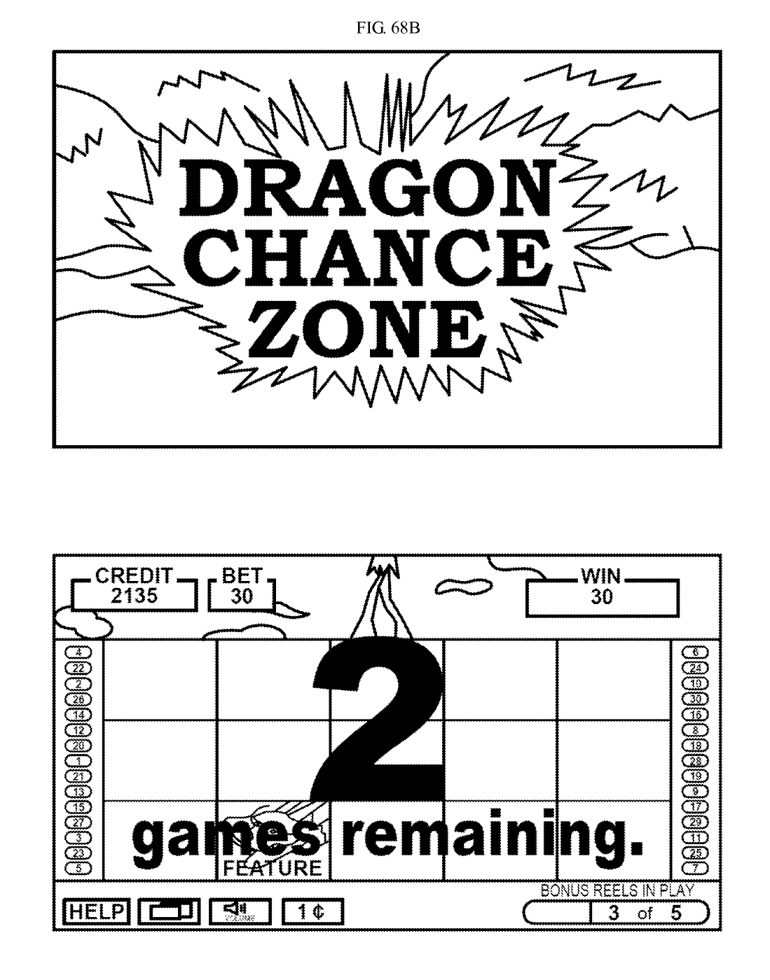

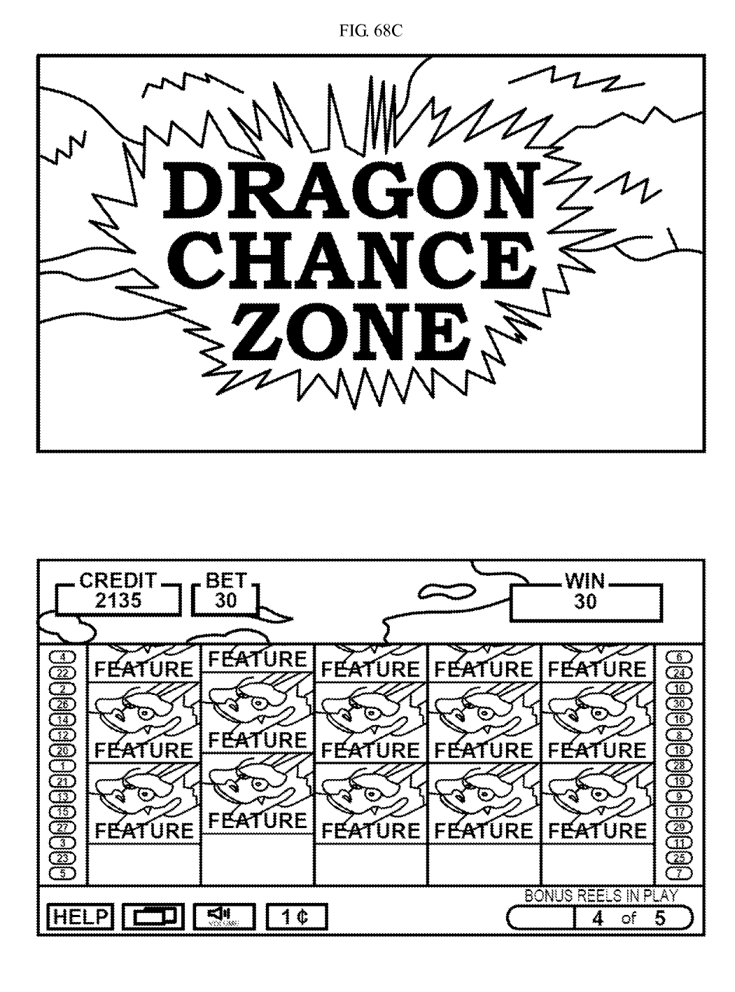

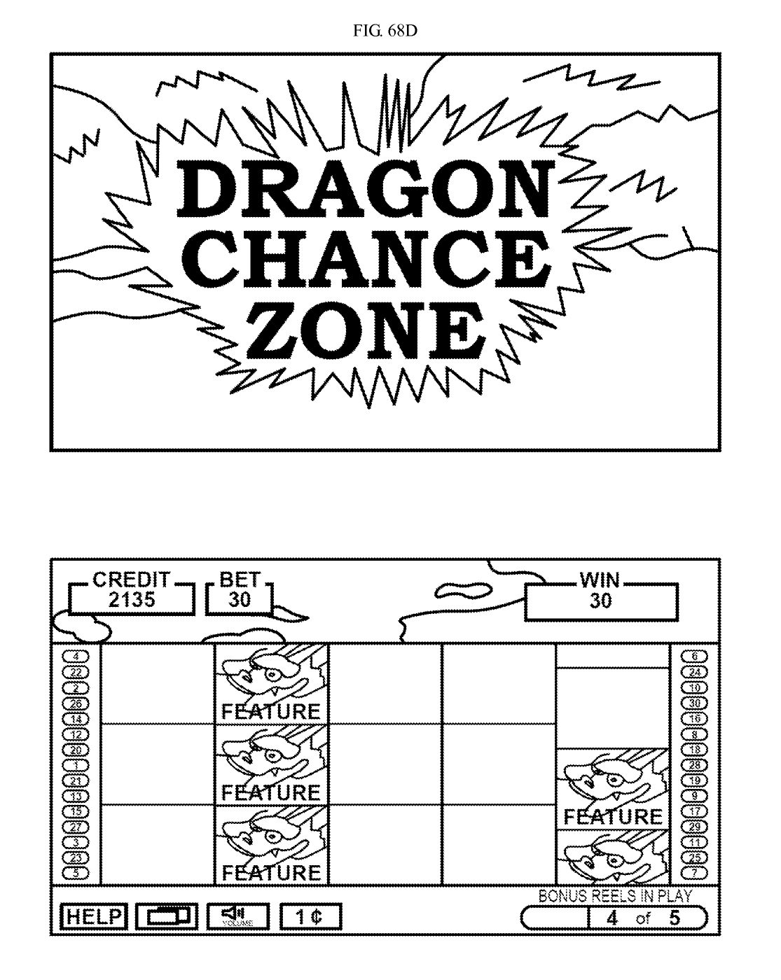

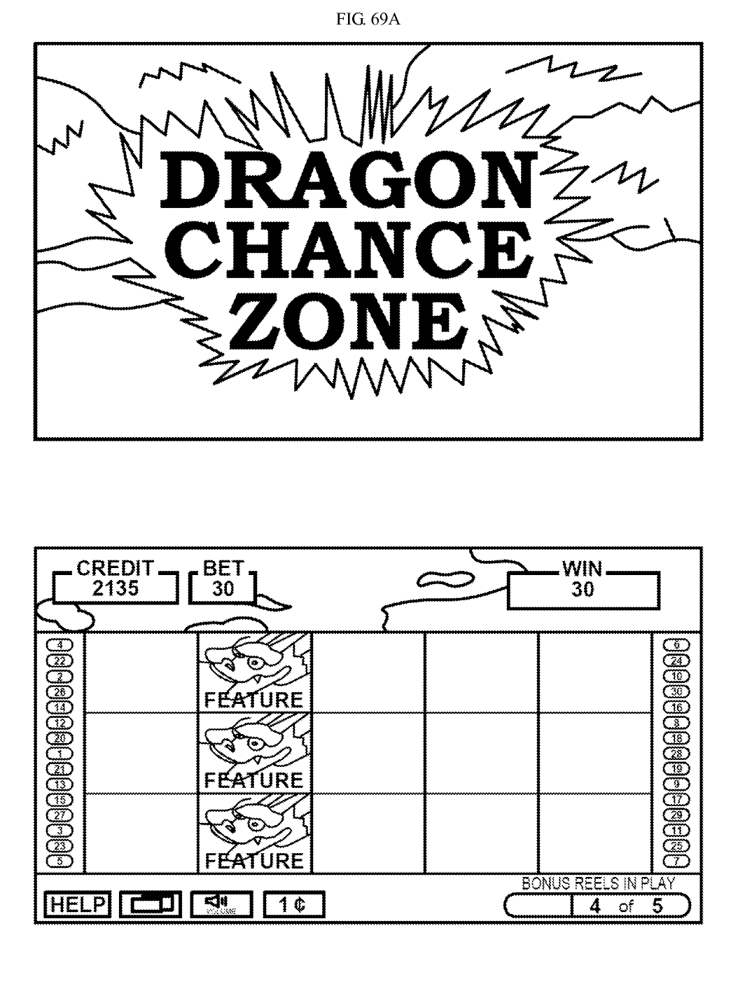

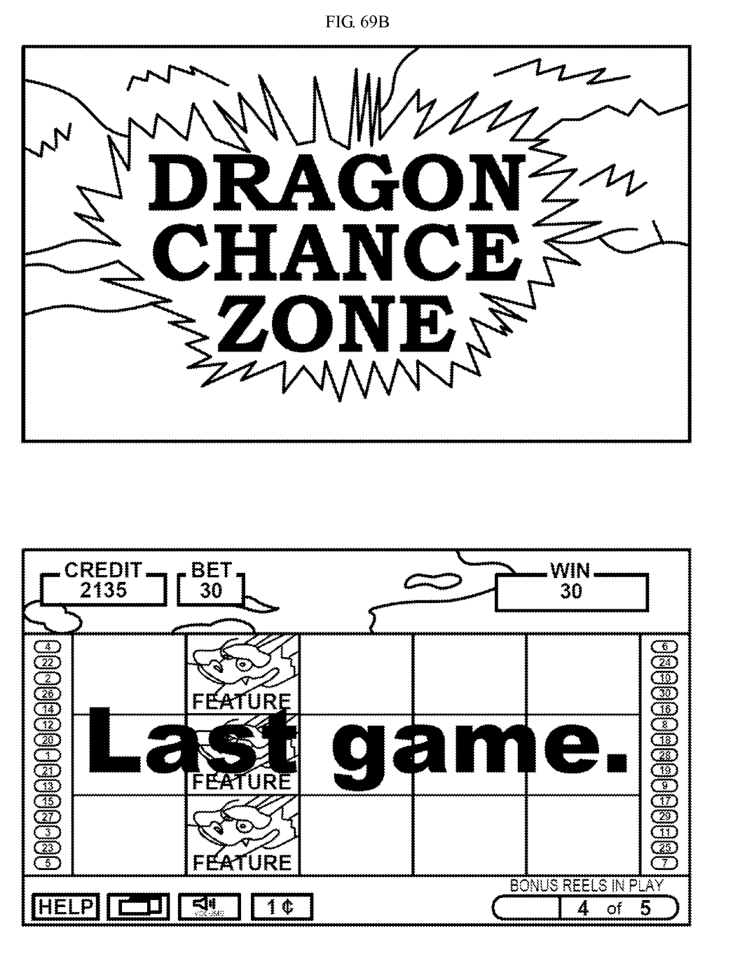

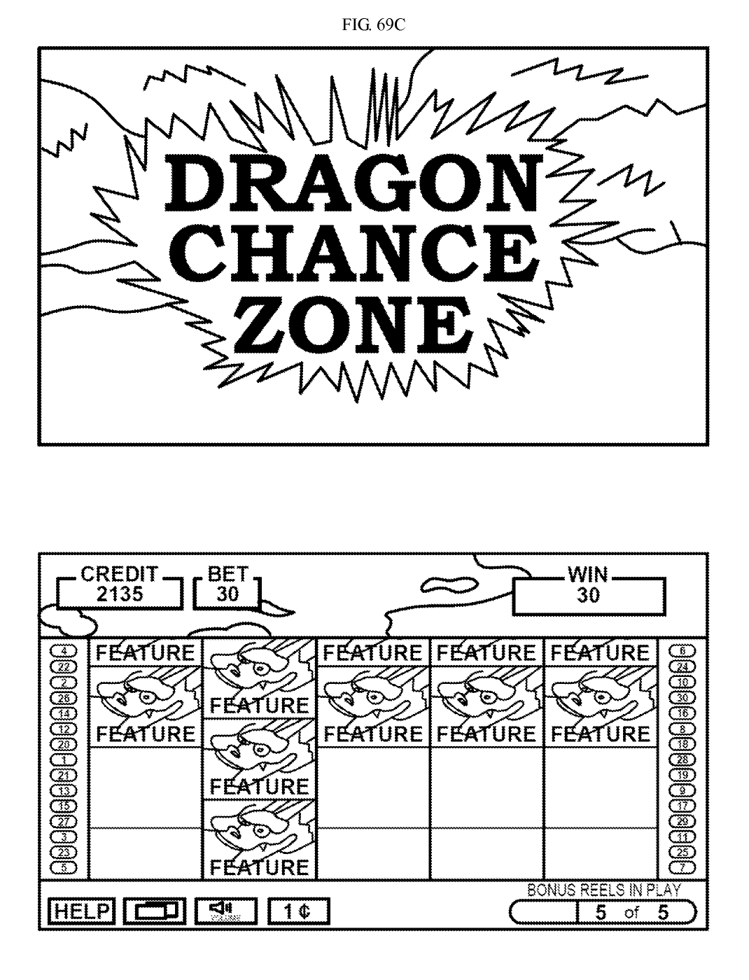

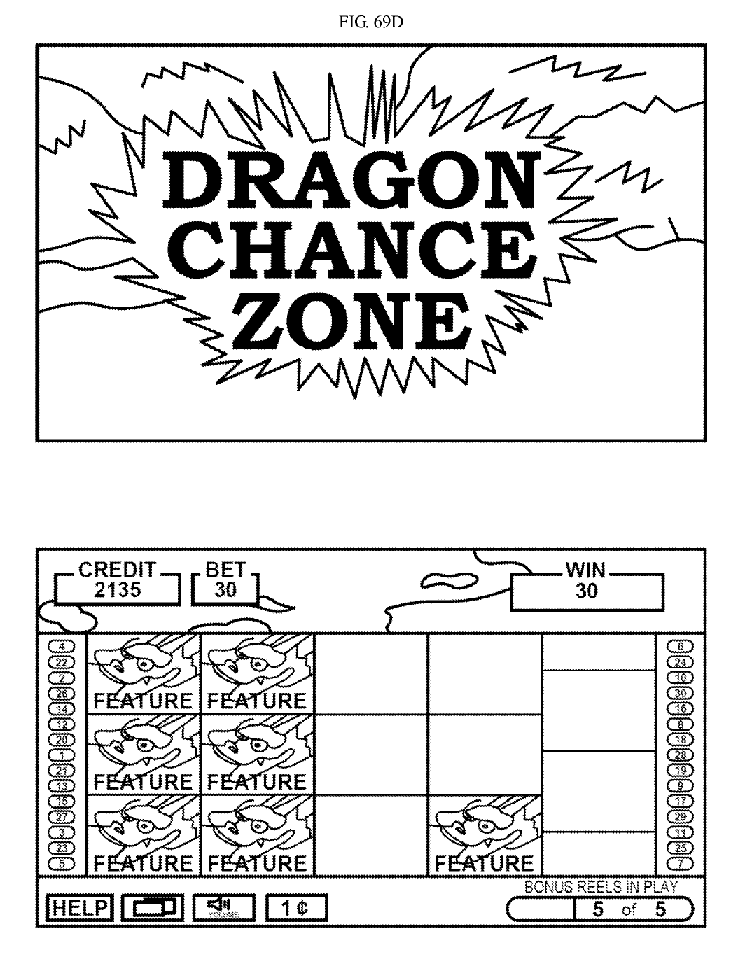

FIG. 58B to FIG. 62B are diagrams illustrating examples of effect images upon starting the chance game mode. FIG. 62C to FIG. 70A are diagrams illustrating an example of a unit game in the chance game mode. Specifically, FIG. 62C to FIG. 66C are diagrams illustrating an example of the first unit game in the chance game mode. FIG. 66D to FIG. 67B are diagrams illustrating an example of the second unit game in the chance game mode. FIG. 67C to FIG. 68A are diagrams illustrating an example of the third unit game in the chance game mode. FIG. 68B to FIG. 69A are diagrams illustrating an example of the fourth unit game in the chance game mode. FIG. 69B to FIG. 70A are diagrams illustrating an example of the fifth unit game in the chance game mode.

FIG. 58B to FIG. 62B are diagrams illustrating the examples of the effect images upon starting the chance game mode. On the upper display device 131, letters indicating “DRAGON CHANCE ZONE” are displayed. This can cause a player to recognize that the chance game mode is started.

First, as shown in FIG. 58B, also on the lower display device 141, letters indicating “DRAGON CHANCE ZONE” are displayed. As shown in FIG. 58C, on the lower display device 141, letters such as CHANCE (an image of a tiger and a symbol of letters “CHANCE”) and “5 CHANCE GAMES” or the like are displayed. As shown in FIG. 58D, on the lower display device 141, letters such as FEATURE (an image of a dragon and a symbols of letters “FEATURE”) and “5 CHANCE GAMES” or the like are displayed.

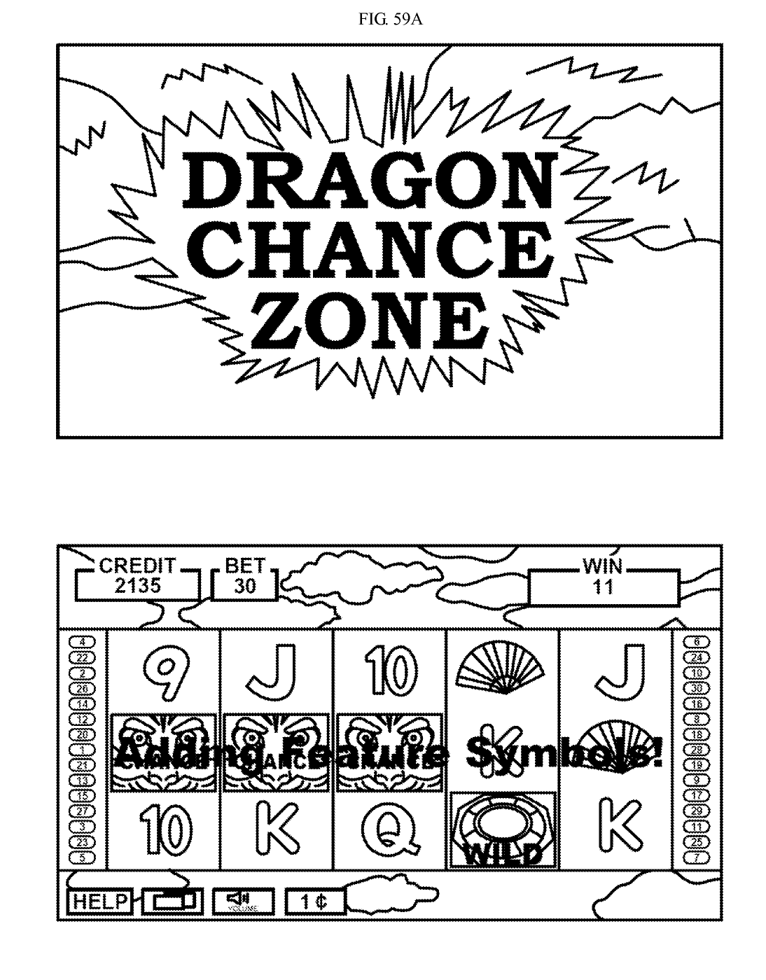

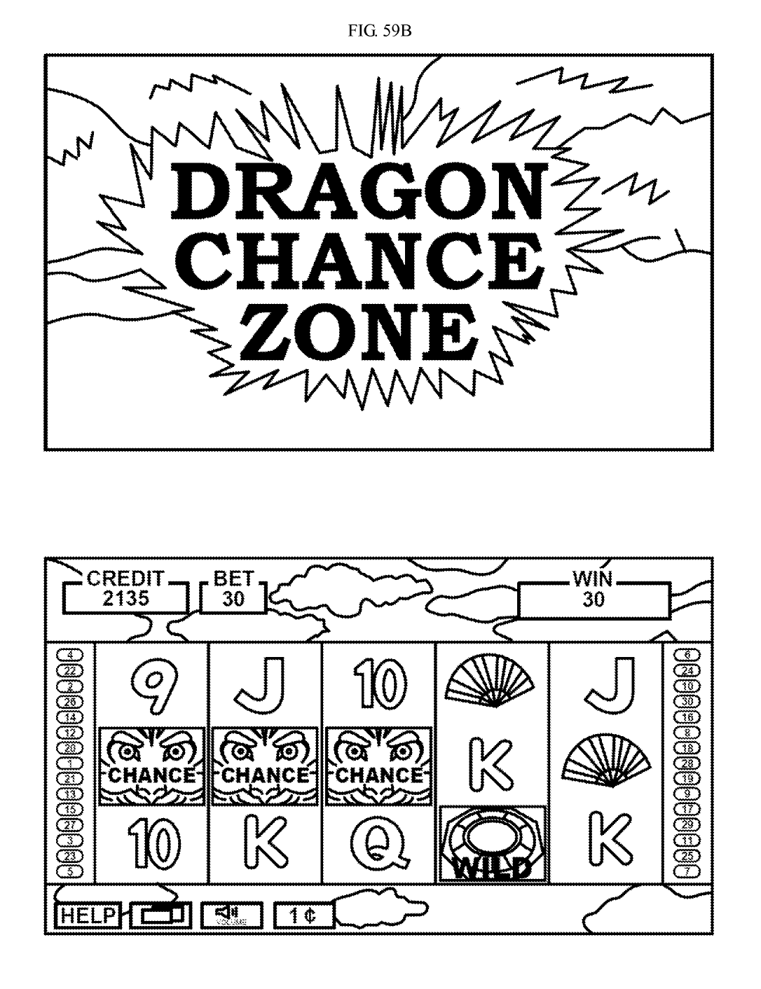

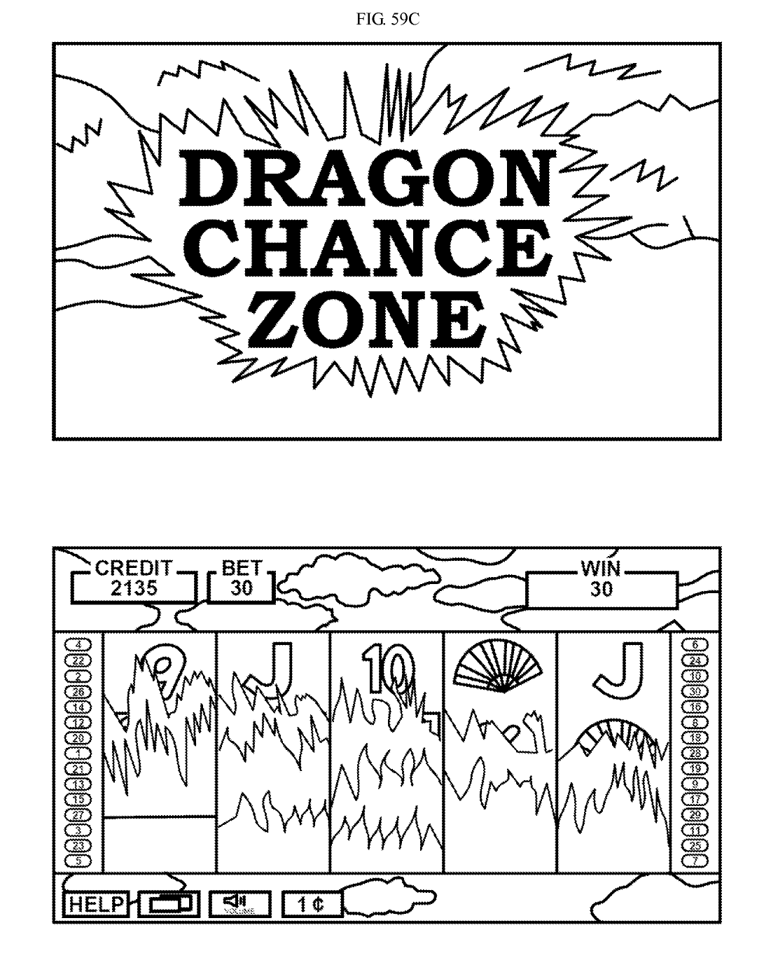

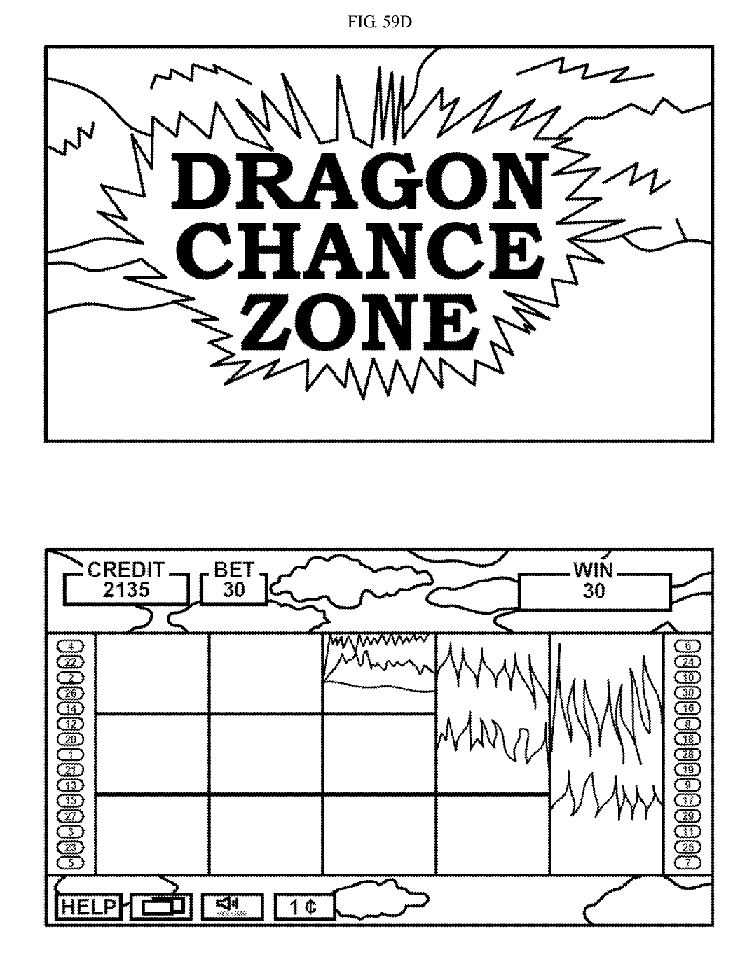

Next, as shown in FIG. 59A and FIG. 59B, on the lower display device 141, the images of five video reels 3a to 3e are displayed. These images are images (refer to FIG. 58A) displayed upon triggering the chance game mode (tiger chance).

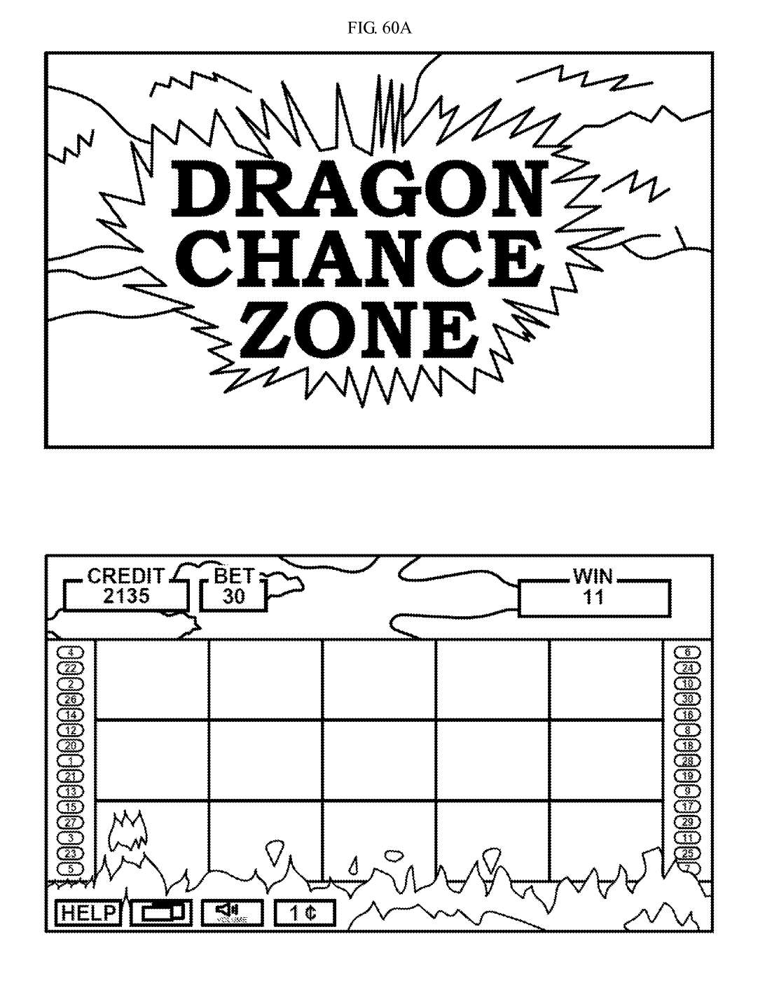

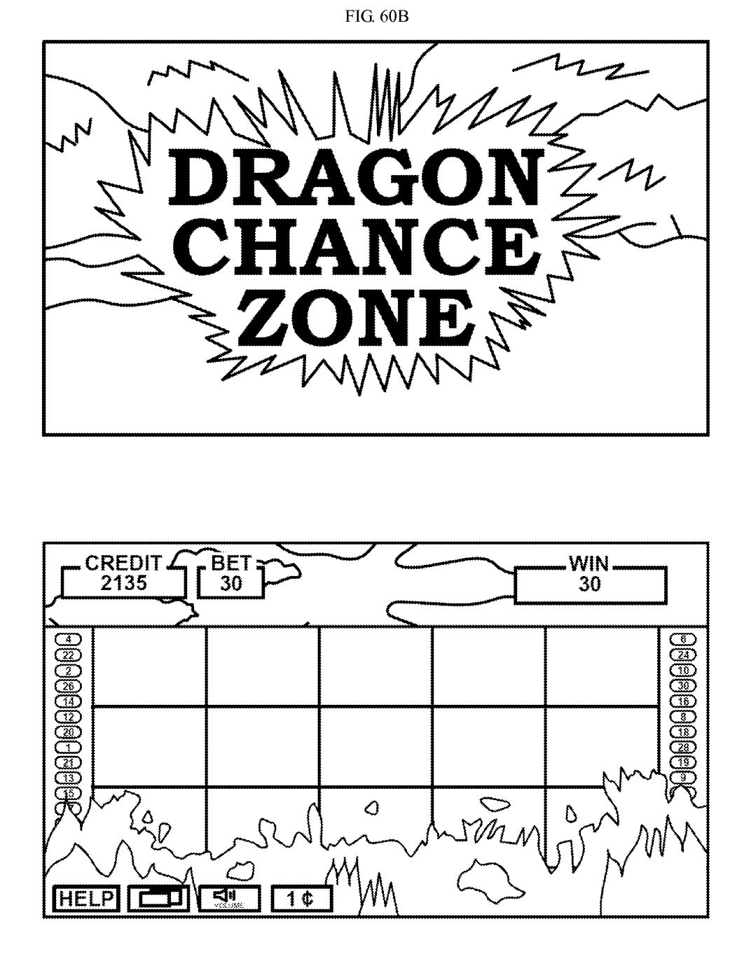

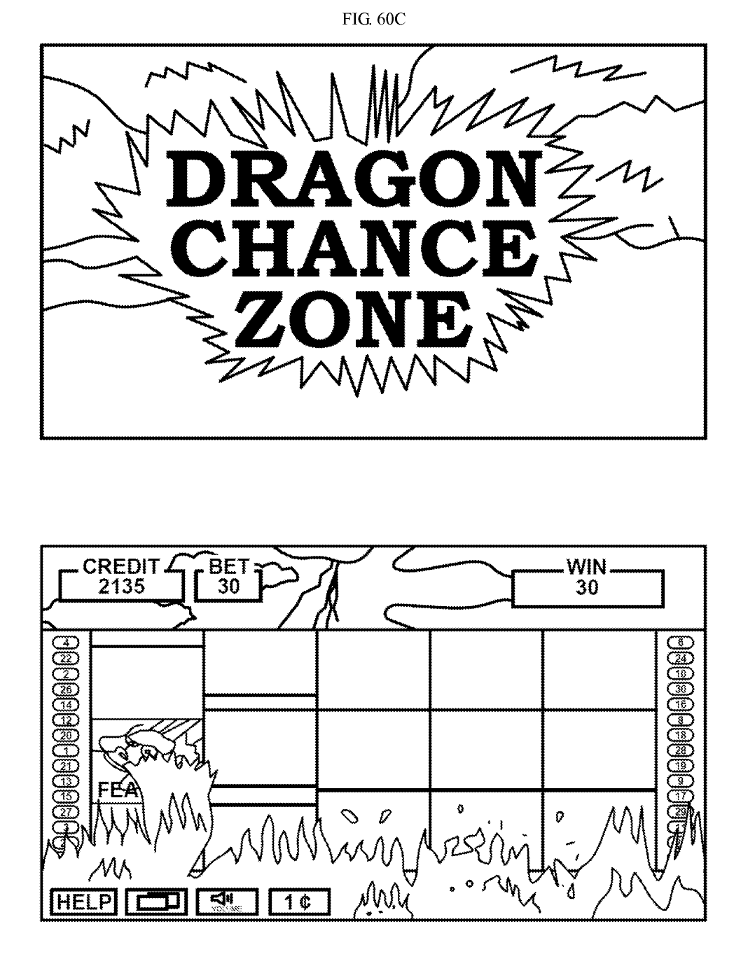

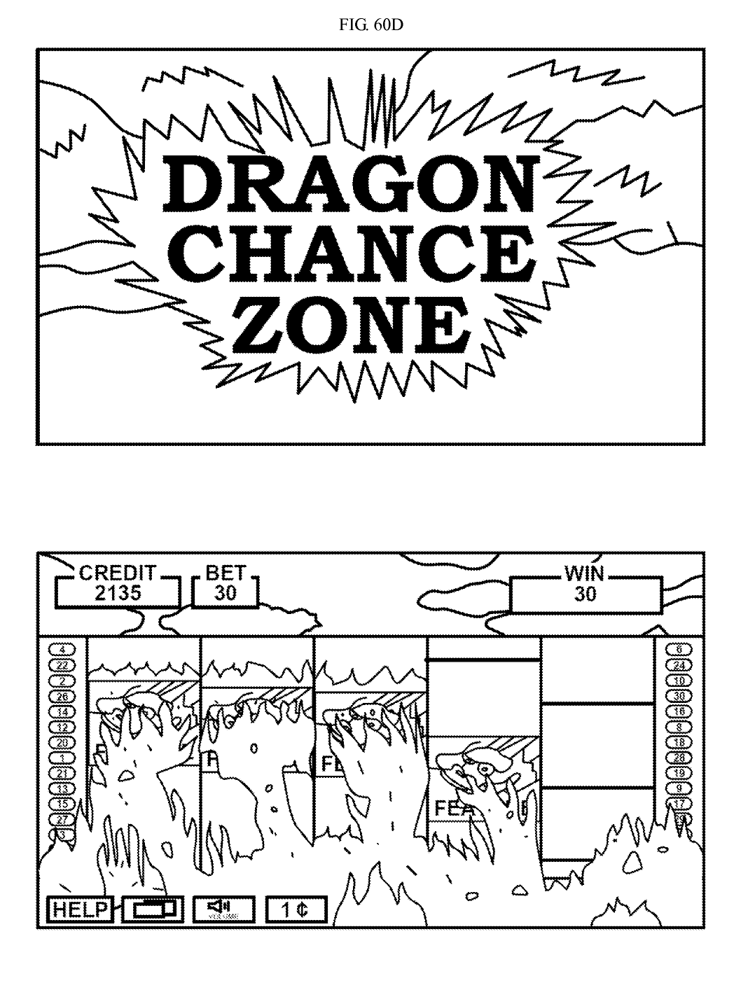

Next, as shown in FIG. 59C to FIG. 60B, effects in which flames are blazing up from lower portions of the five video reels 3a to 3e toward upper portions thereof and all of the displayed symbols disappear are conducted.

Next, as shown in FIG. 60C to FIG. 62A, after all of the symbols have been caused to disappear by the flames, flames are again blazing up from the lower portions of the five video reels 3a to 3e toward the upper portions thereof and the symbols of FEATURE are beginning to be displayed. As shown in FIG. 62B, after the flames have completely ceased, on all of the five video reels 3a to 3e, the symbols of FEATURE are displayed.

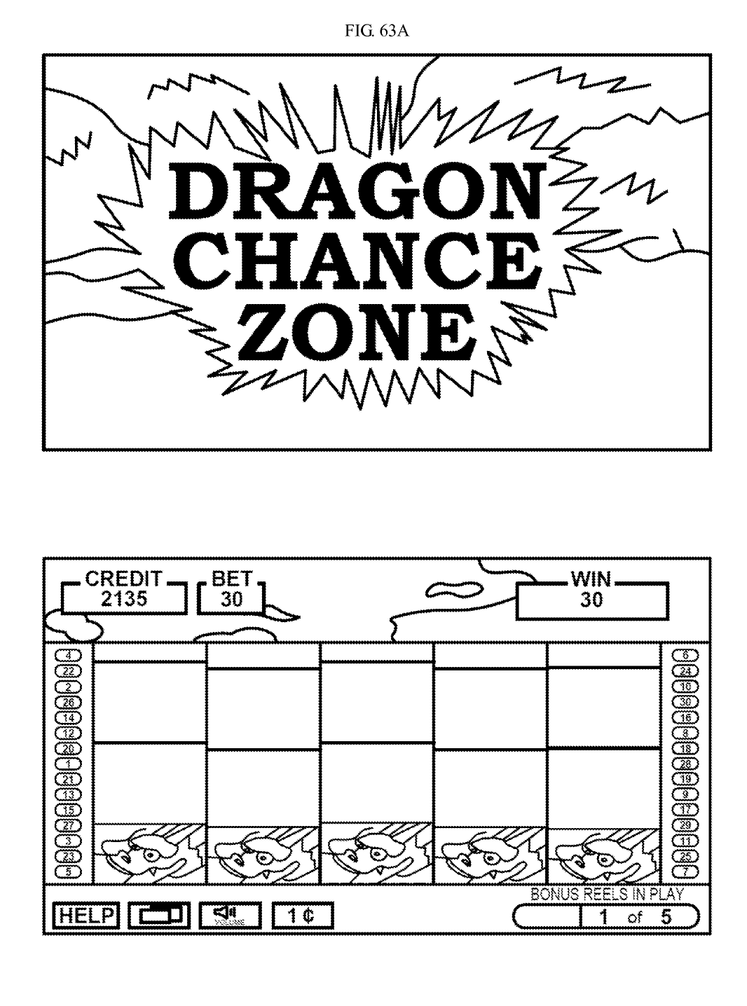

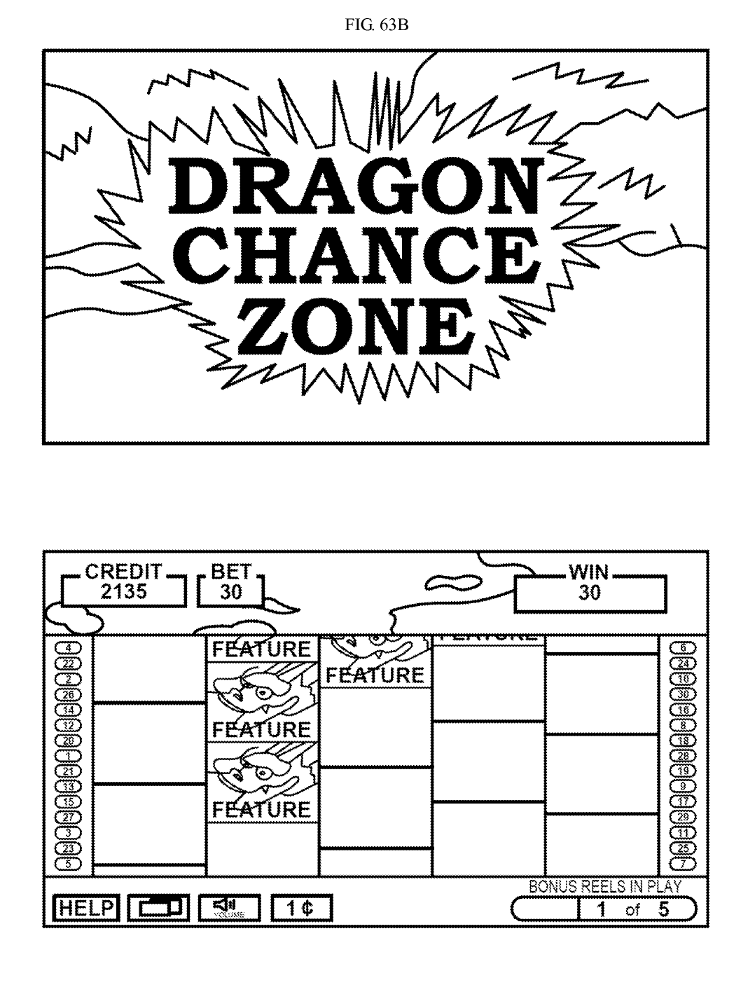

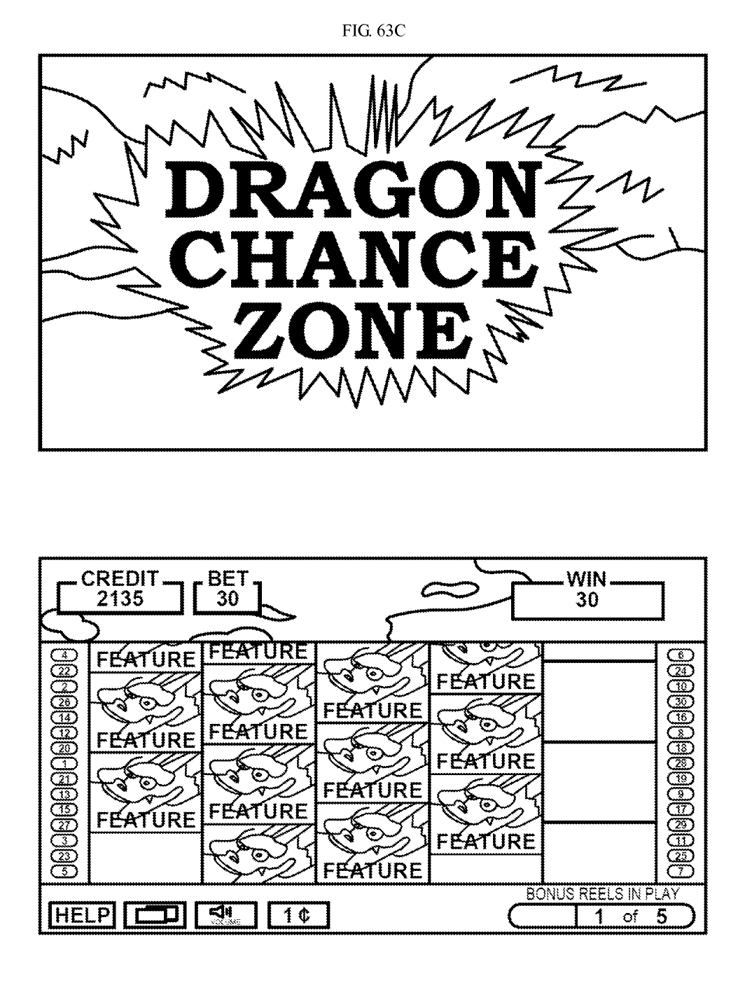

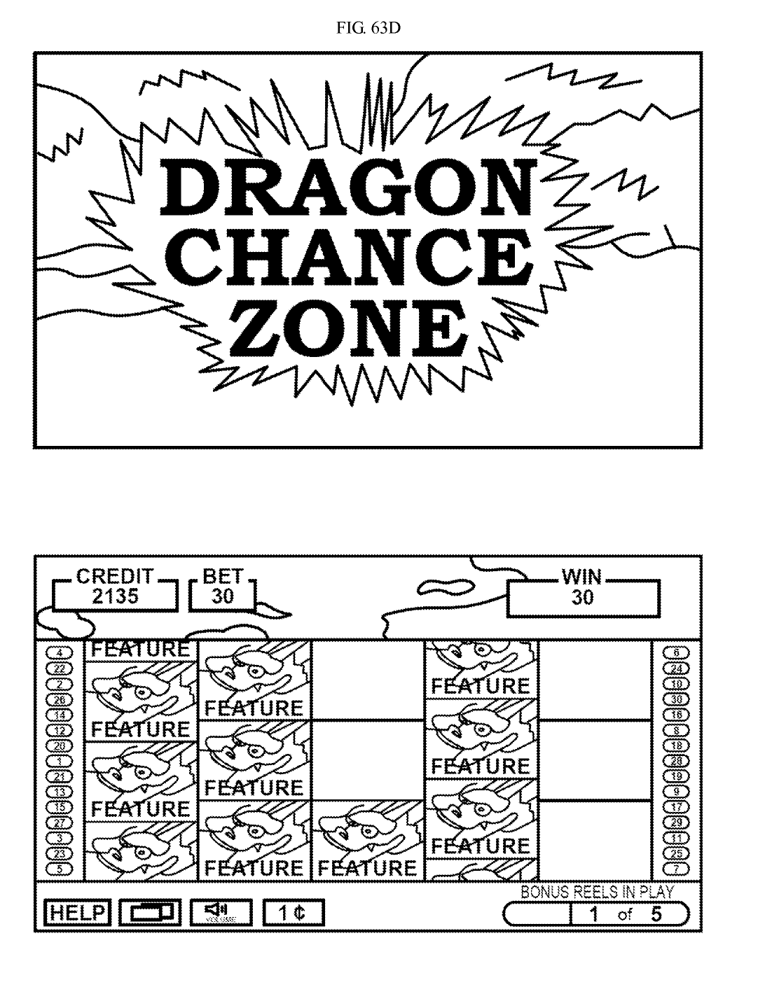

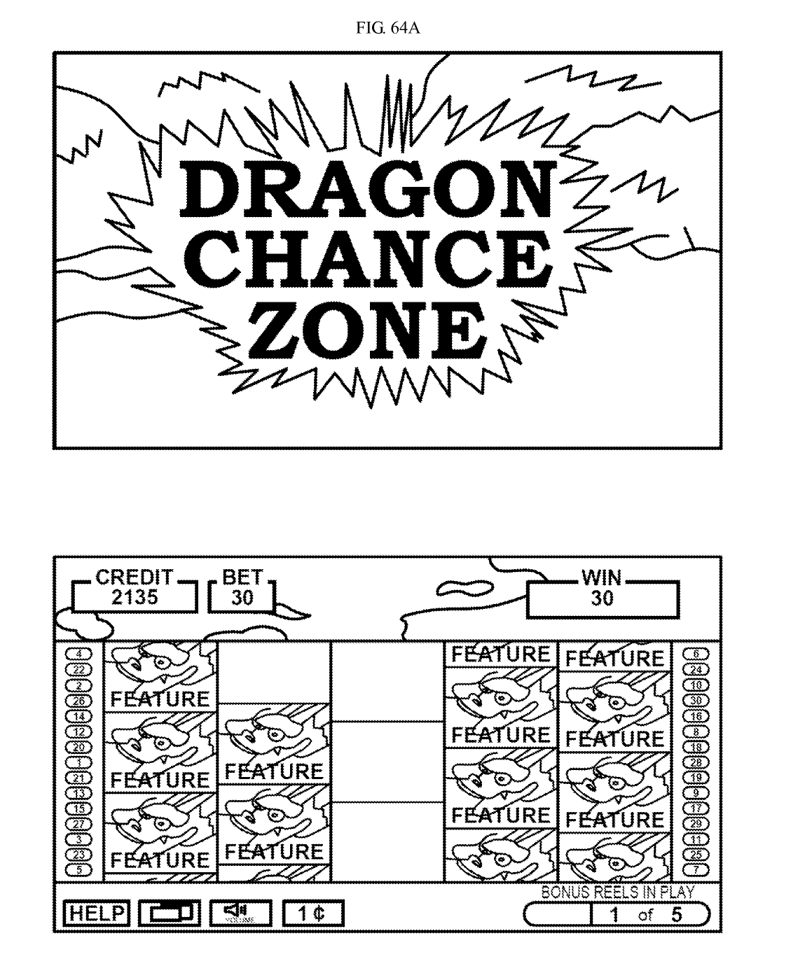

Next, as shown in FIG. 62C to FIG. 66C, the first unit game in the chance game mode is initiated. As described above, in the chance game mode, on all of the video reels 3a to 3e, only two kinds of symbols of FEATURE and BLANK are displayed. As shown in FIG. 63A to FIG. 76A, a white rectangle displayed on each of the video reels 3a to 3e shows BLANK.

As shown in FIG. 62C, on the lower display device 141, letters indicating “DRAGON CHANCE ZONE START” are displayed so as to be superimposed on the symbols of FEATURE.

As shown in FIG. 62D, the letters indicating “DRAGON CHANCE ZONE START” disappear, varying all of the five video reels 3a to 3e is started, and then, the unit game is initiated. As described above, on the respective video reels 3a to 3e used in the unit game in the chance game mode, only two kinds of symbols of FEATURE and BLANK are defined. As shown in FIG. 16 to FIG. 40, each of the video reels 3a to 3e is constituted of blocks in which the symbols of FEATURE are arranged in succession and blocks in which the symbols of BLANK are arranged in succession. Accordingly, when the video reels 3a to 3e are displayed in the varying manner, once the symbols of FEATURE are displayed, the symbols of FEATURE are continuously displayed for a while. Similarly, once the symbols of BLANK are displayed, the symbols of BLANK are continuously displayed for a while.

As shown in FIG. 63A, after the symbols of BLANK have been displayed, the symbols of FEATURE are displayed. Thereafter, as shown in FIG. 63B, on the video reel 3a, the video reel 3d, and the video reel 3e, the symbols of BLANK are continuously displayed, and on the video reel 3b and the video reel 3c, the symbols of FEATURE are beginning to be displayed. Thereafter, as shown in FIG. 63C, also on the video reel 3a and the video reel 3d, the symbols of FEATURE are beginning to be displayed, and on the video reel 3b and the video reel 3c, the symbols of FEATURE are continuously displayed, and on the video reel 3e, the symbols of BLANK are continuously displayed.

As shown in FIG. 63D to FIG. 66C, until the unit game in the chance game mode is finished, that is, until the five video reels 3a to 3e are stopped, the blocks in which the symbols of FEATURE are arranged in succession and the blocks in which the symbols of BLANK are arranged in succession are alternately displayed.

As shown in FIG. 66D, on the lower display device 141, letters indicating “4 games remaining” are displayed, thereby indicating that the number of remaining unit games in the chance game mode is four.

As shown in FIG. 67A and FIG. 67B, varying all of the five video reels 3a to 3e is started, the second unit game is initiated. Similarly, until the five video reels 3a to 3e are stopped, the blocks in which the symbols of FEATURE are arranged in succession and the blocks in which the symbols of BLANK are arranged in succession are alternately displayed.

Next, as shown in FIG. 67C, on the lower display device 141, letters indicating “3 games remaining” are displayed, thereby indicating that the number of remaining unit games in the chance game mode is three.

As shown in FIG. 67D and FIG. 68A, varying all of the five video reels 3a to 3e is started, the third unit game is initiated. Similarly, until the five video reels 3a to 3e are stopped, the blocks in which the symbols of FEATURE are arranged in succession and the blocks in which the symbols of BLANK are arranged in succession are alternately displayed.

Next, as shown in FIG. 68B, on the lower display device 141, letters indicating “2 games remaining” are displayed, thereby indicating that the number of remaining unit games in the chance game mode is two.

As shown in FIG. 68C to FIG. 69A, varying all of the five video reels 3a to 3e is started, the fourth unit game is initiated. Similarly, until the five video reels 3a to 3e are stopped, the blocks in which the symbols of FEATURE are arranged in succession and the blocks in which the symbols of BLANK are arranged in succession are alternately displayed.

Next, as shown in FIG. 69B, on the lower display device 141, letters “Last game.” are displayed, thereby indicating that the unit game to be played is the (fifth) last unit game in the chance game mode.

As shown in FIG. 69C to FIG. 70A, varying all of the five video reels 3a to 3e is started, the fifth unit game is initiated. Similarly, until the five video reels 3a to 3e are stopped, the blocks in which the symbols of FEATURE are arranged in succession and the blocks in which the symbols of BLANK are arranged in succession are alternately displayed.

As shown in FIG. 70A, at the time point at which the fifth unit game has been finished, three symbols of FEATURE are displayed on each of the video reel 3a and the video reel 3b and two symbols of FEATURE are displayed on the video reel 3e. As described above, when it is determined by the symbol drawing process that on each of the three video reels, the symbols of FEATURE appear in the symbol display region 141d, a winning pattern is established. Accordingly, in the fifth unit game, the winning pattern of the symbols of FEATURE is established, and the free game mode is thereby triggered.

As shown in FIG. 70A, on the lower display device 141, letters indicating “YOU GOT FREE GAMES” are displayed, thereby indicating that the free game mode is triggered. This can cause a player to recognize that the free game mode is triggered.

<<Examples of Images in Free Game Mode (Dragon Free Games)>>

As described above, the winning pattern of FEATURE is established, thereby shifting the game mode to a free game mode.

FIG. 70B to FIG. 82 are diagrams illustrating examples of images in the free game mode. FIG. 70B is a diagram illustrating an example of an effect image upon starting the free game mode. FIG. 70C to FIG. 76A are diagrams illustrating examples of images displayed when a maximum number of unit games in the free game mode is determined. FIG. 76B is a diagram illustrating an example of an effect image upon initiating a unit game in the free game mode. FIG. 76C to FIG. 82 are diagrams illustrating examples of unit games in the free game mode.

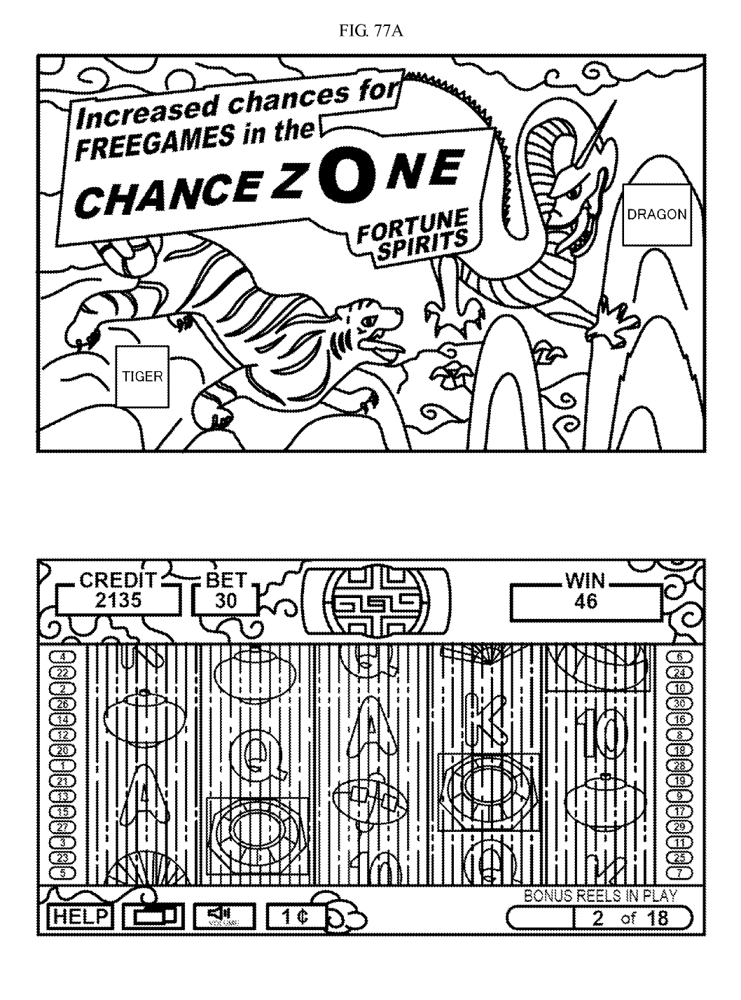

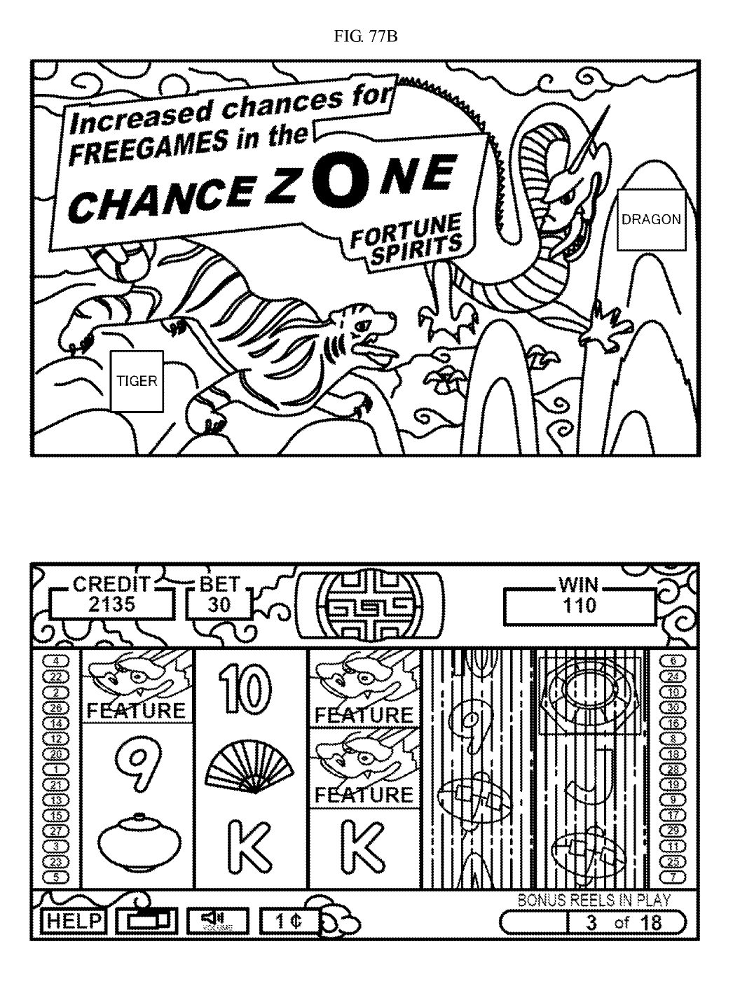

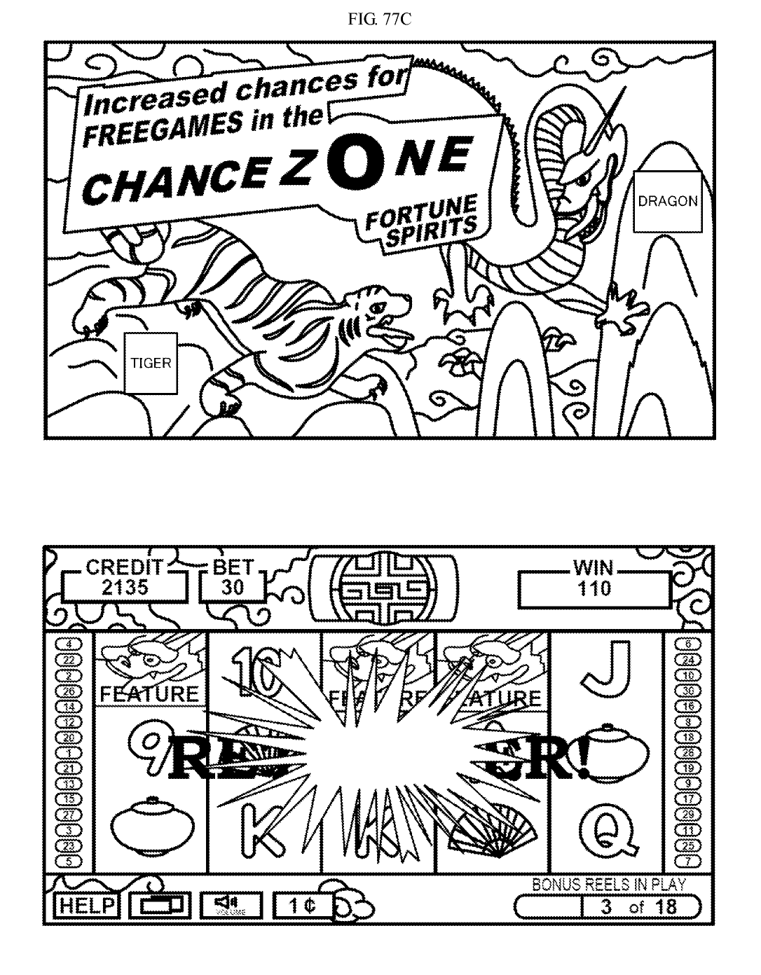

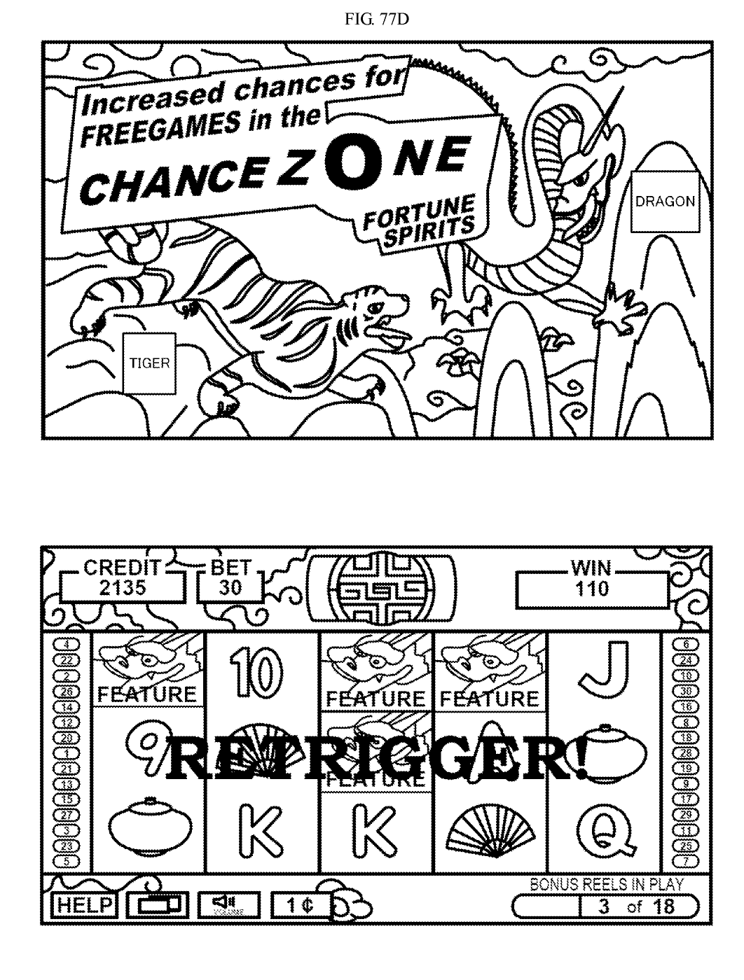

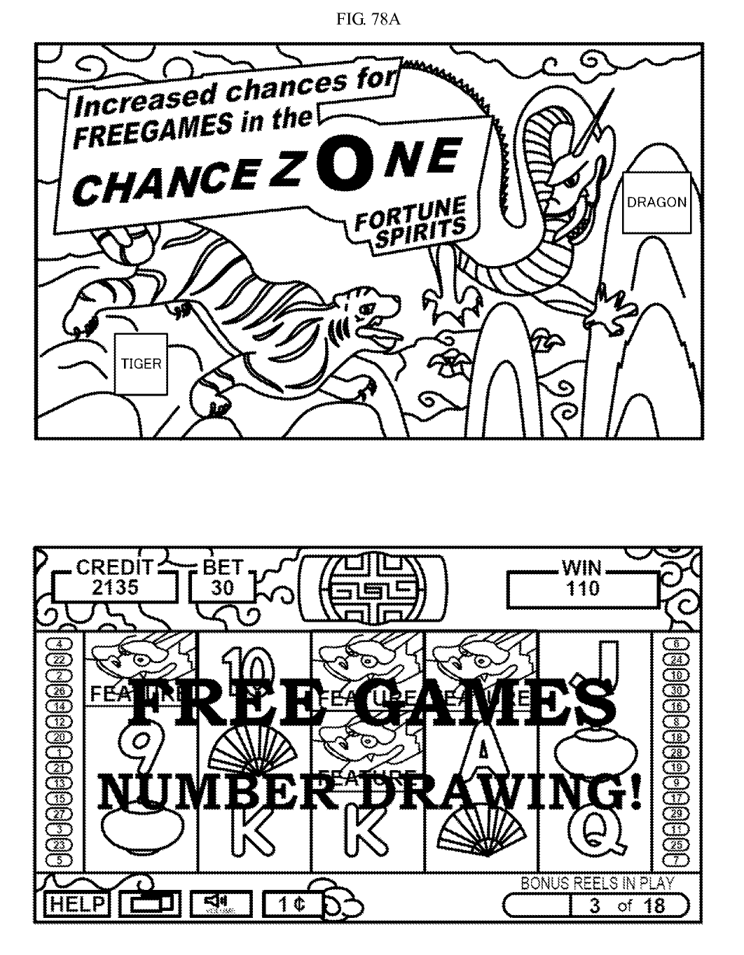

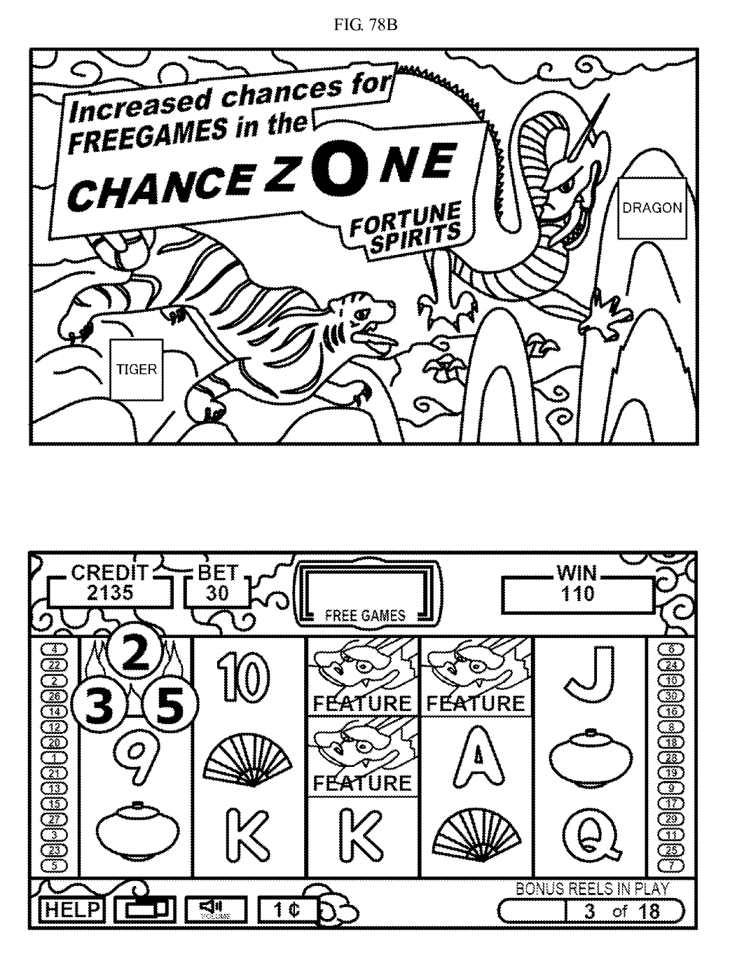

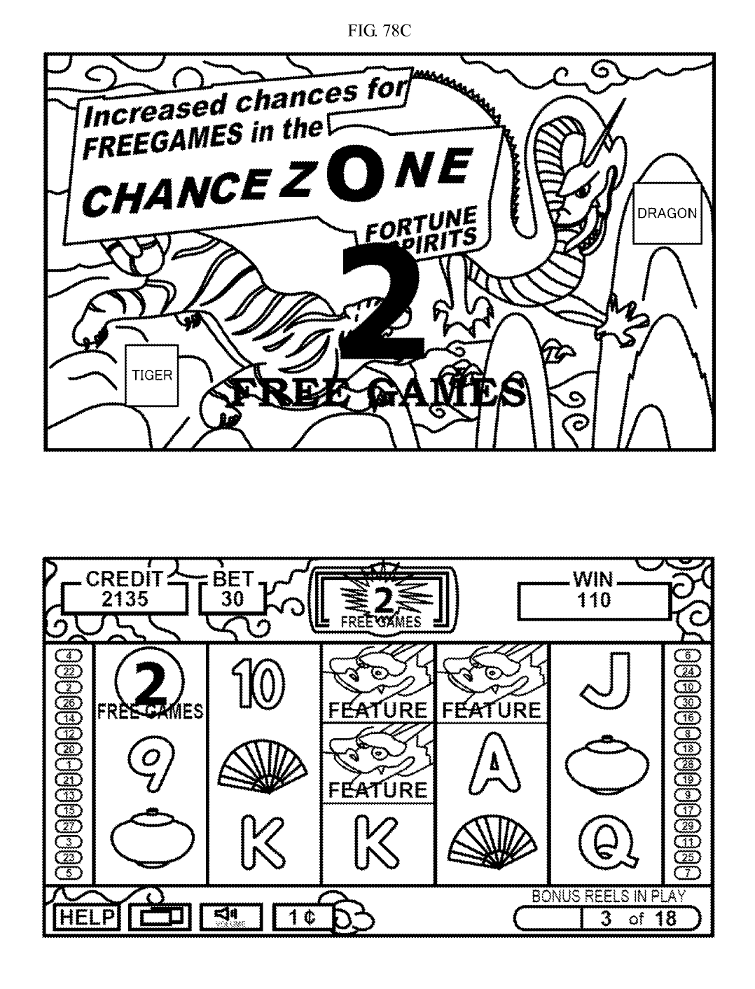

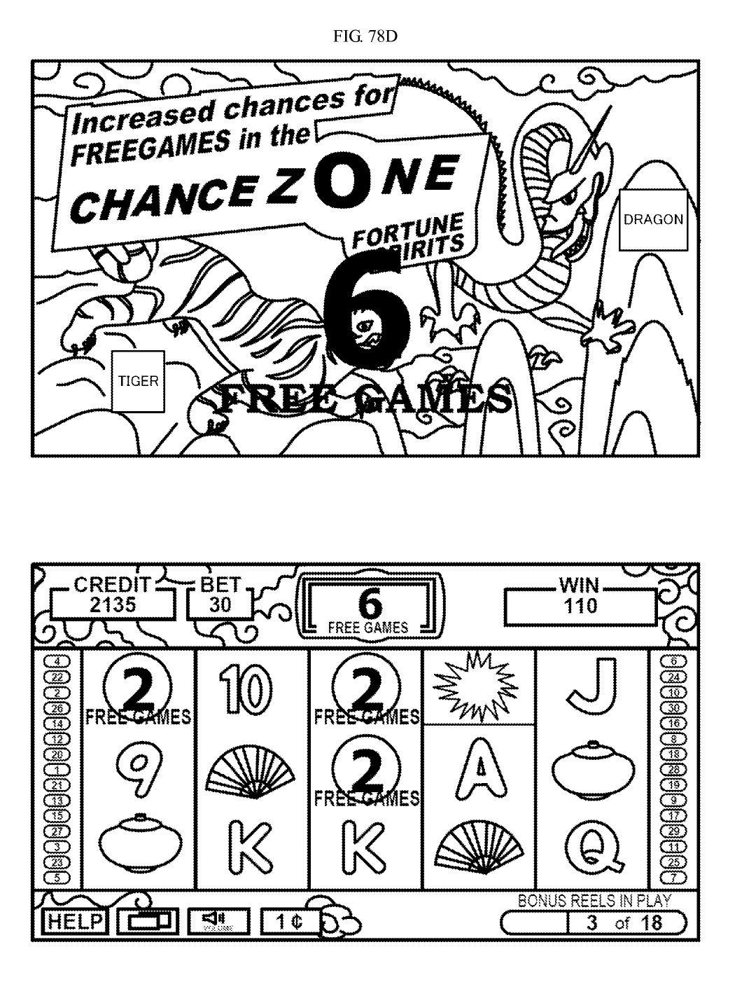

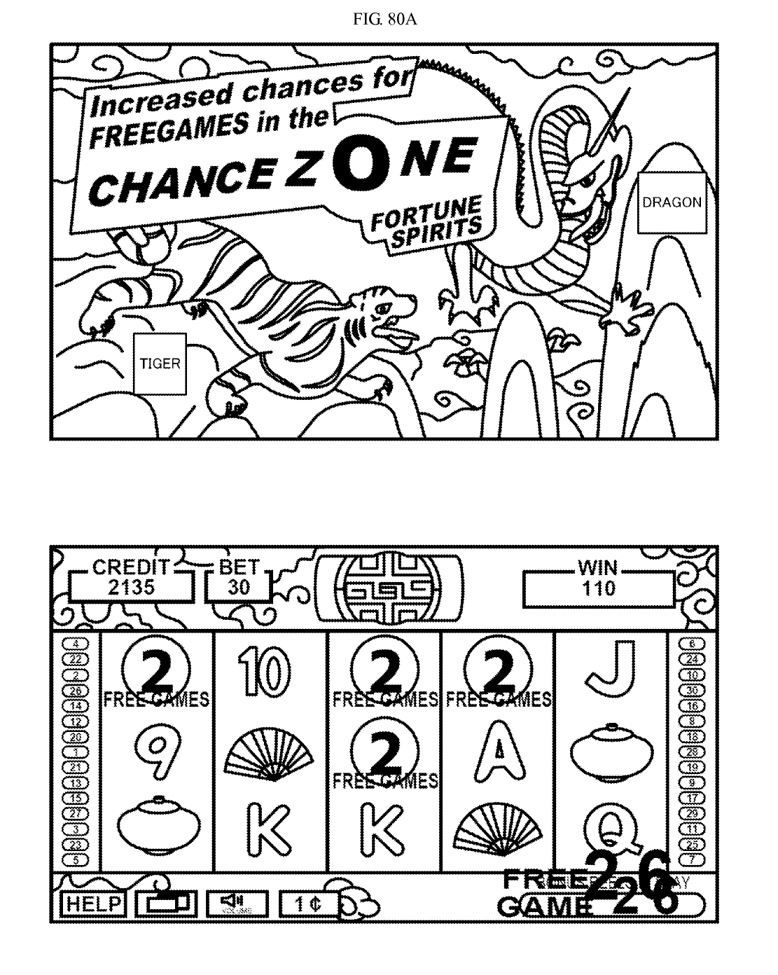

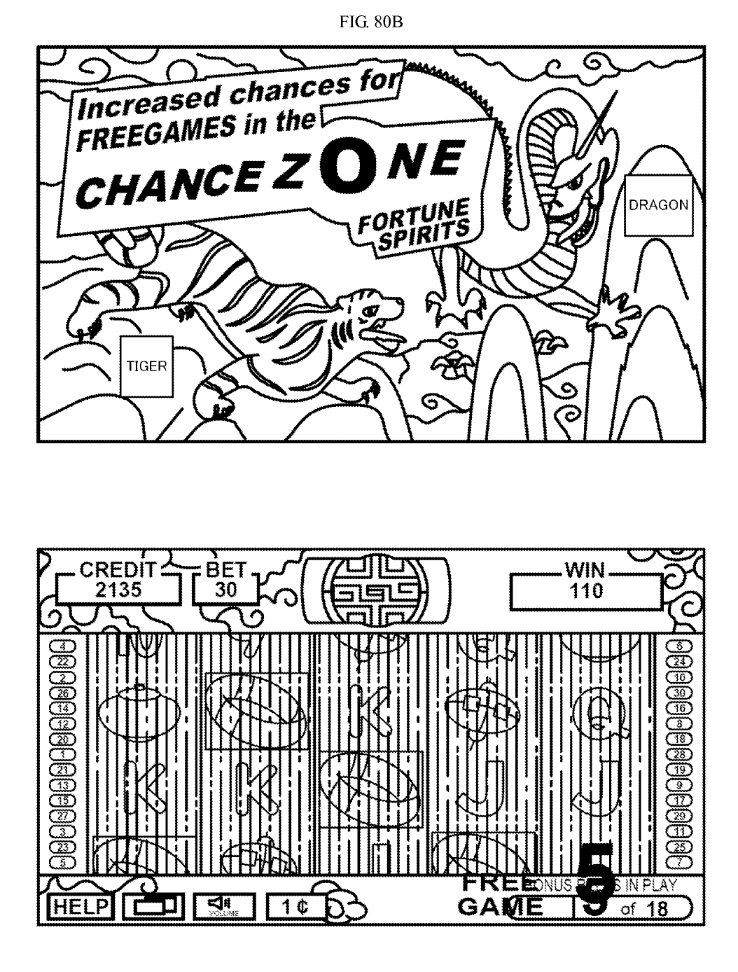

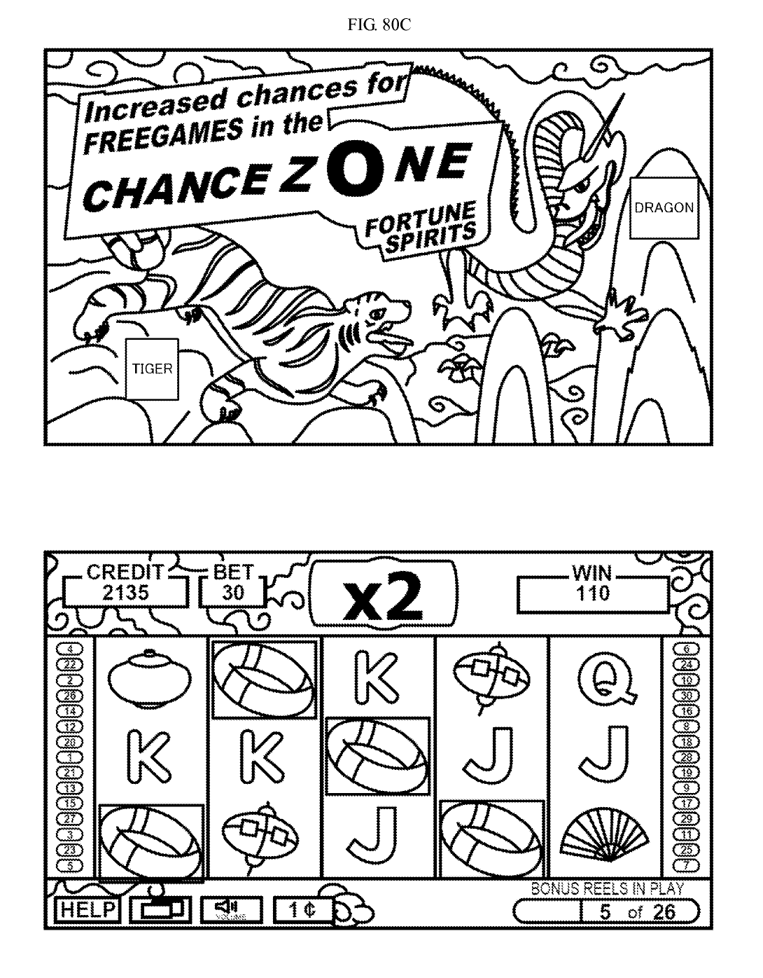

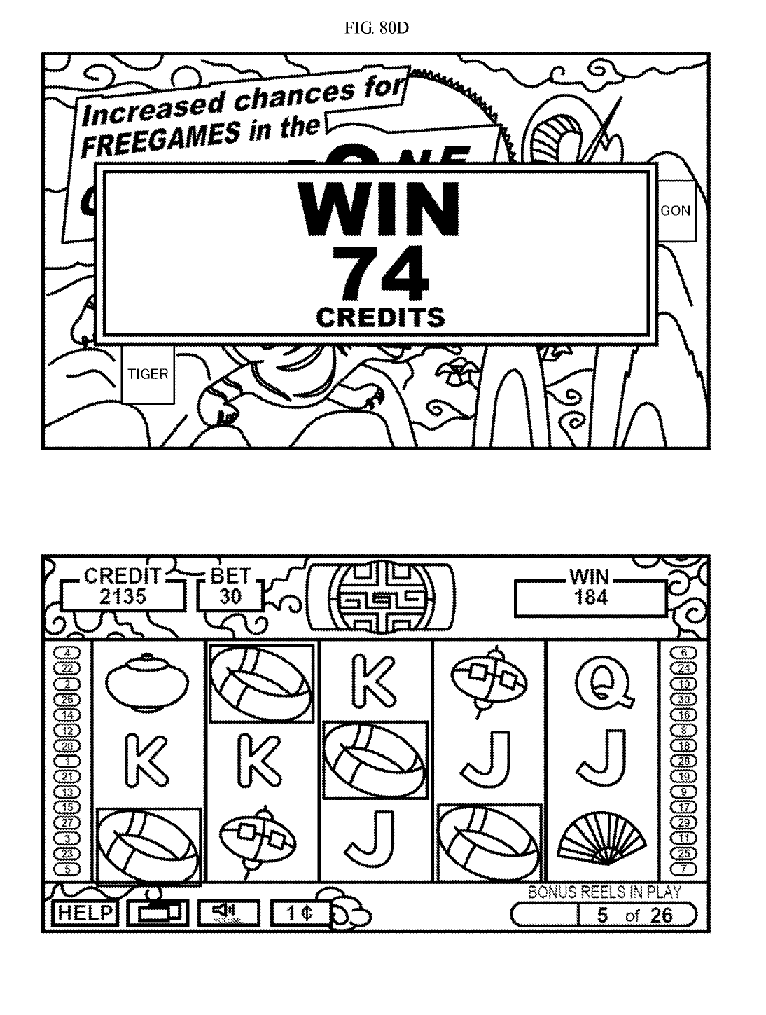

FIG. 76C and FIG. 76D are diagrams each illustrating an example of the first unit game in the free game mode. FIG. 77A and FIG. 77D are diagrams each illustrating an example of the second unit game in the free game mode. FIG. 78B to FIG. 80A are diagrams illustrating examples of images displayed when a retrigger of the free game mode (dragon free games) is established, whereby a maximum number of unit games in the free game mode is newly determined FIG. 80B to FIG. 82 are diagrams each illustrating an example of unit games after the retrigger of the free game mode has been established.

As shown in FIG. 70B, when the free game mode is started, letters indicating “FREE GAMES NUMER DRAWING” are displayed, and a process for determining a maximum number of unit games in the free game mode is executed.

As shown in FIG. 70C, in an upper row of the video reel 3a, the numbers of “2”, “3”, and “5” are displayed so as to be superimposed on the symbol of FEATURE while being rotated. As shown in FIG. 70D, after a while, on the upper row of the video reel 3a, only the number of “2” is displayed so as to be larger than in FIG. 70C. As described above, with respect to the symbol of FEATURE in the upper row of the video reel 3a, the number of games is determined as 2. On the upper display device 131, letters indicating “FREE GAMES 2 FREE GAMES” are displayed.

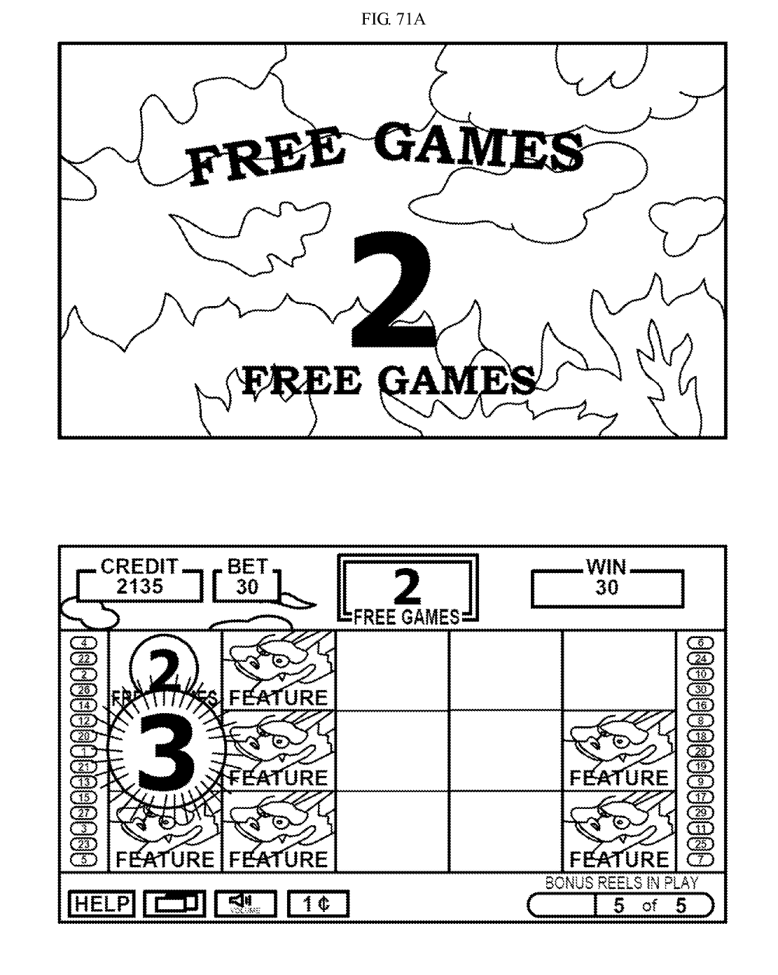

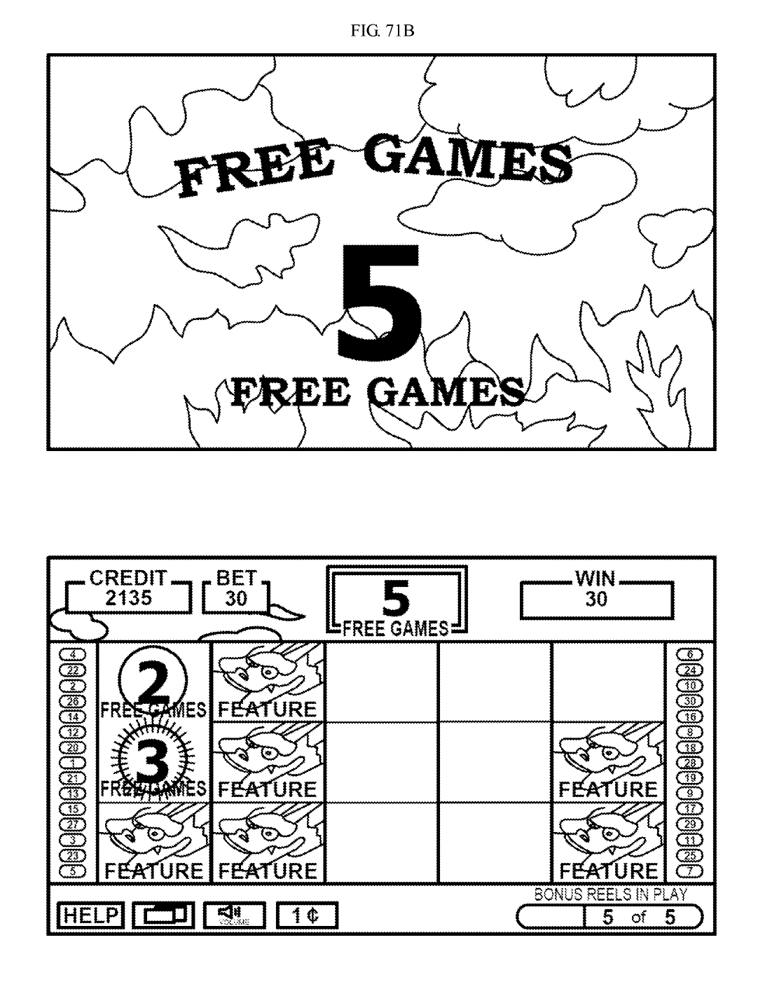

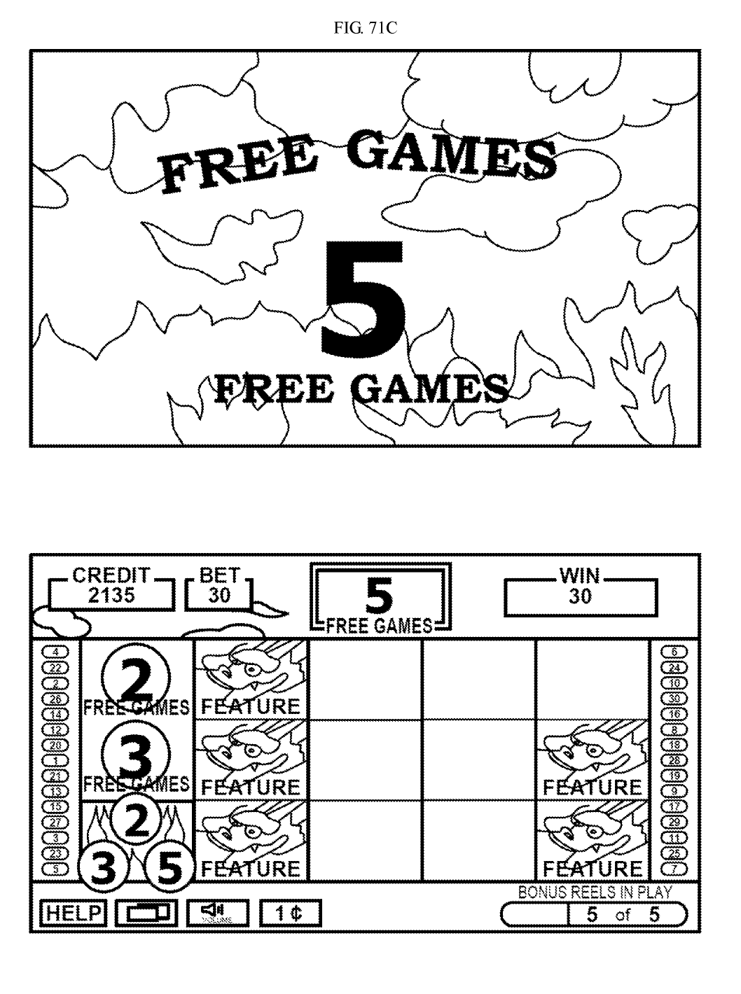

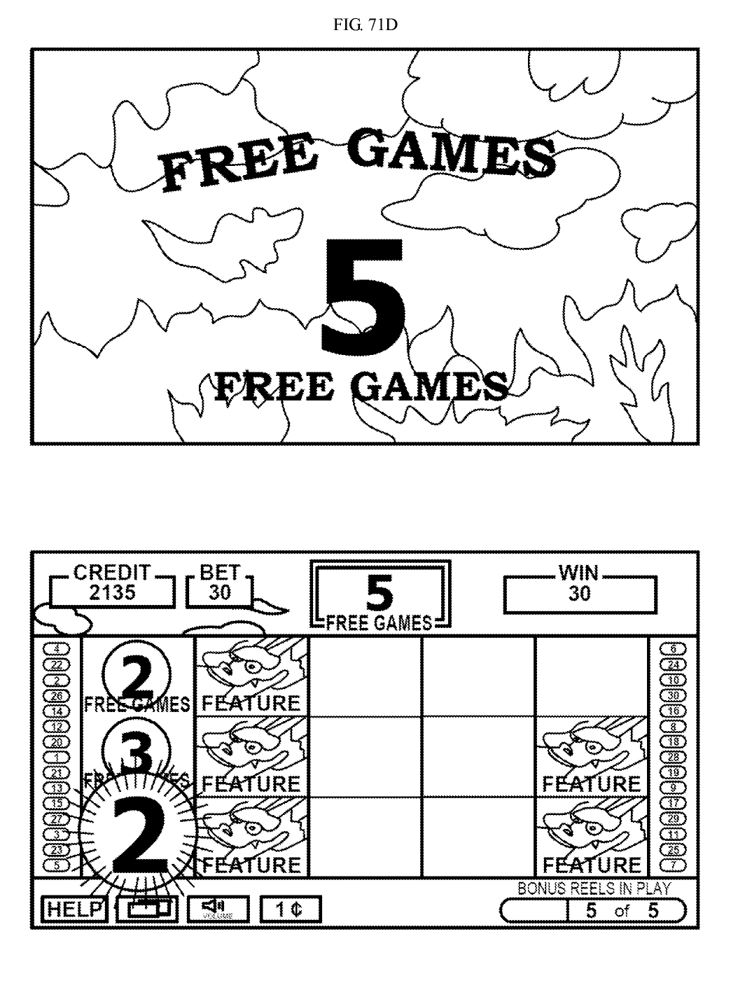

Next, as shown in FIG. 70D, in a middle row of the video reel 3a, similarly, the numbers of “2”, “3”, and “5” are displayed so as to be superimposed on the symbol of FEATURE while being rotated. As shown in FIG. 71A and FIG. 71B, after a while, in the middle row of the video reel 3a, only the number of “3” is displayed so as to be larger than in FIG. 70D. As described above, with respect to the symbol of FEATURE in the middle row of the video reel 3a, the number of games is determined as 3. As shown in FIG. 71B, on the upper display device 131, letters indicating “FREE GAMES 5 FREE GAMES” are displayed. This 5 indicates the sum of 2 and 3 and shows that at this point in time, the number of unit games in the free game mode is 5.

Next, as shown in FIG. 71C, in a lower row of the video reel 3a, similarly, the numbers of “2”, “3”, and “5” are displayed so as to be superimposed on the symbol of FEATURE while being rotated. As shown in FIG. 71D and FIG. 71A, after a while, in the lower row of the video reel 3a, only the number of “2” is displayed so as to be larger than in FIG. 71C. With respect to the symbol of FEATURE in the lower row of the video reel 3a, the number of games is determined as 2.

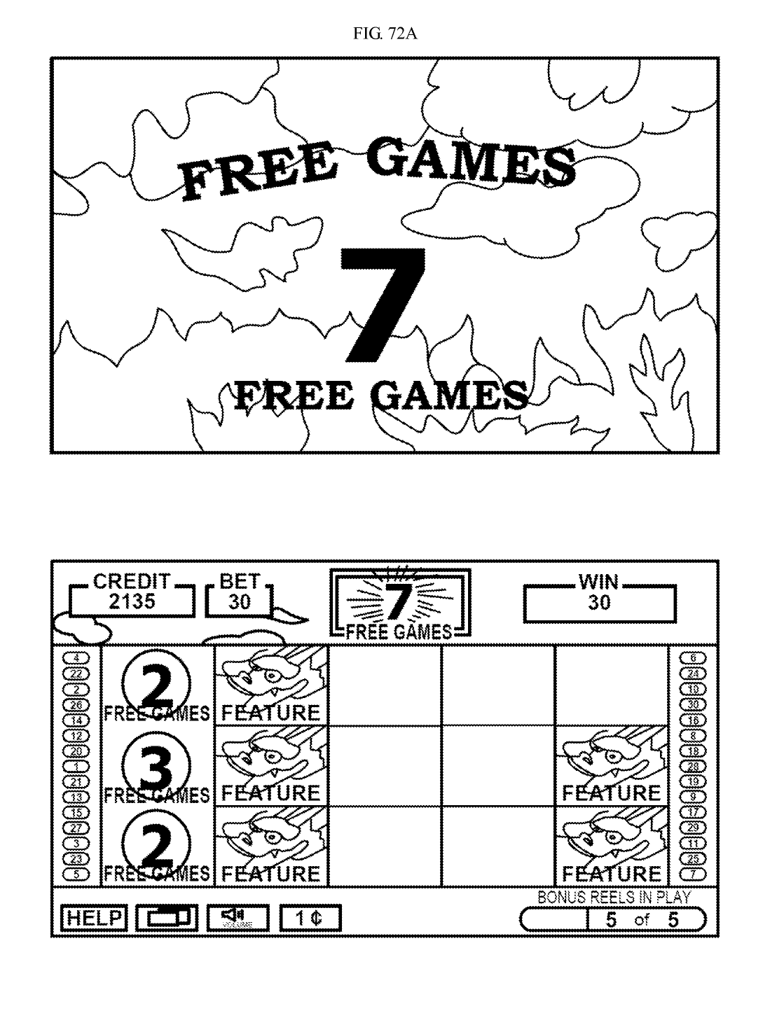

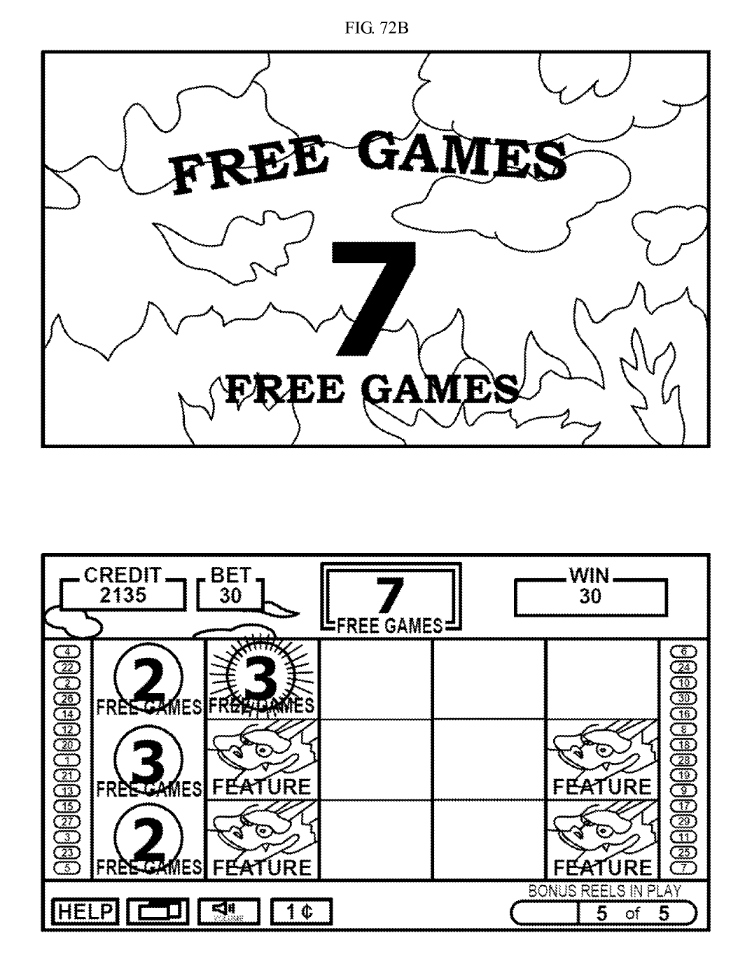

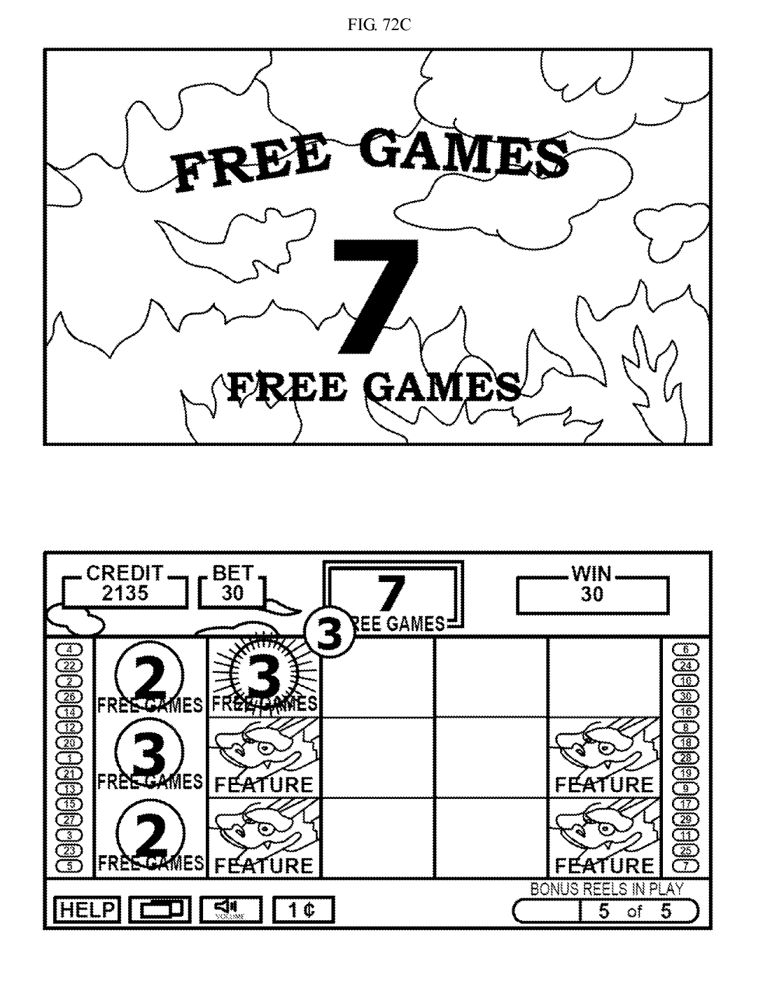

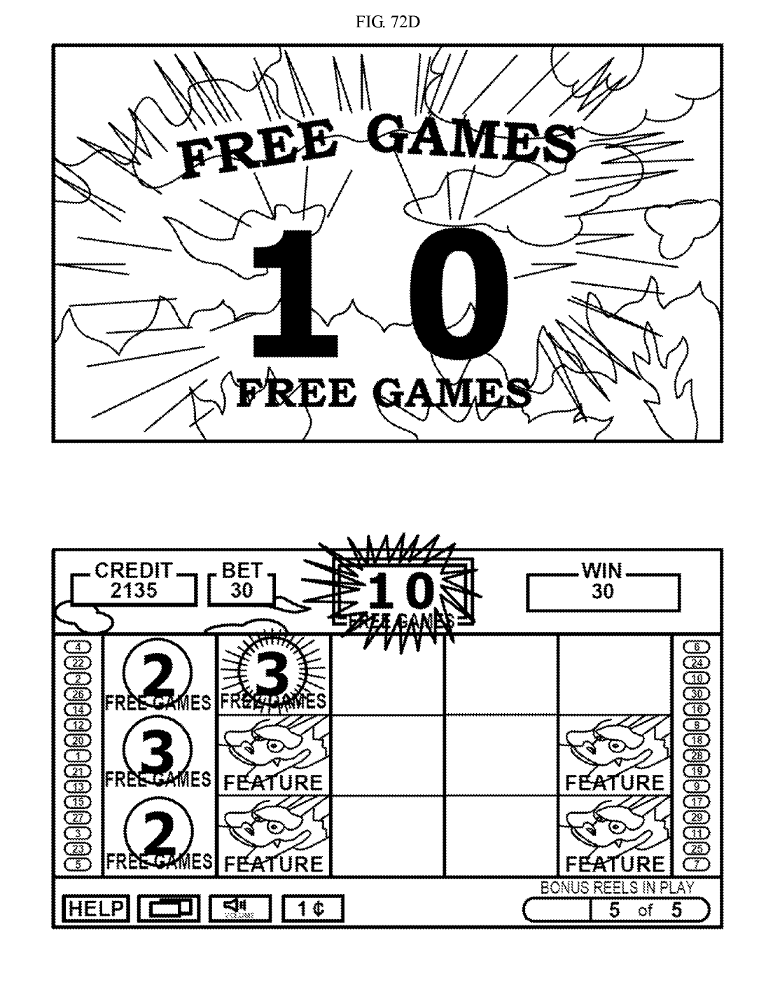

As shown in FIG. 72A, on the upper display device 131, letters “FREE GAMES 7 FREE GAMES” are displayed. This 7 indicates the sum of 2, 3, and 2 and shows that at this point in time, the number of unit games in the free game mode is 7.

Next, as shown in FIG. 72B, in an upper row of the video reel 3b, the number of “3” is displayed. Unlike the case of the video reel 3a, the numbers of “2”, “3”, and “5” are not displayed in the rotated manner, and the number of “3” is directly displayed.

Next, as shown in FIG. 72C, in addition to the number of “3” in the upper row of the video reel 3b, the small number of “3” is displayed while moving.

As shown in FIG. 72D, on the upper display device 131, letters indicating “FREE GAMES 10 FREE GAMES” are displayed. This 10 indicates the sum of 2, 3, 2, and 3 and shows that at this point in time, the number of unit games in the free game mode is 10.

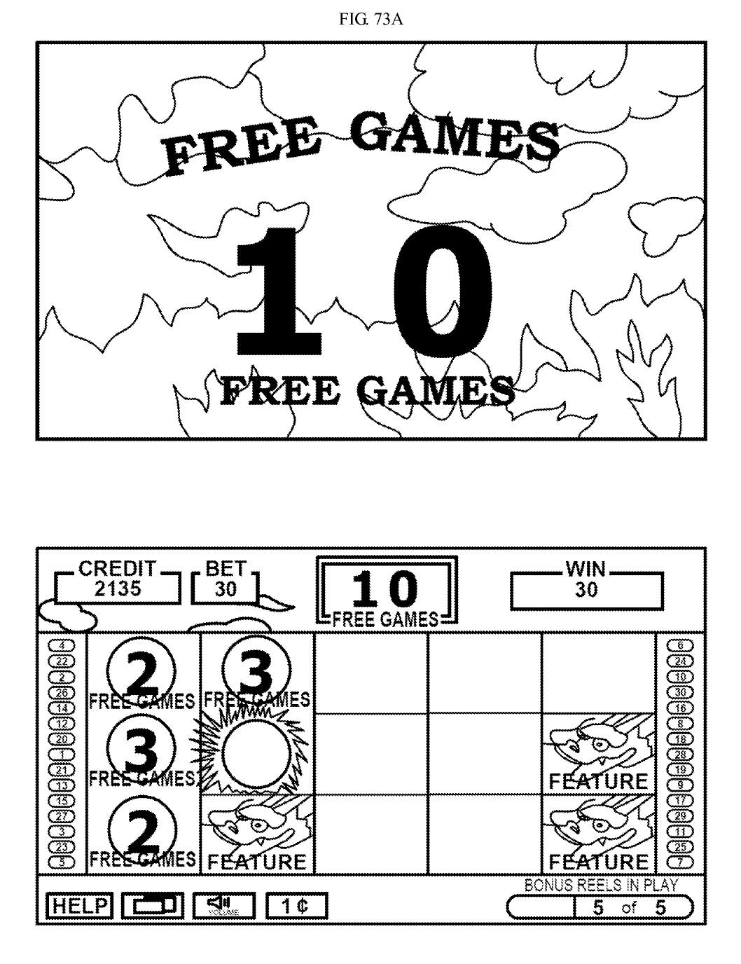

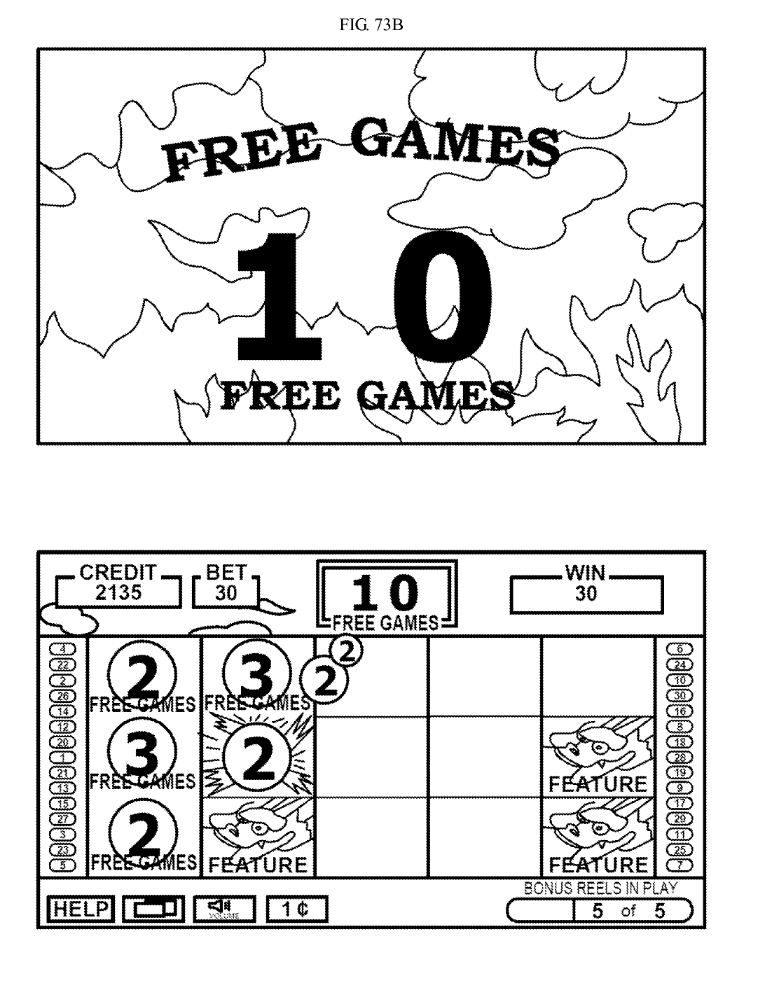

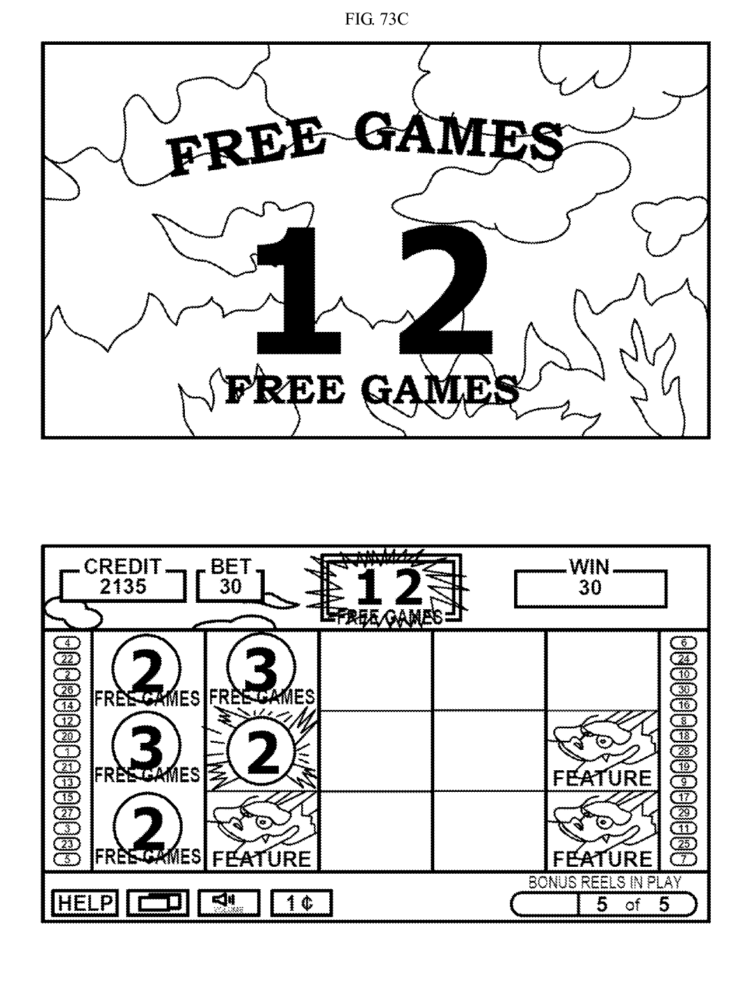

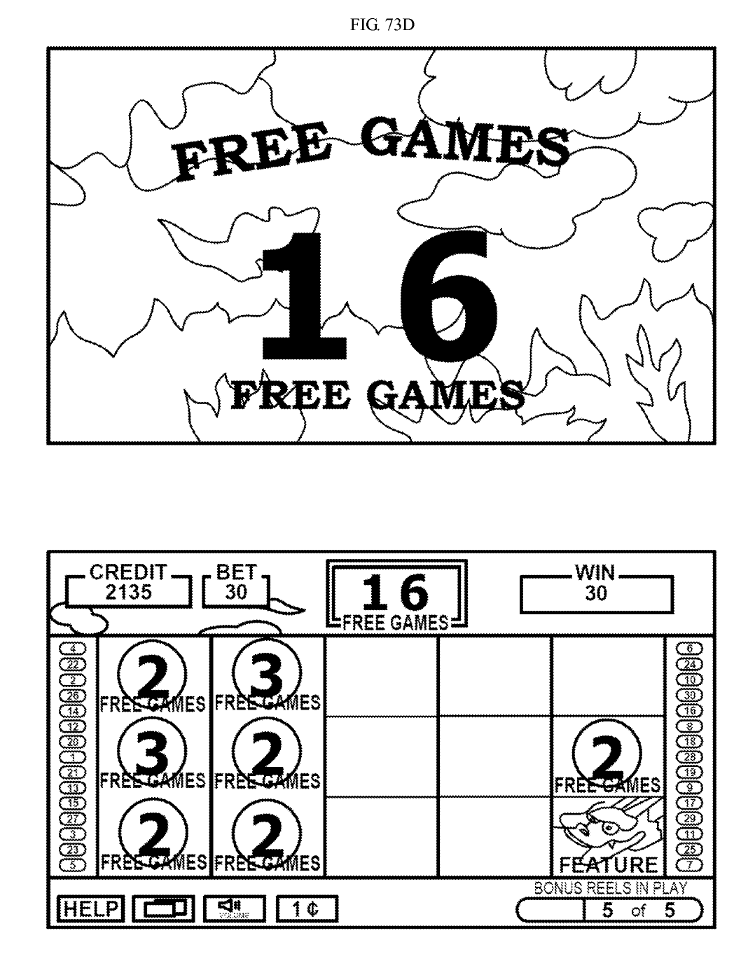

Next, as shown in FIG. 73A to FIG. 73C, in a middle row of the video reel 3b, the number of “2” is displayed. Further, as shown in FIG. 73D, in a lower row of the video reel 3b, the number of “2” is displayed, and in a middle row of the video reel 3e, the number of “2” is displayed.

As shown in FIG. 73D, on the upper display device 131, letters indicating “FREE GAMES 16 FREE GAMES” are displayed. This 16 indicates the sum of 2, 3, 2, 3, 2, 2, and 2 and shows that at this point in time, the number of unit games in the free game mode is 16.

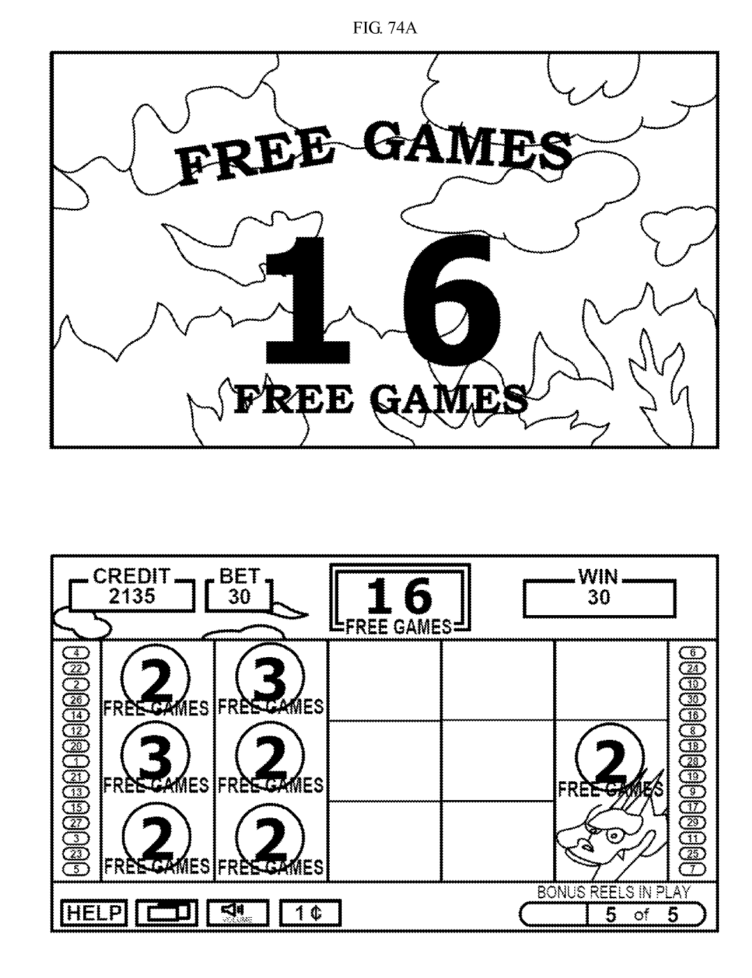

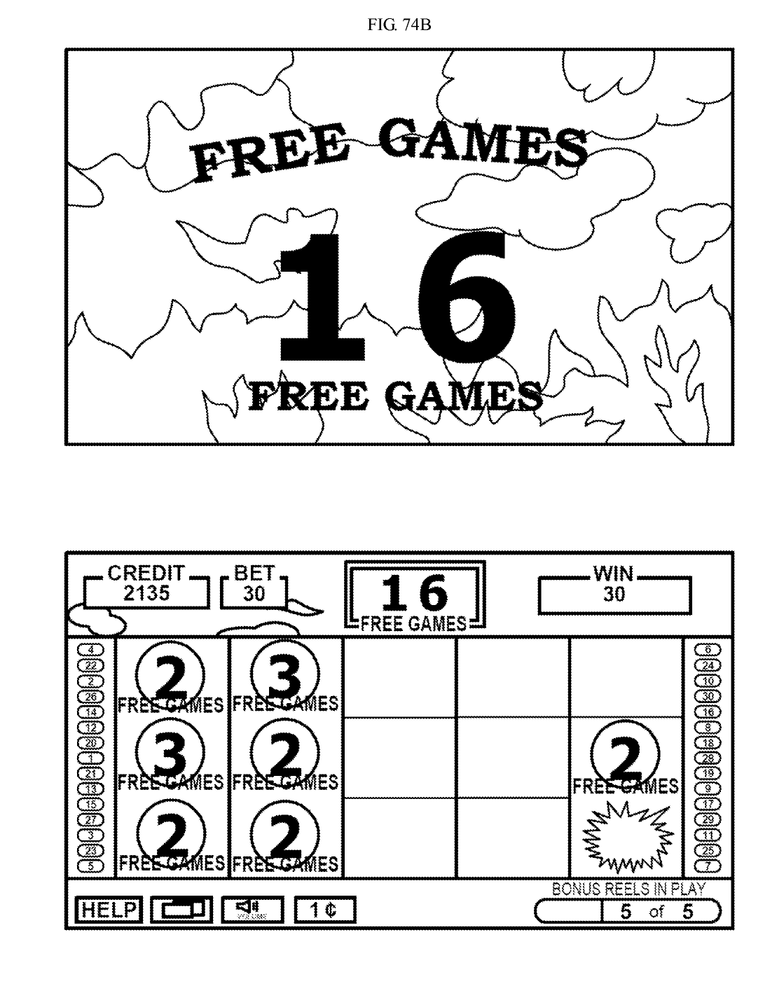

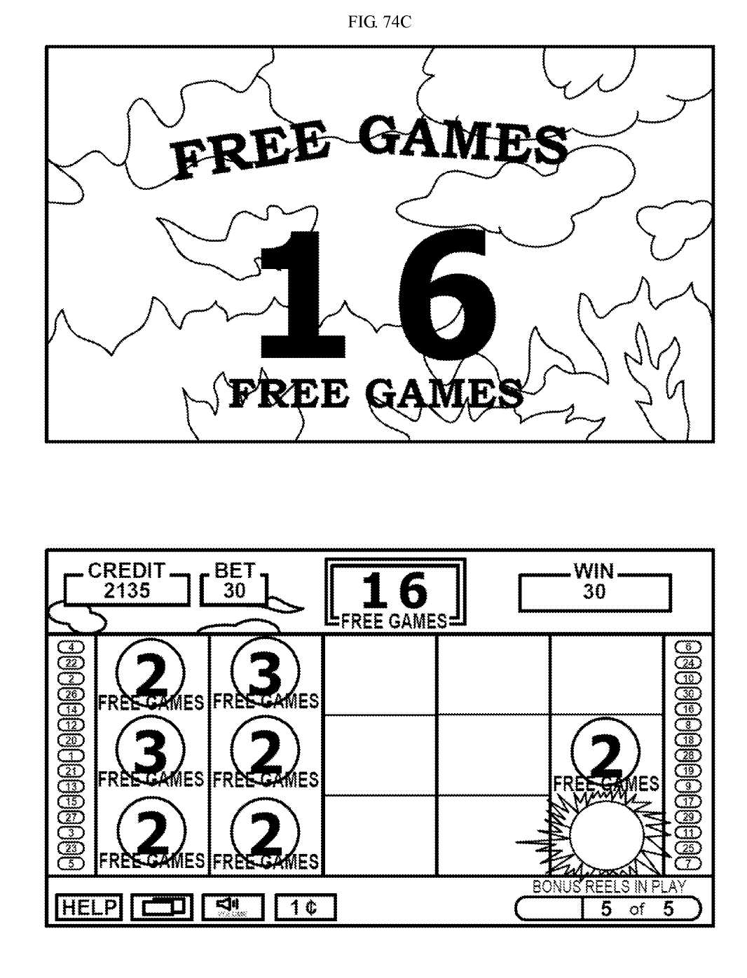

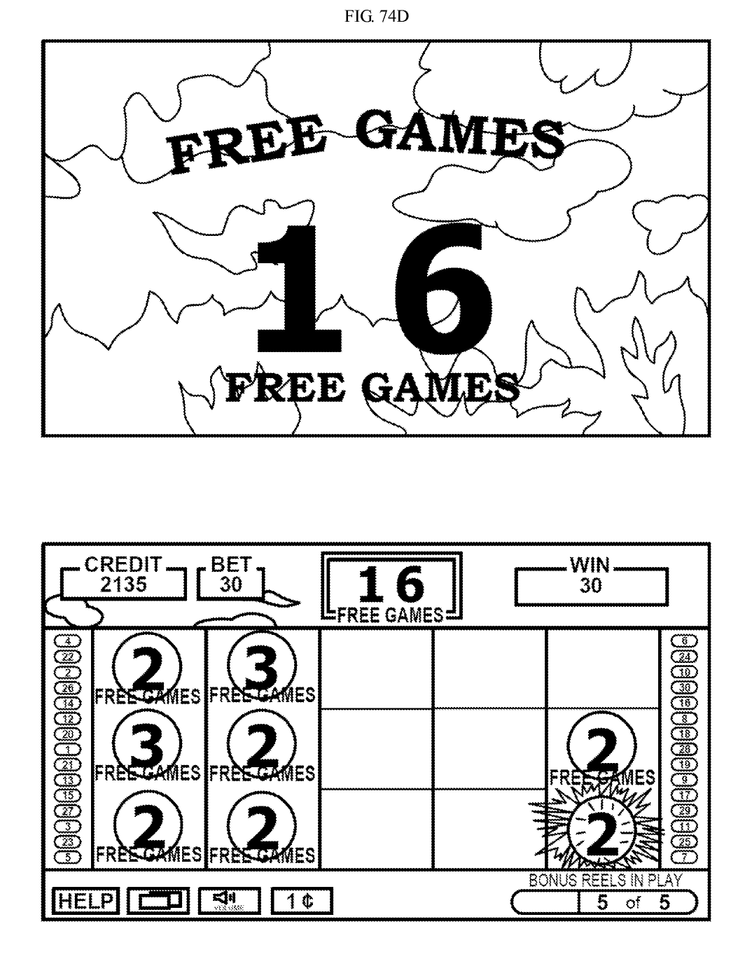

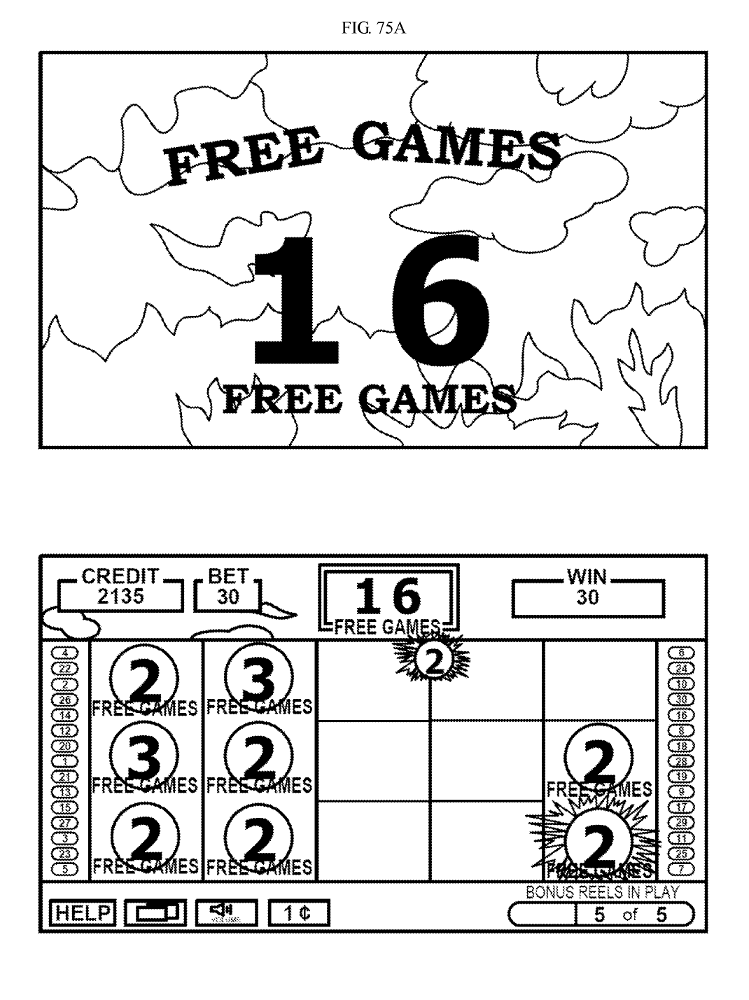

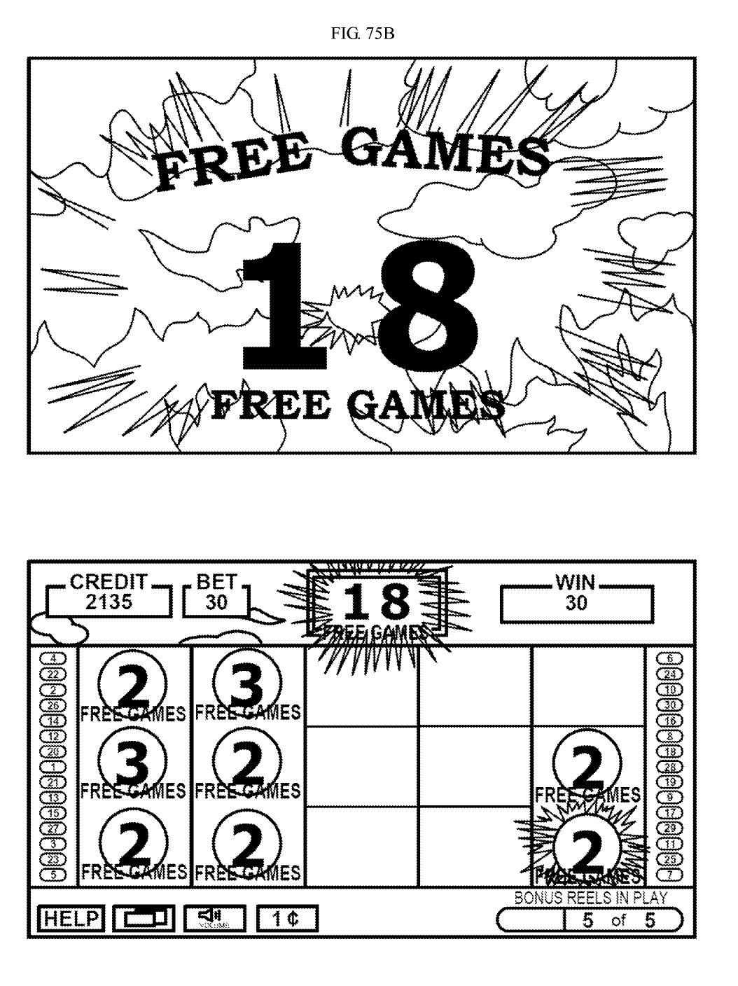

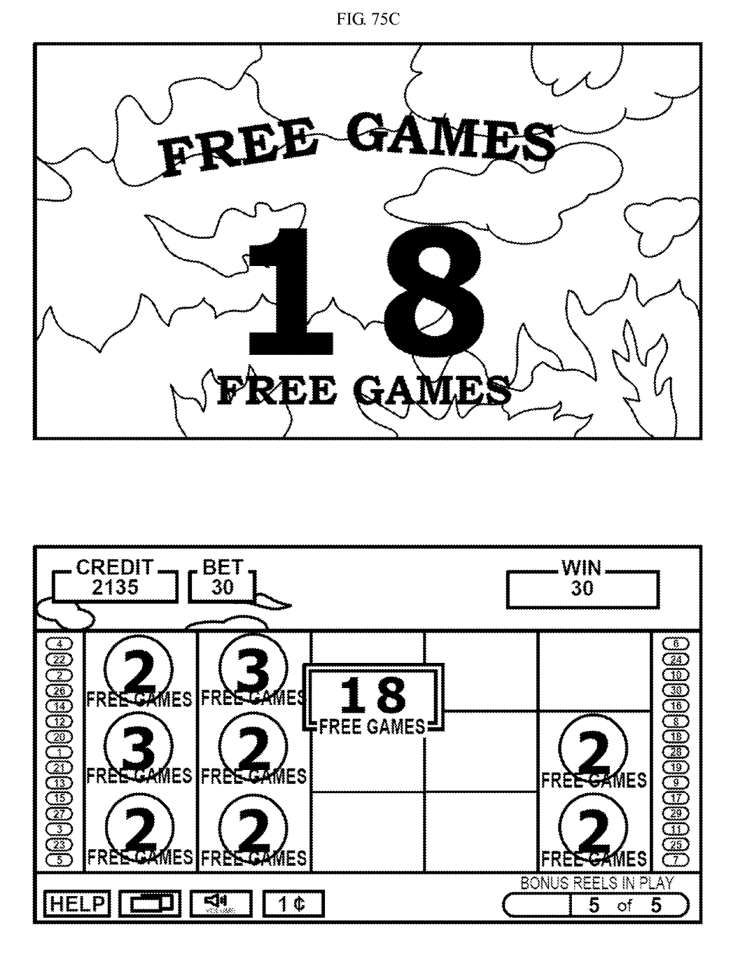

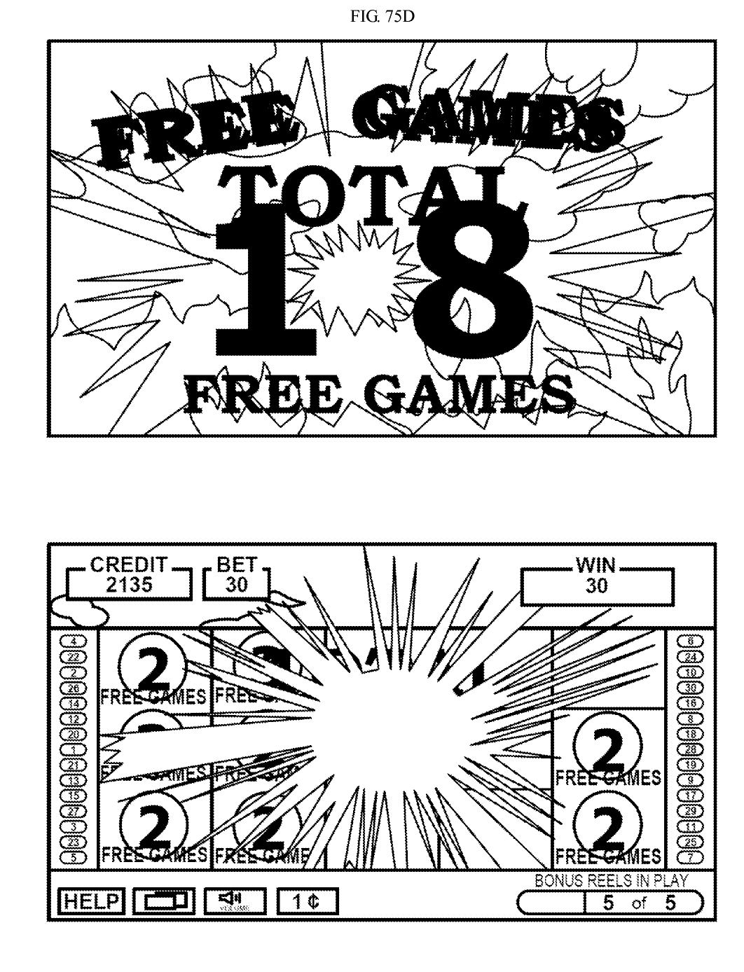

Next, as shown in FIG. 74A, an image of a dragon in the symbol of FEATURE in a lower row of the video reel 3e is once displayed in a brightened manner. Thereafter, as shown in FIG. 74B and FIG. 74C, the symbol of FEATURE in the lower row of the video reel 3e is displayed so as to be once exploded and disappear. Next, as shown in FIG. 74D, in the lower row of the video reel 3e, the number of “2” is displayed. As shown in FIG. 75A, the small number of “2” is displayed so as to be moving.

As shown in FIG. 75B, on the upper display device 131, letters indicating “FREE GAMES 18 FREE GAMES” are displayed. This 18 indicates the sum of 2, 3, 2, 3, 2, 2, 2, and 2 and shows that at this point in time, the number of unit games in the free game mode is 18.

As shown in FIG. 75C, the number of “18” is displayed so as to be moving, and as shown in FIG. 75D, the number of “18” is displayed so as to be illuminated. On the upper display device 131, letters indicating “FREE GAMES TOTAL 18 FREE GAMES” are displayed so as to be large.

As shown in FIG. 76A, the number of “18” is normally displayed. On the upper display device 131, letters indicating “FREE GAMES 18 FREE GAMES is displayed so as to have a normal size.

As described above, each of the maximum numbers of unit games in the free game mode is determined.

As shown in FIG. 76B, the images in the screens of the upper display device 131 and the lower display device 141 once disappear. Thus, it is made possible to cause a player to recognize that each unit game in the free game mode is initiated.

As shown in FIG. 76C, the unit game in the free game mode is initiated, and varying the five video reels 3a to 3e is started. As shown in FIG. 76D, on the upper display device 131, information indicating “WIN 16 CREDITS” is displayed, thereby indicating that in this unit game, 16 credits are awarded to a player as a payout.

Further, as shown in FIG. 77A, the unit game in the free game mode is initiated, and varying the five video reels 3a to 3e is started. As shown in FIG. 77B, the three video reels 3a to 3c are displayed in the stopped manner.

As shown in FIG. 77C, when it is determined by the symbol drawing process that the five video reels 3a to 3e are displayed in the stopped manner and on the three video reels, the symbols of FEATURE appear in the symbol display region 141d, a winning pattern is established. In this unit game, the winning pattern of the symbols of FEATURE is established, and the free game mode is retriggered.

As shown in FIG. 77C and FIG. 77D, letters indicating “RETRIGGER” are displayed so as to be superimposed on the five video reels 3a to 3e.

As shown in FIG. 78A, letters indicating “FREE GAMES NUMBER DRAWING” are displayed, and a process for determining a maximum number of unit games in the free game mode is executed.

As shown in FIG. 78B to FIG. 83A, with respect to each of the symbols of FEATURE which have appeared, each number of games is determined by the drawing process. A shown in FIG. 78C, first, with respect to the symbol of FEATURE in the upper row of the video reel 3a, the number of games is determined as 2.

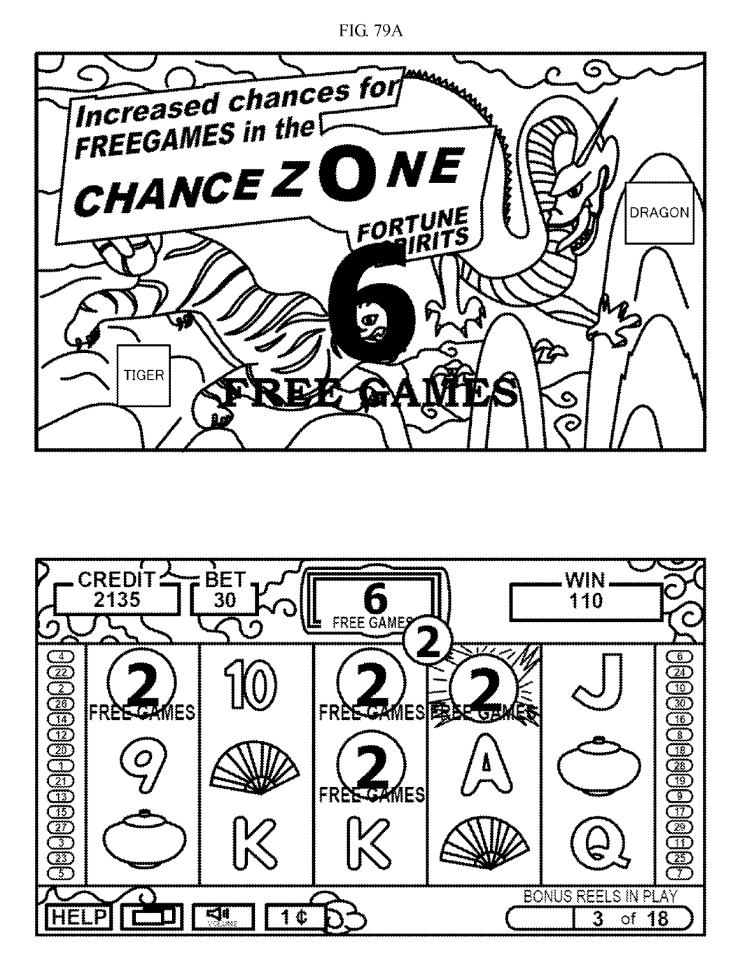

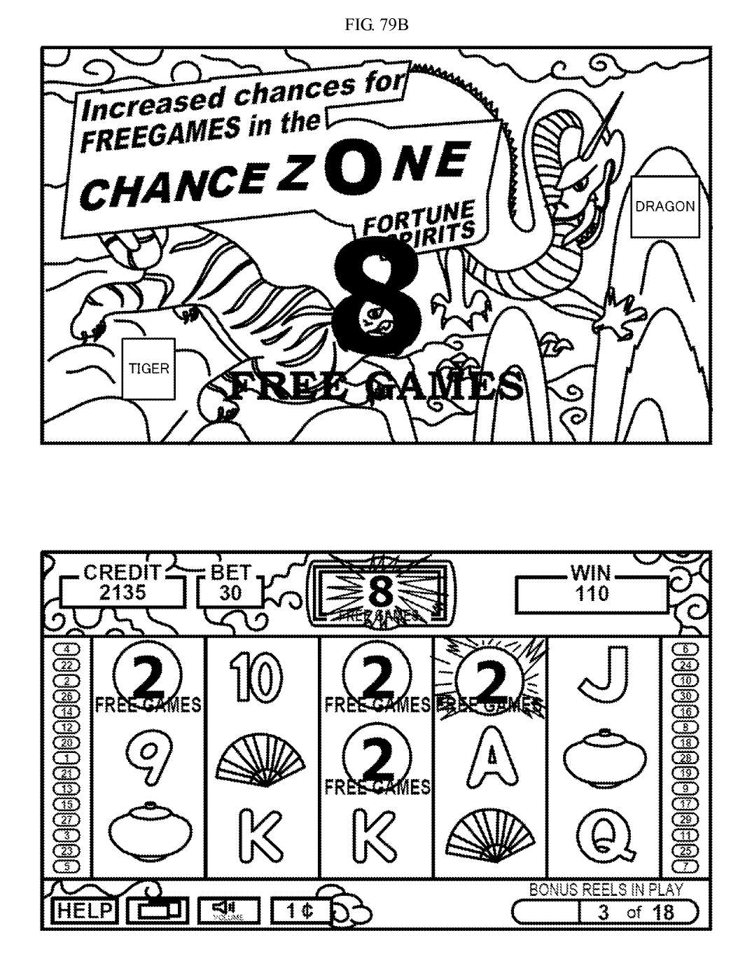

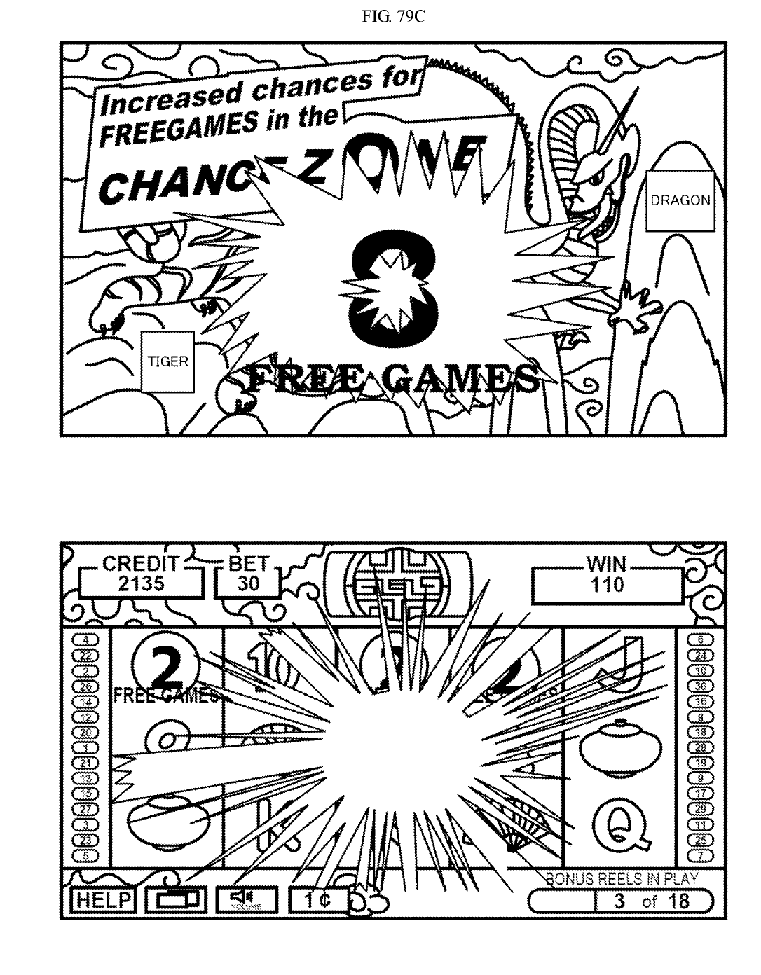

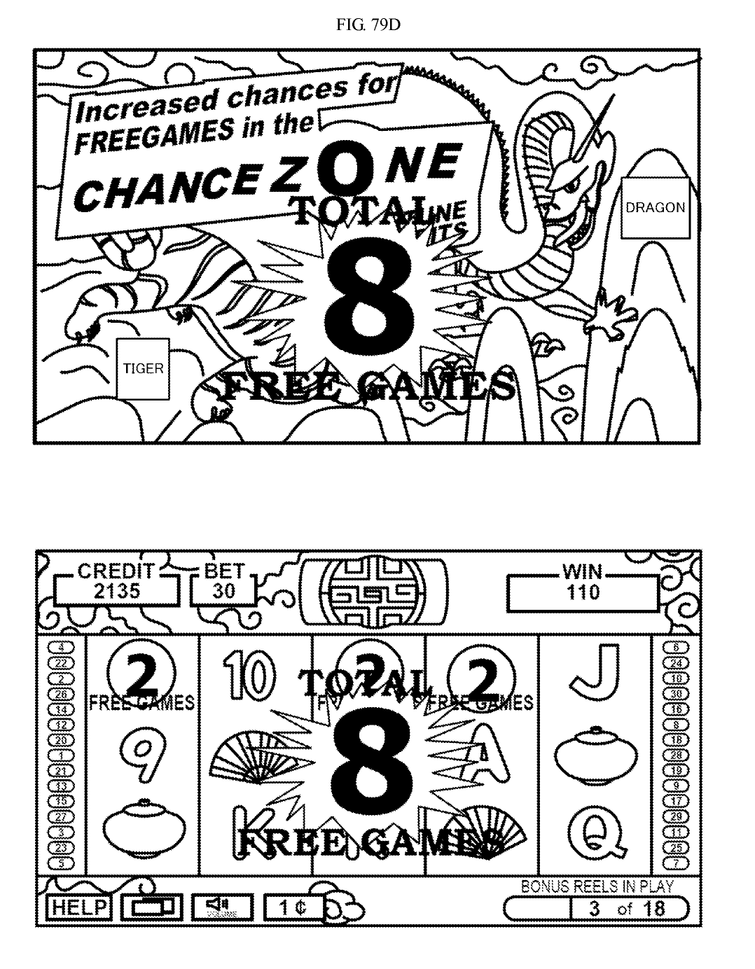

As shown in FIG. 78D, first, with respect to each of the symbol of FEATURE in the upper row of the video reel 3c and the symbol of FEATURE in the middle row of the video reel 3c, the number of games is determined as 2. Further, as shown in FIG. 79A, first, with respect to the symbol of FEATURE in the upper row of the video reel 3d, the number of games is determined as 2.

As shown in FIG. 79B to FIG. 79D, the total of unit games is determined as 8.

As shown in FIG. 80A to FIG. 80D, again, the unit game in the free game mode is executed. As shown in FIG. 80D, on the upper display device 131, information indicating “WIN 74 CREDITS” is displayed, thereby indicating that in this unit game, 74 credits are awarded to a player as a payout.

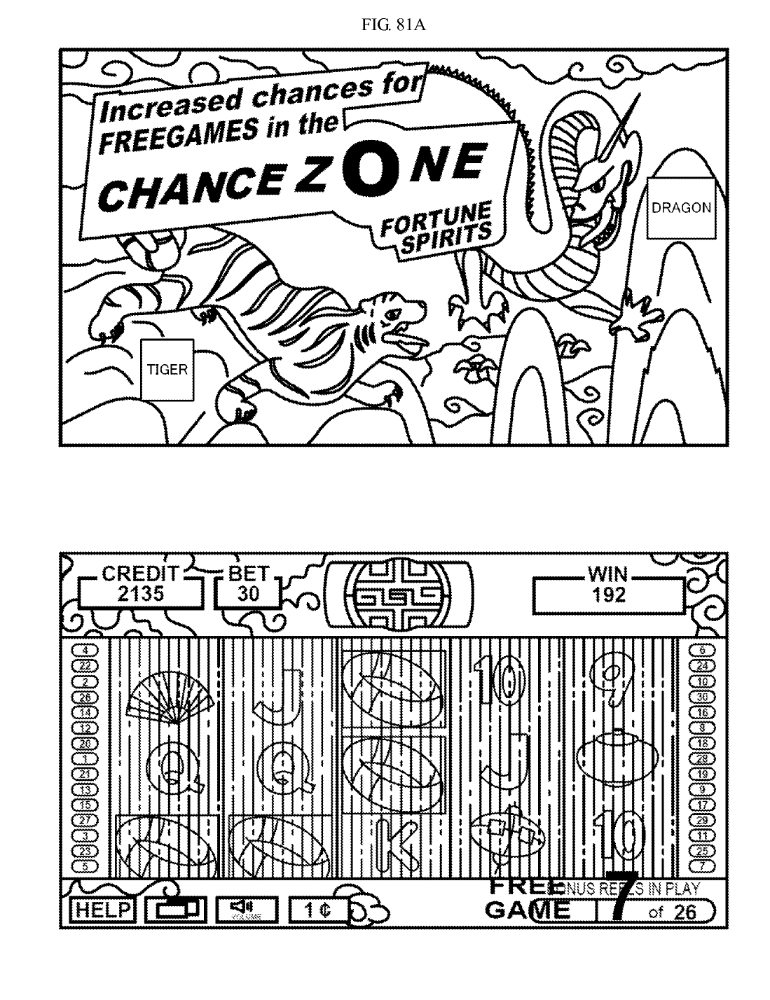

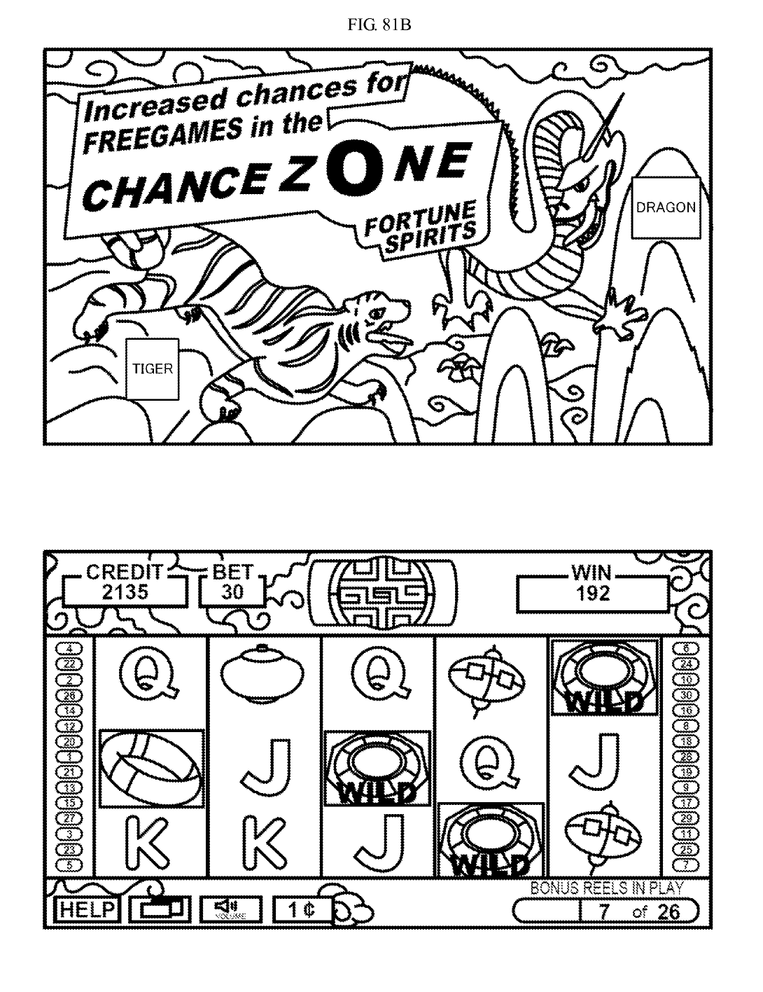

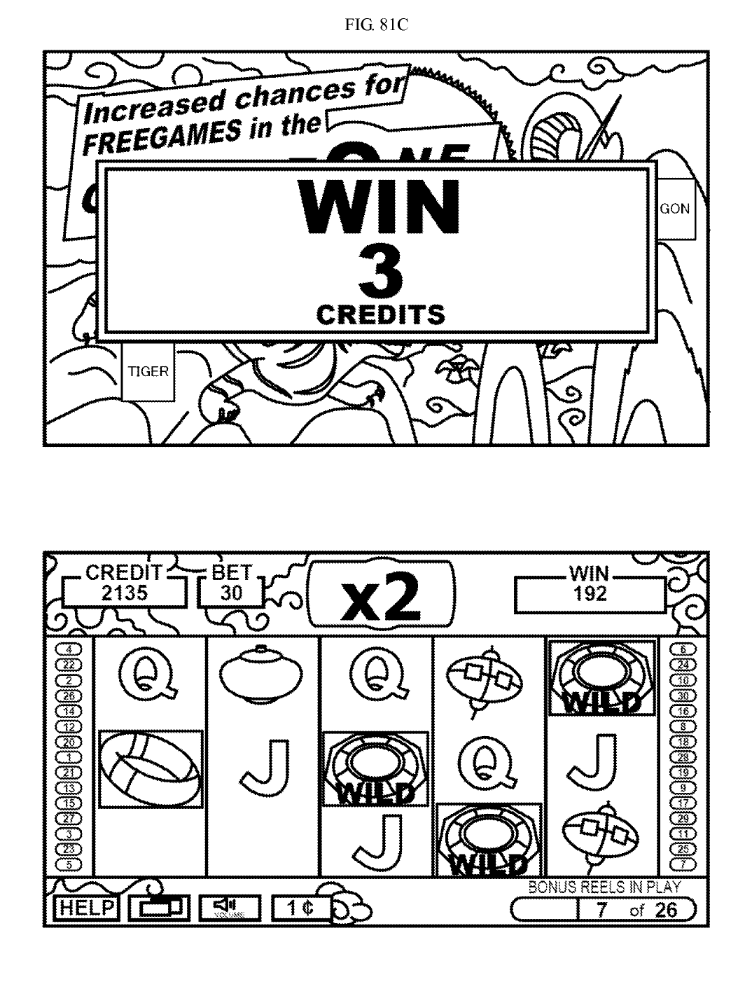

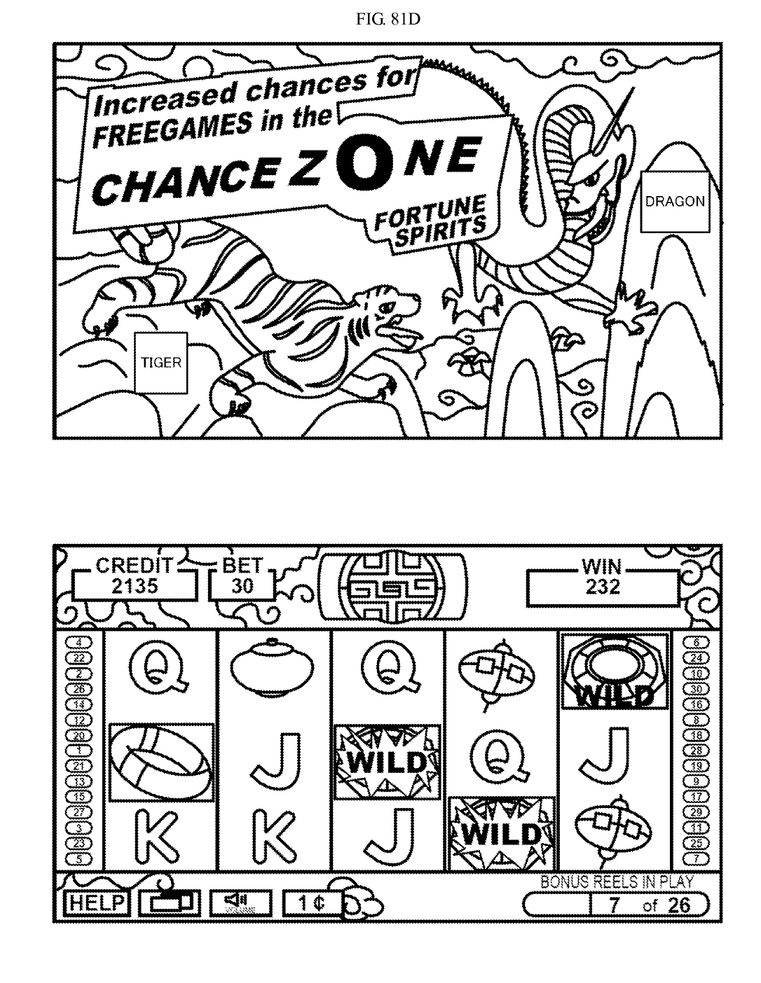

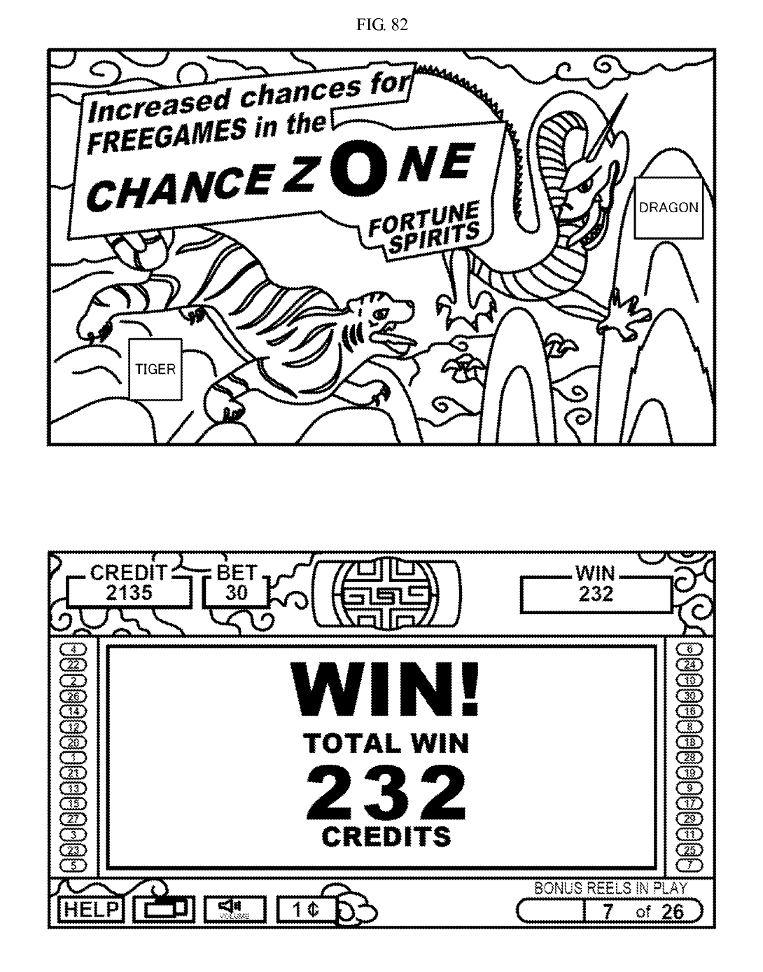

As shown in FIG. 81A to FIG. 81C, the subsequent unit game is executed. As shown in FIG. 81C, on the upper display device 131, information indicating “WIN 3 CREDITS” is displayed, thereby indicating that in this unit game, 3 credits are awarded to a player as a payout.

As shown in FIG. 81D and FIG. 82, when all of the unit games in the free game mode are finished, on the lower display device 141, information indicating “WIN! TOTAL WIN 232 CREDITS” is displayed, thereby indicating that in this free game mode, 232 credits are awarded to a player as all of payouts.

### REFERENCE SIGNS LIST

1 gaming machine
10 slot machine
3a, 3b, 3c, 3d, and 3e video reels
100 controller, game controller
200 main CPU
210 main RAM
131 upper display device
131b upper liquid crystal display panel
141 lower display device
141b lower liquid crystal panel
141d lower symbol display region

What is claimed is:

1. A gaming machine comprising:
a display for displaying a game outcome in a base game mode; and
a controller for controlling a first transition route along which a game mode is directly shifted to a free game mode in accordance with the game outcome and a second transition route along which once via a transit game mode, the game mode is shifted to the free game mode in accordance with the game outcome,
the controller being programmed to control a game so as to make a probability with which along the second transition route, the game mode is shifted from the transit game mode to the free game mode higher than a probability with which along the first transition route, the game mode is shifted from the base game mode to the free game mode.

2. The gaming machine according to claim 1, wherein
the controller is further programmed to execute processes described below:
a process in which when the game mode is shifted to the transit game mode along the second transition route, image information indicating that the game mode is the transit game mode is displayed on the display;
a process in which after the game mode has been shifted to the transit game mode along the second transition route, a drawing table used in the base game mode to draw for shifting to the free game mode is changed to a high probability drawing table, the high probability drawing table having a higher probability with which the game mode is shifted to the free game mode than a probability of the drawing table with which the game mode is shifted to the free game mode; and
a process in which a predetermined number of games in the transit game mode executed by using the high probability drawing table is managed, and when the predetermined number of games have been played, the game mode is shifted to the base game mode.

3. The gaming machine according to claim 1, wherein
a probability with which the game mode is shifted from the base game mode to the free game mode along the first transition route is set to be low, as compared with a probability with which the game mode is shifted from the base game mode to the transit game mode along the second transition route; and
the controller is further programmed to execute processes described below:
a process which is conducted such that with the base game mode as a starting point, a probability with which the game mode is shifted to the free game mode along the second transition route is high as a whole, as compared with a probability with which the game mode is shifted to the free game mode along the first transition route.

4. A gaming machine comprising:
a display for displaying an outcome of a unit game by rearranging a plurality of symbols; and
a controller for executing a unit game in a base game mode played on the condition of placing a bet and a unit game in a free game mode which does not require any bet to be placed,
the controller being programmed to execute processes described below:
a process (4-1) which is a transit game mode shifting process in which in the base game mode, upon the occurrence of a trigger which is generated when a first specific symbol is selected by conducting a symbol drawing process in which symbols to be rearranged are selected by a drawing, a game mode is shifted to a transit game mode; and
a process (4-2) which is a free game mode shifting process in which in the transit game mode, upon the occurrence of a trigger which is generated when a second specific symbol is selected by conducting the symbol drawing process, the game mode is shifted from the transit game mode to the free game mode.

5. The gaming machine according to claim 4, wherein
the controller executes a process (5-1) which is a free game mode shifting process in which in the base game mode, upon the occurrence of a trigger which is generated when the second specific symbol is selected by conducting the symbol drawing process, the game mode is shifted to the free game mode.

6. The gaming machine according to claim 5, wherein
a probability with which the game mode is shifted via the transit game mode to the free game mode by conducting the (4-1) process and the (4-2) process is higher than a probability with which the game mode is shifted to the free game mode by conducting the (5-1) free game mode shifting process.

7. The gaming machine according to claim 4, wherein
in each of the base game mode and the transit game mode, conducted is a game in which after scrolling along scroll lines symbol arrays which a plurality of kinds of symbols constitute, by rearranging a plurality of symbols, an outcome of a unit game is displayed, and
a number of the second specific symbols included in the symbol arrays used in the transit game mode is larger than a number of the second specific symbols included in the symbol arrays used in the base game mode.

8. The gaming machine according to claim 4, wherein
when upon rearranging the plurality of symbols in the transit game mode, a number of the scroll lines having the second specific symbol is greater than or equal to a predetermined number, the game mode is shifted to the free game mode.

9. The gaming machine according to claim 8, wherein
in the transit game mode, conducted is a game in which a unit game which does not require any bet to be placed can be played at up to a predetermined maximum number of times, and
in a unit game played last among the unit games, the second specific symbols are rearranged on the scroll lines whose number is obtained by subtracting one or more from the predetermined number.
